SEQUENCE LISTING (634 sequences)

SEQ ID NO: 1 - DNA, 348 bp, Homo Sapiens
gaggtgcagctgttggagtctgggggaggcttggtacagcctggggggtccctgcgtctctcctgtgcagcctccggattcacctttagcagctatgccatgagctgggtccgccaggctccagggaagggtctagagtgggtctcagctattagtggtagtggtggtagcacatactacgcagactccgtgaagggccggttcaccatctcccgtgacaattccaagaacacgctgtatctgcaaatgaacagcctgcgtgccgaggacaccgcggtatattactgtgcgaaaagttatggtgcttttgactactggggtcagggaaccctggtcaccgtctcgagc

SEQ ID NO: 2 - DNA, 348 bp, Homo Sapiens
ctccacgtcgacaacctcagaccccctccgaaccatgtcggaccccccagggacgcagagaggacacgtcggaggcctaagtggaaatcgtcgatacggtactcgacccaggcggtccgaggtcccttcccagatctcacccagagtcgataatcaccatcaccaccatcgtgtatgatgcgtctgaggcacttcccggccaagtggtagagggcactgttaaggttcttgtgcgacatagacgtttacttgtcggacgcacggctcctgtggcgccatataatgacacgcttttcaataccacgaaaactgatgaccccagtcccttgggaccagtggcagagctcg

SEQ ID NO: 3 - protein, 116 aa, Homo Sapiens
EVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCAKSYGAFDYWGQGTLVTVSS

SEQ ID NO: 4 - DNA, 324 bp, Homo Sapiens
gacatccagatgacccagtctccatcctccctgtctgcatctgtaggagaccgtgtcaccatcacttgccgggcaagtcagagcattagcagctatttaaattggtaccagcagaaaccagggaaagcccctaagctcctgatctatgctgcatccagtttgcaaagtggggtcccatcacgtttcagtggcagtggatctgggacagatttcactctcaccatcagcagtctgcaacctgaagattttgctacgtactactgtcaacagagttacagtacccctaatacgttcggccaagggaccaaggtggaaatcaaacgg

SEQ ID NO: 5 - DNA, 324 bp, Homo Sapiens
ctgtaggtctactgggtcagaggtaggagggacagacgtagacatcctctggcacagtggtagtgaacggcccgttcagtctcgtaatcgtcgataaatttaaccatggtcgtctttggtccctttcggggattcgaggactagatacgacgtaggtcaaacgtttcaccccagggtagtgcaaagtcaccgtcacctagaccctgtctaaagtgagagtggtagtcgtcagacgttggacttctaaaacgatgcatgatgacagttgtctcaatgtcatggggattatgcaagccggttccctggttccacctttagtttgcc

SEQ ID NO: 6 - protein, 108 aa, Homo Sapiens
DIQMTQSPSSLSASVGDRVTITCRASQSISSYLNWYQQKPGKAPKLLIYAASSLQSGVPSRFSGSGSGTDFTLTISSLQPEDFATYYCQQSYSTPNTFGQGTKVEIKR

SEQ ID NO: 7 - protein, 115 aa, Unknown
  antibody sequence
DIQMTQSPSSLSASVGDRVTITCQASQDISNYLAWYQQKPGKAPELRIYDASNLETGVPSRFSGSGSGTDFTFTISSLQPEDIATYYCQQYQNLPLTFGPGTKVDIKRTVAAPSV

SEQ ID NO: 8 - protein, 214 aa, Unknown
  antibody sequence
QIVLTQSPAIMSASPGEKVTMTCSASSSVYYMYWYQQKPGSSPRLLIYDTSNLASGVPVRFSGSGSGTSYSLTISRMEAEDAATYYCQQWSSYPPITFGVGTKLELKRADAAPTVSIFPPSSEQLTSGGASVVCFLNNFYPKDINVKWKIDGSERQNGVLNSWTDQDSKDSTYSMSSTLTLTKDEYERHNSYTCEATHKTSTSPIVKSFNRNEC

SEQ ID NO: 9 - protein, 212 aa, Unknown
  antibody sequence
DIVLTQSPAIMSASPGEKVTMTCSASSSVNYMYWYQQKSGTSPKRWIYDTSKLASGVPVRFSGSGSGTSYSLTISSMETEDAATYYCQQWGRNPTFGGGTKLEIKRADAAPTVSIFPPSSEQLTSGGASVVCFLNNFYPKDINVKWKIDGSERQNGVLNSWTDQDSKDSTYSMSSTLTLTKDEYERHNSYTCEATHKTSTSPIVKSFNRNEC

SEQ ID NO: 10 - protein, 106 aa, Unknown
  antibody sequence
QIVLTQSPAIMSASPGEKVTMTCSASSSVSYMHWYQQKSGTSPKRWIYDTSKLASGVPARFSGSGSGTSYSLTISSMEAEDAATYYCQQWSSNPYTFGGGTKLEIK

SEQ ID NO: 11 - protein, 106 aa, Unknown; identical to SEQ ID NO: 10
  antibody sequence

SEQ ID NO: 12 - protein, 214 aa, Unknown
  antibody sequence
EIQLTQSPSSLSASLGERVSLTCRTSQEISGYLSWLQQKPDGTIKRLIYDATKLDSGAPKRFSGSRSGSDYSLTISSLESEDFADYYCLQYASFPRTFGGGTKLEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 13 - protein, 108 aa, Unknown
  antibody sequence
DIQMTQSPSSLSASVGDRVTITCQASQDISDYLIWYQQKLGKAPNLLIYDASTLETGVPSRFSGSGSGTEYTFTISSLQPEDIATYYCQQYDDLPYTFGQGTKVEIKR

SEQ ID NO: 14 - protein, 108 aa, Unknown; identical to SEQ ID NO: 13
  antibody sequence

SEQ ID NO: 15 - protein, 108 aa, Unknown; identical to SEQ ID NO: 13
  antibody sequence

SEQ ID NO: 16 - protein, 104 aa, Unknown
  antibody sequence
DIQMTQSPSSLSASVGDRVTITCQASQDISDYLIWYQQKLGKAPNLLIYDASTLETGVPSRFSGSGSGTEYTFTISSLQPEDIATYYCQQYDDLPYTFGQGTKV

SEQ ID NO: 17 - protein, 95 aa, Unknown
  antibody sequence
DIQMTQSPSTLSASVGDRVTITCRASQSISSWLAWYQQKPGKAPKLLIYDASSLESGVPSRFSGSGSGTEFTLTISSLQPDDFATYYCQQYNSYS

SEQ ID NO: 18 - protein, 96 aa, Unknown
  antibody sequence
DIVLTQAPPSLDVSQGRATISCRTSKSVRTSSYSYMHWYQQKPGQPPKLLNLCNQVSRVPARFSGSGSGTDFTLKIHPVEEEDAATYFCQQSNENP

SEQ ID NO: 19 - protein, 95 aa, Unknown
  antibody sequence
VIWMTQSPSLLSASTGDRVTISCRMSQGISSYLAWYQQKPGKAPELLIYAASTLQSGVPSRFSGSGSGTDFTLTISCLQSEDFATYYCQQYYSFP

SEQ ID NO: 20 - protein, 92 aa, Unknown
  antibody sequence
AIQLTQSPSSLSASVGDRVTITCRASQGISSAYQQKPGKAPKLLIYDASSLESGVPSRFSGSGSGTDFTLTISSLQPEDFATYYCQQFNNYP

SEQ ID NO: 21 - protein, 93 aa, Unknown
  antibody sequence
AIQLTQSPSSLSASVGDRVTITCRASQGISSAWYQQKPGKAPKLLIYDASSLESGVPSRFSGSGSGTDFTLTISSLQPEDFATYYCQQFNNYP

SEQ ID NO: 22 - protein, 93 aa, Unknown
  antibody sequence
DIQMTQSPSSLSASVGDRVTITCQASQDISNYLNWYQQKPGKAPKLLIYDNLETGVPSRFSGSGSGTDFTFTISSLQPEDIATYYCQQYDNLP

SEQ ID NO: 23 - protein, 93 aa, Unknown; identical to SEQ ID NO: 22
  antibody sequence

SEQ ID NO: 24 - protein, 95 aa, Unknown
  antibody sequence
DIQMIQSPSFLSASVGDRVSIICWASEGISSNLAWYLQKPGKSPKLFLYDAKDLHPGVSSRFSGRGSGTDFTLTIISLKPEDFAAYYCKQDFSYP

SEQ ID NO: 25 - protein, 93 aa, Unknown
  antibody sequence
EIVLTQSPATLSLSPGERATLSCRASQSVSSYLAWYQQKPGQAPRLLIYDNRATGIPARFSGSGSGTDFTLTISSLEPEDFAVYYCQQRSNWP

SEQ ID NO: 26 - protein, 93 aa, Unknown
  antibody sequence
EIVLTQSPATLSLSPGERATLSCRASQGVSSYLAWYQQKPGQAPRLLIYDNRATGIPARFSGSGPGTDFTLTISSLEPEDFAVYYCQQRSNWH

SEQ ID NO: 27 - protein, 96 aa, Unknown
  antibody sequence
EIVLTQSPATLSLSPGERATLSCGASQSVSSSYLAWYQQKPGLAPRLLIYDASSRATGIPDRFSGSGSGTDFTLTISRLEPEDFAVYYCQQYGSSP

SEQ ID NO: 28 - protein, 95 aa, Unknown
  antibody sequence
QIVLTQSPAIMSADPGEKVTMTCSASSSVSYMYWYQQKPGSSPRLLIYDTSNLASGVPVRFSGSGSGTSYSLTISRMEAEDAATYYCQQWSSYPP

SEQ ID NO: 29 - protein, 94 aa, Unknown
  antibody sequence
QIVLTQSPAIMSASPGEKVTMTCSASSSVSYMHWYQQKSGTSPKRWIYDTSKLASGVPARFSGSGSGTSYSLTISSMEAEDAATYYCQQWSSNP

SEQ ID NO: 30 - protein, 95 aa, Unknown
  antibody sequence
QIVLTQSPAIMSASPGEKVTMTCSASSSVSYMYWYQQKPGSSPRLWIYDTSNLVSGVPARFSGSRSGTSYSLTISSMEAEDAATYYCQQYSGYPS

SEQ ID NO: 31 - protein, 95 aa, Unknown
  antibody sequence
ENVLTQSPAIMSASPGEKVTMTCSASSSVSYMHWYQQKSSTSPKLWIYDTSKLASGVPGRFSGSGSGNSYSLTISSMEAEDVATYYCFQGSGYPL

SEQ ID NO: 32 - protein, 94 aa, Unknown
  antibody sequence
QILLTQSPAIMSASPGEKVTMTCSASSSVSYMHWYQQKPGSSPKPWIYDTSNLASGFPARFSGSGSGTSYSLIISSMEAEDAATYYCHQRSSYP

SEQ ID NO: 33 - protein, 94 aa, Unknown
  antibody sequence
QIVLTQSPAIMSASPGEKVTMTCSASSSISYMHWYQQKPGTSPKRWIYDTSKLASGVPARFSGSGSGTSYSLTISSMEAEDAATYYCHQRSSYP

SEQ ID NO: 34 - protein, 94 aa, Unknown
  antibody sequence
DIQMTQSPASLSASVGETVTITCQASENIASDLAWYQKQGKSPQLLVYDARNLADGVPSRFSGSGSGTHYSLNIHSLQSEDVARYYCQHYYGTP

SEQ ID NO: 35 - protein, 100 aa, Unknown
  antibody sequence
AQVLTQTESPVSAPVGGTVTINCQASQSVYDNNYLSWYQQKPGQPPKLLIYDASKLASGVPSRFSGSGSGTQFTLTISGVQCDDAATYYCQGSYYSSGWY

SEQ ID NO: 36 - protein, 100 aa, Unknown
  antibody sequence
AQGPTQTPSSVSAAVGGTVTINCQTSESFYSNNILSWYQQKPGQPPKLLIYDASTLASGVPSRFKGSGSGTQFTLTISDVQCDDAATYYCQGSYHSSGWY

SEQ ID NO: 37 - protein, 99 aa, Unknown
  antibody sequence
AAVLTQTPSPVSAAVGGTVTIKCQSSQSVYNNNLLSWYQQKPGQPPKLLIYDASNLASGVPDRFSGSGSGTQFTLTISGVQCDDAATYYCLGGYDDDAD

SEQ ID NO: 38 - protein, 98 aa, Unknown
  antibody sequence
AVVLTQTASPVSAAVGGTVTINCQASQSISTALAWYQQKPGQRPKLLIYDASKLASGVPSRFKGSGSGTQFTLTISGVQCDDAATYYCQQGYSSSSAD

SEQ ID NO: 39 - protein, 121 aa, Unknown
  antibody sequence
EVKVIESGGGLVQPGGSLKLSCAASGFDFSRYWMSWVRQAPGKGLEWIGEINPDSSTINYTPSLKDKFIISRDNAKNTLYLQMSKVRSEDTALYYCARLGGDLHYYAMDYWGQGTSVTVSS

SEQ ID NO: 40 - protein, 121 aa, Unknown; identical to SEQ ID NO: 39
  antibody sequence

SEQ ID NO: 41 - protein, 220 aa, Unknown
  antibody sequence
EVKLLESGGGLVQPGGSLKLSCAASGFDFSKYWMSWVRQAPGKGLEWIGEIHPDSGTINYTPSLKDKFIISRDNAKNSLYLQMSKVRSEDTALYYCARLHYYGYNAYWGQGTLVTVSAESARNPTIYPLTLPPALSSDPVIIGCLIHDYFPSGTMNVTWGKSGKDITTVNFPPALASGGRYTMSNQLTLPAVECPEGESVKCSVQHDSNPVQELDVNCSG

SEQ ID NO: 42 - protein, 135 aa, Unknown
  antibody sequence
MYRSAFSVGLETRVTVPNVPIRFTKIFYNQQNHYDGSTGKFYCNIPGLYYFSYHITVYMKDVKVSLFKKDKAVLFTYDQYQEKNVDQASGSVLLHLEVGDQVWLQVYGDGDHNGLYADNVNDSTFTGFLLYHDTN

SEQ ID NO: 43 - protein, 135 aa, Unknown; identical to SEQ ID NO: 42
  antibody sequence

SEQ ID NO: 44 - protein, 135 aa, Unknown; identical to SEQ ID NO: 42
  antibody sequence

SEQ ID NO: 45 - protein, 135 aa, Unknown; identical to SEQ ID NO: 42
  antibody sequence

SEQ ID NO: 46 - protein, 135 aa, Unknown; identical to SEQ ID NO: 42
  antibody sequence

SEQ ID NO: 47 - protein, 135 aa, Unknown; identical to SEQ ID NO: 42
  antibody sequence

SEQ ID NO: 48 - protein, 217 aa, Unknown
  antibody sequence
AVQLEQSGPGLVRPSQTLSLTCTVSGTSFDDYYWTWVRQPPGRGLEWIGYVFYTGTTLLDPSLRGRVTMLVNTSKNQFSLRLSSVTAADTAVYYCARNLIAGGIDVWGQGSLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEP

SEQ ID NO: 49 - protein, 225 aa, Unknown
  antibody sequence
EVQLVESGGGLVQPGRSLRLSCVTSGFTFDDYAMHWVRQSPGKGLEWVSGISWNTGTIIYADSVKGRFIISRDNAKNSLYLQMNSLRVEDTALYYCAKTRSYVVAAEYYFHYWGQGILVTVSSGSASAPTLFPLVSCENSNPSSTVAVGCLAQDFLPDSITFSWKYKNNSDISSTRGFPSVLRGGKYAATSQVLLPSKDVMQGTNEHVVCKVQHPNGNKEKDVPL

SEQ ID NO: 50 - protein, 148 aa, Unknown
  antibody sequence
DVQLQASGGGSVQAGGSLRLSCAASGYTIGPYCMGWFRQAPGKEREGVAAINMGGGITYYADSVKGRFTISQDNAKNTVYLLMNSLEPEDTAIYYCAADSTIYASYYECGHGLSTGGYGYDSWGQGTQVTVSSGRYPYDVPDYGSGRA

SEQ ID NO: 51 - protein, 216 aa, Unknown
  antibody sequence
DVQLQQSGPELEKPGASVKISCKASGFSLPGHNINWIVQRNGKSLEWIGNIDPYYGGTNFNPKFKGKATLTVDKSSSTLYMHLTSLQSEDSAVYYCARRRDGNYGFTYWGQGTLVTVSAAKTTPPSVYPLAPGSAAQTNSMVTLGCLVKGYFPEPVTVTWNSGSLSSGVHTFPAVLQSDLYTLSSSVTVPSSTWPSETVTCNVAHPASSTKVDKKI

SEQ ID NO: 52 - protein, 97 aa, Unknown
  antibody sequence
QDTLKEYGPGKLPSQTFSLTCTFSGFSLSTYGMMVSWMCQPSGKGLVWLALIWCNNDKGYNPFLRSQLTISKDTSNNQVFLKITSVDPADTATYYCA

SEQ ID NO: 53 - protein, 101 aa, Unknown
  antibody sequence
QVQLQQSGPGLVKPSQTLSLTCAISGDSVSSNSAAWNWIRQSPSRGLEWLGRTYYRSKWYNDYAVSVKSRITINPDTSKNQFSLQLNSVTPEDTAVYYCAR

SEQ ID NO: 54 - protein, 210 aa, Unknown
  antibody sequence
DIQMTQSPAIMSASPGEKVTMTCSASSSVSYMYWYQQKPGSSPRLLIYDSTNLASGVPVRFSGSGSGTSYSLTISRMEAEDAATYYCQQWSTYPLTFGAGTKLELKRADAAPTVSIFPPSSEQLTSGGASVVCFLNNFYPKDINVKWKIDGSERQNGVLNSWTDQDSKDSTYSMSSTLTLTKDEYERHNSYTCEATHKTSTSPIVKSFNR

SEQ ID NO: 55 - protein, 210 aa, Unknown
  antibody sequence
QIVSTQSPAIMSASPGEKVTMTCSASSSRSYMQWYQQKPGTSPKRWIYDTSKLASGVPARFSGSGSGTSYSLTISSMEAEDAATYYCHQRSSYTFGGGTKLEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGE

SEQ ID NO: 56 - protein, 214 aa, Unknown
  antibody sequence
ELVMTQSPSSLSASVGDRVNIACRASQGISSALAWYQQKPGKAPRLLIYDASNLESGVPSRFSGSGSGTDFTLTISSLQPEDFAIYYCQQFNSYPLTFGGGTKVEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 57 - protein, 214 aa, Unknown; identical to SEQ ID NO: 56
  antibody sequence

SEQ ID NO: 58 - protein, 107 aa, Unknown
  antibody sequence
EIVMTQSPASLSLSPGERATLSCRASQSVSNYLAWYQQKPGQAPRLLIHDASGRATGIPDRFSGSTDFTLTISRLEPEDFAVYYCQQRANWGTWTFGQGTKVEIKRT

SEQ ID NO: 59 - protein, 215 aa, Unknown
  antibody sequence
EIVLTQSPATLSLSPGERATLSCGASQSVSSNYLAWYQQKPGQAPRLLIYDASSRATGIPDRFSGSGSGTDFTLTISRLEPEDFAVYYCQQYGSSPLTFGGGTKVEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 60 - protein, 210 aa, Unknown; identical to SEQ ID NO: 54
  antibody sequence

SEQ ID NO: 61 - DNA, 27 bp, Artificial Sequence
  synthetic oligonucleotide
gagcgccgtgcacaggtgcagctgttg

SEQ ID NO: 62 - DNA, 33 bp, Artificial Sequence
  synthetic oligonucleotide
gagtcgacttgcggccgcgctcgagacggtgac

SEQ ID NO: 63 - DNA, 35 bp, Artificial Sequence
  synthetic oligonucleotide
gagcgccgtgcacagatccagatgacccagtctcc

SEQ ID NO: 64 - DNA, 38 bp, Artificial Sequence
  synthetic oligonucleotide
gagtcgacttgcggccgcccgtttgatttccaccttgg

SEQ ID NO: 65 - DNA, 65 bp, Artificial Sequence
  synthetic oligonucleotide
tgcacaggtccactgcaggaggcggccgcagaacaaaaactcatctcagaagaggatctgaattc

SEQ ID NO: 66 - DNA, 65 bp, Artificial Sequence
  synthetic oligonucleotide
ggccgaattcagatcctcttctgagatgagtttttgttctgcggccgcgaggacgtcacctgctg

SEQ ID NO: 67 - DNA, 36 bp, Artificial Sequence
  primer
gagtcgacttgcggccgcgctcgagacggtgaccag

SEQ ID NO: 68 - DNA, 36 bp, Artificial Sequence
  primer
gagcgccgtgcacaggtgcagctgttggagtctggg

SEQ ID NO: 69 - DNA, 24 bp, Artificial Sequence
  primer
atggttgttgtcattgtcggcgca

SEQ ID NO: 70 - DNA, 24 bp, Artificial Sequence
  primer
atgaggttttgctaaacaactttc

SEQ ID NO: 71 - DNA, 35 bp, Artificial Sequence; identical to SEQ ID NO: 63
  primer

SEQ ID NO: 72 - DNA, 38 bp, Artificial Sequence; identical to SEQ ID NO: 64
  primer

SEQ ID NO: 73 - DNA, 27 bp, Artificial Sequence
  primer
gagcgccgtgcacaggtgcagctgttg

SEQ ID NO: 74 - DNA, 33 bp, Artificial Sequence; identical to SEQ ID NO: 62
  primer

SEQ ID NO: 75 - DNA, 35 bp, Artificial Sequence
  oligonucleotide
gcagcatagatcaggagknnaggggctttccctgg

SEQ ID NO: 76 - DNA, 34 bp, Artificial Sequence
  oligonucleotide
gcaaactggatgcagcataknncaggagcttagg

SEQ ID NO: 77 - DNA, 34 bp, Artificial Sequence
  oligonucleotide
gcaaactggatgcagcknngatcaggagcttagg

SEQ ID NO: 78 - DNA, 34 bp, Artificial Sequence
  oligonucleotide
gcaaactggatgcknnatagatcaggagcttagg

SEQ ID NO: 79 - DNA, 31 bp, Artificial Sequence
  oligonucleotide
ttcactctcaccnnkagcagtctgcaacctg

SEQ ID NO: 80 - DNA, 28 bp, Artificial Sequence
  oligonucleotide
ccggaggctgcacaggagagacgcaggg

SEQ ID NO: 81 - DNA, 53 bp, Artificial Sequence
  oligonucleotide
ccctgcgtctctcctgtgcagcctccggannkacctttagcagctatgccatg

SEQ ID NO: 82 - DNA, 28 bp, Artificial Sequence
  oligonucleotide
gaatccggaggctgcacaggagagacgc

SEQ ID NO: 83 - DNA, 53 bp, Artificial Sequence
  oligonucleotide
ctctcctgtgcagcctccggattcaccnnkagcagctatgccatgagctgggc

SEQ ID NO: 84 - DNA, 53 bp, Artificial Sequence
  oligonucleotide
ggcggacccagctcatggcatagctmnnaaaggtgaatccggaggctgcacag

SEQ ID NO: 85 - DNA, 27 bp, Artificial Sequence
  oligonucleotide
atgccatgagctgggtccgccaggctc

SEQ ID NO: 86 - DNA, 58 bp, Artificial Sequence
  oligonucleotide
ggagcctggcggacccagctcatggcatamnngctaaaggtgaatccggaggctgcac

SEQ ID NO: 87 - DNA, 30 bp, Artificial Sequence
  oligonucleotide
atgccatgagctgggtccgccaggctccag

SEQ ID NO: 88 - DNA, 28 bp, Artificial Sequence
  oligonucleotide
gctaaaggtgaatccggaggctgcacag

SEQ ID NO: 89 - DNA, 55 bp, Artificial Sequence
  oligonucleotide
gcagcctccggattcacctttagcagcnnkgccatgagctgggtccgccaggctc

SEQ ID NO: 90 - DNA, 27 bp, Artificial Sequence
  oligonucleotide
agctgctaaaggtgaatccggaggctg

SEQ ID NO: 91 - DNA, 52 bp, Artificial Sequence
  oligonucleotide
ccggattcacctttagcagctatnnkatgagctgggtccgccaggctccagg

SEQ ID NO: 92 - DNA, 58 bp, Artificial Sequence
  oligonucleotide
agacccttccctggagcctggcggacccamnncatggcatagctgctaaaggtgaatc

SEQ ID NO: 93 - DNA, 30 bp, Artificial Sequence
  oligonucleotide
gggtccgccaggctccagggaagggtctag

SEQ ID NO: 94 - DNA, 26 bp, Artificial Sequence
  oligonucleotide
accactaatagctgagacccactcta

SEQ ID NO: 95 - DNA, 58 bp, Artificial Sequence
  oligonucleotide
agagtgggtctcagctattagtggtagtnnkggtagcacatactacgcagactccgtg

SEQ ID NO: 96 - DNA, 28 bp, Artificial Sequence
  oligonucleotide
cgcaggctgttcatttgcagatacagcg

SEQ ID NO: 97 - DNA, 55 bp, Artificial Sequence
  oligonucleotide
gtatctgcaaatgaacagcctgcgannkgaggacaccgcggtatattactgtgcg

SEQ ID NO: 98 - DNA, 26 bp, Artificial Sequence
  oligonucleotide
gcacgcaggctgttcatttgcagata

SEQ ID NO: 99 - DNA, 51 bp, Artificial Sequence
  oligonucleotide
ctgcaaatgaacagcctgcgtgcannkgacaccgcggtatattactgtgcg

SEQ ID NO: 100 - DNA, 27 bp, Artificial Sequence
  oligonucleotide
acgcgtcgacgcaggtgcagctgttgg

SEQ ID NO: 101 - DNA, 33 bp, Artificial Sequence
  oligonucleotide
ttaggatccttattagctcgagacggtgaccag

SEQ ID NO: 102 - DNA, 29 bp, Artificial Sequence
  oligonucleotide
acgcgtcgacgcagatccagatgacccag

SEQ ID NO: 103 - DNA, 35 bp, Artificial Sequence
  oligonucleotide
ttaggatccttattaccgtttgatttccaccttgg

SEQ ID NO: 104 - protein, 10 aa, Homo Sapiens
GFTFSSYAMS

SEQ ID NO: 105 - protein, 17 aa, Homo Sapiens
AISGSGGSTYYADSVKG

SEQ ID NO: 106 - protein, 8 aa, Homo Sapiens
KSYGAFDY

SEQ ID NO: 107 - protein, 10 aa, Homo Sapiens
GFRISDEDMG

SEQ ID NO: 108 - protein, 17 aa, Homo Sapiens
SIYGPSGSTYYADSVKG

SEQ ID NO: 109 - protein, 12 aa, Homo Sapiens
SALEPLSEPLGF

SEQ ID NO: 110 - protein, 10 aa, Homo Sapiens
GDMVNDKDMS

SEQ ID NO: 111 - protein, 17 aa, Homo Sapiens
SISTENGSTYYADSVKG

SEQ ID NO: 112 - protein, 16 aa, Homo Sapiens
GVRDEVAMGENPDLSY

SEQ ID NO: 113 - protein, 10 aa, Homo Sapiens
GFRFSAEDMG

SEQ ID NO: 114 - protein, 17 aa, Homo Sapiens
SIDNDDGSTYYADSVKG

SEQ ID NO: 115 - protein, 16 aa, Homo Sapiens
SSPGPDNEKDNASLKS

SEQ ID NO: 116 - protein, 10 aa, Homo Sapiens
GDSVSNKVMG

SEQ ID NO: 117 - protein, 17 aa, Homo Sapiens
AIDTKDGSTYYADSVKG

SEQ ID NO: 118 - protein, 16 aa, Homo Sapiens
SGDVDADMAWEEEVSS

SEQ ID NO: 119 - protein, 10 aa, Homo Sapiens
GDTLTSDNMA

SEQ ID NO: 120 - protein, 17 aa, Homo Sapiens
TITEAGGSTYYADSVKG

SEQ ID NO: 121 - protein, 15 aa, Homo Sapiens
TYPADVAECAAEVCY

SEQ ID NO: 122 - protein, 10 aa, Homo Sapiens
GVNVSHDSMT

SEQ ID NO: 123 - protein, 17 aa, Homo Sapiens
AIRGPNGSTYYADSVKG

SEQ ID NO: 124 - protein, 19 aa, Homo Sapiens
SGARHADTERPPSQQTMPF

SEQ ID NO: 125 - protein, 10 aa, Homo Sapiens
GYRISPDYMG

SEQ ID NO: 126 - protein, 17 aa, Homo Sapiens
SISNNGGSTYYADSVKG

SEQ ID NO: 127 - protein, 15 aa, Homo Sapiens
SVDAAESGIDSNVGS

SEQ ID NO: 128 - protein, 10 aa, Homo Sapiens
GYRVNAQDMS

SEQ ID NO: 129 - protein, 17 aa, Homo Sapiens
TIENENGSTYYADSVKG

SEQ ID NO: 130 - protein, 13 aa, Homo Sapiens
SCTRGGCYDTFPY

SEQ ID NO: 131 - protein, 10 aa, Homo Sapiens
GYNITDENMA

SEQ ID NO: 132 - protein, 17 aa, Homo Sapiens
TIAADNGSTYYADSVKG

SEQ ID NO: 133 - protein, 14 aa, Homo Sapiens
TTEAAGVEEDNVRS

SEQ ID NO: 134 - protein, 10 aa, Homo Sapiens
GDKVSYNNMA

SEQ ID NO: 135 - protein, 17 aa, Homo Sapiens
SITTENGSTYYADSVKG

SEQ ID NO: 136 - protein, 19 aa, Homo Sapiens
GNRNSPVDYRELQSTPLDS

SEQ ID NO: 137 - protein, 10 aa, Homo Sapiens
GDNFNNENMG

SEQ ID NO: 138 - protein, 17 aa, Homo Sapiens
TISDTNGSTYYADSVKG

SEQ ID NO: 139 - protein, 13 aa, Homo Sapiens
TTGTRQPQKEVGS

SEQ ID NO: 140 - protein, 10 aa, Homo Sapiens
GVNVTDQDMG

SEQ ID NO: 141 - protein, 17 aa, Homo Sapiens
SIRSNDGSTYYADSVKG

SEQ ID NO: 142 - protein, 12 aa, Homo Sapiens
GRSSGRTDAVPY

SEQ ID NO: 143 - protein, 10 aa, Homo Sapiens
GDSISDDYMA

SEQ ID NO: 144 - protein, 17 aa, Homo Sapiens
SIDDKNGSTYYADSVKG

SEQ ID NO: 145 - protein, 11 aa, Homo Sapiens
GGDGQAHKVDY

SEQ ID NO: 146 - protein, 10 aa, Homo Sapiens
GDMLNYKVMG

SEQ ID NO: 147 - protein, 17 aa, Homo Sapiens
SIITQDGSTYYADSVKG

SEQ ID NO: 148 - protein, 12 aa, Homo Sapiens
GIPLDRADDIEY

SEQ ID NO: 149 - protein, 10 aa, Homo Sapiens
GYKVNDNTMA

SEQ ID NO: 150 - protein, 17 aa, Homo Sapiens
SIDTTDGSTYYADSVKG

SEQ ID NO: 151 - protein, 11 aa, Homo Sapiens
ASDQRTADMRS

SEQ ID NO: 152 - protein, 10 aa, Homo Sapiens
GVTVSDENMG

SEQ ID NO: 153 - protein, 17 aa, Homo Sapiens
GISSNDGSTYYADSVKG

SEQ ID NO: 154 - protein, 14 aa, Homo Sapiens
RDYGSRVDQQHLES

SEQ ID NO: 155 - protein, 10 aa, Homo Sapiens
GVTLNDEYMG

SEQ ID NO: 156 - protein, 17 aa, Homo Sapiens
SINDRNGSTYYADSVKG

SEQ ID NO: 157 - protein, 15 aa, Homo Sapiens
SWVVPGRKSAEPMDY

SEQ ID NO: 158 - protein, 10 aa, Homo Sapiens
GYTFSDNDMA

SEQ ID NO: 159 - protein, 17 aa, Homo Sapiens
GITSDSGSTYYADSVKG

SEQ ID NO: 160 - protein, 17 aa, Homo Sapiens
TESPNGVTKLSDKNFES

SEQ ID NO: 161 - protein, 10 aa, Homo Sapiens
GDNVISDDMS

SEQ ID NO: 162 - protein, 17 aa, Homo Sapiens
TINGPSGSTYYADSVKG

SEQ ID NO: 163 - protein, 21 aa, Homo Sapiens
ANGEDTDMLDMWGDRSAALKS

SEQ ID NO: 164 - protein, 10 aa, Homo Sapiens
GVKFNDEDMS

SEQ ID NO: 165 - protein, 17 aa, Homo Sapiens
SIGTENGSTYYADSVKG

SEQ ID NO: 166 - protein, 14 aa, Homo Sapiens
AGPSGHEGNYDIDS

SEQ ID NO: 167 - protein, 10 aa, Homo Sapiens
GDKITSKNMS

SEQ ID NO: 168 - protein, 17 aa, Homo Sapiens
TIPAEGGSTYYADSVKG

SEQ ID NO: 169 - protein, 12 aa, Homo Sapiens
TACFPSAQHVES

SEQ ID NO: 170 - protein, 10 aa, Homo Sapiens
GFTFDLYDMS

SEQ ID NO: 171 - protein, 17 aa, Homo Sapiens
SIVNSGVRTYYADSVKG

SEQ ID NO: 172 - protein, 12 aa, Homo Sapiens
KLNQSYHWDFDY

SEQ ID NO: 173 - protein, 10 aa, Homo Sapiens
GFTFSDYRMS

SEQ ID NO: 174 - protein, 17 aa, Homo Sapiens
TIISNGKFTYYADSVKG

SEQ ID NO: 175 - protein, 10 aa, Homo Sapiens
KQDWMYMFDY

SEQ ID NO: 176 - protein, 10 aa, Homo Sapiens
GFTFSKYWMS

SEQ ID NO: 177 - protein, 17 aa, Homo Sapiens
SIDFMGPHTYYADSVKG

SEQ ID NO: 178 - protein, 15 aa, Homo Sapiens
KGRTSMLPMKGKFDY

SEQ ID NO: 179 - protein, 10 aa, Homo Sapiens
GFTFYDYNMS

SEQ ID NO: 180 - protein, 17 aa, Homo Sapiens
TITHTGGVTYYADSVKG

SEQ ID NO: 181 - protein, 10 aa, Homo Sapiens
KQNPSYQFDY

SEQ ID NO: 182 - protein, 10 aa, Homo Sapiens
GFTFHRYSMS

SEQ ID NO: 183 - protein, 17 aa, Homo Sapiens
TILPGGDVTYYADSVKG

SEQ ID NO: 184 - protein, 10 aa, Homo Sapiens
KQTPDYMFDY

SEQ ID NO: 185 - protein, 10 aa, Homo Sapiens
GFTFWKYNMA

SEQ ID NO: 186 - protein, 17 aa, Homo Sapiens
TILGEGNNTYYADSVKG

SEQ ID NO: 187 - protein, 9 aa, Homo Sapiens
KTMDYKFDY

SEQ ID NO: 188 - protein, 10 aa, Homo Sapiens
GFTFDEYNMS

SEQ ID NO: 189 - protein, 17 aa, Homo Sapiens
TILPHGDRTYYADSVKG

SEQ ID NO: 190 - protein, 10 aa, Homo Sapiens
KQDPLYRFDY

SEQ ID NO: 191 - protein, 120 aa, Homo Sapiens
EVQLLESGGGLVQPGGSLRLSCAASGFTFEWYWMGWVRQAPGKGLEWVSAISGSGGSTYYADSVKGRFTISRDNSKNTLYLQMNSLRAEDAAVYYCAKVKLGGGPNFGYRGQGTLVTVSS

SEQ ID NO: 192 - protein, 15 aa, Homo Sapiens
CAASGFTFEWYWMGW

SEQ ID NO: 193 - protein, 15 aa, Homo Sapiens
CAASGDTFEWYWMGW

SEQ ID NO: 194 - protein, 15 aa, Homo Sapiens
CAASGQTFEWYWMGW

SEQ ID NO: 195 - protein, 15 aa, Homo Sapiens
CAASGFTFEWDWMGW

SEQ ID NO: 196 - protein, 15 aa, Homo Sapiens
CAASGFTFEWQWMGW

SEQ ID NO: 197 - protein, 15 aa, Homo Sapiens
CAASGFTFQYGPMSW

SEQ ID NO: 198 - protein, 15 aa, Homo Sapiens
CAASGFTFAADNMDW

SEQ ID NO: 199 - protein, 15 aa, Homo Sapiens
CAASGFTFPTNEMSW

SEQ ID NO: 200 - protein, 15 aa, Homo Sapiens
CAASGFTFGNASMDW

SEQ ID NO: 201 - protein, 15 aa, Homo Sapiens
CAASGFTFEDDLMNW

SEQ ID NO: 202 - protein, 15 aa, Homo Sapiens
CAASGFTFGGDEMTW

SEQ ID NO: 203 - protein, 15 aa, Homo Sapiens
CAASGFTFDDSTMQW

SEQ ID NO: 204 - protein, 15 aa, Homo Sapiens
CAASGFTFDNSVMGW

SEQ ID NO: 205 - protein, 15 aa, Homo Sapiens
CAASGFTFDQTAMHW

SEQ ID NO: 206 - protein, 15 aa, Homo Sapiens
CAASGFTFPELPMGW

SEQ ID NO: 207 - protein, 15 aa, Homo Sapiens
CAASGFTFTPGKMNW

SEQ ID NO: 208 - protein, 15 aa, Homo Sapiens
CAASGFTFEHRTMGW

SEQ ID NO: 209 - protein, 15 aa, Homo Sapiens
CAASGFTFPNSDMVW

SEQ ID NO: 210 - protein, 15 aa, Homo Sapiens
CAASGFTFGKSTMAW

SEQ ID NO: 211 - protein, 108 aa, Unknown
  H1 Sequence
DIQMTQSPSSLSASVGDRVTITCRASQSIDSYLHWYQQKPGKAPKLLIYSASELQSGVPSRFSGSGSGTDFTLTISSLQPEDFATYYCQQVVWRPFTFGQGTKVEIKR

SEQ ID NO: 212 - protein, 15 aa, Unknown
  H1 Sequence
KAPKLLIYSASELQS

SEQ ID NO: 213 - protein, 15 aa, Unknown
  H1 Sequence
KAPKLLIDSASELQS

SEQ ID NO: 214 - protein, 15 aa, Unknown
  H1 Sequence
KAPKLLINSASELQS

SEQ ID NO: 215 - protein, 9 aa, Homo Sapiens
DNVSDKTMG

SEQ ID NO: 216 - protein, 6 aa, Homo Sapiens
GIEAGS

SEQ ID NO: 217 - protein, 13 aa, Homo Sapiens
SDDVIMTPAQIGS

SEQ ID NO: 218 - protein, 9 aa, Homo Sapiens
FTISNDNMG

SEQ ID NO: 219 - protein, 6 aa, Homo Sapiens
SIEAAD

SEQ ID NO: 220 - protein, 14 aa, Homo Sapiens
GGYGPSFVSNDVNS

SEQ ID NO: 221 - protein, 9 aa, Homo Sapiens
DRLNHQNMG

SEQ ID NO: 222 - protein, 6 aa, Homo Sapiens
TIDNGN

SEQ ID NO: 223 - protein, 15 aa, Homo Sapiens
TQDDGAKTSSETVKS

SEQ ID NO: 224 - protein, 9 aa, Homo Sapiens
DSFTNNAMG

SEQ ID NO: 225 - protein, 6 aa, Homo Sapiens
GIDTHD

SEQ ID NO: 226 - protein, 12 aa, Homo Sapiens
GMRFKPDDQVSS

SEQ ID NO: 227 - protein, 9 aa, Homo Sapiens
DMFSAESMG

SEQ ID NO: 228 - protein, 6 aa, Homo Sapiens
AINVAN

SEQ ID NO: 229 - protein, 12 aa, Homo Sapiens
SGVWNNYSALRF

SEQ ID NO: 230 - protein, 9 aa, Homo Sapiens
DKFNNENMG

SEQ ID NO: 231 - protein, 6 aa, Homo Sapiens
TIDAES

SEQ ID NO: 232 - protein, 12 aa, Homo Sapiens
GGQSEREEDVTY

SEQ ID NO: 233 - protein, 9 aa, Homo Sapiens
DSLNPKNMS

SEQ ID NO: 234 - protein, 6 aa, Homo Sapiens
GIQEPN

SEQ ID NO: 235 - protein, 12 aa, Homo Sapiens
THDESKPEEIDY

SEQ ID NO: 236 - protein, 9 aa, Homo Sapiens
DRFNSNDMS

SEQ ID NO: 237 - protein, 6 aa, Homo Sapiens
TISMEN

SEQ ID NO: 238 - protein, 15 aa, Homo Sapiens
RRDTGFTQSAYPFES

SEQ ID NO: 239 - protein, 9 aa, Homo Sapiens
DMVNDKDMS

SEQ ID NO: 240 - protein, 6 aa, Homo Sapiens
SISTEN

SEQ ID NO: 241 - protein, 16 aa, Homo Sapiens
GVRDEVAMGENPDLSY

SEQ ID NO: 242 - protein, 9 aa, Homo Sapiens
DTISTKDMG

SEQ ID NO: 243 - protein, 6 aa, Homo Sapiens
TITDQN

SEQ ID NO: 244 - protein, 12 aa, Homo Sapiens
STAPWLPDAMDS

SEQ ID NO: 245 - protein, 9 aa, Homo Sapiens
VMVSDQDMA

SEQ ID NO: 246 - protein, 6 aa, Homo Sapiens
TIDVGS

SEQ ID NO: 247 - protein, 15 aa, Homo Sapiens
GTGQSQTVETDALDS

SEQ ID NO: 248 - protein, 9 aa, Homo Sapiens
FRFSAEDMG

SEQ ID NO: 249 - protein, 6 aa, Homo Sapiens
SIDNDD

SEQ ID NO: 250 - protein, 16 aa, Homo Sapiens
SSPGPDNEKDNASLKS

SEQ ID NO: 251 - protein, 9 aa, Homo Sapiens
DSLTHDNMS

SEQ ID NO: 252 - protein, 6 aa, Homo Sapiens
TINTPS

SEQ ID NO: 253 - protein, 12 aa, Homo Sapiens
TQDDVRHADLTS

SEQ ID NO: 254 - protein, 9 aa, Homo Sapiens
DSVSNKVMG

SEQ ID NO: 255 - protein, 6 aa, Homo Sapiens
AIDTKD

SEQ ID NO: 256 - protein, 16 aa, Homo Sapiens
SGDVDADMAWEEEVSS

SEQ ID NO: 257 - protein, 9 aa, Homo Sapiens
FMLSDQDMG

SEQ ID NO: 258 - protein, 6 aa, Homo Sapiens
SIGNAD

SEQ ID NO: 259 - protein, 12 aa, Homo Sapiens
RVPRTNQQAVNS

SEQ ID NO: 260 - protein, 9 aa, Homo Sapiens
DSIIPTNMG

SEQ ID NO: 261 - protein, 6 aa, Homo Sapiens
GIDDRN

SEQ ID NO: 262 - protein, 19 aa, Homo Sapiens
TGDDGDISPGGKTQTTLDS

SEQ ID NO: 263 - protein, 9 aa, Homo Sapiens
DSVIDQNMG

SEQ ID NO: 264 - protein, 6 aa, Homo Sapiens
SINNQD

SEQ ID NO: 265 - protein, 13 aa, Homo Sapiens
GVNAGGHATPIYS

SEQ ID NO: 266 - protein, 9 aa, Homo Sapiens
DRVTDEIMG

SEQ ID NO: 267 - protein, 6 aa, Homo Sapiens
AIEEHD

SEQ ID NO: 268 - protein, 19 aa, Homo Sapiens
TVPRGTLQPAQSHSESVKS

SEQ ID NO: 269 - protein, 9 aa, Homo Sapiens
DTLTSDNMA

SEQ ID NO: 270 - protein, 6 aa, Homo Sapiens
TITEAG

SEQ ID NO: 271 - protein, 15 aa, Homo Sapiens
TYPADVAECAAEVCY

SEQ ID NO: 272 - protein, 9 aa, Homo Sapiens
DRVSSDDMA

SEQ ID NO: 273 - protein, 6 aa, Homo Sapiens
SIHNDN

SEQ ID NO: 274 - protein, 17 aa, Homo Sapiens
RVGSQVNKHGMTDEVAY

SEQ ID NO: 275 - protein, 9 aa, Homo Sapiens
VNVSHDSMT

SEQ ID NO: 276 - protein, 6 aa, Homo Sapiens
AIRGPN

SEQ ID NO: 277 - protein, 19 aa, Homo Sapiens
SGARHADTERPPSQQTMPF

SEQ ID NO: 278 - protein, 9 aa, Homo Sapiens
DRVSDEVMS

SEQ ID NO: 279 - protein, 6 aa, Homo Sapiens
SIDDND

SEQ ID NO: 280 - protein, 15 aa, Homo Sapiens
AKALAEEIHSSNLPS

SEQ ID NO: 281 - protein, 9 aa, Homo Sapiens
DSFSTEDMG

SEQ ID NO: 282 - protein, 6 aa, Homo Sapiens
SIHGND

SEQ ID NO: 283 - protein, 15 aa, Homo Sapiens
GARANGVYDDAEVGF

SEQ ID NO: 284 - protein, 9 aa, Homo Sapiens
DMLNAQNMS

SEQ ID NO: 285 - protein, 6 aa, Homo Sapiens
SIGAAD

SEQ ID NO: 286 - protein, 19 aa, Homo Sapiens
ADEAWSSDTGRFQEDKLGS

SEQ ID NO: 287 - protein, 9 aa, Homo Sapiens
FKISSKTMG

SEQ ID NO: 288 - protein, 6 aa, Homo Sapiens
SICAGG

SEQ ID NO: 289 - protein, 15 aa, Homo Sapiens
ASNKCRLELSADVEY

SEQ ID NO: 290 - protein, 9 aa, Homo Sapiens
DRVINHTMG

SEQ ID NO: 291 - protein, 6 aa, Homo Sapiens
AIVGTD

SEQ ID NO: 292 - protein, 19 aa, Homo Sapiens
APRGVSEENVLHWEHKVPS

SEQ ID NO: 293 - protein, 9 aa, Homo Sapiens
DSVSDENMG

SEQ ID NO: 294 - protein, 6 aa, Homo Sapiens
TIGAGG

SEQ ID NO: 295 - protein, 11 aa, Homo Sapiens
SAGSEPTQMES

SEQ ID NO: 296 - protein, 9 aa, Homo Sapiens
YMLSDDDMS

SEQ ID NO: 297 - protein, 6 aa, Homo Sapiens
TISEPS

SEQ ID NO: 298 - protein, 13 aa, Homo Sapiens
TDSGRTTAQEVPY

SEQ ID NO: 299 - protein, 9 aa, Homo Sapiens
YRVNAQDMS

SEQ ID NO: 300 - protein, 6 aa, Homo Sapiens
TIENEN

SEQ ID NO: 301 - protein, 13 aa, Homo Sapiens
SCTRGGCYDTFPY

SEQ ID NO: 302 - protein, 9 aa, Homo Sapiens
YNITDENMA

SEQ ID NO: 303 - protein, 6 aa, Homo Sapiens
TIAAND

SEQ ID NO: 304 - protein, 14 aa, Homo Sapiens
TTEAAGVEEDNVRS

SEQ ID NO: 305 - protein, 9 aa, Homo Sapiens
DTVSHKTMG

SEQ ID NO: 306 - protein, 6 aa, Homo Sapiens
TISDKD

SEQ ID NO: 307 - protein, 15 aa, Homo Sapiens
SPSPRLDGGQESVTS

SEQ ID NO: 308 - protein, 9 aa, Homo Sapiens
DKVSYNNMA

SEQ ID NO: 309 - protein, 6 aa, Homo Sapiens
SITTEN

SEQ ID NO: 310 - protein, 19 aa, Homo Sapiens
GNRNSPVDYRELQSTPLDS

SEQ ID NO: 311 - protein, 9 aa, Homo Sapiens
DMVSYEDMA

SEQ ID NO: 312 - protein, 6 aa, Homo Sapiens
TIEEAN

SEQ ID NO: 313 - protein, 14 aa, Homo Sapiens
ANKRDRRQKESVAS

SEQ ID NO: 314 - protein, 9 aa, Homo Sapiens
DNFNNENMG

SEQ ID NO: 315 - protein, 6 aa, Homo Sapiens
TISDTN

SEQ ID NO: 316 - protein, 13 aa, Homo Sapiens
TTGTRQPQKEVGS

SEQ ID NO: 317 - protein, 9 aa, Homo Sapiens
VNVTDQDMG

SEQ ID NO: 318 - protein, 6 aa, Homo Sapiens
SIRSND

SEQ ID NO: 319 - protein, 12 aa, Homo Sapiens
GRSSGRTDAVPY

SEQ ID NO: 320 - protein, 9 aa, Homo Sapiens
DSISDDYMA

SEQ ID NO: 321 - protein, 6 aa, Homo Sapiens
SIDDKN

SEQ ID NO: 322 - protein, 11 aa, Homo Sapiens
GGDGQAHKVDY

SEQ ID NO: 323 - protein, 9 aa, Homo Sapiens
DMLNYKVMG

SEQ ID NO: 324 - protein, 6 aa, Homo Sapiens
SIITQD

SEQ ID NO: 325 - protein, 12 aa, Homo Sapiens
GIPLDRADDIEY

SEQ ID NO: 326 - protein, 9 aa, Homo Sapiens
YKVNDNTMA

SEQ ID NO: 327 - protein, 6 aa, Homo Sapiens
SIDTTD

SEQ ID NO: 328 - protein, 11 aa, Homo Sapiens
ASDQRTADMRS

SEQ ID NO: 329 - protein, 9 aa, Homo Sapiens
VTVSDENMG

SEQ ID NO: 330 - protein, 6 aa, Homo Sapiens
GISSND

SEQ ID NO: 331 - protein, 14 aa, Homo Sapiens
RDYGSRVDQQHLES

SEQ ID NO: 332 - protein, 9 aa, Homo Sapiens
DTLTDQNMS

SEQ ID NO: 333 - protein, 6 aa, Homo Sapiens
TITDPD

SEQ ID NO: 334 - protein, 15 aa, Homo Sapiens
TKVEDWEERKESVQS

SEQ ID NO: 335 - protein, 9 aa, Homo Sapiens
VTLNDEYMG

SEQ ID NO: 336 - protein, 6 aa, Homo Sapiens
SINDRN

SEQ ID NO: 337 - protein, 15 aa, Homo Sapiens
SWVVPGRKSAEPMDY

SEQ ID NO: 338 - protein, 9 aa, Homo Sapiens
YTFSDNDMA

SEQ ID NO: 339 - protein, 6 aa, Homo Sapiens
GITSDS

SEQ ID NO: 340 - protein, 17 aa, Homo Sapiens
TESPNGVTKLSDKNFES

SEQ ID NO: 341 - protein, 9 aa, Homo Sapiens
DNVISDDMS

SEQ ID NO: 342 - protein, 6 aa, Homo Sapiens
TINGPS

SEQ ID NO: 343 - protein, 21 aa, Homo Sapiens
ANGEDTDMLDMWGDRSAALKS

SEQ ID NO: 344 - protein, 9 aa, Homo Sapiens
VKFNDEDMS

SEQ ID NO: 345 - protein, 6 aa, Homo Sapiens
SIGTEN

SEQ ID NO: 346 - protein, 14 aa, Homo Sapiens
AGPSGHEGNYDIDS

SEQ ID NO: 347 - protein, 9 aa, Homo Sapiens
DTVSPENMA

SEQ ID NO: 348 - protein, 6 aa, Homo Sapiens
SIKSPS

SEQ ID NO: 349 - protein, 11 aa, Homo Sapiens
GNQPENPSMEY

SEQ ID NO: 350 - protein, 9 aa, Homo Sapiens
DRVTPQNMG

SEQ ID NO: 351 - protein, 6 aa, Homo Sapiens
TIHTTD

SEQ ID NO: 352 - protein, 17 aa, Homo Sapiens
ASRNQTAKSLTQDDIAS

SEQ ID NO: 353 - protein, 9 aa, Homo Sapiens
VKLTDNNMS

SEQ ID NO: 354 - protein, 6 aa, Homo Sapiens
SIDNRN

SEQ ID NO: 355 - protein, 12 aa, Homo Sapiens
GTDNASNDSVEY

SEQ ID NO: 356 - protein, 9 aa, Homo Sapiens
FSVSDQDMA

SEQ ID NO: 357 - protein, 6 aa, Homo Sapiens
TIKDTN

SEQ ID NO: 358 - protein, 17 aa, Homo Sapiens
GRSVPSSDHWDADSVEF

SEQ ID NO: 359 - protein, 9 aa, Homo Sapiens
YNVIDENMG

SEQ ID NO: 360 - protein, 6 aa, Homo Sapiens
AIPDEG

SEQ ID NO: 361 - protein, 11 aa, Homo Sapiens
ALSPSHQSLKS

SEQ ID NO: 362 - protein, 9 aa, Homo Sapiens
DNVTSETMA

SEQ ID NO: 363 - protein, 6 aa, Homo Sapiens
AIPNQD

SEQ ID NO: 364 - protein, 17 aa, Homo Sapiens
GTDMNMHSRGNKTKFNY

SEQ ID NO: 365 - protein, 9 aa, Homo Sapiens
DTLNDYNMS

SEQ ID NO: 366 - protein, 6 aa, Homo Sapiens
TINDPN

SEQ ID NO: 367 - protein, 14 aa, Homo Sapiens
GSKSRGGPPEELHS

SEQ ID NO: 368 - protein, 9 aa, Homo Sapiens
VNINDNVMG

SEQ ID NO: 369 - protein, 6 aa, Homo Sapiens
AIDDRN

SEQ ID NO: 370 - protein, 16 aa, Homo Sapiens
SASHLAPPSNETAVRY

SEQ ID NO: 371 - protein, 9 aa, Homo Sapiens
VNLNAENMS

SEQ ID NO: 372 - protein, 6 aa, Homo Sapiens
TIGMGS

SEQ ID NO: 373 - protein, 11 aa, Homo Sapiens
AVNTLEQTVPY

SEQ ID NO: 374 - protein, 9 aa, Homo Sapiens
DTITNKNMG

SEQ ID NO: 375 - protein, 6 aa, Homo Sapiens
TITAPN

SEQ ID NO: 376 - protein, 13 aa, Homo Sapiens
APVERKGSQEVGF

SEQ ID NO: 377 - protein, 9 aa, Homo Sapiens
DRVTDNNMA

SEQ ID NO: 378 - protein, 6 aa, Homo Sapiens
TIADDN

SEQ ID NO: 379 - protein, 13 aa, Homo Sapiens
TLQGVGNAPQFQS

SEQ ID NO: 380 - protein, 9 aa, Homo Sapiens
DKISNQYMA

SEQ ID NO: 381 - protein, 6 aa, Homo Sapiens
AIDNND

SEQ ID NO: 382 - protein, 18 aa, Homo Sapiens
SIWGDEPVADSRDPEVNS

SEQ ID NO: 383 - protein, 9 aa, Homo Sapiens
DTISTQDMA

SEQ ID NO: 384 - protein, 6 aa, Homo Sapiens
TIDTPN

SEQ ID NO: 385 - protein, 12 aa, Homo Sapiens
TANGEITESVRY

SEQ ID NO: 386 - protein, 9 aa, Homo Sapiens
YMVSDQTMG

SEQ ID NO: 387 - protein, 6 aa, Homo Sapiens
SIHDPG

SEQ ID NO: 388 - protein, 11 aa, Homo Sapiens
RNEGSSEPIYS

SEQ ID NO: 389 - protein, 9 aa, Homo Sapiens
VMITDEIMG

SEQ ID NO: 390 - protein, 6 aa, Homo Sapiens
TIDTAD

SEQ ID NO: 391 - protein, 21 aa, Homo Sapiens
GPRAVRQEVADQGIQYENLPS

SEQ ID NO: 392 - protein, 9 aa, Homo Sapiens
DRVNPETMG

SEQ ID NO: 393 - protein, 6 aa, Homo Sapiens
AITNRG

SEQ ID NO: 394 - protein, 11 aa, Homo Sapiens
TPTLGETELGY

SEQ ID NO: 395 - protein, 9 aa, Homo Sapiens
DRFITQDMG

SEQ ID NO: 396 - protein, 6 aa, Homo Sapiens
TINTQN

SEQ ID NO: 397 - protein, 11 aa, Homo Sapiens
RQKNGANNVGY

SEQ ID NO: 398 - protein, 9 aa, Homo Sapiens
DSVSNEVMS

SEQ ID NO: 399 - protein, 6 aa, Homo Sapiens
TIDTTN

SEQ ID NO: 400 - protein, 13 aa, Homo Sapiens
RGEQLDGSAPVAS

SEQ ID NO: 401 - protein, 9 aa, Homo Sapiens
VNINTESMA

SEQ ID NO: 402 - protein, 6 aa, Homo Sapiens
SINDTN

SEQ ID NO: 403 - protein, 15 aa, Homo Sapiens
GDVYPWNIGNETLPS

SEQ ID NO: 404 - protein, 9 aa, Homo Sapiens
DMVNAQFMG

SEQ ID NO: 405 - protein, 6 aa, Homo Sapiens
TISTDD

SEQ ID NO: 406 - protein, 13 aa, Homo Sapiens
SSSSRGLESQLHY

SEQ ID NO: 407 - protein, 9 aa, Homo Sapiens
DTFNDQDMA

SEQ ID NO: 408 - protein, 6 aa, Homo Sapiens
TIEVPS

SEQ ID NO: 409 - protein, 14 aa, Homo Sapiens
GDLVDSSATPQFAF

SEQ ID NO: 410 - protein, 9 aa, Homo Sapiens
DRVIANYMG

SEQ ID NO: 411 - protein, 6 aa, Homo Sapiens
AIKSSD

SEQ ID NO: 412 - protein, 13 aa, Homo Sapiens
TGPRWGEEKDVEF

SEQ ID NO: 413 - protein, 9 aa, Homo Sapiens
VNVNDKDMA

SEQ ID NO: 414 - protein, 6 aa, Homo Sapiens
TISGRD

SEQ ID NO: 415 - protein, 16 aa, Homo Sapiens
SNLSPEYGTRATSVDS

SEQ ID NO: 416 - protein, 9 aa, Homo Sapiens
DTVIYEYMG

SEQ ID NO: 417 - protein, 6 aa, Homo Sapiens
AIRMTD

SEQ ID NO: 418 - protein, 14 aa, Homo Sapiens
GGDGMIDSSTSVSF

SEQ ID NO: 419 - protein, 9 aa, Homo Sapiens
DTFNTQTMG

SEQ ID NO: 420 - protein, 6 aa, Homo Sapiens
TIDVEN

SEQ ID NO: 421 - protein, 11 aa, Homo Sapiens
TCCDDSPAIDN

SEQ ID NO: 422 - protein, 9 aa, Homo Sapiens
DTFSTENMA

SEQ ID NO: 423 - protein, 6 aa, Homo Sapiens
GISNPD

SEQ ID NO: 424 - protein, 20 aa, Homo Sapiens
ASGVLDSTAEAHDNKQELRS

SEQ ID NO: 425 - protein, 9 aa, Homo Sapiens
DMINSKDMG

SEQ ID NO: 426 - protein, 6 aa, Homo Sapiens
TINEPN

SEQ ID NO: 427 - protein, 14 aa, Homo Sapiens
SRGVDALGEAPVDS

SEQ ID NO: 428 - protein, 9 aa, Homo Sapiens
FNVSDEDMG

SEQ ID NO: 429 - protein, 6 aa, Homo Sapiens
GIEGTN

SEQ ID NO: 430 - protein, 11 aa, Homo Sapiens
GEAKKENDMNF

SEQ ID NO: 431 - protein, 9 aa, Homo Sapiens
DRITNQNMG

SEQ ID NO: 432 - protein, 6 aa, Homo Sapiens
TIGGDN

SEQ ID NO: 433 - protein, 13 aa, Homo Sapiens
SMVPRQGPQELNY

SEQ ID NO: 434 - protein, 9 aa, Homo Sapiens
DSFNAKDMG

SEQ ID NO: 435 - protein, 6 aa, Homo Sapiens
TIDGNN

SEQ ID NO: 436 - protein, 17 aa, Homo Sapiens
RDVHRANGGLDQSELEY

SEQ ID NO: 437 - protein, 9 aa, Homo Sapiens
DSFTDQDMT

SEQ ID NO: 438 - protein, 6 aa, Homo Sapiens
SITTSD

SEQ ID NO: 439 - protein, 13 aa, Homo Sapiens
RAKVPARTEELES

SEQ ID NO: 440 - protein, 9 aa, Homo Sapiens
VTVNPQVMG

SEQ ID NO: 441 - protein, 6 aa, Homo Sapiens
SIHTPD

SEQ ID NO: 442 - protein, 14 aa, Homo Sapiens
GKEESSAETPAVDS

SEQ ID NO: 443 - protein, 9 aa, Homo Sapiens
DMITPKNMA

SEQ ID NO: 444 - protein, 6 aa, Homo Sapiens
TIANPN

SEQ ID NO: 445 - protein, 11 aa, Homo Sapiens
APSGMNDDLTY

SEQ ID NO: 446 - protein, 9 aa, Homo Sapiens
DTINDDSMG

SEQ ID NO: 447 - protein, 6 aa, Homo Sapiens
TIHDKD

SEQ ID NO: 448 - protein, 15 aa, Homo Sapiens
TRRDQSFGTAPALKS

SEQ ID NO: 449 - protein, 9 aa, Homo Sapiens
DMVNDKTMS

SEQ ID NO: 450 - protein, 6 aa, Homo Sapiens
AIDNQS

SEQ ID NO: 451 - protein, 11 aa, Homo Sapiens
AQERVEPYVEF

SEQ ID NO: 452 - protein, 9 aa, Homo Sapiens
DTISDKDMA

SEQ ID NO: 453 - protein, 6 aa, Homo Sapiens
GIPTDD

SEQ ID NO: 454 - protein, 13 aa, Homo Sapiens
GWDEDKKATGVAY

SEQ ID NO: 455 - protein, 9 aa, Homo Sapiens
DSVTTQNMS

SEQ ID NO: 456 - protein, 6 aa, Homo Sapiens
TISTPN

SEQ ID NO: 457 - protein, 14 aa, Homo Sapiens
GMDAENRNADTPRS

SEQ ID NO: 458 - protein, 9 aa, Homo Sapiens
YTLNNQNMS

SEQ ID NO: 459 - protein, 6 aa, Homo Sapiens
SIQTAD

SEQ ID NO: 460 - protein, 18 aa, Homo Sapiens
GGGSPMLSQAVSSSPLRS

SEQ ID NO: 461 - protein, 9 aa, Homo Sapiens
DNVSSQDMA

SEQ ID NO: 462 - protein, 6 aa, Homo Sapiens
TIMNSN

SEQ ID NO: 463 - protein, 15 aa, Homo Sapiens
GSPDASIQESSNLDY

SEQ ID NO: 464 - protein, 9 aa, Homo Sapiens
DRVNAQDMG

SEQ ID NO: 465 - protein, 6 aa, Homo Sapiens
SINDDD

SEQ ID NO: 466 - protein, 11 aa, Homo Sapiens
TRSDEETSLRS

SEQ ID NO: 467 - protein, 9 aa, Homo Sapiens
DKINDEDMS

SEQ ID NO: 468 - protein, 6 aa, Homo Sapiens
SIADNS

SEQ ID NO: 469 - protein, 13 aa, Homo Sapiens
TDPVNGLASDVRS

SEQ ID NO: 470 - protein, 9 aa, Homo Sapiens
DSISNNNMG

SEQ ID NO: 471 - protein, 6 aa, Homo Sapiens
SIGNRD

SEQ ID NO: 472 - protein, 11 aa, Homo Sapiens
AGESEEEALGY

SEQ ID NO: 473 - protein, 9 aa, Homo Sapiens
DNITNENMG

SEQ ID NO: 474 - protein, 6 aa, Homo Sapiens
SIGAPG

SEQ ID NO: 475 - protein, 15 aa, Homo Sapiens
STQKNNAREPYTLDS

SEQ ID NO: 476 - protein, 9 aa, Homo Sapiens
VMLSDENMG

SEQ ID NO: 477 - protein, 6 aa, Homo Sapiens
TISGDN

SEQ ID NO: 478 - protein, 16 aa, Homo Sapiens
RESDWYGGVEAKELNY

SEQ ID NO: 479 - protein, 9 aa, Homo Sapiens
DKVTHQDMS

SEQ ID NO: 480 - protein, 6 aa, Homo Sapiens
TIASRD

SEQ ID NO: 481 - protein, 14 aa, Homo Sapiens
TGDDFGGADASLAS

SEQ ID NO: 482 - protein, 9 aa, Homo Sapiens
VIVNNDDMS

SEQ ID NO: 483 - protein, 6 aa, Homo Sapiens
SITNPD

SEQ ID NO: 484 - protein, 19 aa, Homo Sapiens
TANSMKAGSDWVGEEALAY

SEQ ID NO: 485 - protein, 9 aa, Homo Sapiens
DRVSANAMA

SEQ ID NO: 486 - protein, 6 aa, Homo Sapiens
TICVKD

SEQ ID NO: 487 - protein, 14 aa, Homo Sapiens
GSERCESSASNVQY

SEQ ID NO: 488 - protein, 9 aa, Homo Sapiens
FMINNQNMA

SEQ ID NO: 489 - protein, 6 aa, Homo Sapiens
GIGDAS

SEQ ID NO: 490 - protein, 15 aa, Homo Sapiens
GMEGSQHQSEPNVKS

SEQ ID NO: 491 - protein, 9 aa, Homo Sapiens
DSFNAKAMG

SEQ ID NO: 492 - protein, 6 aa, Homo Sapiens
AIDNES

SEQ ID NO: 493 - protein, 14 aa, Homo Sapiens
TSGSYDLYDEDLRF

SEQ ID NO: 494 - protein, 9 aa, Homo Sapiens
FRVNDEVMA

SEQ ID NO: 495 - protein, 6 aa, Homo Sapiens
SIENEN

SEQ ID NO: 496 - protein, 15 aa, Homo Sapiens
GPGHTISAKTPSLAS

SEQ ID NO: 497 - protein, 9 aa, Homo Sapiens
DTISDKDMA

SEQ ID NO: 498 - protein, 6 aa, Homo Sapiens
GIPTDD

SEQ ID NO: 499 - protein, 11 aa, Homo Sapiens
GWDEDKKQVGY

SEQ ID NO: 500 - protein, 9 aa, Homo Sapiens
DRLINNDMT

SEQ ID NO: 501 - protein, 6 aa, Homo Sapiens
SIRDTD

SEQ ID NO: 502 - protein, 13 aa, Homo Sapiens
ANENTPAQPEVNS

SEQ ID NO: 503 - protein, 9 aa, Homo Sapiens
VTICHHYMG

SEQ ID NO: 504 - protein, 6 aa, Homo Sapiens
AIRSND

SEQ ID NO: 505 - protein, 11 aa, Homo Sapiens
TDFCKDKNVAY

SEQ ID NO: 506 - protein, 9 aa, Homo Sapiens
YNFNDEDMA

SEQ ID NO: 507 - protein, 6 aa, Homo Sapiens
TIGSPN

SEQ ID NO: 508 - protein, 12 aa, Homo Sapiens
RDPLMSDTAFSY

SEQ ID NO: 509 - protein, 9 aa, Homo Sapiens
DNVSSKSMA

SEQ ID NO: 510 - protein, 6 aa, Homo Sapiens
SISNEN

SEQ ID NO: 511 - protein, 12 aa, Homo Sapiens
TGPGDYPEQLES

SEQ ID NO: 512 - protein, 9 aa, Homo Sapiens
DKVSSESMG

SEQ ID NO: 513 - protein, 6 aa, Homo Sapiens
AIEGPS

SEQ ID NO: 514 - protein, 11 aa, Homo Sapiens
THKGREDAIES

SEQ ID NO: 515 - protein, 9 aa, Homo Sapiens
VTVSADSMG

SEQ ID NO: 516 - protein, 6 aa, Homo Sapiens
AIEAPD

SEQ ID NO: 517 - protein, 17 aa, Homo Sapiens
TGPVEDPGSTDPHQMHS

SEQ ID NO: 518 - protein, 9 aa, Homo Sapiens
DTISAEVMG

SEQ ID NO: 519 - protein, 6 aa, Homo Sapiens
GICGHS

SEQ ID NO: 520 - protein, 16 aa, Homo Sapiens
RGVERGDGCNESEIES

SEQ ID NO: 521 - protein, 9 aa, Homo Sapiens
DKFSTQNMA

SEQ ID NO: 522 - protein, 6 aa, Homo Sapiens
GIVAAN

SEQ ID NO: 523 - protein, 14 aa, Homo Sapiens
TPQLNQRRQDELGS

SEQ ID NO: 524 - protein, 9 aa, Homo Sapiens
DTLNNEDMA

SEQ ID NO: 525 - protein, 6 aa, Homo Sapiens
TIANEG

SEQ ID NO: 526 - protein, 16 aa, Homo Sapiens
AHGGSVGKVGQSTVDS

SEQ ID NO: 527 - protein, 9 aa, Homo Sapiens
DMVSNDAMG

SEQ ID NO: 528 - protein, 6 aa, Homo Sapiens
SIQDAD

SEQ ID NO: 529 - protein, 12 aa, Homo Sapiens
TGDMYKEPPVKS

SEQ ID NO: 530 - protein, 9 aa, Homo Sapiens
YTVSNEYMS

SEQ ID NO: 531 - protein, 6 aa, Homo Sapiens
SIHDAD

SEQ ID NO: 532 - protein, 17 aa, Homo Sapiens
THGPRPALLVQSSEVTS

SEQ ID NO: 533 - protein, 9 aa, Homo Sapiens
DTISDQSMG

SEQ ID NO: 534 - protein, 6 aa, Homo Sapiens
SIDTSS

SEQ ID NO: 535 - protein, 12 aa, Homo Sapiens
RDFGINAQPVDY

SEQ ID NO: 536 - protein, 9 aa, Homo Sapiens
DNVTNDDMG

SEQ ID NO: 537 - protein, 6 aa, Homo Sapiens
TINTPG

SEQ ID NO: 538 - protein, 14 aa, Homo Sapiens
AAEKGGSEAPQMTS

SEQ ID NO: 539 - protein, 9 aa, Homo Sapiens
DTVSYQNMG

SEQ ID NO: 540 - protein, 6 aa, Homo Sapiens
AINSRD

SEQ ID NO: 541 - protein, 18 aa, Homo Sapiens
GPEGGQELGHSADPKLGS

SEQ ID NO: 542 - protein, 9 aa, Homo Sapiens
DTVSSEDMG

SEQ ID NO: 543 - protein, 6 aa, Homo Sapiens
GIDATS

SEQ ID NO: 544 - protein, 14 aa, Homo Sapiens
TAEGGRGDAATMNS

SEQ ID NO: 545 - protein, 9 aa, Homo Sapiens
DMVSHEDMG

SEQ ID NO: 546 - protein, 6 aa, Homo Sapiens
TINSQD

SEQ ID NO: 547 - protein, 11 aa, Homo Sapiens
SDMTEDETLNY

SEQ ID NO: 548 - protein, 9 aa, Homo Sapiens
FTFSDDNMG

SEQ ID NO: 549 - protein, 6 aa, Homo Sapiens
SIDARD

SEQ ID NO: 550 - protein, 15 aa, Homo Sapiens
GQHTPASVLPDQVNS

SEQ ID NO: 551 - protein, 9 aa, Homo Sapiens
DMFSAESMG

SEQ ID NO: 552 - protein, 6 aa, Homo Sapiens
AINVAN

SEQ ID NO: 553 - protein, 12 aa, Homo Sapiens
SGVWNNYSALRF

SEQ ID NO: 554 - protein, 9 aa, Homo Sapiens
DRVINQNMG

SEQ ID NO: 555 - protein, 6 aa, Homo Sapiens
SIEEND

SEQ ID NO: 556 - protein, 14 aa, Homo Sapiens
TCSAVAKCTPEVES

SEQ ID NO: 557 - protein, 9 aa, Homo Sapiens
YRISPDYMG

SEQ ID NO: 558 - protein, 6 aa, Homo Sapiens
SISNNG

SEQ ID NO: 559 - protein, 15 aa, Homo Sapiens
SVDAAESGIDSNVGS

SEQ ID NO: 560 - protein, 9 aa, Homo Sapiens
DKITSKNMS

SEQ ID NO: 561 - protein, 6 aa, Homo Sapiens
TIPAEG

SEQ ID NO: 562 - protein, 12 aa, Homo Sapiens
TACFPSAQHVES

SEQ ID NO: 563 - protein, 9 aa, Homo Sapiens
DMFSAESMG

SEQ ID NO: 564 - protein, 6 aa, Homo Sapiens
AINVAN

SEQ ID NO: 565 - protein, 12 aa, Homo Sapiens
SGVWNNYSALRF

SEQ ID NO: 566 - protein, 9 aa, Homo Sapiens
YTLSDEYMG

SEQ ID NO: 567 - protein, 6 aa, Homo Sapiens
AINNKD

SEQ ID NO: 568 - protein, 15 aa, Homo Sapiens
SWKSAVLGGEEPLRF

SEQ ID NO: 569 - protein, 9 aa, Homo Sapiens
DNVSNENMG

SEQ ID NO: 570 - protein, 6 aa, Homo Sapiens
SIDMDD

SEQ ID NO: 571 - protein, 11 aa, Homo Sapiens
ASSPEAKEVKY

SEQ ID NO: 572 - protein, 9 aa, Homo Sapiens
VNITDETMG

SEQ ID NO: 573 - protein, 6 aa, Homo Sapiens
GIETAS

SEQ ID NO: 574 - protein, 13 aa, Homo Sapiens
GQKHVFGNYTFPS

SEQ ID NO: 575 - protein, 9 aa, Homo Sapiens
VKLNYQYMG

SEQ ID NO: 576 - protein, 6 aa, Homo Sapiens
GIDMQN

SEQ ID NO: 577 - protein, 12 aa, Homo Sapiens
SGDDCFYSPIKF

SEQ ID NO: 578 - protein, 9 aa, Homo Sapiens
VRLNDQDMG

SEQ ID NO: 579 - protein, 6 aa, Homo Sapiens
SIETDS

SEQ ID NO: 580 - protein, 18 aa, Homo Sapiens
RALPTTRRGGVLASDIGS

SEQ ID NO: 581 - protein, 9 aa, Homo Sapiens
DSVNHYDMT

SEQ ID NO: 582 - protein, 6 aa, Homo Sapiens
SIADNN

SEQ ID NO: 583 - protein, 18 aa, Homo Sapiens
GESMNQRGESELSDTFRF

SEQ ID NO: 584 - protein, 9 aa, Homo Sapiens
DTINDQNMG

SEQ ID NO: 585 - protein, 6 aa, Homo Sapiens
SIGNDN

SEQ ID NO: 586 - protein, 19 aa, Homo Sapiens
GANSQTDVLVKARPQTVES

SEQ ID NO: 587 - protein, 9 aa, Homo Sapiens
DMVNPQTMG

SEQ ID NO: 588 - protein, 6 aa, Homo Sapiens
AICDPG

SEQ ID NO: 589 - protein, 11 aa, Homo Sapiens
GGVLQDKPMGY

SEQ ID NO: 590 - protein, 9 aa, Homo Sapiens
VTLSYTNMG

SEQ ID NO: 591 - protein, 6 aa, Homo Sapiens
AIETGS

SEQ ID NO: 592 - protein, 14 aa, Homo Sapiens
PLSFISKEQSQVDS

SEQ ID NO: 593 - protein, 9 aa, Homo Sapiens
FTLYSEIMG

SEQ ID NO: 594 - protein, 6 aa, Homo Sapiens
TIPTKN

SEQ ID NO: 595 - protein, 17 aa, Homo Sapiens
AQGGGGVLDQGTEDLSY

SEQ ID NO: 596 - protein, 9 aa, Homo Sapiens
FKVSDQAMA

SEQ ID NO: 597 - protein, 6 aa, Homo Sapiens
TMINTD

SEQ ID NO: 598 - protein, 11 aa, Homo Sapiens
AQDQKKNDVKS

SEQ ID NO: 599 - protein, 9 aa, Homo Sapiens
DTISTQNMG

SEQ ID NO: 600 - protein, 6 aa, Homo Sapiens
GIHDDD

SEQ ID NO: 601 - protein, 20 aa, Homo Sapiens
GRIKEFRVKWCGAPEEQVSY

SEQ ID NO: 602 - protein, 9 aa, Homo Sapiens
DTIIDDNMS

SEQ ID NO: 603 - protein, 6 aa, Homo Sapiens
TIDTGD

SEQ ID NO: 604 - protein, 17 aa, Homo Sapiens
GCLGTFGVNGLPADLGS

SEQ ID NO: 605 - protein, 9 aa, Homo Sapiens
DNITDQAMG

SEQ ID NO: 606 - protein, 6 aa, Homo Sapiens
GIPDQS

SEQ ID NO: 607 - protein, 12 aa, Homo Sapiens
GYKLGIKPHLDY

SEQ ID NO: 608 - protein, 9 aa, Homo Sapiens
VTVTDNNMG

SEQ ID NO: 609 - protein, 6 aa, Homo Sapiens
TIRDDD

SEQ ID NO: 610 - protein, 13 aa, Homo Sapiens
GANPTGKASRLSS

SEQ ID NO: 611 - protein, 9 aa, Homo Sapiens
DKLNNKVMS

SEQ ID NO: 612 - protein, 6 aa, Homo Sapiens
TSDDKN

SEQ ID NO: 613 - protein, 13 aa, Homo Sapiens
ADPLRVRQQPVYS

SEQ ID NO: 614 - protein, 9 aa, Homo Sapiens
DKVNTQNMG

SEQ ID NO: 615 - protein, 6 aa, Homo Sapiens
AIRNQN

SEQ ID NO: 616 - protein, 14 aa, Homo Sapiens
APDGKPGPQHSVGS

SEQ ID NO: 617 - protein, 9 aa, Homo Sapiens
DTVSTDSMS

SEQ ID NO: 618 - protein, 6 aa, Homo Sapiens
SIPGSN

SEQ ID NO: 619 - protein, 15 aa, Homo Sapiens
SNGMAQVGQDEHVRS

SEQ ID NO: 620 - protein, 9 aa, Homo Sapiens
DTVTADNMG

SEQ ID NO: 621 - protein, 6 aa, Homo Sapiens
GIANPD

SEQ ID NO: 622 - protein, 16 aa, Homo Sapiens
RAAQGVGDFQPATISY

SEQ ID NO: 623 - protein, 9 aa, Homo Sapiens
DMVTDQNMG

SEQ ID NO: 624 - protein, 6 aa, Homo Sapiens
SISMPN

SEQ ID NO: 625 - protein, 21 aa, Homo Sapiens
TQDGITKGIFRAGAADTNLQS

SEQ ID NO: 626 - protein, 9 aa, Homo Sapiens
DNFTNHDMS

SEQ ID NO: 627 - protein, 6 aa, Homo Sapiens
TISDTD

SEQ ID NO: 628 - protein, 9 aa, Homo Sapiens
SSDIGTRRH

SEQ ID NO: 629 - protein, 9 aa, Homo Sapiens
DSLTANSMD

SEQ ID NO: 630 - protein, 6 aa, Homo Sapiens
GIDTSD

SEQ ID NO: 631 - protein, 16 aa, Homo Sapiens
ASQRQSQPALEYDLNH

SEQ ID NO: 632 - protein, 9 aa, Homo Sapiens
VRVNNQNMS

SEQ ID NO: 633 - protein, 6 aa, Homo Sapiens
AIDSAN

SEQ ID NO: 634 - protein, 14 aa, Homo Sapiens
ADGAPLGGSTKLDH

(19) United States
(12) Patent Application Publication
(10) Pub. No.: US 2009/0005257 A1
(43) Pub. Date: Jan. 1, 2009

(54) Process for Recovering Polypeptides that Unfold Reversibly from a Polypeptide Repertoire

(76) Inventors: Laurent S. Jespers, Cambridge (GB); Philip C. Jones, Cambridge (GB); H.J. Kristoffer Famm, Degeberga (SE); Gregory P. Winter, Cambridge (GB)

Correspondence Address: MCDERMOTT WILL & EMERY LLP, 28 STATE STREET, BOSTON, MA, 02109-1775, US

(21) Appl. No.: 10/556,360

(22) PCT Filed: May 14, 2004
(86) PCT No.: PCT/GB04/02102

§ 371 Date: Jun. 18, 2008

Related U.S. Application Data
(60) Provisional application No. 60/470,340, filed on May 14, 2003.
(60) Provisional application No. 60/554,021, filed on Mar. 17, 2004.

(51) Int. Cl. C40B 30/04; C40B 30/10; C40B 30/08

(52) U.S. Cl. 506/9; 506/12; 506/11

(57) ABSTRACT

The invention relates to polypeptides that unfold reversibly (e.g., unfolds when heated and refolds when cooled), to repertoires containing polypeptides that unfold reversibly and to libraries that contain polypeptides that unfold reversibly or nucleic acids that encode polypeptides that unfold reversibly. The invention further relates to processes for producing a library enriched in polypeptides that unfold reversibly or nucleic acids encoding polypeptides that unfold reversibly, processes for selecting and/or isolating polypeptides that unfold reversibly, and to methods for producing a polypeptide that unfolds reversibly.

### RELATED APPLICATIONS

This application claims the benefit of U.S. Provisional Patent Application No. 60/554,021, filed on Mar. 17, 2004, and of U.S. Provisional Patent Application No. 60/470,340, filed on May 14, 2003. The entire teachings of the above applications are incorporated herein by reference.

### BACKGROUND OF THE INVENTION

Polypeptides have become increasingly import agents in a variety of applications, including use as medical therapeutic and diagnostic agents and in industrial applications. One factor that has hinder further application of polypeptides is their physical and chemical properties. For example, polypeptides generally must retain proper folding to be active. However, polypeptides tend to unfold or denature under storage conditions or conditions where they could find utility (e.g., when exposed to heat, organic solvents). It addition, many polypeptides are produced only with relatively low yield using biological production systems. Accordingly, they can be prohibitively costly to produce.

A key factor that limits further application of polypeptides is the tendency of unfolded or denatured polypeptides to aggregate irreversibly. Aggregation is influenced by polypeptide concentration and is thought to arise in many cases from partially folded or unfolded intermediates. Factors and conditions that favor partially folded intermediates, such as elevated temperature and high polypeptide concentration, promote irreversible aggregation. (Fink, A. L., Folding & Design 3:R1-R23 (1998).) For example, storing purified polypeptides in concentrated form, such as a lyophilized preparation, frequently results in irreversible aggregation of at least a portion of the polypeptides. Also, production of a polypeptide by expression in biological systems, such as E. coli, often results in the formation of inclusion bodies which contain aggregated polypeptides. Recovering active polypeptides from inclusion bodies can be very difficult and require adding additional steps, such as a refolding step, to a biological production system.

One approach that has been attempted for preparing polypeptides with improved properties is the selection of polypeptide variants that have improved stability or solubility. (See, e.g., Jung, S. et al., J. Mol. Biol. 294:163-180 (1999); Davies, J and Riechmannn, L., Prot. Eng. 9:531-537 (1996), Waldo, G. S., Curr. Opin. Chem. Biol. 7:33-38 (2003).) However, selection for improved stability or solubility does not address the aggregation problem because stability (e.g., thermal stability, thermodynamic stability) and solubility are characteristics of the properly folded polypeptide while aggregation arises from the partially folded or partially denatured state. In addition, there is no recognized correlation between polypeptide stability and aggregation. (Fink, A. L., Folding & Design 3:R1-R23 (1998).)

A need exists for polypeptides with improved properties that can be produced with high yields using biological production systems.

### SUMMARY OF THE INVENTION

The invention relates to polypeptides that unfold reversibly, to repertoires containing polypeptides that unfold reversibly and to libraries that contain polypeptides that unfold reversibly or nucleic acids that encode polypeptides that unfold reversibly. The invention ether relates to processes for producing a library enriched in polypeptides that unfold reversibly or nucleic acids encoding polypeptides that unfold reversibly, processes for selecting and/or isolating polypeptides that unfold reversibly, and to methods for producing a polypeptide that unfolds reversibly.

In one aspect, the invention is a process for selecting, isolating and/of recovering a polypeptide that unfolds reversibly from a library or a repertoire of polypeptides (e.g., a polypeptide display system). In one embodiment, the method comprises unfolding a collection of polypeptides (e.g., the polypeptides in a library, a repertoire or a polypeptide display system), refolding at least a portion of the unfolded polypeptides, and selecting, isolating and/or recovering a refolded polypeptide. In another embodiment, the method comprises providing a collection of unfolded polypeptides (e.g., the polypeptides in a library, a repertoire or a polypeptide display system), refolding at least a portion of the unfolded polypeptides, and selecting, isolating and/or recovering a refolded polypeptide. In another embodiment, the method comprises providing a polypeptide display system comprising a repertoire, heating the repertoire to a temperature (Ts) at which at least a portion of the displayed polypeptides unfold and cooling the repertoire to a temperature (T) that is lower than Ts to produce a cooled repertoire. The cooled repertoire comprises at least a portion of polypeptides that have unfolded and refolded and a portion of polypeptides that have aggregated. The method further comprises recovering at a temperature (Tr) at least one polypeptide that binds a ligand and unfolds reversibly. Preferably the ligand binds folded polypeptide and does not bind aggregated polypeptides, the recovered polypeptide has a melting temperature (Tm), and Ts>Tm>Tc, and Ts>Tm>Tr.

In other aspects, the invention relates to repertoires of polypeptides that unfold reversibly, to libraries of nucleic acids that encode polypeptides that unfold reversibly, and to methods for producing such libraries and repertoires.

In one aspect, the invention is an isolated polypeptide that unfolds reversibly. In some embodiments, the polypeptide that unfolds reversibly is a variant of a parental polypeptide that differs from the parental polypeptide in amino acid sequence (e.g., by one or more amino acid replacements, additions and/or deletions), but qualitatively retains function of the parental polypeptide.

The invention also relates to a process for producing an antibody variable domain library enriched in variable domains that unfold reversibly. In one embodiment, the process comprises (1) providing a phage display system comprising a plurality of displayed antibody variable regions, wherein at least a portion of the displayed variable regions have been unfolded and refolded, (2) selecting phage displaying variable regions that have unfolded, refolded and regained binding function from said phage display system, (3) obtaining nucleic acids encoding CDR1 and/or CDR2 of the variable regions displayed on the recovered phage, and (4) assembling a library of nucleic acids encoding antibody variable domains, wherein said nucleic acids obtained in (3) are operably linked to one or more other nucleic acids to produce a library of constructs that encode antibody variable domains in which CDR1 and/or CDR2 are encoded by the nucleic acid obtained in (3). In particular embodiments, substantially all of the displayed variable regions in (1) have been unfolded by heating to about 80° C. and refolded by cooling. In other particular embodiments, library of nucleic acids assembled in (4) encodes an antibody variable domain in which CDR3 is randomized or is not derived from antibody variable regions that has been selected for the ability to unfold reversibly.

The polypeptides that unfold reversibly described herein can be produced as soluble proteins in the supernatant of E. coli or yeast cultures with high yield,

### BRIEF DESCRIPTION OF THE DRAWINGS

FIG. 1 is an illustration of a nucleic acid encoding human immunoglobulin heavy chain variable region DP47dummy (also referred to herein as DP47d), comprising germline V_{H} gene segment DP47 and germline VJ gene segment JH4b (SEQ ID NO:1, coding strand; SEQ ID NO:2 non-coding strand). FIG. 1 also presents the amino acid sequence of the encoded V_{H} domain (SEQ ID NO:3). The amino acids are numbered according to the system of Kabat. (Kabat, E. A. et al., Sequences of Proteins of Immunological Interest, Fifth Edition, U.S. Department of Health and Human Services, U.S. Government Printing Office (1991).)

FIG. 2 is an illustration of a nucleic acid encoding human immunoglobulin light chain (κ) variable region DPK9 dummy (also referred to herein as DPK9d), comprising germline Vκ gene segment DPK9 and germline JK gene segment JK1. (SEQ ID NO:4, coding strand; SEQ ID NO:5 non-coding strand). FIG. 2 also presents the amino acid sequence of the encoded Vκ domain (SEQ ID NO:6). The amino acids are numbered according to the system of Kabat.

FIGS. 3A-3F are histograms that illustrate the relative amount of protein A binding activity retained by phage clones displaying V_{H} domains based on a DP47d scaffold after heat-induced unfolding and refolding. A sample of each phage clone was heated to cause the displayed V_{H} domains to unfold and then cooled to cause refolding, and a sample was left unheated. Binding of the heat-treated and the untreated phage samples to protein A was assessed by ELISA. The binding activity of the heat-treated clones expressed as a percentage of the binding activity of the untreated clones is illustrated. The columns marked “dp47” refer to DP47d.

FIGS. 4A-4C are panels of a table illustrating the amino acid sequences of the complementarity determining regions (CDR1, CDR2, CDR3) of several of the V_{H} domains displayed on the phage that retained greater than >60% relative binding to protein A in FIGS. 3A-3F. The sequences are identified in FIGS. 4A-4C by clone number. These clones are also referred to herein using a “pA-” prefix. For example, Clone 13 is also referred to herein as “pA-C13.” The first group of sequences presented in FIGS. 4A and 4B are from clones that had a high degree of refolding as assessed by the results of protein A binding (group 1). The next group of sequences in FIG. 4C are from clones with good refolding. These clones also contain mutations outside the CDRs (group 2). The final group of sequences in FIG. 4C are from clones with lower refolding.

FIG. 5 is a graph illustrating the relationship between the capacity of a displayed V_{H} domain to undergo reversible heat unfolding and the hydrophobicity of the amino acid sequence from position 22 to position 36 of the V_{H} domain. The Sweet/Eisenberg hydrophobicity score (SE-15 value) for the sequence for position 22 to position 36 of several displayed V_{H} was determined using a window of 15 amino acids. The SE-15 value was plotted against the relative protein A binding activity (ELISA) for each clone after undergoing heat-induced unfolding and refolding. The graph illustrates that the ability of a displayed V_{H} to undergo heat-induced unfolding and refolding correlates with an SE-15 value of 0 or less for the amino acid sequence from position 22 to position 36. Amino acid positions are defined according to Kabat.

FIG. 6 is a histogram illustrating the Sweet/Eisenberg hydrophobicity score (Sweet/Eisenberg value) for the sequence for position 22 to position 36 of several displayed V_{H}. V_{H} domains DP47d and BSA1 have Sweet/Eisenberg values that are greater than 0, and do not undergo reversible heat-induced unfolding. V_{H} domains HEL4, pA-C13, pA-C36, pA-C47, pA-C59, pA-C76 and pA-C85 have Sweet/Eisenberg values that are less than 0, and the V_{H} domains of each of these clones undergo reversible heat-induced unfolding. Amino acid positions are defined according to Kabat.

FIG. 7 is an illustration of the characteristic shape of an unfolding curve and a refolding curve. The curves are plotted using a measure of the concentration of property folded polypeptide (e.g., ellipticity or fluorescence) as the abscissa, and the unfolding agent (e.g., heat (temperature)) as the ordinate. The unfolding and refolding curves include a region in which the polypeptides are folded, an unfolding/refolding transition in which polypeptides are unfolded to various degrees, and a portion in which the polypeptides are unfolded. The y-axis intercept of the refolding curve is the relative amount of refolded protein recovered. In the illustrated plot, TM is the melting temperature of the polypeptide, and TM−10 and TM+10 are the melting temperature of the polypeptide minus 10 degrees and plus 10 degrees, respectively. The illustrated refolding curve indicates that greater than 75% of the polypeptides refolded.

FIG. 8 is a graph showing heat-induced unfolding of dAb HEL4. dAb HEL4 was unfolded by heating and ellipticity assessed during heating (filled circles). The unfolded dAb was then refolded by decreasing the temperature. The refolded dAb was then again unfolded by heating and ellipticity assessed during heating (open diamonds). The graph shows that the unfolding curves of both heat-induced unfoldings are superimposable, demonstrating that dAb HEL4 undergoes reversible heat-induced unfolding. The inset shows the far-UV CD spectra for folded dAb HEL4 at 25° C. (Fold) and for unfolded dAb HEL4 at 80° C. Unfold).

FIG. 9 is a graph showing that a dAb comprising DP47 variant in which Trp47 was replace with Arg (DP47-W47R) does not unfold reversibly upon heating. dAb DP47-W47R was unfolded by heating and ellipticity assessed during heating (filled circles). The unfolded dAb was then refolded by decreasing the temperature. The refolded dAb was then again unfolded by heating and ellipticity assessed during heating (open squares). The unfolding curves are not superimposable and have a shape characteristic of denatured polypeptides.

FIG. 10 is a graph showing that a dAb comprising DP47 variant in which Ser35 was replaced with Gly (DP47-S47G) unfolds reversibly upon heating to a limited extent. dAb DP47-S47G was unfolded by heating and ellipticity assessed during heating (filled circles). The unfolded dAb was then refolded by decreasing the temperature. The refolded dAb was then again unfolded by heating and ellipticity assessed during heating (open diamonds). The unfolding curves are not superimposable and reveal that a proportion of the ellipticity (and hence a portion of the original secondary structure) was recovered upon refolding, and that a melting transition is observed upon re-heating the sample.

FIG. 11 is a graph illustrating the relationship between thermodynamic stability of polypeptides (ΔG folded→unfolded) and reversible unfolding of polypeptides displayed on phage. The graph shows that non-refoldable polypeptides BSA1 and DP47d have high thermodynamic stability, and that refoldable polypeptide HEL4 and several refoldable mutants of DP47 have lower thermodynamic stability. Thermodynamic stability of refoldable polypeptides was determined from ellipticity data obtained during heat-induced unfolding. Thermodynamic stability of polypeptides that were not refoldable was determined by monitoring fluorescence during urea-induced unfolding.

FIG. 12 is a graph illustrating the relationship between thermodynamic stability of polypeptides (ΔG folded→unfolded) and protein expression level in E. coli supernatant. The graph shows that non-refoldable polypeptides BSA1 and DP47 have high thermodynamic stability but are expressed at relatively low levels, and that refoldable polypeptide HEL4 and several refoldable mutants of DP47d have lower thermodynamic stability but are expressed at relatively high levels. Thermodynamic stability of refoldable polypeptides was determined from ellipticity data obtained during heat-induced unfolding. Thermodynamic stability of polypeptides that were not refoldable was determined by monitoring fluorescence during urea-induced unfolding. Protein expression is the amount of polypeptide purified using protein A sepharose from a 1 L culture of E. coli, normalized to cell density (OD600) of the culture.

FIG. 13 is a graph illustrating the relationship between protein expression levels in E. coli supernatant and reversible unfolding of polypeptides displayed on phage. The graph shows that non-refoldable polypeptides BSA1 and DP47d are expressed at relatively low levels, and that refoldable polypeptide HEL4 and several refoldable mutants of DP47d have are expressed at relatively high levels. The graph reveals a direct correlation between reversible unfolding of polypeptides displayed on phage and the quantity of polypeptide in the supernatant of cultures of E. coli that express the polypeptide. Protein expression is the amount of polypeptide purified using protein A sepharose from a IL culture of E. coli, normalized to cell density (OD600) of the culture.

FIG. 14 is a graph showing heat-induced unfolding of a single chain Fv (scFv) containing a reversibly unfoldable Vκ (DPK9-I75N) and a reversibly unfoldable V_{H} (DP47-F27D). The scFv was unfolded by heating and ellipticity assessed during heating (filled circles). The unfolded scFv was then refolded by decreasing the temperature. The refolded scFv was then again unfolded by heating and ellipticity assessed during heating (open diamonds). The graph shows that the unfolding curves of both heat-induced unfoldings are superimposable, demonstrating that scFv undergoes reversible heat-induced unfolding. Other scFvs containing germline V_{H} and germline Vκ, germline V_{H} and unfoldable Vκ (DPK9-175N), or reversibly unfoldable V_{H} (DP47-F27D) and germline Vκ aggregated under the conditions used. The inset shows the far-UV CD spectra for folded scFv before heat induced unfolding (dark trace) and for folded scFV following heat induced unfolding and refolding (lighter trace). The spectra are superimposable indicating that the scFv regained all secondary structure following refolding.

FIGS. 15A and 15B are histograms showing the effect of heat-treatment of phage (80° C. for 10 min then cooled to 4° C. for 10 min) on binding of displayed dabs to protein A or antibody. In FIG. 15A, phage displaying (5×10¹¹ TU/ml) either DP47d or HEL4 dAb multivalently were assayed for binding to either anti-c-myc antibody (9E10) or protein A by ELISA. 9E10 recognises the c-myc tag peptide tag appended to the dAb as a linear determinant. Using a dilution series of phage, the retained binding was calculated from the phage titers required for an ELISA signal of 0.5 OD₆₅₀ₙₘ-OD₄₅₀ₙₘ (titer untreated/titer heat treated). In FIG. 15B, phage displaying DP47d were assayed for binding to protein A by ELISA. Phage concentration was high (5×10¹¹ TU/ml) or low (1×10⁹ TU/ml) and DP47d was displayed in multivalent or monovalent states.

FIG. 15C is a histogram showing the effect of heat-treatment of phage (80° C. for 10 min then cooled to 4° C. for 10 min) on infectivity. Phage displaying either DP47d or HEL4 multivalently were heated and then cooled, after 10 min a phage sample was treated with 0.9 mg/mL trypsin at 22° C. for 10 min, and then used to infect E. coli TG1 cells.

FIGS. 16A-16C are copies of transmission electron micrographs of negatively stained phage tips before and after heat treatment (10 min at 80° C.). FIGS. 16A and 16B show that heated DP47d phages form aggregates. However, as shown in FIG. 16C, heated HEL4 phages which display the HEL4 V_{H} domain, which unfolds reversibly, did not form aggregates.

FIG. 16D is a copy of an image of a Western blot in which 10¹⁰ transducing units (TU) of phage per lane were separated and detected using an anti-pIII mouse monoclonal antibody. The phage loaded in lanes 1 to 6 were: fd, HEL4 (multivalent), DP47d (multivalent), M13, HEL4 (monovalent), and DP47d (monovalent), respectively.

FIG. 17A is a representative analytical gel-filtration chromatogram of selected human V_{H}3 dAbs. The chromatograms for C13 (—), C36 (— - —), C47 (— —), C59 (---), C76 (-) and C85 (.........) dabs (10 μM in PBS) were obtained using a SUPERDEX-75 column (Amersham Biosciences), apparent Mr for C13, C36, C47, C59, C76 and C85 were 22 kDa, 17 kDa, 19 kDa, 10 kDa, 20 kDa, and 15 kDa, respectively.

FIG. 17B is a graph showing heat induced denaturation curves of the C36 dAb (5 μM in PBS) recorded by CD at 235 nm:. ▾, mean residual ellipticity upon first heating; ⋄, mean residual ellipticity upon second heating. Inset: CD spectra of dAb HEL4 (5 W in PBS) in the far-UV region at different temperature: ▴, 25° C. before unfolding; , 85° C. (unfolded polypeptide); ◯, 25° C. after sample cooling.

FIG. 18A is a graph showing that TAR2.10-27 and variants TAR2-10-27 F27D and TAR2-10-27 Y23D bind human Tumor Necrosis Factor Receptor 1 (TNFR1) and inhibit binding of TNF to the receptor in a receptor binding ELISA. TNFR1 was immobilized on the plate and TNF was mixed with TAR2-10-27, TAR2-10-27 F27D or TAR2-10-27 Y23D and then added to the wells. The amount of TNF that bound the immobilized receptor was quantified using an anti-TNF antibody. TAR2-10-27, TAR2-10-27 F27D and TAR2-10-27 Y23D each bound human TNFR1 and inhibited the binding of TNF to the receptor.

FIG. 18B is a graph showing that TAR2-10-27 and variants TAR2-10-27 F27D and TAR2-10-27 Y23D bound human Tumor Necrosis Factor Receptor 1 (TNFR1) expressed on HeLa cells and inhibited INF-induced production of IL-8 in an in vitro assay. HeLa cells were plated in microtitre plates and incubated overnight with TAR2-10-27, TAR2-10-27 F27D or TAR2-10-27 Y23D and 300 pg/ml TNF. Post incubation, the supernatant was aspirated off the cells and the amount of IL-8 in the supernatant was measured using a sandwich ELISA. TAR2-10-27, TAR2-10-27 F27D and TAR2-10-27 Y23D each bound human TNFR1 and inhibited TNF-induced IL-8 production.

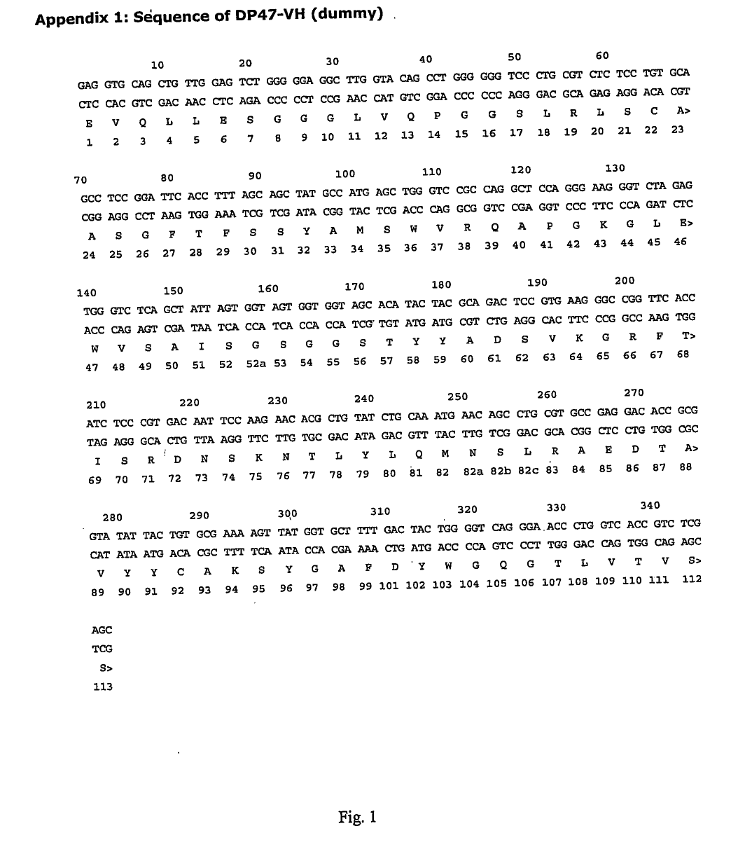

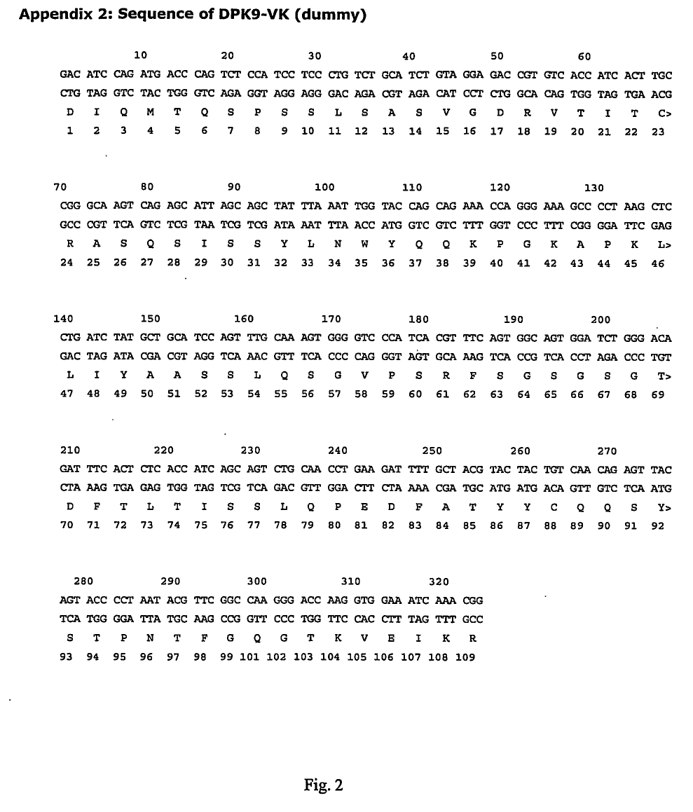

### DETAILED DESCRIPTION OF THE INVENTION

The invention relates to polypeptides that unfold reversibly and to methods for selecting and/or designing such polypeptides. Polypeptides that unfold reversibly provide several advantages. Notably, such polypeptides are resistant to aggregation or do not aggregate. Due to this resistance to aggregation, polypeptides that unfold reversibly can readily be produced in high yield as soluble proteins by expression using a suitable biological production system, such as E. coli. In addition, polypeptides that unfold reversibly can be formulated and/or stored at higher concentrations than conventional polypeptides, and with less aggregation and loss of activity.

As described herein, polypeptides that unfold reversibly can be selected from a polypeptide display system in which the polypeptides have been unfolded (e.g., by heating) and refolding (e.g., by cooling). The selection and design processes described herein yields polypeptides that unfold reversibly and are resistant to aggregation. These selection and design processes are distinct from methods that select polypeptides based on enhanced stability, such as polypeptides that remain folded at elevated temperature. (See, e.g., Jung, S. et al., J. Mol. Biol. 294:163-180 (1999).)

As used herein, “polypeptide display system” refers to a system in which a collection of polypeptides are accessible for selection based upon a desired characteristic, such as a physical, chemical or functional characteristic. The polypeptide display system can be a suitable repertoire of polypeptides (e.g., in a solution, immobilized on a suitable support). The polypeptide display system can also be a biochemical system that employs a cellular expression system (e.g., expression of a library of nucleic acids in, e.g., transformed, infected, transfected or transduced cells and display of the encoded polypeptides on the surface of the cells) or an acellular expression system (e.g., emulsion compartmentalization and display). Preferred polypeptide display systems link the coding function of a nucleic acid and physical, chemical and/or functional characteristics of a polypeptide encoded by the nucleic acid. When such a polypeptide display system is employed, polypeptides that have a desired physical, chemical and/or functional characteristic can be selected and a nucleic acid encoding the selected polypeptide can be readily isolated or recovered. A number of polypeptide display systems that link the coding function of a nucleic acid and physical, chemical and/or functional characteristics of a polypeptide are known in the art, for example, bacteriophage display (phage display), ribosome display, emulsion compartmentalization and display, yeast display, puromycin display, bacterial display, polypeptide display on plasmid and covalent display and the like. (See, e.g., EP 0436597 (Dyax), U.S. Pat. No. 6,172,197 (McCafferty et al.), U.S. Pat. No. 6,489,103 (Griffiths et al.).) The polypeptide display system can comprise a plurality of replicable genetic display packages, as described by McCafferty et al. (e.g., WO 92/01047; U.S. Pat. No. 6,172,197). A replicable genetic display package RGDP) is a biological particle which has genetic information providing the particle with the ability to replicate. An RGDP can display on its surface at least part of a polypeptide. The polypeptide can be encoded by genetic information native to the RGDP and/or artificially placed into the RGDP or an ancestor of it. The RGDP can be a virus e.g., a bacteriophage, such as fd or M13. For example, the RGDP can be a bacteriophage which displays an antibody variable domain (e.g., V_{H}, V_{L}) at its surface. This type of RGDP can be referred to as a phage antibody pAb).

As used herein, the terms “reversibly unfoldable” and “unfolds reversibly” refer to polypeptides that can be unfolded (e.g., by heat) and refolded in the method of the invention. A reversibly unfoldable polypeptide (a polypeptide that unfolds reversibly) loses function when unfolded but regains function upon refolding. Such polypeptides are distinguished from polypeptides that aggregate when unfolded or that improperly refold (misfolded polypeptides), i.e., do not regain function. Preferably, a polypeptide that unfolds reversibly can unfold reversibly when displayed in a polypeptide display system, for example, when display on bacteriophage. Particularly preferred polypeptide that unfold reversibly can unfold reversibly when displayed in a polypeptide display system and as a soluble polypeptide (e.g., an autonomous soluble polypeptide).

As used herein, “repertoire of polypeptides” refers to a collection of polypeptides that are characterized by amino acid sequence diversity. The individual members of a repertoire can have common features, such as common structural features (e.g., a common core structure) and/or common functional features (e.g., capacity to bind a common ligand (e.g., a generic ligand or a target ligand)).

As used herein, “library” refers to a collection of heterogeneous nucleic acids that can be expressed and preferably are replicable. For example, a library can contain a collection of heterogeneous nucleic acids that are incorporated into a suitable vector, such as an expression plasmid, a phagemid and the like. Expression of such a library can produce a repertoire of polypeptides. “Library” also refers to a collection of heterogeneous polypeptides that are displayed in a polypeptide display system that links coding function of a nucleic acid and physical, chemical and/or functional characteristics of a polypeptide encoded by the nucleic acid, and can be selected or screened to provide an individual polypeptide (and nucleic acid encoding same) or a population of polypeptides (and nucleic acids encoding same) that have a desired physical, chemical and/or functional characteristic. A collection of phage that displays a collection of heterogeneous polypeptides is one example of such a library. A library that is a collection of heterogeneous polypeptides encompasses a repertoire of polypeptides.

As used herein, “functional” describes a polypeptide that is properly folded so as to have a specific desired activity, such as ligand-binding activity (e.g., binding generic ligand, binding target ligand), or the biological activity of native or naturally produced protein. For example, the term “fictional polypeptide” includes an antibody or antigen-binding fragment thereof that binds a target antigen through its antigen-binding site, and an enzyme that binds its substrate(s).

As used herein, “generic ligand” refers to a ligand that binds a substantial portion (e.g., substantially all) of the functional members of a given repertoire. A generic ligand (e.g., a common generic ligand) can bind many members of a given repertoire even though the members may not have binding specificity for a common target ligand. In general, the presence of a functional generic ligand-binding site on a polypeptide (as indicated by the ability to bind a generic ligand) indicates that the polypeptide is correctly folded and functional. Accordingly, polypeptides that are correctly folded can be selected or recovered from a repertoire of polypeptides by binding to a generic ligand. Suitable examples of generic ligands include superantigens, antibodies that bind an epitope expressed on a substantial portion of functional members of a repertoire, and the like.

As used herein, “target ligand” refers to a ligand which is specifically or selectively bound by a polypeptide. For example, a target ligand can be a ligand for which a specific binding polypeptide or polypeptides in a repertoire are identified. For example, when a polypeptide is an antibody or antigen-binding fragment thereof, the target ligand can be any desired antigen or epitope, and when a polypeptide is an enzyme, the target ligand can be any desired substrate. Binding to the target antigen is dependent upon the polypeptide being functional, and upon the specificity of the target antigen-binding site of the polypeptide.

As used herein, “antibody polypeptide” is a polypeptide that is an antibody, a portion of an antibody, or a fusion protein that contains a portion of an antibody (e.g., an antigen-binding portion). Thus, “antibody polypeptides” include, for example, an antibody (e.g., an IgG), an antibody heavy chain, an antibody light chain, homodimers and heterodimers of heavy chains and/or light chains, and antigen-binding fragments or portions of an antibody, such as a Fv fragment (e.g., single chain Fv (scFv), a disulfide bonded Fv), a Fab fragment, a Fab′ fragment, a F(ab′)₂ fragment, a single variable domain (V_{H}, V_{L}), a dAb and the like.

As used herein, “antibody format” refers to any suitable polypeptide structure in which an antibody variable domain can be incorporated so as to confer binding specificity for antigen on the structure. A variety of suitable antibody formats are known in the art, such as, chimeric antibodies, humanized antibodies, human antibodies, single chain antibodies, bispecific antibodies, antibody heavy chains, antibody light chains, homodimers and heterodimers of antibody heavy chains and/or light chains, antigen-binding fragments of any of the foregoing (e.g., a Fv fragment (e.g., single chain Fv (scFv), a disulfide bonded Fv), a Fab fragment, a Fab′ fragment, a F(ab′)₂ fragment), a single variable domain (e.g., V_{H}, V_{L}), a dAb, and modified versions of any of the foregoing (e.g., modified by the covalent attachment of polyethylene glycol or other suitable polymer).

“Superantigen” is a term of art that refers to generic ligands that interact with members of the immunoglobulin superfamily at a site that is distinct from the conventional ligand-binding sites of these proteins. Staphylococcal enterotoxins are examples of superantigens which interact with T-cell receptors. Superantigens that bind antibodies include Protein G, which binds the IgG constant region (Bjorck and Kronvall, J. Immunol., 133:969 (1984)); Protein A which binds the IgG constant region and V_{H} domains (Forsgren and Sjoquist, J. Immunol., 97:822 (1966)); and Protein L which binds V_{L} domains (Bjorek, J. Immunol., 140:1194 (1988)).

As used herein, “unfolding agent” refers to an agent (e.g., compound) or to energy that can cause polypeptide unfolding. When an unfolding agent is a compound, the compound can be added to a polypeptide display system in an amount sufficient to cause a desired degree of polypeptide unfolding. Examples of suitable compounds include, chaotropic agents (e.g., guanidine hydrochloride, urea), acids (e.g., hydrochloric acid, acetic acid), bases (e.g., sodium hydroxide, potassium hydroxide), and organic solvents (e.g., an alcohol (e.g., methanol, ethanol), a ketone (e.g., methyl ethyl ketone), an aldehyde (e.g., formaldehyde, dimethylformaldehyde), tetrahydrofuran, dioxane, toluene and the like). The unfolding agent can be energy, such as heat and/or pressure. When the unfolding agent is heat, the polypeptide system is exposed to a sufficient amount of energy (e.g., thermal, electromagnetic) to impart enough heat to the polypeptide display system to raise the temperature of the system to a temperature that is sufficient to cause a desired degree of polypeptide unfolding. Preferred unfolding agents (or combinations of unfolding agents) do not substantially inhibit aggregation of unfolded polypeptides that do not unfold reversibly.

As used herein, “folding gatekeeper” refers to an amino acid residue that, by virtue of its biophysical characteristics and by its position in the amino acid sequence of a protein, prevents the irreversible formation of aggregates upon protein unfolding. A folding gatekeeper residue blocks off-pathway aggregation, thereby ensuring that the protein can undergo reversible unfolding. A folding gate keeper generally reduces the SE score (hydrophobicity score) of the amino acid sequence of the region in which it is found.

As used herein “secretable” or “secreted” means that when a polypeptide is produced by expression in E. coli, it is produced and exported to the periplasmic space or to the medium.

### Assessing Unfolding and Refolding

Polypeptide unfolding and refolding can be assessed, for example, by directly or indirectly detecting polypeptide structure using any suitable method. For example, polypeptide structure can be detected by circular dichroism (CD) (e.g., far-UV CD, near-UV CD), fluorescence (e.g., fluorescence of tryptophan side chains), susceptibility to proteolysis, nuclear magnetic resonance (NMR), or by detecting or measuring a polypeptide function that is dependent upon proper folding. In one example, polypeptide unfolding is assessed using a functional assay in which loss of binding function (e.g., binding a generic and/or target ligand, binding a substrate) indicates that the polypeptide is unfolded.

The extent of unfolding and refolding of a soluble polypeptide can determined by using an unfolding or denaturation curve. An unfolding curve can be produced by plotting the unfolding agent (e.g., temperature, concentration of chaotropic agent, concentration of organic solvent) as the ordinate and the relative concentration of folded polypeptide as the abscissa. The relative concentration of folded polypeptide can be determined directly or indirectly using any suitable method (e.g., CD, fluorescence, binding assay). For example, apolypeptide solution can be prepared and ellipticity of the solution determined by CD. The ellipticity value obtained represents a relative concentration of folded polypeptide of 100%. The polypeptide in the solution is then unfolded by incrementally adding unfolding agent (e.g., heat, a chaotropic agent) and ellipticity is determined at suitable increments (e.g., after each increase of one degree in temperature). The polypeptide in solution is then refolded by incrementally reducing the unfolding agent and ellipticity is determined at suitable increments. The data can be plotted to produce an unfolding curve and a refolding curve. As shown in FIG. 7, the unfolding and refolding curves have a characteristic shape that includes a portion in which the polypeptide molecules are folded, an unfolding/refolding transition in which polypeptide molecules are unfolded to various degrees, and a portion in which the polypeptide molecules are unfolded. The y-axis intercept of the refolding curve is the relative amount of refolded protein recovered. A recovery of at least about 50%, or at least about 60%, or at least about 70%, or at least about 75%, or at least about 80%, or at least about 85%, or at least about 90%, or at least about 95% is indicative that the polypeptide unfolds reversibly.

In a preferred embodiment, the soluble polypeptide unfolds reversibly when heated. Reversibility of unfolding of the soluble polypeptide is determined by preparing a polypeptide solution and plotting heat unfolding and refolding curves for the polypeptide. The peptide solution can be prepared in any suitable solvent, such as an aqueous buffer that has a pH suitable to allow the peptide to dissolve (e.g., pH that is about 3 units above or below the isoelectric point (pI)). The polypeptide solution is concentrated enough to allow unfolding/folding to be detected. For example, the polypeptide solution can be about 0.1 μM to about 100 μM, or preferably about 1 μM to about 10 μM.

If the melting temperature (Tm) of the soluble polypeptide is known, the solution can be heated to about ten degrees below the Tm (Tm-10) and folding assessed by ellipticity or fluorescence (e.g., far-UV CD scan from 200 nm to 250 nm, fixed wavelength CD at 235 nm or 225 nm; tryptophan fluorescent emission spectra at 300 to 450 n with excitation at 298 nm) to provide 100% relative folded polypeptide. The solution is then heated to at least ten degrees above Tm (m+C10) in predetermined increments (e.g., increases of about 0.1 to about 1 degree), and ellipticity or fluorescence is determined at each increment. Then, the polypeptide is refolded by cooling to at least Tm-10 in predetermined increments and ellipticity or fluorescence determined at each increment. If the melting temperature of the polypeptide is not known, the solution can be unfolded by incrementally heating from about 25° C. to about 100° C. and then refolded by incrementally cooling to at least about 25° C., and ellipticity or fluorescence at each heating and cooling increment is determined. The data obtained can be plotted to produce an unfolding curve and a refolding curve, in which the y-axis intercept of the refolding curve is the relative amount of refolded protein recovered.

Some polypeptides unfold reversibly as soluble polypeptides, but not as displayed polypeptides (e.g., displayed as phage coat protein fusion proteins on the surface of a bacteriophage). However, polypeptides that undergo reversible unfolding as displayed polypeptides generally also undergo reversible unfolding when prepared as soluble polypeptides. Thus, reversible unfolding in the context of a displayed polypeptide is highly advantageous and affords the ability to select polypeptides that are reversibly unfoldable as soluble polypeptides from a repertoire or library of displayed polypeptides.

Unfolding and refolding of polypeptides that are contained within a polypeptide display system, for example, polypeptides displayed on bacteriophage, can be assessed by detecting polypeptide function that is dependent upon proper folding. For example, a polypeptide display system comprising displayed polypeptides that have a common function, such as binding a common ligand (e.g. a generic ligand, a target ligand, a substrate), can be unfolded and then refolded, and refolding can be assessed using a functional assay. For example, whether a polypeptide that has a binding activity unfolds reversibly can be determined by displaying the polypeptide on a bacteriophage and measuring or determining binding activity of the displayed polypeptide. The displayed polypeptide can be unfolded by heating the phage displaying the polypeptide to about 80° C., and then refolded by cooling the phage to about 20° C. or about room temperature, and binding activity of the refolded polypeptide can be measure or determined. A recovery of at least about 50%, or at least about 60%, or at least about 70%, or at least about 75%, or at least about 80%, or at least about 85%, or at least about 90%, or at least about 95% of the binding activity is indicative that the polypeptide unfolds reversibly. In a preferred embodiment, the displayed polypeptide comprises an antibody variable domain, and binding to a generic ligand (e.g., protein A, protein L) or a target ligand is determined.

The polypeptides disclosed herein unfold reversibly in solution and/or when displayed in a suitable polypeptide display system at a polypeptide concentration of at least about 1 μM to about 1 mM, at least about 1 μM to about 500 μM, or at least about 1 μM to about 100 μM. For example, certain single human antibody variable domains can unfold reversibly when displayed in a multimeric phage display system % at produces a local concentration (on the phage tip) of displayed antibody variable domain polypeptide of about 0.5 mM. In particular embodiments, the polypeptides unfold reversibly in solution or when displayed on the phage tip at a polypeptide concentration of about 10 μM, about 20 μM, about 30 μM, about 40 μM about 50 μM, about 60 μM, about 70 μM, about 80 μM, about 90 μM, about 100 μM, about 200 μM, about 300 μM, about 400 μM or about 500 μM.

### Selection Methods

In one aspect, the invention is a process for selecting, isolating and/or recovering a polypeptide that unfolds reversibly from a library or a repertoire of polypeptides (e.g., a polypeptide display system). In one embodiment, the method comprises unfolding a collection of polypeptides (e.g., the polypeptides in a library, a repertoire or a polypeptide display system), refolding at least a portion of the unfolded polypeptides, and selecting, isolating and/or recovering a refolded polypeptide. In another embodiment, the method comprises providing a collection of unfolded polypeptides (e.g., the polypeptides in a library, a repertoire or a polypeptide display system), refolding at least a portion of the unfolded polypeptides, and selecting, isolating and/or recovering a refolded polypeptide.

### Polypeptide Display Systems

Preferably, the polypeptide that unfolds reversibly is selected, isolated and/or recovered from a repertoire of polypeptides in a suitable polypeptide display system. For example, a polypeptide that unfolds reversibly can be selected, isolated and/or recovered from a repertoire of polypeptides that is in solution, or is covalently or noncovalently attached to a suitable surface, such as plastic or glass (e.g., microtiter plate, polypeptide array such as a microarray). For example an array of peptides on a surface in a manner that places each distinct library member (e.g., unique peptide sequence) at a discrete, predefined location in the array can be used. The identity of each library member in such an array can be determined by its spatial location in the array. The locations in the array where binding interactions between a target ligand, for example, and reactive library members occur can determined, thereby identifying the sequences of the reactive members on the basis of spatial location. (See, e.g., U.S. Pat. No. 5,143,854, WO 90/15070 and WO 92/10092.)

Preferably, the method employs a polypeptide display system that links the coding function of a nucleic acid and physical, chemical and/or functional characteristics of the polypeptide encoded by the nucleic acid. Preferably, the polypeptide display system comprises a library, such as a bacteriophage display library. Bacteriophage display is a particularly preferred polypeptide display system.

A number of suitable bacteriophage display systems (e.g., monovalent display and multivalent display systems) have been described. (See, e.g., Griffiths et al., U.S. Pat. No. 6,555,313 B1 (incorporated herein by reference); Johnson et al., U.S. Pat. No. 5,733,743 (incorporated herein by reference); McCafferty et al., U.S. Pat. No. 5,969,108 (incorporated herein by reference); Mulligan-Kehoe, U.S. Pat. No. 5,702,892 (incorporated herein by reference); Winter, G. et al., Annu. Rev. Immunol. 12:433-455 (1994); Soumillion, P. et al., Appl. Biochem. Biotechnol. 47(2-3):175-189 (1994); Castagnoli, L. et al., Comb. Chem. High Throughput Screen, 4(2):121-133 (2001).) The polypeptides displayed in a bacteriophage display system can be displayed on any suitable bacteriophage, such as a filamentous phage (e.g., fd, M13, F1), a lytic phage (e.g., T4, T7, lambda), or an RNA phage (e.g., MS2), for example.

Generally, a library of phage that displays a repertoire of polypeptides, as fission proteins with a suitable phage coat protein, is produced or provided. Such a library can be produced using any suitable methods, such as introducing a library of phage vectors or phagemid vectors encoding the displayed polypeptides into suitable host bacteria, and culturing the resulting bacteria to produce phage (e.g., using a suitable helper phage or complementing plasmid if desired). The library of phage can be recovered from such a culture using any suitable method, such as precipitation and centrifugation.

The polypeptide display system can comprise a repertoire of polypeptides that contains any desired amount of diversity. For example, the repertoire can contain polypeptides that have amino acid sequences that correspond to naturally occurring polypeptides expressed by an organism, group of organisms, desired tissue or desired cell type, or can contain polypeptides that have random or randomized amino acid sequences. If desired, the polypeptides can share a common core or scaffold. For example, all polypeptides in the repertoire or library can be based on a scaffold selected from protein A, protein L, protein G, a fibronectin domain, an anticalin, CTLA4, a desired enzyme (e.g., a polymerase, a cellulase), or a polypeptide from the immunoglobulin superfamily, such as an antibody or antibody fragment (e.g., a V_{H}, a V_{L}). The polypeptides in such a repertoire or library can comprise defined regions of random or randomized amino acid sequence and regions of common amino acid sequence. In certain embodiments, all or substantially all polypeptides in a repertoire are of a desired type, such as a desired enzyme (e.g. a polymerase) or a desired antigen-binding fragment of an antibody (e.g., human V_{H} or human V_{L}). In preferred embodiments, the polypeptide display system comprises a repertoire of polypeptides wherein each polypeptide comprises an antibody variable domain. For example, each polypeptide in the repertoire can contain a V_{H}, a V_{L} or an Fv (e.g., a single chain Fv).

Amino acid sequence diversity can be introduced into any desired region of a desired polypeptide or scaffold using any suitable method. For example, amino acid sequence diversity can be introduced into a target region, such as a complementarity determining region of an antibody variable domain or a hydrophobic domain, by preparing a library of nucleic acids that encode the diversified polypeptides using any suitable mutagenesis methods (e.g. low fidelity PCR, oligonucleotide-mediated or site directed mutagenesis, diversification using NNK codons) or any other suitable method. If desired, a region of a polypeptide to be diversified can be randomized.

The size of the polypeptides that make up the repertoire is largely a matter of choice and uniform polypeptide size is not required. Generally, the polypeptides in the repertoire contain at least about nine amino acid residues and have secondary structure. Preferably, the polypeptides in the repertoire have at least tertiary structure (form at least one domain).

The repertoires of polypeptides comprise polypeptides that unfold reversibly and can be unfolded using a suitable unfolding agent as described herein. A repertoire of polypeptides can be enriched in polypeptides that unfold reversibly and, for example, are secretable when expressed in E. coli. Generally, at least about 10% of the polypeptides contained in such an enriched repertoire unfold reversibly. More preferably, at least about 20%, or at least about 30%, or at least about 40%, or at least about 50%, or at least about 60%, or at least about 70%, or at least about 80%, or at least about 90% of the polypeptides in the enriched repertoire unfold reversibly. Preferred repertoires contain polypeptides that unfold reversibly when heated.

In certain embodiments, substantially all polypeptides in the repertoire share a common selectable characteristic (e.g., physical characteristic, chemical characteristic, functional characteristic). Preferably, the common selectable characteristic is dependent upon proper folding and distinguishes properly folded polypeptides from unfolded and misfolded polypeptides. For example, the common selectable characteristic can be a characteristic such as binding affinity which allows properly folded polypeptides to be distinguished from and selected over misfolded and unfolded polypeptides. In certain embodiments, the common selectable characteristic can be used to select properly folded polypeptides but is absent from unfolded and misfolded polypeptides. For example, a repertoire of polypeptides in which substantially all polypeptides in the repertoire have a common functional characteristic that distinguishes properly folded polypeptides from unfolded and misfolded polypeptides, such as a common binding function (e.g., bind a common generic ligand, bind a common target ligand, bind (or are bound by) a common antibody), a common catalytic activity or resistant to proteolysis (e.g., proteolysis mediated by a particular protease) can be used in the method. In other embodiments, a repertoire of polypeptides in which substantially all polypeptides that unfold reversibly in the repertoire have a common selectable characteristic that distinguishes properly folded polypeptides from unfolded and misfolded polypeptides can be used in the method.

In particular embodiments, the polypeptide display system comprises a library of polypeptides that comprise immunoglobulin variable domains (e.g., V_{H}, V_{L}). The variable domains can be based on a germine sequence (e.g., DP47dummy (SEQ ID NO:3, DPK9 dummy (SEQ ID NO:6)) and if desired can have one or more diversified regions, such as the complementarity determining regions. Other suitable germline sequence for V_{H} include, for example, sequences encoded by the V_{H} gene segments DP4, DP7, DP8, DP9, DP10, DP31, DP33, DP45, DP46, DP49, DP50, DP51, DP53, DP54, DP65, DP66, DP67, DP68 and DP69, and the JH segments JH1, JH2, JH3, JH4, JH4b, JR5 and JH6. Other suitable germline sequence for V_{L} include, for example, sequences encoded by the Vκ gene segments DPK1, DPK2, DPK3, DPK4, DPK5, DPK6, DPK7, DPK8, DPK9, DPK10, DPK12, DPK13, DPK15, DPK16, DPK18, DPK19, DPK20, DPK21, DPK22, DPK23, DPK24, DPK25, DPK26 and DPK 28, and the JK segments Jκ 1, Jκ 2, Jκ 3, Jκ 4 and Jκ 5.

One or more of the framework regions (FR) of the variable domain can comprise (a) the amino acid sequence of a human framework region, (b) at least 8 contiguous amino acids of the amino acid sequence of a human framework region, or (c) an amino acid sequence encoded by a human germline antibody gene segment, wherein said framework regions are as defined by Kabat. In certain embodiments, the amino acid sequence of one or more of the framework regions is the same as the amino acid sequence of a corresponding framework region encoded by a human germline antibody gene segment, or the amino acid sequences of one or more of said framework regions collectively comprise up to 5 amino acid differences relative to the amino acid sequence of said corresponding framework region encoded by a human germline antibody gene segment.

In other embodiments, the amino acid sequences of FR1, FR2, FR3 and FR4 are the same as the amino acid sequences of corresponding framework regions encoded by a human germline antibody gene segment, or the amino acid sequences of FR1, FR2, FR3 and FR4 collectively contain up to 10 amino acid differences relative to the amino acid sequences of corresponding framework regions encoded by said human germline antibody gene segments. In other embodiments, the amino acid sequence of said FR1, FR2 and FR3 are the same as the amino acid sequences of corresponding framework regions encoded by said human germline antibody gene segment.

The polypeptides comprising a variable domain preferably comprise a target ligand binding site and/or a generic ligand binding site. In certain embodiments, the generic ligand binding site is a binding site for a superantigen, such as protein A, protein L or protein G.

The variable domain can be based on any desired variable domain, for example a human V_{H} (e.g., V_{H} 1a, V_{H} 1b, ASH 2, V_{H} 3, V_{H} 4, V_{H} 5, V_{H} 6), a human Vλ (e.g., VλI, VλII, VλIII, VλIV, VλV or VλVI) or a human Vκ (e.g., Vκ1, Vκ2, Vκ3, Vκ4, Vκ5, Vκ6, Vκ7, Vκ8, Vκ9 or Vκ10). Preferably, the variable domain is not a Camelid immunoglobulin domain, such as a V_{H} H, or contain one or more amino acids (e.g., frame work amino acids) that are unique to Camelid immunoglobulin variable domains encoded by germine sequences but not, for example, to human immunoglobulin variable domains. (See, e.g. Davies et al., Protein Engineering 9:531-537 (1996); Tanha et al, J. Biol. Chem. 276:24774-24780 (2001); Riechmann et al., J. Immunol. Methods 23:25-38 (1999).) In one embodiment, the V_{H} that unfolds reversibly does not comprise one or more amino acids that are unique to murine (e.g., mouse) germline framework regions. Preferably, the variable domain unfolds reversibly when heated.

The isolated polypeptide comprising a variable domain can be an antibody format. Thus, in certain embodiments, the isolated polypeptide comprising a variable domain that unfolds reversibly can be a homodimer of variable domain, a heterodimer comprising a variable domain, an Fv, a scFv, a disulfide bonded Fv, a Fab, a single variable domain or a variable domain fused to an immunoglobulin Fc portion.

In one embodiment the polypeptide display system comprises polypeptides that are nucleic acid polymerases, such as variants of a thermostable DNA polymerase (e.g., Taq polymerase.)

### Unfolding and Refolding

The polypeptides (e.g., displayed polypeptides) can be unfolded using any desired unfolding agent. Suitable unfolding agents include, for example, heat and/or pressure, low or high pH, chaotropic agents (e.g., guanidine hydrochloride, urea and the like) and organic solvents (e.g., an alcohol (e.g., methanol, ethanol), a ketone (e.g., methyl ethyl ketone), an aldehyde (e.g., formaldehyde, dimethylformaldehyde), tetrahydrofuran, dioxane, toluene and the like). In certain embodiments, the displayed polypeptides are unfolded using an unfolding agent, with the proviso that the unfolding agent is not a chaotropic agent. Generally, unfolding is effectuated by exposing the collection of polypeptides to an amount of unfolding agent (e.g., heat) that is sufficient to cause at least about 10% of the polypeptides in the collection to unfold. In particular embodiments, unfolding is effectuated by exposing the collection of polypeptides to an amount of unfolding agent (e.g., heat) that is sufficient to cause at least about 20%, or at least about 30%, or at least about 40%, or at least about 50%, or at least about 60% or at least about 70%, or at least about 80%, or at least about 90%, or at least about 95%, or at least about 98%, or at least about 99%, or substantially all of the polypeptides in the collection to unfold.

In practice, the polypeptides in the repertoire would have a range of melting temperatures (Tm). A Tm (e.g., for use in methods described herein) can be obtained for a repertoire by obtaining a random sample of about 10 to about 100 polypeptides from the repertoire and determining the average Tm for the polypeptides in the sample.

Preferably, the displayed polypeptides are unfolded by heating the polypeptide display system to a suitable unfolding temperature (Ts), such as a temperature that is sufficient to cause at least about 10% of the displayed polypeptides to unfold. A temperature that is sufficient to cause a desired percentage of displayed polypeptides to unfold can readily determined using any suitable methods, for example by reference to an unfolding and/or refolding curve (as described herein). When it is desirable to unfold substantially all displayed polypeptides, the lowest temperature that falls within the unfolded portion of the unfolding and refolding curve for the polypeptide system will generally be sufficient. The temperature selected will be dependent upon the thermostability of the displayed polypeptides. For example, an unfolding temperature of 100° C. or higher can be used if the displayed polypeptides are from, or are variants of polypeptides from, a thermophile or extreme thermophile (e.g., Thermus aquaticus). When the polypeptides are unfolded using heat, the polypeptides are generally unfolded by heating to temperature (Ts) that is at least about the melting temperature (Tm) of the polypeptide to be selected or greater that the Tm of the polypeptide to be selected.

In certain embodiments, the displayed polypeptides are unfolded by raising the temperature of the polypeptide display system to an unfolding temperature that is between about 25° C. and about 100° C. When the polypeptide display system is phage display, it is preferred that the displayed polypeptides are unfolded by raising the temperature of the phage display system to about 80° C. Unfolding displayed or soluble polypeptides at high temperatures (e.g., at about 100° C.) is also preferred and can be advantageous. For example, heat sterilizable polypeptides can be selected, isolated and/or sterilized by heating the polypeptide display or system or soluble polypeptide to about 100° C.

Once the desired unfolding temperature has been attained, the polypeptide display system can be maintained at that temperature for a period of time (e.g., up to about 10 hours), if desired. For example, the polypeptide display system can be maintained at the unfolding temperature for a period of about 100 milliseconds to about 10 hours. In particular embodiments, the polypeptide display system is maintained at the unfolding temperature for about 1 second to about 20 minutes.

The temperature of the polypeptide display system can be raised at any suitable rate, for example at a rate of about 1° C. per millisecond to about 1° C. per hour. In a particular embodiment, the temperature is preferably raised at a rate of about 1° C. per second.

The unfolded polypeptides in the polypeptide display system, or a portion of the unfolded polypeptides, can be refolded by decreasing the amount or concentration of unfolding agent in the system. The amount or concentration of unfolding agent in the system can be decreased using any suitable method, for example, by dilution, dialysis, buffer exchange, titration or other suitable method. Heat can be reduced by cooling at room temperature or under refrigeration (e.g., in a refrigerated cooling block or bath), for example. Pressure can be reduced, for example, by venting.

It may be desirable to refold only a portion of the unfolded displayed polypeptides before selection. For example, highly stable polypeptides that unfold reversibly can be selected, isolated and/recovered when the unfolding agent is decreased minimally, such that only the most stable portion (e.g., about 0.00001% to about 1%) of the unfolded displayed polypeptides refold. Accordingly, refolding can be effectuated by decreasing the amount or concentration of unfolding agent in the polypeptide display system to an amount or concentration that results in the desired degree of refolding. The amount or concentration of unfolding agent that can remain in the polypeptide display system but permit the desired percentage of unfolded displayed polypeptides to refold can be readily determined using any suitable method, for example by reference to an unfolding and refolding curve (as described herein). When it is desirable to refold substantially all unfolded displayed polypeptides, the amount or concentration of unfolding agent can be reduced to the concentration or amount in the polypeptide display system before unfolding (e.g., the system is cooled to room temperature) or the unfolding agent can be substantially removed.

Generally, refolding is effectuated by decreasing the amount or concentration of unfolding agent (e.g., heat) so that at least about 0.00001% of the unfolded polypeptides refold. In particular embodiments, refolding is effectuated by decreasing the amount or concentration of unfolding agent (e.g., heat) so that at least about 0.0001%, or at least about 0.001%, or at least about 0.01%, or at least about 0.1%, or at least about 1%, or at least about 10%, or about 20%, or at least about 30%, or at least about 40%, or at least about 50%, or at least about 60% or at least about 70%, or at least about 80%, or at least about 90%, or at least about 95%, or at least about 98%, or at least about 99%, or substantially all of the unfolded polypeptides that can undergo refolding in the polypeptide display system refold.

As described herein, heat is a preferred unfolding agent. In certain embodiments where the displayed polypeptides are heat unfolded, the displayed unfolded polypeptides are refolded by lowering the temperature of the polypeptide display system to a refolding temperature (Tc) that is below about 99° C. but above the freezing temperature of the polypeptide display system. As with unfolding, the refolding temperature selected will be dependent upon the thermostability of the displayed polypeptides. For example, a refolding temperature of 100° C. or higher can be used if the displayed polypeptides are from, or are variants of polypeptides from, a thermophile or extreme thermophile (e.g., Thermus aquaticus). Preferably, the unfolding temperature and refolding temperature differ by at least about 10° C. to at least about 120° C.

In one embodiment, the polypeptide display system is a phage display system, the displayed polypeptides are unfolded by heating the system to about 80° C., and the displayed unfolded polypeptides can be refolded by reducing the temperature of the phage display system to a temperature between about 1° C. to about 70° C. In more particular embodiments, the displayed unfolded polypeptides are refolded by reducing the temperature of the phage display system to a temperature between about 1° C. to about 60° C., or about 1° C. to about 50° C., or about 1° C. to about 40° C., or about 1° C. to about 30° C., or about 1° C. to about 20° C., or about 1° C. to about 10° C.

Once the desired refolding temperature has been attained, the polypeptide display system can be maintained at that temperature for any desired period of time (e.g., up to about 10 hours), if desired. For example, the polypeptide display system can be maintained at the refolding temperature for a period of about 100 milliseconds to about 10 hours. In particular embodiments, the polypeptide display system is maintained at the refolding temperature for about 1 minute to about 20 minutes.

The temperature of the polypeptide display system can be decreased at any suitable rate, for example at a rate of about 1° C. per millisecond to about 1° C. per hour. In a particular embodiment, the temperature is preferably decreased at a rate of about 1° C. per 100 milliseconds or about 1° C. per second.

The polypeptide display system can be maintained at atmospheric pressure (˜1 atm) during unfolding and refolding of the displayed polypeptides. However, if desired, the polypeptide display system can be maintained at lower or higher pressure. In such situations, more or less unfolding agent may be required to obtain the desired degree of unfolding. For example, more or less heat may need to be applied to the polypeptide display system (relative to a system at 1 atm) in order to achieve the desired unfolding temperature because lowering or raising the pressure of the system can change the temperature of the system.

Unfolding and refolding can be carried out under suitable pH or buffer conditions. Generally, unfolding and refolding are carried out at a pH of about 1 to about 13, or about 2 to about 12. Preferred pH conditions for unfolding and refolding are a pH of about 5 to about 9, or about 6 to about 8, or about 7. Folding and unfolding the polypeptides under acidic or alkaline conditions can allow for selection of polypeptides that function under extreme acidic or alkaline conditions, such as polypeptide drugs that can be administered orally and/or have therapeutic action in the stomach.

### Selection/Isolation/Recovery

A polypeptide that unfolds reversibly (e.g., a population of polypeptides that unfold reversibly) can be selected, isolated and/or recovered from a repertoire or library (e.g., in a polypeptide display system) using any suitable method. A polypeptide can be recovered by selecting and/or isolating the polypeptide. Recovery can be carried out at a suitable recovery temperature (Tr). Generally, a suitable recovery temperature is any temperature that is less than the melting temperature (Tm) of the polypeptide but higher than the freezing temperature of the polypeptide display system. In certain embodiments, the recovery temperature (Tr) is substantially the same as the refolding temperature (Tc), (e.g., Tr=Tc).

In certain embodiments, a polypeptide that unfold reversibly is selected or isolated based on a selectable characteristic (e.g., physical characteristic, chemical characteristic, functional characteristic) that distinguishes properly folded polypeptides from unfolded and misfolded polypeptides. Examples of such selectable characteristics include fluorescence, susceptibility to fluorescence quenching and susceptibility to chemical modification (e.g., with Iodoacetic acid, Iodoacetamide or other suitable polypeptide modifying agent). Preferably, a polypeptide that unfolds reversibly is selected, isolated and/or recovered based on a suitable selectable functional characteristic that distinguishes properly folded polypeptides from unfolded and misfolded polypeptides. Suitable functional characteristics for selecting or isolating a polypeptide that unfolds reversibly include any function that is dependent on proper folding of the polypeptide. Accordingly, a polypeptide that unfolds reversibly can have the function when properly folded, but the function can be lost or diminished upon unfolding and can be absent or diminished when the polypeptide is unfolded or misfolded. Suitable selectable functional characteristics include, for example, binding to a generic ligand (e.g., a superantigen), binding to a target ligand (e.g., an antigen, an epitope, a substrate), binding to an antibody (e.g., through an epitope expressed on the properly folded polypeptide), a catalytic activity and resistance to proteolysis. (See, e.g., Tomlinson et al., WO 99/20749; WO 01/57065; WO 99/58655.)

In preferred embodiments, the polypeptide that unfolds reversibly is selected and/or isolated from a library or repertoire of polypeptides in which substantially all polypeptides that unfold reversibly share a common selectable feature. For example, the polypeptide that unfolds reversibly can be selected from a library or repertoire of polypeptides in which substantially all polypeptides that unfold reversibly bind a common generic ligand, bind a common target ligand, bind (or are bound by) a common antibody, possess a common catalytic activity or are each resistant to proteolysis (e.g., proteolysis mediated by a particular protease). Selection based on binding to a common generic ligand can yield a population of polypeptide that contains all or substantially all polypeptides that unfold reversibly that were components of the original library or repertoire.

Any suitable method can be used to select, isolate and/or recover the polypeptides that unfold reversibly. For example, polypeptides that bind a target ligand or a generic ligand, such as protein A, protein L or an antibody, can be selected, isolated and/or recovered by panning or using a suitable affinity matrix. Panning can be accomplished by adding a solution of ligand (e.g., generic ligand, target ligand) to a suitable vessel (e.g., tube, petri dish) and allowing the ligand to become deposited or coated onto the walls of the vessel. Excess ligand can be washed away and polypeptides (e.g., a phage display library) can be added to the vessel and the vessel maintained under conditions suitable for polypeptides to bind the immobilized ligand. Unbound polypeptide can be washed away and bound polypeptides can be recovered using any suitable method, such as scraping or lowering the pH, for example.

Suitable ligand affinity matrices generally contain a solid support or bead (e.g., agarose) to which a ligand is covalently or noncovalently attached. The affinity matrix can be combined with polypeptides (e.g., a phage display library) using a batch process, a column process or any other suitable process under conditions suitable for binding of polypeptides to the ligand on the matrix. Polypeptides that do not bind the affinity matrix can be washed away and bound polypeptides can be eluted and recovered using any suitable method, such as elution with a lower pH buffer, with a mild denaturing agent (e.g., urea), or with a peptide that competes for binding to the ligand.

In some embodiments, the generic or target ligand is an antibody or antigen binding fragment thereof. Antibodies or antigen binding fragments that bind structural features of polypeptides that are substantially conserved in the polypeptides of a library or repertoire are particularly useful as generic ligands. Antibodies and antigen binding fragments suitable for use as ligand for isolating, selecting and/or polypeptides that unfold reversibly can be monoclonal or polyclonal and can be prepared using any suitable method.

Polypeptides that unfold reversibly can also be selected, for example, by binding metal ions. For example, immobilized metal affinity chromatography (IMAC; Hubert and Porath, J. Chromotography, 98:247 (1980)) takes advantage of the metal-binding properties of histidine and cysteine amino acid residues, as well as others that may bind metals, on the exposed surfaces of numerous proteins. It employs a resin, typically agarose, comprising a bidentate metal chelator (e.g. iminodiacetic acid, IDA, a dicarboxylic acid group) to which is complexed metallic ions. Such resins can be readily prepared, and several such resins are commercially available, such as CHELATING SEPHAROSE 6B (Pharmacia Fine Chemicals; Piscataway, N.J.). Metallic ion that are of use include, but are not limited to, the divalent cations Ni²⁺, Cu²⁺, Zn²⁺, and Co²⁺. A repertoire of polypeptides or library can prepared in binding buffer which consists essentially of salt (typically, NaCl or KCl) at a 0.1- to 1.0 M concentration and a weak ligand (e.g., Tris, ammonia), the latter of which has affinity for the metallic ions of the resin, but to a lesser degree than does a polypeptide to be selected according to the invention. Useful concentrations of the weak ligand range from 0.01- to 0.1M in the binding buffer.

The repertoire of polypeptides or library can contacted with the resin under conditions which permit polypeptides having metal-binding domains to bind. Non-binding polypeptides can be washed away, and the selected polypeptides are elated with a buffer in which the weak ligand is present in a higher concentration than in the binding buffer, specifically, at a concentration sufficient for the weak ligand to displace the selected polypeptides, despite its lower binding affinity for the metallic ions. Useful concentrations of the weak ligand in the elution buffer are 10- to 50-fold higher than in the binding buffer, typically from 0.1 to 0.3 M. Preferably the concentration of salt in the elution buffer equals that in the binding buffer. According to the methods of the present invention, the metallic ions of the resin typically serve as the generic ligand; however, it is contemplated that they can also be used as the target ligand.

IMAC can be carried out using a standard chromatography apparatus (columns, through which buffer is drawn by gravity, pulled by a vacuum or driven by pressure), or by batch procedure, in which the metal-bearing resin is mixed, in slurry form, with the repertoire of polypeptides or library.

Partial purification of a serum T4 protein by IMAC has been described (Staples et al., U.S. Pat. No. 5,169,936); however, the broad spectrum of proteins comprising surface-exposed metal-binding domains also encompasses other soluble T4 proteins, human serum proteins (e.g., IgG, haptoglobin, hemopexin, Gc-globulin, Clq, C3, C4), human desmoplasmin, Dolichos biflorus lectin, zinc-inhibited Tyr(P) phosphatases, phenolase, carboxypeptidase isoenzymes, Cu, Zn superoxide dismutases (including those of humans and all other eukaryotes), nucleoside diphosphatase, leukocyte interferon, lactoferrin, human plasma α₂-SH glycoprotein, β₂-macroglobulin, α₁-antitrypsin, plasminogen activator, gastrointestinal polypeptides, pepsin, human and bovine serum albumin, granule proteins from granulocytes, lysozymes, non-histone proteins, human fibrinogen, human serum transfer human lymphotoxin, calmodulin, protein A, avidin, myoglois, somatomedins, human growth hormone, transforming growth factors, platelet-derived growth factor, α-human atrial natriuretic polypeptide, cardiodilatin and others. In addition, extracellular domain sequences of membrane-bound proteins may be purified using IMAC. Polypeptides that unfold reversibly and comprise a scaffold from any of the above proteins or metal-binding variants thereof can be selected, isolated or recovered using the methods described herein.

Polypeptides that unfold reversibly can also be selected from a suitable phage display system (or other suitable polypeptide display system), based on infectivity of phage following unfolding and refolding or based on aggregation of phage displaying polypeptides. A high local concentration of displayed polypeptide can be produced by displaying polypeptides on multivalent phage proteins (e.g., pIII protein of filamentous bacteriophage). The displayed polypeptides are adjacently located at the phage tip and can interact with each other and form aggregates if they do not unfold reversibly. Such aggregates can be intraphage aggregates which form between the polypeptides displayed on a particular phage and/or interphage aggregates which form between polypeptides displayed on two or more phage when the phage display system comprises a plurality of phage particles at a sufficient concentration. Accordingly, polypeptides that unfold reversibly can be selected from a multivalent phage display system by recovering displayed polypeptides that do not aggregate using any suitable method, such as centrifugation (e.g., ultracentrifugation), or by selecting based on function of the displayed polypeptide or infectivity of the phage.

For example, when heated to a suitable temperature (e.g., about 80° C.) the displayed polypeptides unfold. However, heating filamentous phage to 80° C. reduces infectivity of the phage only slightly (Holliger et al., J. Mol. Biol. 288:649-657 (1999)). The high local concentration of displayed polypeptides can lead to aggregation of unfolded polypeptides and thereby, substantially reduce the infectivity of phage that display polypeptides that do not unfold reversibly. For example, infectivity of phage that display polypeptides that do not unfold reversibly can be reduced by 70 fold or more. However, infectivity of phage displaying polypeptides that unfold reversibly is reduced to a lesser degree or substantially unchanged by heating, for example, at 80° C. (relative to infectivity of phage that do not display polypeptides following heating at 80° C.). Accordingly, in certain embodiments, polypeptides that unfold reversibly can be selected by unfolding and refolding the polypeptides in a suitable polypeptide display system (e.g., a filamentous bacteriophage display system), and selecting phage with infectivity that is not substantially reduced or that is substantially unchanged. The selected polypeptides that unfold reversibly can be further selected for any desired properties, such as binding a desired antigen, catalytic activity, and the like. Selection based on infectivity can also be employed to prepare a library or repertoire that is enriched in polypeptides that unfold reversibly or nucleic acids encoding polypeptides that unfold reversibly.

Polypeptides that unfold reversibly can also be selected from a suitable phage display system (or other suitable polypeptide display system), based on aggregation of phage displaying polypeptides that do not unfold reversibly. For example, a suitable polypeptide display system can be unfolded (e.g., by heating to about 80° C.) and refolded by cooling under conditions in which at least a portion of polypeptides that do not unfold reversibly aggregate. The presence or degree of aggregation can be determined using any suitable method, such as electron microscopy or an infectivity assay. Polypeptides that unfold reversibly can be selected by recovering polypeptides (e.g., displayed on phage) that do not aggregate using any suitable method, such as centrifugation (e.g., ultracentrifugation) or by infecting suitable host bacteria (when the polypeptides are displayed on phage).

Other polypeptide display systems, including systems in which polypeptides are immobilized on a solid support, can be prepared in which displayed polypeptides that do not unfold reversibly can form aggregates. Generally, the displayed polypeptides in such a system are positioned in close proximity to each other. For example, the displayed polypeptides can separated by no more than about twice the length of linear amino acid sequence of the polypeptide. The displayed polypeptides are separated by no more that a distance that is determined by multiplying the number of ammo acid residues in the polypeptide by the length of a peptide bond (3.8 Å) times 2. For example, the polypeptides can be separated by no more than about 200 Å to about 300 Å. In a particular example, the polypeptide contains 100 amino acids, and they are separated by no more that 760 Å. The displayed polypeptides are spaced no closer than the distance between the centers of two adjacent identical globular polypeptides. For example, two immunoglobulin variable domains that are tethered to a substrate by their C-termini should be no closer that 25 Å.

Such polypeptide display systems can be prepared using any suitable method. For example, polypeptides can be concatenated (see, e.g., WO 02/30945) or produced as fusion proteins which bring the polypeptides together (e.g., by dimerizing or oligomerizing, by assembly into a viral coat or capsid). Such polypeptide display systems can also be prepared by immobilizing polypeptides on to a suitable solid support (e.g., a bead, plastic, glass) using any suitable method. Polypeptides that unfold reversibly can be selected from such a polypeptide display system by recovering displayed polypeptides that do not aggregate using any suitable method. For example, when the polypeptides are displayed on a mobile sold support (e.g., beads) interbead aggregates can form and be removed by as centrifugation or other suitable method.

Generally, the polypeptide display system comprises a plurality of polypeptide species and more than one copy (polypeptide molecule) of each species. Preferably, each polypeptide species is present in a concentration that is sufficient to permit aggregation of species that do not unfold reversibly. For example, in polypeptide display systems in which more than one copy of a displayed polypeptides species are located adjacent to each other or co-localized, such as phage display, each species of polypeptide is present in a concentration (e.g., local concentration such as on the phage tip) that is sufficiently high to permit aggregation of species that do not unfold reversibly.

In one embodiment, the process for selecting a polypeptide that binds a ligand and unfolds reversibly from a repertoire of polypeptides comprises, providing a polypeptide display system comprising a repertoire of polypeptides; heating the repertoire to a temperature (Ts) at which at least a portion of the displayed polypeptides are unfolded; cooling the repertoire to a temperature (T) wherein Ts>Tc, whereby at least a portion of the polypeptides have refolded and a portion of the polypeptides have aggregated; and recovering at a temperature (Tr) at least one polypeptide that unfolds reversibly and binds a ligand. Preferably, the ligand is bound by (binds) folded polypeptide but is not bound by (does not bind) aggregated polypeptides. The recovered polypeptide that unfolds reversibly has a melting temperature (Tm), and preferably, the repertoire was heated to Ts, cooled to Tc and the polypeptide that unfolds reversibly was isolated at Tr, such that Ts>Tm>Tc, and Ts>Tm>Tr. Preferably, the recovered polypeptide is not misfolded. Misfolded polypeptides can be identified based on certain selectable characteristic (e.g., physical characteristic, chemical characteristic, functional characteristic) that distinguishes properly folded polypeptides from unfolded and misfolded polypeptides as described herein.

In additional embodiments, the process further comprises confirming that the recovered polypeptide binds a ligand (e.g., target ligand, generic ligand). The process can further comprise confirming that the Tm of the recovered polypeptide is less than the temperature Ts to which the repertoire was heated. The Tm of a recovered polypeptide can be determined using any suitable method, e.g., by circular dichroism, change in fluorescence of the polypeptide with increasing temperature, differential scanning calorimetry (DSC). Preferably, the recovered polypeptide has a Tm that is equal to or greater than about 37° C., and more preferably greater that about 37° C., when rounded up to the nearest whole number. In other embodiments, the Tm of the recovered polypeptide is less than about 60° C. In other embodiments, the Tm of the recovered polypeptide is greater than about 37° C. and less than about 60° C.

In one embodiment, the polypeptide is recovered at a temperature (Tr) that is substantially the same as Tc (e.g., Tc=Tr). In other embodiments, Ts is at least about 60° C. In certain embodiments, the Tm of the recovered polypeptide is less than about 60° C., and the repertoire was heated to a temperature (Ts) greater than about 60° C.

In certain embodiments, the polypeptide display system comprises a plurality of replicable genetic display packages. Preferably, the polypeptide display system is a phage display system, such as a multivalent phage display system. In some embodiments, the polypeptide display system, pre-selection repertoire and/or pre-selection library comprises at least about 10³ nm embers (species), at least about 10⁴ members, at least about 10⁵ members, at least about 10⁶ members, or at least about 10⁷ members. In one embodiment, a phage display system is provided and at least a portion of the polypeptides that aggregate at Tc form interphage aggregates. In another embodiment, a phage display system is provided and at least a portion of the polypeptides that aggregate at Tc form interphage aggregates and intraphage aggregates.

### Methods for Designing Polypeptides

In another aspect, the invention relates to a method for designing and/or preparing a variant polypeptide that unfolds reversibly. The method comprises providing the amino acid sequence of a parental polypeptide, identifying one or more regions of said amino acid sequence that are hydrophobic, selecting one or more of the hydrophobic regions, and replacing one or more amino acids in a selected region to produce a variant amino acid sequence in which the hydrophobicity of the selected region is reduced. A polypeptide that comprises or consists of the variant amino acid sequence can be produced and, if desired, its ability to unfold reversibly can be assessed or confirmed using any suitable method. Preferably, the variant unfolds reversibly when heated and cooled, as described herein.

A variant polypeptide that unfolds reversibly can be prepared using any desired parental polypeptide. For example, the polypeptide that unfolds reversibly can be prepared using a parental polypeptide that is based on a scaffold selected from an enzyme, protein A, protein L, a fibronectin, an anticalin, a domain of CTLA4, or a polypeptide of the immunoglobulin superfamily, such as an antibody or an antibody fragment.

When the parental polypeptide is an antibody variable domain (e.g., a human V_{H}, a human V_{L}), it can comprise V and/or D (where the polypeptide comprises a V_{H} domain) and/or J segment sequences encoded by a germline V, D or J segment respectively, or a sequence that results from naturally occurring or artificial mutations (e.g., somatic mutation or other processes). For example, the parental polypeptide can be a parental immunoglobulin variable domain having an amino acid sequence that is encoded by germline gene segments, or that results from insertion and/or deletion of nucleotides during V(D)J recombination (e.g., N nucleotides, P nucleotides) and/or mutations that arise during affinity maturation.

Similarly, the parental polypeptide can be a parental enzyme that has an amino acid sequence encoded by the germline or that results from naturally occurring or artificial mutation (e.g., somatic mutation).

Hydrophobic regions of the parental polypeptide can be identified using any suitable scale or algorithm. Preferably, hydrophobic regions are identified using the method of Sweet and Eisenberg. (Sweet, R. M. and Eisenberg, D., J. Mol. Biol. 171:479-488 (1983).) The Sweet and Eisenberg method can produce a hydrophobicity score (S/E score) for an amino acid sequence (e.g., an identified hydrophobic region) using a 9 to 18 amino acid window (e.g., a window of 9, 10, 11, 12, 13, 14, 15, 16, 17 or 18 amino acids). A 15 amino acid window is generally preferred. In some embodiments, a parental amino acid sequence is analyzed using the Sweet and Eisenberg method, and a hydrophobicity plot for a selected hydrophobic region is generated (ordinate is the S/E score using a suitable window, abscissa is the amino acid positions of the selected region). A variant amino acid sequence for the selected hydrophobic region is designed in which one or more of the amino acid residues in the parental sequence with a different amino acid residue, and analyzed using the Sweet and Eisenberg method. A hydrophobicity plot for the variant amino acid sequence is produces. A decrease in the area under the curve of the hydrophobicity plot of a selected hydrophobic region in the variant amino acid sequence relative to the area under the curve of the corresponding region in the parental amino acid sequence is indicative of a reduction in hydrophobicity of the selected region. The amino acid sequence of the variant V_{H} or variant V_{L} can comprise one or more of the amino acid replacements for V_{H} or V_{L} described herein. The amino acid sequence of the variant Vex or variant V_{L} can comprise one or more framework regions as described herein.

In a preferred embodiments, a polypeptide comprising a variant antibody variable domain that unfolds reversibly is designed and/or prepared. In one embodiment, the variant antibody variable domain is a variant V_{H} domain in which the hydrophobicity of the amino acid sequence from position 22 to position 36 is reduced (Kabat amino acid numbering system) relative to the corresponding amino acid sequence of the parental V_{H}. In another embodiment, the variant antibody variable domain is a variant V_{H} and the hydrophobicity of the H1 loop is reduced relative to the H1 loop of the parental V_{H} (H1 loop is as defined by the AbM amino acid numbering system). Preferably, hydrophobicity is determined using the method of Sweet and Eisenberg with a 15 amino acid window for V_{H}. In certain embodiments, the S/E score of the amino acid sequence from position 22 to position 36 of the variant V_{H}, is 0.15 or less, or 0.1 or less for an S/E score rounded to one decimal place, or 0.09 or less, or 0.08 or less, or 0.07 or less, or 0.06 or less, or 0.05 or less, or 0.04 or less, or 0 or less. Preferably, the S/E score of the H1 loop of the variant V_{H} is 0 or less.

In another embodiment, the variant antibody variable domain is a variant V_{L} and the hydrophobicity of the FR2CDR2 region and/or FR3 is reduced relative to the FR2-CDR2 region and/or FR3 of the parental V_{L} (FR2-CDR2 region and FR3 region are as defined by the Kabat amino acid numbering system). In another embodiment, the variant antibody variable domain is a variant V_{L} and the hydrophobicity of the amino acid sequence from position 44 to position 53 and/or position 73 to position 76 is reduced relative to the corresponding amino acid sequence of the parental V_{L} (Kabat amino acid numbering system). Preferably, hydrophobicity is determined using the method of Sweet and Eisenberg with an 11 amino acid window for V_{L}. In certain embodiments, the S/E score of the amino acid sequence from position 44 to position 53 that has a S/E score of less than 0.23. For example, the S/E score for position 44 to position 53 of the variant V_{L} can be than 0.2, less than 0.17, less than 0.15, less than 0.13, less than 0.10, or less than −0.1. In some embodiments, the S/E score for FR3 of the variant V_{L} is less than 0.35. For example, the S/E score for FR3 of the variant V_{L} can be less than 0.3, less than 0.25, less than 0.2, less than 0.17, less than 0.15, less than 0.13, less than 0.10, or less than −0.1.

A variant polypeptide that comprises a variant amino acid sequence and unfolds reversibly can be prepared using any suitable method. For example, the amino acid sequence of a parental polypeptide can be altered at particular positions (as described herein with respect to antibody variable domain polypeptides) to produce a variant polypeptide fat unfolds reversibly.

### Libraries/Repertoires

In other aspects, the invention relates to repertoires of polypeptides that unfold reversibly, to libraries that encode polypeptides that unfold reversibly, and to methods for producing such libraries and repertoires.

The libraries and repertoires of polypeptides comprise polypeptides that unfold reversibly (and/or nucleic acids encoding polypeptides that unfold reversibly) using a suitable unfolding agent as described herein. Generally at least about 1% of the polypeptides contained in the repertoire or library or encoded by the library unfold reversibly. More preferably, at least about 10%, or at least about 20%, or at least about 30%, or at least about 40%, or at least about 50%, or at least about 60%, or at least about 70%, or at least about 80%, or at least about 90% of the polypeptides in the repertoire or library or encoded by the library unfold reversibly. Such libraries are referred to herein as being enriched in polypeptides that unfold reversibly or in nucleic acids encoding polypeptides that unfold reversibly. Preferred repertoires and libraries contain polypeptides that unfold reversibly when heated. Preferably, the libraries of the invention comprise heterogeneous nucleic acids that are replicable in a suitable host, such as recombinant vectors that contain nucleic acids encoding polypeptides (e.g., plasmids, phage, phagmids) that are replicable in E. coli, for example.

Libraries that encode and/or contain polypeptides that unfold reversibly can be prepared or obtained using any suitable method. The library of the invention can be designed to encode polypeptides that are based on a polypeptide of interest (e.g., a polypeptide selected from a library) or can be selected from another library using the methods described herein. For example, a library enriched in polypeptides that unfold reversibly can be prepared using a suitable polypeptide display system.

In one example, a phage display library comprising a repertoire of displayed polypeptides comprising an antibody variable domain (e.g., V_{H}, Vκ, Vλ) is unfolded and refolded as described herein and a collection of refolded polypeptides is recovered thereby yielding a phage display library enriched in polypeptides that unfold reversibly. In another example, a phage display library comprising a repertoire of displayed polypeptides comprising an antibody variable domain (e.g., V_{H}, Vκ, Vλ) is first screened to identify members of the repertoire that have binding specificity for a desired target antigen. A collection of polypeptides having the desired binding specificity are recovered, the collection is unfolded and refolded, and a collection of polypeptides that unfold reversibly and have the desired binding specificity is recovered, yielding a library enriched in polypeptides that unfold reversibly.

In another example, a polypeptide of interest, such as an immunoglobulin variable domain, is selected (e.g., from a library) and the amino acid sequence of the polypeptide is analyzed to identify regions of hydrophobicity. Hydrophobicity can be determined using any suitable method, scale or algorithm. Preferably, hydrophobicity is determined using the method of Sweet and Eisenberg. (Sweet, R. M. and Eisenberg, D., J. Mol. Biol. 171:479-488 (1983).) A region of hydrophobicity in the polypeptide is selected and a collection of nucleic acids is prepared that contains sequence diversity targeted to the region encoding the hydrophobic region of the polypeptide. The collection of nucleic acids can be randomized in the target region or sequence diversity that results in reduced hydrophobicity of the selected region of the polypeptide (through amino acid replacement) can be introduced. The collection of nucleic acids can then be inserted into a suitable vector (e.g., aphage, aphagemid) to yield a library. The library can be expressed in a suitable polypeptide display system and the polypeptides in the display system can be unfolded, refolded and a collection of polypeptides that unfold reversibly can be selected or recovered as described herein to yield a library enriched in polypeptides that unfold reversibly.

When the library is based on a polypeptide of interest, it is preferred that the hydrophobic region targeted for sequence diversification is a hydrophobic region that is associated with aggregation of unfolded polypeptides. Such aggregation prone hydrophobic regions can be identified using any suitable method. For example, amino acids in the hydrophobic regions can be replaced with less hydrophobic residues (e.g., Tyr replaced with Asp or Glu). The resulting polypeptides can be unfolded and aggregation can be assessed using any suitable method. Decreased aggregation of polypeptide that contains an amino acid replacement indicates that the hydrophobic region that contains the amino acid replacement is an aggregation prone hydrophobic region

A particular repertoire of polypeptides or library comprises V_{H} domains (e.g., based on a parental V_{H} domain comprising a germline V_{H} gene segment) containing at least one amino acid replacement that reduces the hydrophobicity of the amino acid sequence from position 22 to position 36, or position 26 to position 35, as defined by the Kabat amino acid numbering scheme. Another particular repertoire of polypeptides or library comprises V_{H} domains wherein the hydrophobicity of the amino acid sequence from position 22 to position 36 (Kabat amino acid numbering scheme) has a Sweet/Eisenberg hydrophobicity score of 0 or less. Preferably, at least about 1% of the polypeptides contained in the repertoire or library have a Sweet/Eisenberg hydrophobicity score of 0 or less for the amino acid sequence from position 22 to position 36. More preferably, at least about 10%, or at least about 20%, or at least about 30%, or at least about 40%, or at least about 50%, or at least about 60%, or at least about 70%, or at least about 80%, or at least about 90% of the polypeptides have a Sweet/Eisenberg hydrophobicity score of 0 or less for the amino acid sequence from position 22 to position 36.

Another particular repertoire of polypeptides or library comprises V_{L} domains (e.g., based on a parental V_{L} domain comprising a germline V_{L} gene segment) containing at least one amino acid replacement that reduces the hydrophobicity of the amino acid sequence from position 44 to position 53, as defined by the Kabat amino acid numbering scheme. Another repertoire of polypeptides or library comprises V_{L} domains (e.g., based on a parental V_{L} domain comprising a germline V_{L} gene segment) containing at least one amino acid replacement that reduces the hydrophobicity of framework 3 (FR3), as defined by the Kabat amino acid numbering scheme. Other repertoires and libraries can be produced that contain polypeptides comprising an antibody variable region having amino acid sequence diversity at particular residues or regions as described herein.

The libraries and repertoires can be based on a polypeptide that unfolds reversibly (e.g., when heated), such as a polypeptide that unfolds reversibly that is selected or designed as described herein. Generally, one or more amino acid residues are identified in the amino acid sequence or the polypeptide that unfolds reversibly that prevent irreversible aggregation of the polypeptide upon unfolding. Such amino acid residues are referred to herein as folding gatekeepers. (See Examples, Sections 16-19) Folding gatekeepers can be identified, for example, by aligning the amino acid sequences of two or more polypeptides that unfold reversibly and that are based on a common amino acid sequence (polypeptide scaffold amino acid sequence) but contain some degree of sequence diversity. Such an alignment can be used to identify amino acid substitutions in the scaffold sequence that are common to polypeptides that unfold reversibly. A polypeptide based on the scaffold sequence but containing one or more the identified amino acid substitutions can be prepared and assessed for reversible unfolding, to confirm that the identified amino acid residues are folding gatekeepers. Folding gatekeeper residues can also be designed into a desired polypeptide, such as a human V_{H} as described herein. (See Examples, Sections 16-19)

The library can comprise a collection of nucleic acids that encode polypeptides that unfold reversibly and/or a collection of polypeptides that unfold reversibly in which each polypeptide contains a common folding gatekeeper residue (one or more common folding gatekeeper residues). For example, as described herein, a library comprising a collection of heterogeneous nucleic acids that each encode a human antibody variable domain containing a folding gatekeeper residue can be prepared. If desired, the members of the library can have sequence diversity in a particular region (e.g., in the CDRs). In certain embodiments, the library comprises a collection of heterogeneous nucleic acids encoding antibody variable domains (e.g., V_{H} (human V_{H}), V_{L}, (human V_{L})) that contain folding gatekeeper residues. In one embodiment, the library comprises a collection of heterogeneous nucleic acids encoding V_{H}s (human V_{H}s) that contain folding gatekeeper residues in CDR1, CDR1 and CDR2 or CDR2. Preferably, the nucleic acids in such a library encode V_{H}s that contain diverse CDR3s (e.g., randomized CDR3s).

The gatekeeper residues can be designed into CDR1 and/or CDR2 using the methods described herein or other suitable methods, and nucleic acids produced that encode V_{H}s that contain those gatekeeper residues. V_{H}, that unfold reversibly can be isolated or selected, using the methods described herein or other suitable method, and nucleic acid(s) encoding CDR1 and/or CDR2 from a V_{H} that unfolds reversibly (the same or different V_{H}s) can be obtained and ligated to one or more nucleic acids encoding suitable framework regions and CDR3.

In one embodiment, the library of nucleic acids encodes a polypeptide that unfolds reversibly, wherein each member of the library encodes a polypeptide comprising the amino acid sequence of a parental polypeptide in which at least one amino acid residue is replaced with a folding gatekeeper residue and at least one other amino acid residue is replaced, added or deleted. The parental polypeptide can be an antibody variable domain that comprises framework regions as described herein. In particular embodiments, the parental polypeptide is a human V_{H} and a folding gatekeeper is introduced into CDR1. In another particular embodiment, the parental polypeptide is a human V_{L} and a folding gatekeeper is introduced into the FR2-CDR2 region.

In another embodiment, the library of nucleic acids encodes an antibody variable domain that unfolds reversibly, wherein each member of the library comprising a first nucleic acid encoding CDR1 and optionally CDR2 of the variable domain or an antibody variable domain that unfolds reversibly, where said first nucleic acid is operably linked to one or more other nucleic acids to produce a construct that encodes antibody variable domains in which CDR1 and optionally CDR2 are encoded by said first nucleic acid. If desired, the members of the library encode an antibody variable domain in which CDR3 is diversified (e.g., at targeted positions) or randomized (e.g., across the entire CDR3 sequence and/or has CDR3s of varying length).

Libraries that encode a repertoire of a desired type of polypeptides can readily be produced using any suitable method. For example, a nucleic acid sequence that encodes a desired type of polypeptide (e.g. a polymerase, an immunoglobulin variable domain) can be obtained and a collection of nucleic acids that each contain one or more mutations can be prepared, for example by amplifying the nucleic acid using an error-prone polymerase chain reaction (PCR) system, by chemical mutagenesis (Deng et al. J. Biol. Chem., 269:9533 (1994)) or using bacterial mutator strains (Low et al. J. Mol. Biol., 260:359 (1996)).

In other embodiments, particular regions of the nucleic acid can be targeted for diversification. Methods for mutating selected positions are also well known in the art and include, for example, the use of mismatched oligonucleotides or degenerate oligonucleotides, with or without the use of PCR. For example, synthetic antibody libraries have been created by targeting mutations to the antigen binding loops. Random or semi-random antibody H3 and L3 regions have been appended to germline immunoglobulin V gene segments to produce large libraries with unmutated framework regions (Hoogenboom and Winter (1992) supra; Nissim et al. (1994) supra; Griffths et al. (1994) supra; DeKruif et al. (1995) supra). Such diversification has been extended to include some or all of the other antigen binding loops (Crameri et al. (1996) Nature Med., 2:100; Riechmann et al. (1995) Bio/Technology, 13:475; Morphosys, WO 97/08320, supra). In other embodiments, particular regions of the nucleic acid can be targeted for diversification by, for example, a two-step PCR strategy employing the product of the first PCR as a “mega-primer.” (See, e.g., Landt, O. et al., Gene 96:125-128 (1990).) Targeted diversification can also be accomplished, for example, by SOE PCR. (See, e.g., Horton, R. M. et al., Gene 77:6168 (1989).)

As described herein, sequence diversity at selected positions can be achieved by altering the coding sequence which specifies the sequence of the polypeptide such that a number of possible amino acids (e.g., all 20 or a subset thereof) can be incorporated at that position. Using the IUPAC nomenclature, the most versatile codon is NNK, which encodes all amino acids as well as the TAG stop codon. The NNK codon is preferably used in order to introduce the required diversity. Other codons which achieve the same ends are also of use, including the NNN codon, which leads to the production of the additional stop codons TGA and TAA. Such a targeted approach can allow the full sequence space in a target area to be explored.

Preferred libraries of polypeptides that unfold reversibly comprise polypeptides that are members of the immunoglobulin superfamily (e.g., antibodies or portions thereof). For example the libraries can comprise antibody polypeptides that unfold reversibly and have an known main-chain conformation. (See, e.g., Tomlinson et al., WO 99/20749.)

Libraries can be prepared in a suitable plasmid or vector. As used herein, vector refers to a discrete element that is used to introduce heterologous DNA into cells for the expression and/or replication thereof. Any suitable vector can be used, including plasmids (e.g., bacterial plasmids), viral or bacteriophage vectors, artificial chromosomes and episomal vectors. Such vectors may be used for simple cloning and mutagenesis, or an expression vector can be used to drive expression of the library. Vectors and plasmids usually contain one or more cloning sites (e.g., a polylinker), an origin of replication and at least one selectable marker gene. Expression vectors can further contain elements to drive transcription and translation of a polypeptide, such as an enhancer element, promoter, transcription termination signal, signal sequences, and the like. These elements can be arranged in such a way as to be operably linked to a cloned insert encoding a polypeptide, such that the polypeptide is expressed and produced when such an expression vector is maintained under conditions suitable for expression (e.g., in a suitable host cell).

Cloning and expression vectors generally contain nucleic acid sequences that enable the vector to replicate in one or more selected host cells. Typically in cloning vectors, this sequence is one that enables the vector to replicate independently of the host chromosomal DNA and includes origins of replication or autonomously replicating sequences. Such sequences are well known for a variety of bacteria, yeast and viruses. The origin of replication from the plasmid pBR322 is suitable for most Gram-negative bacteria, the 2 micron plasmid origin is suitable for yeast, and various viral origins (e.g. SV40, adenovirus) are useful for cloning vectors in mammalian cells. Generally, the origin of replication is not needed for mammalian expression vectors unless these are used in mammalian cells able to replicate high levels of DNA, such as COS cells.

Cloning or expression vectors can contain a selection gene also referred to as selectable marker. Such marker genes encodes a protein necessary for the survival or growth of transformed host cells gown in a selective culture medium. Host cells not transformed with the vector containing the selection gene will therefore not survive in the culture medium. Typical selection genes encode proteins that confer resistance to antibiotics and other toxins, e.g. ampicillin, neomycin, methotrexate or tetracycline, complement auxotrophic deficiencies, or supply critical nutrients not available in the growth media.

Suitable expression vectors can contain a number of components, for example, an origin of replication, a selectable marker gene, one or more expression control elements, such as a transcription control element (e.g., promoter, enhancer, terminator) and/or one or more translation signals, a signal sequence or leader sequence, and the like. Expression control elements and a signal or leader sequence, if present, can be provided by the vector or other source. For example, the transcriptional and/or translational control sequences of a cloned nucleic acid encoding an antibody chain can be used to direct expression.

A promoter can be provided for expression in a desired host cell. Promoters can be constitutive or inducible. For example, a promoter can be operably linked to a nucleic acid encoding an antibody, antibody chain or portion thereof, such that it directs transcription of the nucleic acid. A variety of suitable promoters for procaryotic (e.g., the β-lactamase and lactose promoter systems, alkaline phosphatase, the tryptophan (trp) promoter system, lac, tac, T3, T7 promoters for E. coli) and eucaryotic (e.g., simian virus 40 early or late promoter, Rous sarcoma virus long terminal repeat promoter, cytomegalovirus promoter, adenovirus late promoter, EG-1a promoter) hosts are available.

In addition, expression vectors typically comprise a selectable marker for selection of host cells carrying the vector, and, in the case of a replicable expression vector, an origin or replication. Genes encoding products which confer antibiotic or drug resistance are common selectable markers and may be used in procaryotic (e.g., β-lactamase gene (ampicillin resistance), Tet gene for tetracycline resistance) and eucaryotic cells (e.g., neomycin (G418 or geneticin), gpt (mycophenolic acid), ampicillin, or hygromycin resistance genes). Dihydrofolate reductase marker genes permit selection with methotrexate in a variety of hosts. Genes encoding the gene product of auxotrophic markers of the host (e.g., LEU2, URA3, HIS3) are often used as selectable markers in yeast. Use of viral (e.g., baculovirus) or phage vectors, and vectors which are capable of integrating into the genome of the host cell, such as retroviral vectors, are also contemplated.

Suitable expression vectors for expression in prolaxyotic (e.g., bacterial cells such as E. coli) or mammalian cells include, for example, a pET vector (e.g. pET-12a, pET-36, pET-37, pET-39, pET-40, Novagen and others), a phage vector (e.g., pCANTAB 5 E, Pharmacia), pRIT2T Protein A fusion vector, Pharmacia), pCDM8, pcDNA1.1 amp, pcDNA3.1, pRc/RSV, pEF-1 (Invitrogen, Carlsbad, Calif.), pCMV-SCRIPT, pFB, pSG5, pXr1 (Stratagene, La Jolla, Calif.), pCDEF3 (Goldman, L. A., et al., Biotechniques, 21:1013-1015 (1996)), pSVSPORT (GibcoBRL, Rockville, Md.), pEF-Bos (Mizushima, S., et al., Nucleic Acids Res., 18:5322 (1990)) and the like. Expression vectors which are suitable for use in various expression hosts, such as prokaryotic cells (E. coli), insect cells (Drosophila Schnieder S2 cells, Sf9) and yeast (P. methanolica, P. pastoris, S. cerevisiae) and mammalian cells (e.g., COS cells) are available.

Preferred vectors are expression vectors that enable the expression of a nucleotide sequence corresponding to a polypeptide library member. Thus, selection with generic and/or target ligands can be performed by separate propagation and expression of a single clone expressing the polypeptide library member. As described above, the preferred selection display system is bacteriophage display. Thus, phage or phagemid vectors may be used. The preferred vectors are phagemid vectors which have an E. coli. origin of replication (for double stranded replication) and also a phage origin of replication (for production of single-stranded DNA). The manipulation and expression of such vectors is well known in the art (Hoogenboom and Winter (1992) supra; Nissim et al. (1994) supra). Briefly, the vector can contain a β-lactamase gene to confer selectivity on the phagemid and a lac promoter upstream of an expression cassette that can contain a suitable leader sequence (e.g., pelB leader sequence), a multiple cloning site, one or more peptide tags, one or more TAG stop codons and the phage protein pIII. Thus, using various suppressor and non-suppressor strains of E. coli and with the addition of glucose, iso-propyl thio-β-D-galactoside (IPTG) or a helper phage, such as VCS M13, the vector is able to replicate as a plasmid with no expression, produce large quantities of the polypeptide library member only or product phage, some of which contain at least one copy of the polypeptide-pIII fusion on their surface.

The libraries and repertoires of the invention can contain antibody formats. For example, the polypeptide contained within the libraries and repertoires can be whole antibodies or fragments therefore, such as Fab, F(ab′)₂, Fv or scFv fragments, separate V_{H} or V_{L} domains, any of which is either modified or unmodified, scFv fragments, as well as other antibody polypeptides, can be readily produced using any suitable method. A number of suitable antibody engineering methods are well known in the art. For example, a scFv can be formed by lining nucleic acids encoding two variable domains with an suitable oligonucleotide that encodes an appropriately linker peptide, such as (Gly-Gly-Gly-Gly-Ser)₃ or other suitable linker peptide(s). The linker bridges the C-terminal end of the first V region and N-terminal end of the second V region. Similar techniques for the construction of other antibody formats, such as Fv, Fab and F(ab′)₂ fragments. To format Fab and F(ab′)2 fragments, V_{H} and V_{L} polypeptides can combined with constant region segments, which may be isolated from rearranged genes, germline C genes or synthesized from antibody sequence data. A library or repertoire according to the invention can be a V_{H} or V_{L} library or repertoire.

In particular embodiments, the libraries and repertoires comprise immunoglobulin variable domains that unfold reversibly (e.g., V_{H}, V_{L}). The variable domains can be based on a germline sequence (e.g., DP47dummy (SEQ ID NO:3, DPK dummy (SEQ ID NO:6)) and if desired can have one or more diversified regions, such as the complementarity determining regions.

One or more of the framework regions (FR) of the variable domains can comprise (a) the amino acid sequence of a human framework region, do) at least 8 contiguous amino acids of the amino acid sequence of a human framework region, or (c) an amino acid sequence encoded by a human germline antibody gene segment, wherein said framework regions are as defined by Kabat. In certain embodiments, the amino acid sequence of one or more of the framework regions is the same as the amino acid sequence of a corresponding framework region encoded by a human germline antibody gene segment, or the amino acid sequences of one or more of said framework regions collectively comprise up to 5 amino acid differences relative to the amino acid sequence of said corresponding framework region encoded by a human germline antibody gene segment.

In other embodiments, the amino acid sequences of FR1, FR2, FR3 and FR4 are the same as the amino acid sequences of corresponding framework regions encoded by a human germline antibody gene segment, or the amino acid sequences of FR1, FR2, FR3 and FR4 collectively contain up to 10 amino acid differences relative to the amino acid sequences of corresponding framework regions encoded by said human germline antibody gene segments. In other embodiments, the amino acid sequence of said FR1, FR2 and FR3 are the same as the amino acid sequences of corresponding framework regions encoded by said human germline antibody gene segment.

The polypeptides comprising a variable domain that unfolds reversibly preferably comprise a target ligand binding site and/or a generic ligand binding site. In certain embodiments, the generic ligand binding site is a binding site for a superantigen, such as protein A, protein L or protein G.

The variable domains can be based on any desired variable domain, for example a human V_{H} (e.g., V_{H} 1a, V_{H} 1b, V_{H} 2, V_{H} 3, V_{H} 4, V_{H} 5, V_{H} 6), a human Vλ(e.g., VλI, VλII, VλIII, VλIV, VλV or VλVI) or a human Vκ (e.g., Vκ1, Vκ2, Vκ3, Vκ4, Vκ5, Vκ6, Vκ7, Vκ8, Vκ9 or Vκ10). Preferably, the variable domains are not a Camelid immunoglobulin domain, such as a V_{H} H, or contain one or more amino acids (e.g., framework amino acids) that are unique to Camelid immunoglobulin variable domains encoded by germline sequences but not, for example, to human immunoglobulin variable domains. (See, e.g., Davies et al., Protein Engineering 9:531-537 (1996); Tanha et al., J. Biol. Chem. 276:24774-24780 (2001); Riechmann et al., J. Immunol. Methods 23; 25-38 (1999).) In one embodiment, the V_{H} that unfolds reversibly does not comprise one or more amino acids that are unique to murine (e.g., mouse) germline framework regions. Preferably, the variable domain is unfold reversibly when heated and cooled.

The isolated polypeptide comprising a variable domain can be an antibody format. Thus, in certain embodiments, the isolated polypeptide comprising a variable domain that unfolds reversibly can be a homodimer of variable domain, a heterodimer comprising a variable domain, an Fv, a scFv, a disulfide bonded Fv, a Fab, a single variable domain or a variable domain fused to an immunoglobulin Fe portion.

### Polypeptides

In one aspect, the invention is an isolated polypeptide that unfolds reversibly. As described herein, such polypeptides can be expressed in E. coli and recovered in high yield. As described herein, in preferred embodiments the polypeptides that unfold reversibly (e.g., when heated) are secreted when expressed in E. coli, and easily recovered as soluble polypeptides. Such polypeptides are also referred to as secretable when expressed in E. coli. In preferred embodiments, the polypeptide that unfolds reversibly is secreted in a quantity of at least about 0.5 mg/L when expressed in E. coli. In other preferred embodiments, the polypeptide that unfolds reversibly is secreted in a quantity of at least about 0.75 mg/L, at least about 1 mg/L, at least about 4 mg/L, at least about 5 mg/L, at least about 10 mg/L, at least about 15 mg/L, at least about 20 mg/L, at least about 25 mg/L, at least about 30 mg/L, at least about 35 mg/L, at least about 40 mg/L, at least about 45 mg/L, or at least about 50 mg/L, or at least about 100 mg/L, or at least about 200 mg/L, or at least about 300 mg/L, or at least about 400 mg/L, or at least about 500 mg/L, or at least about 600 mg/l, or at least about 700 mg/L, or at least about 800 mg/L, at least about 900 mg/L, at least about 100 mg/L when expressed in E. coli. In other preferred embodiments, the polypeptide that unfolds reversibly is secreted in a quantity of at least about 1 mg/L to at least about 1 g/L, at least about 1 mg/L to at least about 750 mg/L, at least about 100 mg/L to at least about 1 g/L, at least about 200 mg/L to at least about 1 g/L, at least about 300 mg/L to at least about 1 g/L, at least about 400 mg/L to at least about 1 g/L, at least about 500 mg/L to at least about 1 g/L, at least about 600 mg/L to at least about 1 g/L, at least about 700 mg/L to at least about 1 g/L, at least about 800 mg/L to at least about 1 g/L, or at least about 900 mg/L to at least about 1 g/L when expressed in E. coli. Although, the polypeptides described herein can be secretable when expressed in E. coli, they can be produced using any suitable method, such as synthetic chemical methods or biological production methods that do not employ E. coli. In particularly preferred embodiments, the polypeptide that unfolds reversibly is a human antibody variable domain (V_{H}, V_{L}) or comprises a human antibody variable domain that unfolds reversibly.

In some embodiments, the polypeptide that unfolds reversibly is a variant of a parental polypeptide that differs from the parental polypeptide in amino acid sequence (e.g., by one or more amino acid replacements, additions and/or deletions), but qualitatively retains function of the parental polypeptide. Preferably, the activity of the variant polypeptide that unfolds reversibly is at least about 25%, at least about 30%, at least about 40%, at least about 50%, at least about 60%, at least about 70%, at least about 80%, at least about 90%, at least about 95%, or essentially the same as of the activity of the parental polypeptide. For example, if the parental polypeptide is an enzyme, the variant polypeptide can contain an amino acid sequence that differs from the parental enzyme (e.g., by one to about ten amino acid substitutions, deletions and/or insertions) but will retain the catalytic activity of parental enzyme. Preferably, the variant enzyme that unfolds reversibly is characterized by a catalytic rate constant that is at least about 25% of the catalytic rate constant of the parental enzyme.

A variant polypeptide that unfolds reversibly can be prepared using any desired parental polypeptide. For example, the polypeptide that unfolds reversibly can be prepared using a parental polypeptide that is based on a scaffold selected from an enzyme, protein A, protein L, a fibronectin, an anticalin, a domain of CTLA4, or a polypeptide of the immunoglobulin superfamily, such as an antibody or an antibody fragment.

The parental polypeptide can comprise V and/or D (where the polypeptide comprises a V_{H} domain) and/or J segment sequences encoded by a germline V, D or J segment respectively, or a sequence that results from naturally occurring or artificial mutations (e.g., somatic mutation or other processes). For example, the parental polypeptide can be a parental immunoglobulin variable domain having an amino acid sequence that is encoded by germline gene segments, or that results from insertion and/or deletion of nucleotides during V(D)J recombination (e.g., N nucleotides, P nucleotides) and/or mutations that arise during affinity maturation. Similarly, the parental polypeptide can be a parental enzyme that has an amino acid sequence encoded by the germline or that results from naturally occurring or artificial mutation (e.g., somatic mutation).

A variant polypeptide that unfolds reversibly can be prepared using any suitable method. For example, the amino acid sequence of a parental polypeptide can be altered at particular positions (as described herein with respect to antibody variable domain polypeptides) to produce a variant polypeptide that unfolds reversibly. A variant polypeptide that unfolds reversibly can also be produced, for example, by providing a nucleic acid that encodes a parental polypeptide, preparing a library of nucleic acids that encode variants of the parental polypeptide (e.g., by error prone PCR or other suitable method) and expressing the library in a suitable polypeptide display system. A variant polypeptide that unfolds reversibly and retains a desired function of the parental polypeptide can be selected and isolated from such a polypeptide display system using the methods described herein or other suitable methods.

Polypeptides Comprising V Domains that Unfold Reversibly

In preferred embodiments, the isolated polypeptide comprises an immunoglobulin variable domain that unfolds reversibly (e.g., V_{H}, a variant V_{H}, V_{L} and/or variant V_{L}). In certain embodiment the isolated polypeptide comprises a variant V_{H} and/or a variant V_{L} that unfolds reversibly. Preferably the variable domain that unfolds reversibly (e.g., V_{H}, variant V_{H}, V_{L}, variant V_{L}) has binding specificity for a target ligand and binds to the target ligand with a suitable dissociation constant (K_{d}) and suitable off rate (K_{off}) A suitable K_{d} can be about 50 nM to about 20 pM or less, for example about 50 nM, about 1 nM, about 900 pM, about 800 pM, about 700 pM, about 600 pM, about 500 pM, about 400 pM, about 300 pM, about 200 pM, about 100 pM or about 20 pM or less. A suitable K_{off} can be about 1×10⁻¹s⁻¹ to about 1×10⁻⁷ s⁻¹, or less, for example about 1×10⁻¹s⁻¹, about 1×10⁻²s⁻¹, about 1×10⁻³ s⁻¹, about 1×10⁻⁴s⁻¹, about 1×10⁻⁵s⁻¹, about 1×10⁻⁶ s⁻¹ or about 1×10⁻¹s⁻¹ or less. Preferably, K_{d} and K_{off} are determined using surface plasmon resonance.

In certain embodiments, the isolated polypeptide comprises a V_{H} (e.g., variant V_{H}) that unfolds reversibly. In some embodiments, the amino acid sequence of the variant V_{H} that unfolds reversibly differs from the amino acid sequence of the parental V_{H} by at least one amino acid from position 22 to position 36, or differs from the amino acid sequence of the parental V_{H} by at least one amino acid in the H1 loop. The amino acid positions and CDR (H1, H2 and H3) and framework regions (FR1, FR2, FR3 and FR4) of the V_{H} can be defined using any suitable system, such as the systems of Kabat, Chothia or AbM. Preferably, positions 22 through 36 are defined according to the amino acid numbering system of Kabat, and the H1 loop is defined according to the amino acid numbering system used in the AbM software package (antibody analysis and structural modeling software; Oxford Molecular). The amino acid sequence of the variant V_{H} can contain at least one amino acid replacement from position 22 to position 36 relative to the parental V_{H}.

In certain embodiments, the amino acid sequence of the V_{H} that unfolds reversibly contains at least one Pro or Gly residue from position 22 to position 36. In other embodiments, the amino acid sequence of the V_{H} that unfolds reversibly contains at least one Pro or Gly residue in the H1 loop. In certain embodiments, the amino acid sequence of the variant V_{H} that unfolds reversibly contains at least one Pro or Gly replacement from position 22 to position 36 relative to the amino acid sequence of the parental V_{H}. In other embodiments, the amino acid sequence of the variant V_{H} that unfolds reversibly contains at least one Pro or Gly replacement in the H1 loop relative to the amino acid sequence of the parental V_{H}. In a particular embodiment, the variant V_{H} that unfolds reversibly comprises an amino acid sequence wherein the parental amino acid residue at position 29 is replaced with Pro or Gly.

In other embodiments, the variant V_{H} that unfolds reversibly contains at least one amino acid replacement from position 22 to position 36 relative to the parental V_{H} amino acid sequence, such that the hydrophobicity of the amino acid sequence from position 22 to position 36 of the variant V_{H} is reduced relative to the parental V_{H}. Hydrophobicity can be determined using any suitable scale or algorithm. Preferably, hydrophobicity is determined using the method of Sweet and Eisenberg, and the Sweet and Eisenberg hydrophobicity score (S/E score) of the amino acid sequence from position 22 to position 36 of the variant V_{H} is reduced relative to the parental V_{H}. The S/E method can use a 9 to 18 amino acid window (e.g., a window of 9, 10, 11, 12, 13, 14, 15, 16, 17 or 18 amino acids). Preferably, a 15 amino acid window is used for V_{H}.

In certain embodiments the S/E score of the amino acid sequence from position 22 to position 36 of the variant V_{H} is 0.15 or less, or 0.1 or less for an S/E score rounded to one decimal place, or 0.09 or less, or 0.08 or less, or 0.07 or less, or 0.06 or less, or 0.05 or less, or 0.04 or less. In preferred embodiments, the S/E score or the ammo acid sequence from position 22 to position 36 of the variant V_{H} is 0.03 or less, 0.02 or less or 0.01 or less. In more preferred embodiments, the S/B score or the amino acid sequence from position 22 to position 36 of the variant V_{H} is 0 or less.

Producing V_{H} variants that have a reduced S/E score from position 22 to position 36 relative to a parental V_{H} can yield polypeptides that have several advantages. For example, it has been determined that a lower S/E score from position 22 to position 36 correlates with resistance to aggregation and enhanced yields from expression systems (e.g., bacterial expression systems). The capacity of V_{H} domains to resist aggregation at high protein concentrations is associated with a low S/E score. Thus, a variant V_{H} domain with an S/E score from position 22 to position 36 that is lower than the S/E score of the parental V_{H} domain can display enhanced resistance to aggregation, while lowering the S/B score of this region to 0 or less can produce variant V_{H} domains with superior aggregation resistance at high protein concentrations (e.g., about 200 μM.

In other embodiments, the V_{H} that unfolds reversibly contains an amino acid sequence from position 22 to position 36 that has an S/E score of 0.15 or less, or 0.1 or less, or 0.09 or less, or 0.08 or less, or 0.07 or less, or 0.06 or less, or 0.05 or less, or 0.04 or less. In preferred embodiments, the V_{H} that unfolds reversibly contains an amino acid sequence from position 22 to position 36 that has an S/E score of 0.03 or less, 0.02 or less or 0.01 or less. In more preferred embodiments, the V_{H} that unfolds reversibly contains an amino acid sequence from position 22 to position 36 that has an S/E score of 0 or less.

In another embodiment, the amino acid sequence of the variant V_{H} differs from the amino acid sequence of the parental V_{H} by at least one amino acid in the H1 loop. Preferably, the variant V_{H} contains at least one amino acid replacement in the H1 loop, such that the hydrophobicity of H1 loop is reduced relative to the H1 loop of the parental V_{H}. Preferably, the S/E score of the H1 loop of the variant V_{H} is 0 or less.

In other embodiments, the V_{H} that unfolds reversibly contains an H1 loop that has an S/E score of 0 or less.

In particular embodiments, the V_{H} that unfolds reversibly (e.g., variant V_{H}) comprises an amino acid sequence in which one or more of the parental amino acid residues at position 27, 29, 30, 31, 32, 33 and 35 (Kabat numbering) is replaced with another amino acid residue as set forth in Table 1.

TABLE 1

| Position | |
|---|---|
| (Kabat numbering) | Amino Acid |
| 27 | Asp, Glu, His, Ala, Gln, Ser or Gly |
| 29 | Asp, Glu, Val, Ser, Pro, Gln or Gly |
| 30 | Asp, Pro, Gly, Thr, Leu, Gln or Val |
| 31 | Asp, Glu or Pro |
| 32 | Asp, Gln, Glu, Pro or Gly |
| 33 | Asp, Gly or Pro |
| 35 | Asp, Asn or Gly |

The amino acid sequence of the V_{H} that unfolds reversibly (e.g., variant V_{H}) can comprise any one or any combination of amino acid replacements set forth in Table 1, and if desired, a variant V_{H} that unfolds reversibly can further differ from the parental V_{H} by replacement of one or more of the amino acid residues at parental position 22 through parental position 26, parental position 28 and parental position 36 (Kabat numbering).

In more particular embodiments, the variant V_{H} that unfolds reversibly comprises an amino acid sequence in which the parental amino acid residue at position 27 is replaced with Asp or Glu; the parental amino acid residue at position 29 is replaced with Asp, Glu, Pro or Gly; and/or the parental amino acid residue at position 32 is replaced with Asp or Glu (Kabat numbering). In one such embodiment, the variant V_{H} that unfolds reversibly comprises an amino acid sequence in which the parental amino acid residue at position 27 is replaced with Asp; the parental amino acid residue at position 29 is replaced with Asp, Pro or Gly; and/or the parental amino acid residue at position 32 is replaced with Glu (Kabat numbering).

In a specific embodiment, the variant V_{H} that unfolds reversibly comprises an amino acid sequence in which the parental amino acid residue at position 27 is replaced with Asp; the parental amino acid residue at position 29 is replaced with Val; and/or the parental amino acid residue at position 32 is replaced with Asp or Glu; and the parental residue at position 35 is replaced with Gly (Kabat numbering).

In preferred embodiments, the variant V_{H} that unfolds reversibly comprises an amino acid sequence in which the parental amino acid residue at position 27 is replaced with Asp and/or the parental amino acid residue at position 32 is replaced with Asp (Kabat numbering). If desired, the variant V_{H} that unfolds reversibly can further comprise amino acid replacements relative to the parental sequence at one or more of positions 22-26, 28-31 and 33-36 as described herein (Kabat numbering),e.g., to bring the S/E score of one or more of these regions to zero or less.

One or more of the framework regions (FR) of the V_{H} or variant V_{H} that unfold reversibly can comprise (a) the amino acid sequence of a human framework region, (b) at least 8 contiguous amino acids of the amino acid sequence of a human framework region, or (c) an amino acid sequence encoded by a human germline antibody gene segment, wherein said framework regions are as defined by Kabat. In certain embodiments, the amino acid sequence of one or more of the framework regions is the same as the amino acid sequence of a corresponding framework region encoded by a human germline antibody gene segment, or the amino acid sequences of one or more of said framework regions collectively comprise up to 5 amino acid differences relative to the amino acid sequence of said corresponding framework region encoded by a human germline antibody gene segment.

In other embodiments, the amino acid sequences of FR1, FR2, FR3 and FR4 are the same as the amino acid sequences of corresponding framework legions encoded by a human germline antibody gene segment, or the amino acid sequences of FR1, FR2, FR3 and FR4 collectively contain up to 10 amino acid differences relative to the amino acid sequences of corresponding framework regions encoded by said human germline antibody gene segments. In other embodiments, the amino acid sequence of said FR1, FR2 and FR3 are the same as the amino acid sequences of corresponding framework regions encoded by said human germline antibody gene segment. For example, the variant V_{L} can be a variant of human DP47 dummy (SEQ ID NO:3).

The isolated polypeptide comprising a V_{H} that unfolds reversibly (e.g., variant V_{H}) comprises a target ligand binding site and/or a generic ligand binding site. In certain embodiments, the generic ligand binding site is a binding site for a superantigen, such as protein A, protein L or protein G.

The V_{H} that unfolds reversibly can be based on any desired parental V_{H}, for example a human V_{H} (e.g., V_{H} 1a, V_{H} 1b, V_{H} 2, V_{H} 3, V_{H} 4, V_{H} 5, V_{H} 6). Preferably, the V_{H} that unfolds reversibly is not a Camelid immunoglobulin domain, such as a V_{H}H, or does not contain one or more amino acids (e.g., framework amino acids) that are unique to Camelid immunoglobulin variable domains encoded by germline sequences but not, for example, to human immunoglobulin variable domains. (See, e.g., Davies et al., Protein Engineering 9:531-537 (1996); Tanha et al., J. Biol. Chem. 276:24774-24780 (2001); Riechmann et al., J. Immunol. Methods 23:25-38 (1999).) In one embodiment the V_{H} that unfolds reversibly does not comprise one or more amino acids that are unique to murine (e.g., mouse) germline framework regions. Preferably, the V_{H} unfolds reversibly when heated and cooled.

The isolated polypeptide comprising a V_{H} that unfolds reversibly (e.g. variant V_{H}) can be an antibody format. Thus, in certain embodiments, the isolated polypeptide comprising a V_{H} that unfolds reversibly can be a homodimer of V_{H}, a heterodimer comprising a V_{H}, an Fv, a scFv, a disulfide bonded Fv, a Fab, a V_{H} or a V_{H} fused to an immunoglobulin Fc portion.

The invention also relates to an isolated polypeptide comprising an immunoglobulin light chain variable domain (V_{L}) (e.g., a variant V_{L}) that unfolds reversibly. In one embodiment, the isolated polypeptide comprises a V_{L} that unfolds reversibly and comprises an amino acid sequence from position 44 to position 53 that has a Sweet/Eisenberg hydrophobicity score (S/E score) of less than 0.23. In other embodiments, the S/E score for position 44 to position 53 can be less than 0.2, less than 0.17, less than 0.15, less than 0.13, less than 0.10, or less than −0.1 or less. The S/E method can use a 9 to 18 amino acid window (e.g., a window of 9, 10, 11, 12, 13, 14, 15, 16, 17 or 18 amino acids). Preferably, an 11 amino acid window is used for V_{L}. The amino acid positions and CDR (L1, L2 and L3) and framework regions (FR1, FR2, FR3 and FR4) of the V_{L} can be defined using any suitable system, such as the systems of Kabat, Chothia or AbM. Preferably, the amino acid positions and CDR and framework regions are according to the amino acid numbering system of Kabat. In other embodiments, V_{L} that unfolds reversibly further comprises a FR3 that has a Sweet/Eisenberg hydrophobicity score (S/E score) of less than 0.35, and FR3 is as defined by the Kabat amino acid numbering system. In other embodiments, the S/E score for FR3 can be less than 0.3, less than 0.25, less than 0.2, less than 0.17, less than 0.15, less than 0.13, less than 0.10, or less than −0.1 or less.

In certain embodiments, the isolated polypeptide comprises a variant V_{L} that unfolds reversibly. In some embodiments, the amino acid sequence of the valiant V_{L} that unfolds reversibly differs from the amino acid sequence of the parental V_{L} by at least one amino acid from position 44 to position 53 of said variant V_{L}, such that the variant V_{L} comprises the amino acid sequence of a parental V_{L} wherein at least one amino acid residue from position 44 to position 53 is replaced such that the Sweet/Eisenberg hydrophobicity score (S/E score) of the amino acid sequence from position 44 to position 53 of said variant V_{L} is less than 0.23. The amino acid sequence of the variant V_{L} that unfolds reversibly can contain at least one amino acid replacement from position 44 to position 53 relative to the parental V_{L}. In other embodiments, the amino acid sequence of the variant V_{L} that unfolds reversibly further differs from the amino acid sequence of the parental V_{L} by at least one amino acid in FR3 of said variant V_{L}. In these embodiments, the variant V_{L} that unfolds reversibly comprises FR3 having the amino acid sequence of a parental V_{L} FR3 wherein at least one amino acid residue is replaced such that the Sweet/Eisenberg hydrophobicity score (S/E score) of FR3 said variant V_{L} is less than 0.35.

In other embodiments, the amino acid sequence of the variant V_{L} that unfolds reversibly differs from the amino acid sequence of the parental V_{L} by at least one amino acid in M of said variant V_{L}, such that the variant V_{L} comprises the amino acid sequence of a parental V_{L} wherein at least one amino acid residue in FR3 is replaced such that the Sweet/Eisenberg hydrophobicity score (S/E score) of the amino acid sequence of FR3 of said variant V_{L} is less than 0.35. For example, the amino acid sequence of the variant V_{L} that unfolds reversibly can differ from the amino acid sequence of the parental V_{L} by at least one amino acid from position 73 to position 76 of said variant V_{L}, such that the variant V_{L} comprises the amino acid sequence of a parental V_{L} wherein at least one amino acid residue from position 73 to position 76 is replaced such that the Sweet/Eisenberg hydrophobicity score (S/E score) of the amino acid sequence of FR3 of said variant V_{L} is less than 0.35.

In particular embodiments, the V_{L} that unfolds reversibly comprises an amino acid sequence in which one or more of the amino acid residues at position 10, 13, 20, 23, 26, 27, 29, 31, 32, 35, 36, 39, 40, 42, 45, 46, 47, 48, 49, 50, 57, 59, 60, 68, 75, 79, 80, 83, 89, 90 and 92 (Kabat numbering) is replaced with another amino acid residue as set forth in Table 2. For example, when the isolated V_{L} that unfolds reversibly is a variant V_{L}, it can comprise a amino acid sequence in which one or more of the parental amino acid residues at position 10, 13, 20, 23, 26, 27, 29, 31, 32, 35, 36, 39, 40, 42, 45, 46, 47, 48, 49, 50, 57, 59, 60, 68, 75, 79, 80, 83, 89, 90 and 92 (Kabat numbering) is replaced with another amino acid residue as set forth in Table 2.

TABLE 2

| Position | |
|---|---|
| (Kabat | |
| numbering) | Amino Acid |
| 10 | Phe |
| 13 | Gly |
| 20 | Ala or Ser |
| 23 | Trp |
| 26 | Asn |
| 27 | Arg |
| 29 | Val |
| 31 | Gly |
| 32 | Ser or Phe |
| 35 | Gly |
| 36 | His |
| 39 | Arg |
| 40 | Ser |
| 42 | Thr, Asn or Glu |
| 45 | Glu, Asp, Gln, Pro, |
| | Asn, His or Thr |
| 46 | Asn, Phe, His or Pro |
| 47 | Pro |
| 48 | Asn, Pro, Asp, Thr, Gly or Val |
| 49 | Asn, Asp, Ser, Cys, Glu, Gly, Lys or |
| | Arg |
| 50 | Pro, Asp, Asn, Glu or Arg |
| 57 | Glu |
| 60 | Pro |
| 68 | Glu |
| 69 | Glu |
| 75 | Asn or Met |
| 79 | Arg |
| 80 | Ala |
| 83 | Ala or Leu |
| 89 | Arg |
| 90 | Gln or Pro |
| 92 | His |

The amino acid sequence of the V_{L} or variant V_{L} that unfolds reversibly can comprise any one or any combination of amino acid replacements set forth in Table 2, and if desired can further differ from the parental V_{L} by replacement of the amino acid residue at parental position 26 with Asn and/or replacement of the amino acid residue at parental position 89 with Arg (Kabat numbering).

In more particular embodiments, the variant V_{L} that unfolds reversibly comprises an amino acid sequence in which the parental amino acid residue at position 45 is replaced with Glu, Asp, Gln, Pro, Asn, His or Thr, the parental amino acid residue at position 48 is replaced with Asn, Pro, Asp, Thr, Gly or Val; the parental amino acid residue at position 49 is replaced with Asn, Asp, Ser, Cys, Glu, Gly, Lys or Arg; the parental amino acid residue at position 50 is replaced with Pro, Asp, Asn, Glu or Arg; and/or the parental amino acid residue at position 75 is replaced with Asn or Met. (Kabat numbering).

In other particular embodiments, the V_{L} or variant V_{L} that unfolds reversibly comprises an amino acid sequence which contain one of the amino acid replacements set forth in Table 2 and has an amino acid sequences that comprises:

Gly at position 31 and Asn at position 49;

Ser at position 32 and Asn at position 75;

Ser at position 40 and Asp at position 49;

Arg at position 39 and Asn at position 49;

Glu at position 45 and Asn at position 75;

Pro at position 46 and Asp at position 50;

Asn at position 26, Thr at position 42 and Asp at position 50;

Phe at position 32, Glu at position 45 and Glu at position 57;

Asp at position 49, Ala at position 80 and Arg at position 89;

Asn at position 49, Glu at position 68 and Arg at position 79;

Ser at position 20, Trp at position 23, Phe at position 46 and Asn at position 49;

Val at position 29, Asn at position 42, Glu at position 45, Leu at position 83 and His at position 92;

Thr at position 35 and Pro at position 90;

Asp at position 45 and Pro at position 60;

Arg at position 49 and Phe at position 10;

Ser at position 49 and Ala at position 20;

Ser at position 49 and Arg at position 27;

Pro at position 50 and Val at position 48; and

Arg at position 50, Gly at position 13 and Glu at position 42, wherein amino acid positions are by Kabat numbering.

In certain embodiments, the amino acid sequence of the variant V_{L} that unfolds reversibly contains at least one Pro or Gly replacement from position 44 to position 53 and/or in FR3 (e.g., from position 73 to position 76) relative to the amino acid sequence of the parental V_{L}. In a particular embodiment, the amino acid sequence of the variant V_{L}, comprises Pro at position 45, position 48 and/or position 50.

One or more of the framework regions (FR) of the V_{L} or variant V_{L} that unfolds reversibly can comprise (a) the amino acid sequence of a human framework region, (b) at least 8 contiguous amino acids of the amino acid sequence of a human framework region, or (c) an amino acid sequence encoded by a human germline antibody gene segment, wherein said framework regions are as defined by Kabat. In certain embodiments, the amino acid sequence of one or more of the framework regions is the same as the amino acid sequence of a corresponding framework region encoded by a human germline antibody gene segment, or the amino acid sequences of one or more of said framework regions collectively comprise up to 5 amino acid differences relative to the amino acid sequence of said corresponding framework region encoded by a human germline antibody gene segment.

In other embodiments, the amino acid sequences of FR1, FM, FR3 and FR4 are the same as the amino acid sequences of corresponding framework regions encoded by a human germline antibody gene segment, or the amino acid sequences of FR1, FR2, FR3 and FR4 collectively contain up to 10 amino acid differences relative to the amino acid sequences of corresponding framework regions encoded by said human germline antibody gene segments. In other embodiments, the amino acid sequence of said FR1, FR2 and FR3 are the same as the amino acid sequences of corresponding framework regions encoded by said human germline antibody gene segment. For example, the variant V_{L} can a variant of human DPK9 dummy (SEQ ID NO:6).

The isolated polypeptide comprising a V_{L} that unfolds reversibly (e.g., variant V_{L}) comprises a target ligand binding site and/or a generic ligand binding site. In certain embodiments, the generic ligand binding site is a binding site for a superantigen, such as protein A, protein L or protein G.

The V_{L} that unfolds reversibly can be based on any desired parental V_{L}, for example a human Vλ(e.g., VλI, VλII, VλIII, VλIV, VλV or VλVI) or a human Vκ (e.g., Vκ1, Vκ2, Vκ3, Vκ4, Vκ5, Vκ6, Vκ7, Vκ8, Vκ9 or Vκ10). Preferably, the V_{L} that unfolds reversibly is not a Camelid immunoglobulin domain, or contain one or more amino acids (e.g., framework amino acids) that are unique to Camelid immunoglobulin variable domains encoded by germline sequences but not, for example, to human immunoglobulin variable domains. (See, e.g., Davies et al., Protein Engineering 9:531-537 (1996); Tanha et al., J. Biol. Chem. 276:24774-24780 (2001); Riechmann et al., J. Immunol. Methods 23:25-38 (1999).) In one embodiment, the V_{H} that unfolds reversibly does not comprise one or more amino acids that are unique to murine (e.g., mouse) germline framework regions. Preferably, the V_{L} unfolds reversibly when heated.

The isolated polypeptide comprising a V_{L} that unfolds reversibly (e.g., variant V_{L}) can be an antibody format. Thus, in certain embodiments, the isolated polypeptide comprising a V_{L} that unfolds reversibly can be a homodimer of V_{L}, a heterodimer comprising a V_{L}, an Fv, a scFv, a disulfide bonded Fv, a Fab, a V_{L} or a V_{L} fused to an immunoglobulin Fc portion.

### Isolated Polypeptides Comprising Disulfide Bonded V Domains

The invention also relates to an isolated polypeptide comprising an immunoglobulin variable domain (e.g., V_{H}, V_{L}), wherein said variable domain comprises a disulfide bond between a cysteine in CDR2 and a cysteine in CDR3, wherein CDR2 and CDR3 are defined using the Kabat amino acid numbering system. In some embodiments, the disulfide bond is between cysteine residues at position 52a and position 98; position 51 and position 98; or position 51 and position 100b, wherein said positions are defined using the Kabat amino acid numbering system. In other embodiments, the disulfide bond is between a cysteine at position 51 and a cysteine in CDR3; or a cysteine in CDR2 and a cysteine at position 98, wherein CDR2, CDR3 and said positions are defined using the Kabat amino acid numbering system.

The isolated polypeptide comprising a disulfide bonded variable domain can be an antibody format. Thus, in certain embodiments, the isolated polypeptide comprising a disulfide bonded variable domain can be a homodimer of variable domains, a heterodimer of variable domains, an Fv, a scFv, a Fab, a single variable domain or a single variable domain fused to an immunoglobulin Fc portion.

### Nucleic Acids, Host Cells and Methods for Producing Refoldable Polypeptides

The invention also relates to isolated and/or recombinant nucleic acids encoding polypeptides that unfold reversibly as described herein.

Nucleic acids referred to herein as “isolated” are nucleic acids which have been separated away from other material (e.g., other nucleic acids such as genomic DNA, cDNA and/or RNA) in its original environment (e.g., in cells or in a mixture of nucleic acids such as a library). An isolated nucleic acid can be isolated as part of a vector (e.g., a plasmid). Nucleic acids can be naturally occurring, produced by chemical synthesis, by combinations of biological and chemical methods (e.g., semisynthetic), and be isolated using any suitable methods.

Nucleic acids referred to herein as “recombinant” are nucleic acids which have been produced by recombinant DNA methodology, including methods which rely upon artificial recombination, such as cloning into a vector or chromosome using, for example, restriction enzymes, homologous recombination, viruses and the like, and nucleic acids prepared using the polymerase chain reaction (PCR). “Recombinant” nucleic acids ate also those that result from recombination of endogenous or exogenous nucleic acids through the natural mechanisms of cells or cells modified to allow recombination (e.g. cells modified to express Cre or other suitable recombinase), but are selected for after the introduction to the cells of nucleic acids designed to allow and make recombination probable. For example, a functionally rearranged human-antibody transgene is a recombinant nucleic acid.

Nucleic acid molecules of the present invention can be used in the production of antibodies (e.g., human antibodies, humanized antibodies, chimeric antibodies and antigen-binding fragments of the foregoing), e.g., antibodies that bind an αE integrin or integrin αE chain (CD103). For example, a nucleic acid (e.g., DNA) encoding an antibody of the invention can be incorporated into a suitable construct (e.g., an expression vector) for further manipulation or for production of the encoded polypeptide in suitable host cells.

Expression constructs or expression vectors suitable for the expression of a antibody or antigen-binding fragment are also provided. For example, a nucleic acid encoding all or part of a desired antibody can be inserted into a nucleic acid vector, such as a plasmid or virus, for expression. The vector can be capable of replication in a suitable biological system (e.g., a replicon). A variety of suitable vectors are known in the art, including vectors which are maintained in single copy or multiple copy, or which become integrated into the host cell chromosome. Suitable expression vectors can contain a number of components, for example, an origin of replication, a selectable marker gene, one or more expression control elements, such as a transcription control element (e.g., promoter, enhancer, terminator) and/or one or more translation signals, a signal sequence or leader sequence, and the like. Expression control elements and a signal or leader sequence, if present, can be provided by the vector or other source. For example, the transcriptional and/or translational control sequences of a cloned nucleic acid encoding an antibody chain can be used to direct expression.

In another aspect, the invention relates to recombinant host cells and a method of preparing an polypeptide of the invention that unfolds reversibly. The polypeptide that unfolds reversibly can be obtained, for example, by the expression of one or more recombinant nucleic acids encoding a polypeptide that unfolds reversibly or using other suitable methods. For example, the expression constructs described herein can be introduced into a suitable host cell, and the resulting cell can be maintained (e.g., in culture, in an animal, in a plant) under conditions suitable for expression of the constructs. Suitable host cells can be prokaryotic, including bacterial cells such as E. coli, B. subtilis and/or other suitable bacteria; eucaryotic cells, such as fungal or yeast cells (e.g., Pichia pastoris, Aspergillus sp., Saccharomyces cerevisiae, Schizosaccharomyces pombe, Neurospora crassa), or other lower eukaryotic cells, and cells of higher eucaryotes such as those from insects (e.g., Drosophila Schnieder S2 cells, Sf9 insect cells (WO 94/26087 (O'Connor)), mammals (e.g., COS cells, such as COS-1 (ATCC Accession No. CRL-1650) and COS-7 (ATCC Accession No. CRL-1651), CHO (e.g., ATCC Accession No. CRL-9096), 293 (ATCC Accession No. CRL-1573), HeLa (ATCC Accession No. CCL-2), CV1 (ATCC Accession No. CCL-70), WOP (Dailey, L, et al., J. Virol., 54:739-749 (1985), 3T3, 293T (Pear, W. S., et al., Proc. Natl. Acad. Sci. U.S.A., 90:8392-8396 (1993)) NSO cells, SP2/0, HuT 78 cells and the like, or plants (e.g., tobacco). (See, for example, Ausubel, F. M. et al., eds, Current Protocols in Molecular Biology, Greene Publishing Associates and John Wiley & Sons Inc. (1993).)

The invention also relates to a recombinant host cell which comprises a (one or more) recombinant nucleic acid or expression construct comprising a nucleic acid encoding a polypeptide that unfolds reversibly. The invention also includes a method of preparing an polypeptide that unfolds reversibly, comprising maintaining a recombinant host cell of the invention under conditions appropriate for expression of a polypeptide that unfolds reversibly. The method can further comprise the step of isolating or recovering the polypeptide that unfolds reversibly, if desired.

For example, a nucleic acid molecule (i.e., one or more nucleic acid molecules) encoding a polypeptide that unfolds reversibly, or an expression construct (i.e., one or more constructs) comprising such nucleic acid molecule(s), can be introduced into a suitable host cell to create a recombinant host cell using any method appropriate to the host cell selected (e.g., transformation, transfection, electroporation, infection), such that the nucleic acid molecule(s) are operably linked to one or more expression control elements (e.g., in a vector, in a construct created by processes in the cell, integrated into the host cell genome). The resulting recombinant host cell can be maintained under conditions suitable for expression (e.g., in the presence of an inducer, in a suitable animal, in suitable culture media supplemented with appropriate salts, growth factors, antibiotics, nutritional supplements, etc.), whereby the encoded polypeptide(s) are produced. If desired, the encoded protein can be isolated or recovered (e.g., from the animal, the host cell, medium, milk). This process encompasses expression in a host cell of a transgenic animal (see, e.g., WO 92/03918, GenPharm International).

The polypeptides that unfolds reversibly described herein can also be produced in a suitable in vitro expression system, by chemical synthesis or by any other suitable method.

In certain embodiments, the invention does not include a polypeptide having a variable domain comprising a sequence encoded by a germline V_{H} or germline V_{L} gene segment, or consisting of or comprising SEQ ID NOS:7-60.

| | |
|---|---|
| ASP ILE GLN MET THR GLN SER PRO SER SER LEU SER ALA | SEQ ID NO: 7 |
| SER VAL GLY ASP ARG VAL THR ILE THR CYS GLN ALA SER | |
| GLN ASP ILE SER ASN TYR LEU ALA TRP TYR GLN GLN LYS | |
| PRO GLY LYS ALA PRO GLU LEU ARG ILE TYR ASP ALA SER | |
| ASN LEU GLU THR GLY VAL PRO SER ARG PHE SER GLY SER | |
| GLY SER GLY THR ASP PHE THR PHE THR ILE SER SER LEU | |
| GLN PRO GLU ASP ILE ALA THR TYR TYR CYS GLN GLN TYR | |
| GLN ASN LEU PRO LEU THR PHE GLY PRO GLY THR LYS VAL | |
| ASP ILE LYS ARG THR VAL ALA ALA PRO SER VAL | |
| GLN ILE VAL LEU THR GLN SER PRO ALA ILE MET SER ALA | SEQ ID NO: 8 |
| SER PRO GLY GLU LYS VAL THR MET THR CYS SER ALA SER | |
| SER SER VAL TYR TYR MET TYR TRP TYR GLN GLN LYS PRO | |
| GLY SER SER PRO ARG LEU LEU ILE TYR ASP THR SER ASN | |
| LEU ALA SER GLY VAL PRO VAL ARG PHE SER GLY SER GLY | |
| SER GLY THR SER TYR SER LEU THR ILE SER ARG MET GLU | |
| ALA GLU ASP ALA ALA THR TYR TYR CYS GLN GLN TRP SER | |
| SER TYR PRO PRO ILE THR PHE GLY VAL GLY THR LYS LEU | |
| GLU LEU LYS ARG ALA ASP ALA ALA PRO THR VAL SER ILE | |
| PHE PRO PRO SER SER GLU GLN LEU THR SER GLY GLY ALA | |
| SER VAL VAL CYS PHE LEU ASN ASN PHE TYR PRO LYS ASP | |
| ILE ASN VAL LYS TRP LYS ILE ASP GLY SER GLU ARG GLN | |
| ASN GLY VAL LEU ASN SER TRP THR ASP GLN ASP SER LYS | |
| ASP SER THR TYR SER MET SER SER THR LEU THR LEU THR | |
| LYS ASP GLU TYR GLU ARG HIS ASN SER TYR THR CYS GLU | |
| ALA THR HIS LYS THR SER THR SER PRO ILE VAL LYS SER | |
| PHE ASN ARG ASN GLU CYS | |
| ASP ILE VAL LEU THR GLN SER PRO ALA ILE MET SER ALA | SEQ ID NO: 9 |
| SER PRO GLY GLU LYS VAL THR MET THR CYS SER ALA SER | |
| SER SER VAL ASN TYR MET TYR TRP TYR GLN GLN LYS SER | |
| GLY THR SER PRO LYS ARG TRP ILE TYR ASP THR SER LYS | |
| LEU ALA SER GLY VAL PRO VAL ARG PHE SER GLY SER GLY | |
| SER GLY THR SER TYR SER LEU THR ILE SER SER MET GLU | |
| THR GLU ASP ALA ALA THR TYR TYR CYS GLN GLN TRP GLY | |
| ARG ASN PRO THR PHE GLY GLY GLY THR LYS LEU GLU ILE | |
| LYS ARG ALA ASP ALA ALA PRO THR VAL SER ILE PHE PRO | |
| PRO SER SER GLU GLN LEU THR SER GLY GLY ALA SER VAL | |
| VAL CYS PHE LEU ASN ASN PHE TYR PRO LYS ASP ILE ASN | |
| VAL LYS TRP LYS ILE ASP GLY SER GLU ARG GLN ASN GLY | |
| VAL LEU ASN SER TRP THR ASP GLN ASP SER LYS ASP SER | |
| THR TYR SER MET SER SER THR LEU THR LEU THR LYS ASP | |
| GLU TYR GLU ARG HIS ASN SER TYR THR CYS GLU ALA THR | |
| HIS LYS THR SER THR SER PRO ILE VAL LYS SER PHE ASN | |
| ARG ASN GLU CYS | |
| GLN ILE VAL LEU THR GLN SER PRO ALA ILE MET SER ALA | SEQ ID NO: 10 |
| SER PRO GLY GLU LYS VAL THR MET THR CYS SER ALA SER | |
| SER SER VAL SER TYR MET HIS TRP TYR GLN GLN LYS SER | |
| GLY THR SER PRO LYS ARG TRP ILE TYR ASP THR SER LYS | |
| LEU ALA SER GLY VAL PRO ALA ARG PHE SER GLY SER GLY | |
| SER GLY THR SER TYR SER LEU THR ILE SER SER MET GLU | |
| ALA GLU ASP ALA ALA THR TYR TYR CYS GLN GLN TRP SER | |
| SER ASN PRO TYR THR PHE GLY GLY GLY THR LYS LEU GLU | |
| ILE LYS | |
| GLN ILE VAL LEU THR GLN SER PRO ALA ILE MET SER ALA | SEQ ID NO: 11 |
| SER PRO GLY GLU LYS VAL THR MET THR CYS SER ALA SER | |
| SER SER VAL SER TYR MET HIS TRP TYR GLN GLN LYS SER | |
| GLY THR SER PRO LYS ARG TRP ILE TYR ASP THR SER LYS | |
| LEU ALA SER GLY VAL PRO ALA ARG PHE SER GLY SER GLY | |
| SER GLY THR SER TYR SER LEU THR ILE SER SER MET GLU | |
| ALA GLU ASP ALA ALA THR TYR TYR CYS GLN GLN TRP SER | |
| SER ASN PRO TYR THR PHE GLY GLY GLY THR LYS LEU GLU | |
| ILE LYS | |
| GLU ILE GLN LEU THR GLN SER PRO SER SER LEU SER ALA | SEQ ID NO: 12 |
| SER LEU GLY GLU ARG VAL SER LEU THR CYS ARG THR SER | |
| GLN GLU ILE SER GLY TYR LEU SER TRP LEU GLN GLN LYS | |
| PRO ASP GLY THR ILE LYS ARG LEU ILE TYR ASP ALA THR | |
| LYS LEU ASP SER GLY ALA PRO LYS ARG PHE SER GLY SER | |
| ARG SER GLY SER ASP TYR SER LEU THR ILE SER SER LEU | |
| GLU SER GLU ASP PHE ALA ASP TYR TYR CYS LEU GLN TYR | |
| ALA SER PHE PRO ARG THR PHE GLY GLY GLY THR LYS LEU | |
| GLU ILE LYS ARG THR VAL ALA ALA PRO SER VAL PHE ILE | |
| PHE PRO PRO SER ASP GLU GLN LEU LYS SER GLY THR ALA | |
| SER VAL VAL CYS LEU LEU ASN ASN PHE TYR PRO ARG GLU | |
| ALA LYS VAL GLN TRP LYS VAL ASP ASN ALA LEU GLN SER | |
| GLY ASN SER GLN GLU SER VAL THR GLU GLN ASP SER LYS | |
| ASP SER THR TYR SER LEU SER SER THR LEU THR LEU SER | |
| LYS ALA ASP TYR GLU LYS HIS LYS VAL TYR ALA CYS GLU | |
| VAL THR HIS GLN GLY LEU SER SER PRO VAL THR LYS SER | |
| PHE ASN ARG GLY GLU CYS | |
| ASP ILE GLN MET THR GLN SER PRO SER SER LEU SER ALA | SEQ ID NO: 13 |
| SER VAL GLY ASP ARG VAL THR ILE THR CYS GLN ALA SER | |
| GLN ASP ILE SER ASP TYR LEU ILE TRP TYR GLN GLN LYS | |
| LEU GLY LYS ALA PRO ASN LEU LEU ILE TYR ASP ALA SER | |
| THR LEU GLU THR GLY VAL PRO SER ARG PHE SER GLY SER | |
| GLY SER GLY THR GLU TYR THR PHE THR ILE SER SER LEU | |
| GLN PRO GLU ASP ILE ALA THR TYR TYR CYS GLN GLN TYR | |
| ASP ASP LEU PRO TYR THR PHE GLY GLN GLY THR LYS VAL | |
| GLU ILE LYS ARG | |
| ASP ILE GLN MET THR GLN SER PRO SER SER LEU SER ALA | SEQ ID NO: 14 |
| SER VAL GLY ASP ARG VAL THR ILE THR CYS GLN ALA SER | |
| GLN ASP ILE SER ASP TYR LEU ILE TRP TYR GLN GLN LYS | |
| LEU GLY LYS ALA PRO ASN LEU LEU ILE TYR ASP ALA SER | |
| THR LEU GLU THR GLY VAL PRO SER ARG PHE SER GLY SER | |
| GLY SER GLY THR GLU TYR THR PHE THR ILE SER SER LEU | |
| GLN PRO GLU ASP ILE ALA THR TYR TYR CYS GLN GLN TYR | |
| ASP ASP LEU PRO TYR THR PHE GLY GLN GLY THR LYS VAL | |
| GLU ILE LYS ARG | |
| ASP ILE GLN MET THR GLN SER PRO SER SER LEU SER ALA | SEQ ID NO: 15 |
| SER VAL GLY ASP ARG VAL THR ILE THR CYS GLN ALA SER | |
| GLN ASP ILE SER ASP TYR LEU ILE TRP TYR GLN GLN LYS | |
| LEU GLY LYS ALA PRO ASN LEU LEU ILE TYR ASP ALA SER | |
| THR LEU GLU THR GLY VAL PRO SER ARG PHE SER GLY SER | |
| GLY SER GLY THR GLU TYR THR PHE THR ILE SER SER LEU | |
| GLN PRO GLU ASP ILE ALA THR TYR TYR CYS GLN GLN TYR | |
| ASP ASP LEU PRO TYR THR PHE GLY GLN GLY THR LYS VAL | |
| GLU ILE LYS ARG | |
| ASP ILE GLN MET THR GLN SER PRO SER SER LEU SER ALA | SEQ ID NO: 16 |
| SER VAL GLY ASP ARG VAL THR ILE THR CYS GLN ALA SER | |
| GLN ASP ILE SER ASP TYR LEU ILE TRP TYR GLN GLN LYS | |
| LEU GLY LYS ALA PRO ASN LEU LEU ILE TYR ASP ALA SER | |
| THR LEU GLU THR GLY VAL PRO SER ARG PHE SER GLY SER | |
| GLY SER GLY THR GLU TYR THR PHE THR ILE SER SER LEU | |
| GLN PRO GLU ASP ILE ALA THR TYR TYR CYS GLN GLN TYR | |
| ASP ASP LEU PRO TYR THR PHE GLY GLN GLY THR LYS VAL | |
| DIQMTQSPSTLSASVGDRVTITCRASQSISSWLAWYQQKPGKAPKLLIYDAS | SEQ ID NO: 17 |
| SLESGVPSRFSGSGSGTEFTLTISSLQPDDFATYYCQQYNSYS | |
| DIVLTQAPPSLDVSQGRATISCRTSKSVRTSSYSYMHWYQQKPGQPPKLLNL | SEQ ID NO: 18 |
| CASNQVSRVPARFSGSGSGTDFTLKIHPVEEEDAATYFCQQSNENP | |
| VIWMTQSPSLLSASTGDRVTISCRMSQGISSYLAWYQQKPGKAPELLIYAAS | SEQ ID NO: 19 |
| TLQSGVPSRFSGSGSGTDFTLTISCLQSEDFATYYCQQYYSFP | |
| AIQLTQSPSSLSASVGDRVTITCRASQGISSALAYQQKPGKAPKLLIYDASSLE | SEQ ID NO: 20 |
| SGVPSRFSGSGSGTDFTLTISSLQPEDFATYYCQQFNNYP | |
| AIQLTQSPSSLSASVGDRVTITCRASQGISSALAWYQQKPGKAPKLLIYDASS | SEQ ID NO: 21 |
| LESGVPSRFSGSGSGTDFTLTISSLQPEDFATYYCQQFNNYP | |
| DIQMTQSPSSLSASVGDRVTITCQASQDISNYLNWYQQKPGKAPKLLIYDAS | SEQ ID NO: 22 |
| NLETGVPSRFSGSGSGTDFTFTISSLQPEDIATYYCQQYDNLP | |
| DIQMTQSPSSLSASVGDRVTITCQASQDISNYLNWYQQKPGKAPKLLIYDAS | SEQ ID NO: 23 |
| NLETGVPSRFSGSGSGTDFTFTISSLQPEDIATYYCQQYDNLP | |
| DIQMIQSPSFLSASVGDRVSIICWASEGISSNLAWYLQKPGKSPKLFLYDAKD | SEQ ID NO: 24 |
| LHPGVSSRFSGRGSGTDFTLTIISLKPEDFAAYYCKQDFSYP | |
| EIVLTQSPATLSLSPGERATLSCRASQSVSSYLAWYQQKPGQAPRLLIYDASN | SEQ ID NO: 25 |
| RATGIPARFSGSGSGTDFTLTISSLEPEDFAVYYCQQRSNWP | |
| EIVLTQSPATLSLSPGERATLSCRASQGVSSYLAWYQQKPGQAPRLLIYDAS | SEQ ID NO: 26 |
| NRATGIPARFSGSGPGTDFTLTISSLEPEDFAVYYCQQRSNWH | |
| EIVLTQSPATLSLSPGERATLSCGASQSVSSSYLAWYQQKPGLAPRLLIYDAS | SEQ ID NO: 27 |
| SRATGIPDRFSGSGSGTDFTLTISRLEPEDFAVYYCQQYGSSP | |
| QIVLTQSPAIMSASPGEKVTMTCSASSSVSYMYWYQQKPGSSPRLLIYDTSN | SEQ ID NO: 28 |
| LASGVPVRFSGSGSGTSYSLTISRMEAEDAATYYCQQWSSYPP | |
| QIVLTQSPAIMSASPGEKVTMTCSASSSVSYMHWYQQKSGTSPKRWIYDTS | SEQ ID NO: 29 |
| KLASGVPARFSGSGSGTSYSLTISSMEAEDAATYYCQQWSSNP | |
| QIVLTQSPAIMSASPGEKVTMTCSASSSVSYMYWYQQKPGSSPRLWIYDTSN | SEQ ID NO: 30 |
| LVSGVPARFSGSRSGTSYSLTISSMEAEDAATYYCQQYSGYPS | |
| ENVLTQSPAIMSASPGEKVTMTCSASSSVSYMHWYQQKSSTSPKLWIYDTS | SEQ ID NO: 31 |
| KLASGVPGRFSGSGSGNSYSLTISSMEAEDVATYYCFQGSGYPL | |
| QILLTQSPAIMSASPGEKVTMTCSASSSVSYMHWYQQKPGSSPKPWIYDTSN | SEQ ID NO: 32 |
| LASGFPARFSGSGSGTSYSLIISSMEAEDAATYYCHQRSSYP | |
| QIVLTQSPAIMSASPGEKVTMTCSASSSISYMHWYQQKPGTSPKRWIYDTSK | SEQ ID NO: 33 |
| LASGVPARFSGSGSGTSYSLTISSMEAEDAATYYCHQRSSYP | |
| DIQMTQSPASLSASVGETVTITCQASENIASDLAWYQKQGKSPQLLVYDAR | SEQ ID NO: 34 |
| NLADGVPSRFSGSGSGTHYSLNIHSLQSEDVARYYCQHYYGTP | |
| AQVLTQTESPVSAPVGGTVTINCQASQSVYDNNYLSWYQQKPGQPPKLLIY | SEQ ID NO: 35 |
| DASKLASGVPSRFSGSGSGTQFTLTISGVQCDDAATYYCQGSYYSSGWY | |
| AQGPTQTPSSVSAAVGGTVTINCQTSESFYSNNILSWYQQKPGQPPKLLIYD | SEQ ID NO: 36 |
| ASTLASGVPSRFKGSGSGTQFTLTISDVQCDDAATYYCQGSYHSSGWY | |
| AAVLTQTPSPVSAAVGGTVTIKCQSSQSVYNNNLLSWYQQKPGQPPKLLIY | SEQ ID NO: 37 |
| DASNLASGVPDRFSGSGSGTQFTLTISGVQCDDAATYYCLGGYDDDAD | |
| AVVLTQTASPVSAAVGGTVTINCQASQSISTALAWYQQKPGQRPKLLIYDAS | SEQ ID NO: 38 |
| KLASGVPSRFKGSGSGTQFTLTISGVQCDDAATYYCQQGYSSSSAD | |
| GLU VAL LYS VAL ILE GLU SER GLY GLY GLY LEU VAL GLN | SEQ ID NO: 39 |
| PRO GLY GLY SER LEU LYS LEU SER CYS ALA ALA SER GLY | |
| PHE ASP PHE SER ARG TYR TRP MET SER TRP VAL ARG GLN | |
| ALA PRO GLY LYS GLY LEU GLU TRP ILE GLY GLU ILE ASN | |
| PRO ASP SER SER THR ILE ASN TYR THR PRO SER LEU LYS | |
| ASP LYS PHE ILE ILE SER ARG ASP ASN ALA LYS ASN THR | |
| LEU TYR LEU GLN MET SER LYS VAL ARG SER GLU ASP THR | |
| ALA LEU TYR TYR CYS ALA ARG LEU GLY GLY ASP LEU HIS | |
| TYR TYR ALA MET ASP TYR TRP GLY GLN GLY THR SER VAL | |
| THR VAL SER SER | |
| GLU VAL LYS VAL ILE GLU SER GLY GLY GLY LEU VAL GLN | SEQ ID NO: 40 |
| PRO GLY GLY SER LEU LYS LEU SER CYS ALA ALA SER GLY | |
| PHE ASP PHE SER ARG TYR TRP MET SER TRP VAL ARG GLN | |
| ALA PRO GLY LYS GLY LEU GLU TRP ILE GLY GLU ILE ASN | |
| PRO ASP SER SER THR ILE ASN TYR THR PRO SER LEU LYS | |
| ASP LYS PHE ILE ILE SER ARG ASP ASN ALA LYS ASN THR | |
| LEU TYR LEU GLN MET SER LYS VAL ARG SER GLU ASP THR | |
| ALA LEU TYR TYR CYS ALA ARG LEU GLY GLY ASP LEU HIS | |
| TYR TYR ALA MET ASP TYR TRP GLY GLN GLY THR SER VAL | |
| THR VAL SER SER | |
| GLU VAL LYS LEU LEU GLU SER GLY GLY GLY LEU VAL GLN | SEQ ID NO: 41 |
| PRO GLY GLY SER LEU LYS LEU SER CYS ALA ALA SER GLY | |
| PHE ASP PHE SER LYS TYR TRP MET SER TRP VAL ARG GLN | |
| ALA PRO GLY LYS GLY LEU GLU TRP ILE GLY GLU ILE HIS | |
| PRO ASP SER GLY THR ILE ASN TYR THR PRO SER LEU LYS | |
| ASP LYS PHE ILE ILE SER ARG ASP ASN ALA LYS ASN SER | |
| LEU TYR LEU GLN MET SER LYS VAL ARG SER GLU ASP THR | |
| ALA LEU TYR TYR CYS ALA ARG LEU HIS TYR TYR GLY TYR | |
| ASN ALA TYR TRP GLY GLN GLY THR LEU VAL THR VAL SER | |
| ALA GLU SER ALA ARG ASN PRO THR ILE TYR PRO LEU THR | |
| LEU PRO PRO ALA LEU SER SER ASP PRO VAL ILE ILE GLY | |
| CYS LEU ILE HIS ASP TYR PHE PRO SER GLY THR MET ASN | |
| VAL THR TRP GLY LYS SER GLY LYS ASP ILE THR THR VAL | |
| ASN PHE PRO PRO ALA LEU ALA SER GLY GLY ARG TYR THR | |
| MET SER ASN GLN LEU THR LEU PRO ALA VAL GLU CYS PRO | |
| GLU GLY GLU SER VAL LYS CYS SER VAL GLN HIS ASP SER | |
| ASN PRO VAL GLN GLU LEU ASP VAL ASN CYS SER GLY | |
| MET TYR ARG SER ALA PHE SER VAL GLY LEU GLU THR ARG | SEQ ID NO: 42 |
| VAL THR VAL PRO ASN VAL PRO ILE ARG PHE THR LYS ILE | |
| PHE TYR ASN GLN GLN ASN HIS TYR ASP GLY SER THR GLY | |
| LYS PHE TYR CYS ASN ILE PRO GLY LEU TYR TYR PHE SER | |
| TYR HIS ILE THR VAL TYR MET LYS ASP VAL LYS VAL SER | |
| LEU PHE LYS LYS ASP LYS ALA VAL LEU PHE THR TYR ASP | |
| GLN TYR GLN GLU LYS ASN VAL ASP GLN ALA SER GLY SER | |
| VAL LEU LEU HIS LEU GLU VAL GLY ASP GLN VAL TRP LEU | |
| GLN VAL TYR GLY ASP GLY ASP HIS ASN GLY LEU TYR ALA | |
| ASP ASN VAL ASN ASP SER THR PHE THR GLY PHE LEU LEU | |
| TYR HIS ASP THR ASN | |
| MET TYR ARG SER ALA PHE SER VAL GLY LEU GLU THR ARG | SEQ ID NO: 43 |
| VAL THR VAL PRO ASN VAL PRO ILE ARG PHE THR LYS ILE | |
| PHE TYR ASN GLN GLN ASN HIS TYR ASP GLY SER THR GLY | |
| LYS PHE TYR CYS ASN ILE PRO GLY LEU TYR TYR PHE SER | |
| TYR HIS ILE THR VAL TYR MET LYS ASP VAL LYS VAL SER | |
| LEU PHE LYS LYS ASP LYS ALA VAL LEU PHE THR TYR ASP | |
| GLN TYR GLN GLU LYS ASN VAL ASP GLN ALA SER GLY SER | |
| VAL LEU LEU HIS LEU GLU VAL GLY ASP GLN VAL TRP LEU | |
| GLN VAL TYR GLY ASP GLY ASP HIS ASN GLY LEU TYR ALA | |
| ASP ASN VAL ASN ASP SER THR PHE THR GLY PHE LEU LEU | |
| TYR HIS ASP THR ASN | |
| MET TYR ARG SER ALA PHE SER VAL GLY LEU GLU THR ARG | SEQ ID NO: 44 |
| VAL THR VAL PRO ASN VAL PRO ILE ARG PHE THR LYS ILE | |
| PHE TYR ASN GLN GLN ASN HIS TYR ASP GLY SER THR GLY | |
| LYS PHE TYR CYS ASN ILE PRO GLY LEU TYR TYR PHE SER | |
| TYR HIS ILE THR VAL TYR MET LYS ASP VAL LYS VAL SER | |
| LEU PHE LYS LYS ASP LYS ALA VAL LEU PHE THR TYR ASP | |
| GLN TYR GLN GLU LYS ASN VAL ASP GLN ALA SER GLY SER | |
| VAL LEU LEU HIS LEU GLU VAL GLY ASP GLN VAL TRP LEU | |
| GLN VAL TYR GLY ASP GLY ASP HIS ASN GLY LEU TYR ALA | |
| ASP ASN VAL ASN ASP SER THR PHE THR GLY PHE LEU LEU | |
| TYR HIS ASP THR ASN | |
| MET TYR ARG SER ALA PHE SER VAL GLY LEU GLU THR ARG | SEQ ID NO: 45 |
| VAL THR VAL PRO ASN VAL PRO ILE ARG PHE THR LYS ILE | |
| PHE TYR ASN GLN GLN ASN HIS TYR ASP GLY SER THR GLY | |
| LYS PHE TYR CYS ASN ILE PRO GLY LEU TYR TYR PHE SER | |
| TYR HIS ILE THR VAL TYR MET LYS ASP VAL LYS VAL SER | |
| LEU PHE LYS LYS ASP LYS ALA VAL LEU PHE THR TYR ASP | |
| GLN TYR GLN GLU LYS ASN VAL ASP GLN ALA SER GLY SER | |
| VAL LEU LEU HIS LEU GLU VAL GLY ASP GLN VAL TRP LEU | |
| GLN VAL TYR GLY ASP GLY ASP HIS ASN GLY LEU TYR ALA | |
| ASP ASN VAL ASN ASP SER THR PHE THR GLY PHE LEU LEU | |
| TYR HIS ASP THR ASN | |
| MET TYR ARG SER ALA PHE SER VAL GLY LEU GLU THR ARG | SEQ ID NO: 46 |
| VAL THR VAL PRO ASN VAL PRO ILE ARG PHE THR LYS ILE | |
| PHE TYR ASN GLN GLN ASN HIS TYR ASP GLY SER THR GLY | |
| LYS PHE TYR CYS ASN ILE PRO GLY LEU TYR TYR PHE SER | |
| TYR HIS ILE THR VAL TYR MET LYS ASP VAL LYS VAL SER | |
| LEU PHE LYS LYS ASP LYS ALA VAL LEU PHE THR TYR ASP | |
| GLN TYR GLN GLU LYS ASN VAL ASP GLN ALA SER GLY SER | |
| VAL LEU LEU HIS LEU GLU VAL GLY ASP GLN VAL TRP LEU | |
| GLN VAL TYR GLY ASP GLY ASP HIS ASN GLY LEU TYR ALA | |
| ASP ASN VAL ASN ASP SER THR PHE THR GLY PHE LEU LEU | |
| TYR HIS ASP THR ASN | |
| MET TYR ARG SER ALA PHE SER VAL GLY LEU GLU THR ARG | SEQ ID NO: 47 |
| VAL THR VAL PRO ASN VAL PRO ILE ARG PHE THR LYS ILE | |
| PHE TYR ASN GLN GLN ASN HIS TYR ASP GLY SER THR GLY | |
| LYS PHE TYR CYS ASN ILE PRO GLY LEU TYR TYR PHE SER | |
| TYR HIS ILE THR VAL TYR MET LYS ASP VAL LYS VAL SER | |
| LEU PHE LYS LYS ASP LYS ALA VAL LEU PHE THR TYR ASP | |
| GLN TYR GLN GLU LYS ASN VAL ASP GLN ALA SER GLY SER | |
| VAL LEU LEU HIS LEU GLU VAL GLY ASP GLN VAL TRP LEU | |
| GLN VAL TYR GLY ASP GLY ASP HIS ASN GLY LEU TYR ALA | |
| ASP ASN VAL ASN ASP SER THR PHE THR GLY PHE LEU LEU | |
| TYR HIS ASP THR ASN | |
| ALA VAL GLN LEU GLU GLN SER GLY PRO GLY LEU VAL ARG | SEQ ID NO: 48 |
| PRO SER GLN THR LEU SER LEU THR CYS THR VAL SER GLY | |
| THR SER PHE ASP ASP TYR TYR TRP THR TRP VAL ARG GLN | |
| PRO PRO GLY ARG GLY LEU GLU TRP ILE GLY TYR VAL PHE | |
| TYR THR GLY THR THR LEU LEU ASP PRO SER LEU ARG GLY | |
| ARG VAL THR MET LEU VAL ASN THR SER LYS ASN GLN PHE | |
| SER LEU ARG LEU SER SER VAL THR ALA ALA ASP THR ALA | |
| VAL TYR TYR CYS ALA ARG ASN LEU ILE ALA GLY GLY ILE | |
| ASP VAL TRP GLY GLN GLY SER LEU VAL THR VAL SER SER | |
| ALA SER THR LYS GLY PRO SER VAL PHE PRO LEU ALA PRO | |
| SER SER LYS SER THR SER GLY GLY THR ALA ALA LEU GLY | |
| CYS LEU VAL LYS ASP TYR PHE PRO GLU PRO VAL THR VAL | |
| SER TRP ASN SER GLY ALA LEU THR SER GLY VAL HIS THR | |
| PHE PRO ALA VAL LEU GLN SER SER GLY LEU TYR SER LEU | |
| SER SER VAL VAL THR VAL PRO SER SER SER LEU GLY THR | |
| GLN THR TYR ILE CYS ASN VAL ASN HIS LYS PRO SER ASN | |
| THR LYS VAL ASP LYS LYS VAL GLU PRO | |
| GLU VAL GLN LEU VAL GLU SER GLY GLY GLY LEU VAL GLN | SEQ ID NO: 49 |
| PRO GLY ARG SER LEU ARG LEU SER CYS VAL THR SER GLY | |
| PHE THR PHE ASP ASP TYR ALA MET HIS TRP VAL ARG GLN | |
| SER PRO GLY LYS GLY LEU GLU TRP VAL SER GLY ILE SER | |
| TRP ASN THR GLY THR ILE ILE TYR ALA ASP SER VAL LYS | |
| GLY ARG PHE ILE ILE SER ARG ASP ASN ALA LYS ASN SER | |
| LEU TYR LEU GLN MET ASN SER LEU ARG VAL GLU ASP THR | |
| ALA LEU TYR TYR CYS ALA LYS THR ARG SER TYR VAL VAL | |
| ALA ALA GLU TYR TYR PHE HIS TYR TRP GLY GLN GLY ILE | |
| LEU VAL THR VAL SER SER GLY SER ALA SER ALA PRO THR | |
| LEU PHE PRO LEU VAL SER CYS GLU ASN SER ASN PRO SER | |
| SER THR VAL ALA VAL GLY CYS LEU ALA GLN ASP PHE LEU | |
| PRO ASP SER ILE THR PHE SER TRP LYS TYR LYS ASN ASN | |
| SER ASP ILE SER SER THR ARG GLY PHE PRO SER VAL LEU | |
| ARG GLY GLY LYS TYR ALA ALA THR SER GLN VAL LEU LEU | |
| PRO SER LYS ASP VAL MET GLN GLY THR ASN GLU HIS VAL | |
| VAL CYS LYS VAL GLN HIS PRO ASN GLY ASN LYS GLU LYS | |
| ASP VAL PRO LEU | |
| ASP VAL GLN LEU GLN ALA SER GLY GLY GLY SER VAL GLN | SEQ ID NO: 50 |
| ALA GLY GLY SER LEU ARG LEU SER CYS ALA ALA SER GLY | |
| TYR THR ILE GLY PRO TYR CYS MET GLY TRP PHE ARG GLN | |
| ALA PRO GLY LYS GLU ARG GLU GLY VAL ALA ALA ILE ASN | |
| MET GLY GLY GLY ILE THR TYR TYR ALA ASP SER VAL LYS | |
| GLY ARG PHE THR ILE SER GLN ASP ASN ALA LYS ASN THR | |
| VAL TYR LEU LEU MET ASN SER LEU GLU PRO GLU ASP THR | |
| ALA ILE TYR TYR CYS ALA ALA ASP SER THR ILE TYR ALA | |
| SER TYR TYR GLU CYS GLY HIS GLY LEU SER THR GLY GLY | |
| TYR GLY TYR ASP SER TRP GLY GLN GLY THR GLN VAL THR | |
| VAL SER SER GLY ARG TYR PRO TYR ASP VAL PRO ASP TYR | |
| GLY SER GLY ARG ALA | |
| ASP VAL GLN LEU GLN GLN SER GLY PRO GLU LEU GLU LYS | SEQ ID NO: 51 |
| PRO GLY ALA SER VAL LYS ILE SER CYS LYS ALA SER GLY | |
| PHE SER LEU PRO GLY HIS ASN ILE ASN TRP ILE VAL GLN | |
| ARG ASN GLY LYS SER LEU GLU TRP ILE GLY ASN ILE ASP | |
| PRO TYR TYR GLY GLY THR ASN PHE ASN PRO LYS PHE LYS | |
| GLY LYS ALA THR LEU THR VAL ASP LYS SER SER SER THR | |
| LEU TYR MET HIS LEU THR SER LEU GLN SER GLU ASP SER | |
| ALA VAL TYR TYR CYS ALA ARG ARG ARG ASP GLY ASN TYR | |
| GLY PHE THR TYR TRP GLY GLN GLY THR LEU VAL THR VAL | |
| SER ALA ALA LYS THR THR PRO PRO SER VAL TYR PRO LEU | |
| ALA PRO GLY SER ALA ALA GLN THR ASN SER MET VAL THR | |
| LEU GLY CYS LEU VAL LYS GLY TYR PHE PRO GLU PRO VAL | |
| THR VAL THR TRP ASN SER GLY SER LEU SER SER GLY VAL | |
| HIS THR PHE PRO ALA VAL LEU GLN SER ASP LEU TYR THR | |
| LEU SER SER SER VAL THR VAL PRO SER SER THR TRP PRO | |
| SER GLU THR VAL THR CYS ASN VAL ALA HIS PRO ALA SER | |
| SER THR LYS VAL ASP LYS LYS ILE | |
| QDTLKEYGPGKLPSQTFSLTCTFSGFSLSTYGMMVSWMCQPSGKGLVWLA | SEQ ID NO: 52 |
| LIWCNNDKGYNPFLRSQLTISKDTSNNQVFLKITSVDPADTATYYCA | |
| QVQLQQSGPGLVKPSQTLSLTCAISGDSVSSNSAAWNWIRQSPSRGLEWLG | SEQ ID NO: 53 |
| RTYYRSKWYNDYAVSVKSRITINPDTSKNQFSLQLNSVTPEDTAVYYCAR | |
| ASP ILE GLN MET THR GLN SER PRO ALA ILE MET SER ALA | SEQ ID NO: 54 |
| SER PRO GLY GLU LYS VAL THR MET THR CYS SER ALA SER | |
| SER SER VAL SER TYR MET TYR TRP TYR GLN GLN LYS PRO | |
| GLY SER SER PRO ARG LEU LEU ILE TYR ASP SER THR ASN | |
| LEU ALA SER GLY VAL PRO VAL ARG PHE SER GLY SER GLY | |
| SER GLY THR SER TYR SER LEU THR ILE SER ARG MET GLU | |
| ALA GLU ASP ALA ALA THR TYR TYR CYS GLN GLN TRP SER | |
| THR TYR PRO LEU THR PHE GLY ALA GLY THR LYS LEU GLU | |
| LEU LYS ARG ALA ASP ALA ALA PRO THR VAL SER ILE PHE | |
| PRO PRO SER SER GLU GLN LEU THR SER GLY GLY ALA SER | |
| VAL VAL CYS PHE LEU ASN ASN PHE TYR PRO LYS ASP ILE | |
| ASN VAL LYS TRP LYS ILE ASP GLY SER GLU ARG GLN ASN | |
| GLY VAL LEU ASN SER TRP THR ASP GLN ASP SER LYS ASP | |
| SER THR TYR SER MET SER SER THR LEU THR LEU THR LYS | |
| ASP GLU TYR GLU ARG HIS ASN SER TYR THR CYS GLU ALA | |
| THR HIS LYS THR SER THR SER PRO ILE VAL LYS SER PHE | |
| ASN ARG | |
| GLN ILE VAL SER THR GLN SER PRO ALA ILE MET SER ALA | SEQ ID NO: 55 |
| SER PRO GLY GLU LYS VAL THR MET THR CYS SER ALA SER | |
| SER SER ARG SER TYR MET GLN TRP TYR GLN GLN LYS PRO | |
| GLY THR SER PRO LYS ARG TRP ILE TYR ASP THR SER LYS | |
| LEU ALA SER GLY VAL PRO ALA ARG PHE SER GLY SER GLY | |
| SER GLY THR SER TYR SER LEU THR ILE SER SER MET GLU | |
| ALA GLU ASP ALA ALA THR TYR TYR CYS HIS GLN ARG SER | |
| SER TYR THR PHE GLY GLY GLY THR LYS LEU GLU ILE LYS | |
| ARG THR VAL ALA ALA PRO SER VAL PHE ILE PHE PRO PRO | |
| SER ASP GLU GLN LEU LYS SER GLY THR ALA SER VAL VAL | |
| CYS LEU LEU ASN ASN PHE TYR PRO ARG GLU ALA LYS VAL | |
| GLN TRP LYS VAL ASP ASN ALA LEU GLN SER GLY ASN SER | |
| GLN GLU SER VAL THR GLU GLN ASP SER LYS ASP SER THR | |
| TYR SER LEU SER SER THR LEU THR LEU SER LYS ALA ASP | |
| TYR GLU LYS HIS LYS VAL TYR ALA CYS GLU VAL THR HIS | |
| GLN GLY LEU SER SER PRO VAL THR LYS SER PHE ASN ARG | |
| GLY GLU | |
| GLU LEU VAL MET THR GLN SER PRO SER SER LEU SER ALA | SEQ ID NO: 56 |
| SER VAL GLY ASP ARG VAL ASN ILE ALA CYS ARG ALA SER | |
| GLN GLY ILE SER SER ALA LEU ALA TRP TYR GLN GLN LYS | |
| PRO GLY LYS ALA PRO ARG LEU LEU ILE TYR ASP ALA SER | |
| ASN LEU GLU SER GLY VAL PRO SER ARG PHE SER GLY SER | |
| GLY SER GLY THR ASP PHE THR LEU THR ILE SER SER LEU | |
| GLN PRO GLU ASP PHE ALA ILE TYR TYR CYS GLN GLN PHE | |
| ASN SER TYR PRO LEU THR PHE GLY GLY GLY THR LYS VAL | |
| GLU ILE LYS ARG THR VAL ALA ALA PRO SER VAL PHE ILE | |
| PHE PRO PRO SER ASP GLU GLN LEU LYS SER GLY THR ALA | |
| SER VAL VAL CYS LEU LEU ASN ASN PHE TYR PRO ARG GLU | |
| ALA LYS VAL GLN TRP LYS VAL ASP ASN ALA LEU GLN SER | |
| GLY ASN SER GLN GLU SER VAL THR GLU GLN ASP SER LYS | |
| ASP SER THR TYR SER LEU SER SER THR LEU THR LEU SER | |
| LYS ALA ASP TYR GLU LYS HIS LYS VAL TYR ALA CYS GLU | |
| VAL THR HIS GLN GLY LEU SER SER PRO VAL THR LYS SER | |
| PHE ASN ARG GLY GLU CYS | |
| GLU LEU VAL MET THR GLN SER PRO SER SER LEU SER ALA | SEQ ID NO: 57 |
| SER VAL GLY ASP ARG VAL ASN ILE ALA CYS ARG ALA SER | |
| GLN GLY ILE SER SER ALA LEU ALA TRP TYR GLN GLN LYS | |
| PRO GLY LYS ALA PRO ARG LEU LEU ILE TYR ASP ALA SER | |
| ASN LEU GLU SER GLY VAL PRO SER ARG PHE SER GLY SER | |
| GLY SER GLY THR ASP PHE THR LEU THR ILE SER SER LEU | |
| GLN PRO GLU ASP PHE ALA ILE TYR TYR CYS GLN GLN PHE | |
| ASN SER TYR PRO LEU THR PHE GLY GLY GLY THR LYS VAL | |
| GLU ILE LYS ARG THR VAL ALA ALA PRO SER VAL PHE ILE | |
| PHE PRO PRO SER ASP GLU GLN LEU LYS SER GLY THR ALA | |
| SER VAL VAL CYS LEU LEU ASN ASN PHE TYR PRO ARG GLU | |
| ALA LYS VAL GLN TRP LYS VAL ASP ASN ALA LEU GLN SER | |
| GLY ASN SER GLN GLU SER VAL THR GLU GLN ASP SER LYS | |
| ASP SER THR TYR SER LEU SER SER THR LEU THR LEU SER | |
| LYS ALA ASP TYR GLU LYS HIS LYS VAL TYR ALA CYS GLU | |
| VAL THR HIS GLN GLY LEU SER SER PRO VAL THR LYS SER | |
| PHE ASN ARG GLY GLU CYS | |
| GLU ILE VAL MET THR GLN SER PRO ALA SER LEU SER LEU | SEQ ID NO: 58 |
| SER PRO GLY GLU ARG ALA THR LEU SER CYS ARG ALA SER | |
| GLN SER VAL SER ASN TYR LEU ALA TRP TYR GLN GLN LYS | |
| PRO GLY GLN ALA PRO ARG LEU LEU ILE HIS ASP ALA SER | |
| GLY ARG ALA THR GLY ILE PRO ASP ARG PHE SER GLY SER | |
| THR ASP PHE THR LEU THR ILE SER ARG LEU | |
| GLU PRO GLU ASP PHE ALA VAL TYR TYR CYS GLN GLN ARG | |
| ALA ASN TRP GLY THR TRP THR PHE GLY GLN GLY THR LYS | |
| VAL GLU ILE LYS ARG THR | |
| GLU ILE VAL LEU THR GLN SER PRO ALA THR LEU SER LEU | SEQ ID NO: 59 |
| SER PRO GLY GLU ARG ALA THR LEU SER CYS GLY ALA SER | |
| GLN SER VAL SER SER ASN TYR LEU ALA TRP TYR GLN GLN | |
| LYS PRO GLY GLN ALA PRO ARG LEU LEU ILE TYR ASP ALA | |
| SER SER ARG ALA THR GLY ILE PRO ASP ARG PHE SER GLY | |
| SER GLY SER GLY THR ASP PHE THR LEU THR ILE SER ARG | |
| LEU GLU PRO GLU ASP PHE ALA VAL TYR TYR CYS GLN GLN | |
| TYR GLY SER SER PRO LEU THR PHE GLY GLY GLY THR LYS | |
| VAL GLU ILE LYS ARG THR VAL ALA ALA PRO SER VAL PHE | |
| ILE PHE PRO PRO SER ASP GLU GLN LEU LYS SER GLY THR | |
| ALA SER VAL VAL CYS LEU LEU ASN ASN PHE TYR PRO ARG | |
| GLU ALA LYS VAL GLN TRP LYS VAL ASP ASN ALA LEU GLN | |
| SER GLY ASN SER GLN GLU SER VAL THR GLU GLN ASP SER | |
| LYS ASP SER THR TYR SER LEU SER SER THR LEU THR LEU | |
| SER LYS ALA ASP TYR GLU LYS HIS LYS VAL TYR ALA CYS | |
| GLU VAL THR HIS GLN GLY LEU SER SER PRO VAL THR LYS | |
| SER PHE ASN ARG GLY GLU CYS | |
| ASP ILE GLN MET THR GLN SER PRO ALA ILE MET SER ALA | SEQ ID NO: 60 |
| SER PRO GLY GLU LYS VAL THR MET THR CYS SER ALA SER | |
| SER SER VAL SER TYR MET TYR TRP TYR GLN GLN LYS PRO | |
| GLY SER SER PRO ARG LEU LEU ILE TYR ASP SER THR ASN | |
| LEU ALA SER GLY VAL PRO VAL ARG PHE SER GLY SER GLY | |
| SER GLY THR SER TYR SER LEU THR ILE SER ARG MET GLU | |
| ALA GLU ASP ALA ALA THR TYR TYR CYS GLN GLN TRP SER | |
| THR TYR PRO LEU THR PHE GLY ALA GLY THR LYS LEU GLU | |
| LEU LYS ARG ALA ASP ALA ALA PRO THR VAL SER ILE PHE | |
| PRO PRO SER SER GLU GLN LEU THR SER GLY GLY ALA SER | |
| VAL VAL CYS PHE LEU ASN ASN PHE TYR PRO LYS ASP ILE | |
| ASN VAL LYS TRP LYS ILE ASP GLY SER GLU ARG GLN ASN | |
| GLY VAL LEU ASN SER TRP THR ASP GLN ASP SER LYS ASP | |
| SER THR TYR SER MET SER SER THR LEU THR LEU THR LYS | |
| ASP GLU TYR GLU ARG HIS ASN SER TYR THR CYS GLU ALA | |
| THR HIS LYS THR SER THR SER PRO ILE VAL LYS SER PHE | |
| ASN ARG | |

### Target Ligands, Compositions and Methods

The polypeptides that unfold reversibly described herein can have binding specificity for a target ligand. For example, a polypeptide that comprises an antibody variable region that unfolds reversibly and has binding specificity for a particular target ligand can be selected, isolated and/or recovered using any suitable method, such as the binding methods described herein. Exemplary target ligands that polypeptides that unfold reversibly (e.g., polypeptides comprising a reversibly unfoldable V_{H} or Vκ) can have binding specificity for include, human or animal proteins, cytokines, cytokine receptors, enzymes, co-factors for enzymes and DNA binding proteins. Suitable cytokines and growth factors, cytokine and growth factor receptor and other target ligands include but are not limited to: ApoE, Apo-SAA, BDNF, Cardiotrophin-1, CEA, CD40, CD40 Ligand, CD56, CD38, CD138, BGF, EGF receptor, ENA-78, Eotaxin, Eotaxin-2, Exodus-2, FAPA, FGF-acidic, FGF-basic, fibroblast growth factor-10, FLT3 ligand, Fractalkine (CX3C), GDNF, G-CSF, GM-CSF, GF-β1, human serum albumin, insulin, IFN-γ, IGF-I, IGF-II, IL-1α, IL-1β, IL-1 receptor, IL-2, IL-3, IL-4, IL-5, IL-6, IL-7, IL-8 (72 a.a.), IL-8 (77 a.a.), IL-9, IL-10, IL-1, IL-12, IL-13, IL-15, IL-16, IL-17, IL-18 (IGIF), Inhibin α, Inhibin β, IP-10, keratinocyte growth factor-2 (KGF-2), KGF, Leptin, LIF, Lymphotactin, Mullerian inhibitory substance, monocyte colony inhibitory factor, monocyte attractant protein, M-CSF, MDC (67 a.a.), MDC (69 a.a.), MCP-1 (MCAF), MCP-2, MCP-3, MCP-4, MDC (67 a.a.), MDC (69 a.a.), MIG, MIP-1α, MIP-1β, MIP-3α, MIP-3β, MIP4, myeloid progenitor inhibitor factor-1 (MPW-1), NAP-2, Neurturin, Nerve growth factor, 13-NGF, NT-3, NT-4, Oncostatin M, PDGF-AA, PDGF-AB, PDGF-BB, PF-4, RANTES, SDF1α, SDF1β, SCF, SCGF, stem cell factor (SCF), TARC, TGF-α, TGF-β, TGF-β2, TGF-β3, tumour necrosis factor (TNF), TNF-α, TNF-β, receptor I, TNF receptor II, TNIL-1, TPO, VEGF, VEGF A, VEGF B, VEGF C, VEGF D, VEGF receptor 1, VEGF receptor 2, VEGF receptor 3, GCP-2, GRO/MGSA, GRO-β, GRO-γ, HCCl, 1-309, HER 1, HER 2, HER 3 and HER 4. It will be appreciated that this list is by no means exhaustive.

In some embodiments, the invention is an isolated polypeptide that comprises an antibody variable domain that unfolds reversibly and binds a target ligand. Preferably, the antibody variable domain that unfolds reversibly binds a target ligand that is a cytokine, growth factor, cytokine receptor or growth factor receptor (e.g., a human cytokine, human growth factor, human cytokine receptor or human growth factor receptor). More preferably, the antibody variable domain that unfolds reversibly neutralizes the activity of the a cytokine, growth factor, cytokine receptor or growth factor receptor with a neutralized dose 50 (ND50) of about 1 μM or less, or 500 nM or less, in a standard cellular assay, such as the assay that measures TNF-induced IL-8 secretion by HeLa cells described herein. In particular embodiments, the antibody variable domain that unfolds reversibly neutralizes the activity of the a cytokine, growth factor, cytokine receptor or growth factor receptor with a ND50 of about or about 400 nM or less, or about 300 nM or less, or about 200 nM or less, or about 100 nM or less, or about 1 nM or less, or about 100 μM or less, or about 10 pM or less.

In other embodiments, the antibody variable domain that unfolds reversibly binds a cytokine or growth factor, and inhibits the interaction of the cytokine or growth factor with a cognate cytokine receptor or growth factor receptor with an inhibitory concentration 50 (IC50) of about 1 μM or less, or about 500 nM or less, in a standard receptor binding assay, such as the assay TNF Receptor 1 (p55) assay described herein. In particular embodiments, the antibody variable domain that unfolds reversibly inhibits the interaction of the cytokine or growth factor with a cognate cytokine receptor or growth factor receptor with IC50 of about 400 nM or less, or about 300 nM or less, or about 200 nM or less, or about 100 nM or less, or about 1 nM or less, or about 100 pM or less, or about 10 pM or less. In other embodiments, the antibody variable domain that unfolds reversibly binds a cytokine receptor or growth factor receptor, and inhibits the interaction of the cytokine receptor or growth factor receptor with a cognate cytokine or growth factor with an inhibitory concentration 50 (IC50) of about 1 μM or less, or about 500 nM or less, in a standard receptor binding assay, such as the assay TNF Receptor 1 (p55) assay described herein. In particular embodiments, the antibody variable domain that unfolds reversibly inhibits the interaction of the cytokine receptor or growth factor receptor with a cognate cytokine or growth factor with IC₅₀ of about or about 400 nM or less, or about 300 nM or less, or about 200 nM or less, or about 100 nM or less, or about 1 nM or less, or about 100 pM or less, or about 10 pM or less.

Compositions comprising a polypeptide that unfolds reversibly, including pharmaceutical or physiological compositions are provided. Pharmaceutical or physiological compositions comprise one or more polypeptide that unfolds reversibly and a pharmaceutically or physiologically acceptable carrier. Typically, these carriers include aqueous or alcoholic/aqueous solutions, emulsions or suspensions, including saline and/or buffered media. Parenteral vehicles include sodium chloride solution, Ringer's dextrose, dextrose and sodium chloride and lactated Ringer's. Suitable physiologically-acceptable adjuvants, if necessary to keep a polypeptide complex in suspension, may be chosen from thickeners such as carboxymethylcellulose, polyvinylpyrrolidone, gelatin and alginates. Intravenous vehicles include fluid and nutrient replenishers and electrolyte replenishers, such as those based on Ringer's dextrose. Preservatives and other additives, such as antimicrobials, antioxidants, chelating agents and inert gases, may also be present (Mack (1982) Remington's Pharmaceutical Sciences, 16th Edition).

The compositions can comprise a desired amount of polypeptide that unfolds reversibly. For example the compositions can comprise about 5% to about 99% polypeptide that unfolds reversibly by weight. In particular embodiments, the composition can comprise about 10% to about 99%, or about 20% to about 99%, or about 30% to about 99% or about 40% to about 99%, or about 50% to about 99%, or about 60% to about 99%, or about 70% to about 99%, or about 80% to about 99%, or about 90% to about 99%, or about 95% to about 99% polypeptide that unfolds reversibly by weight.

In one example, the composition is a biological washing powder comprising a polypeptide that unfolds reversibly (e.g., a polypeptide comprising an immunoglobulin variable domain that unfolds reversibly). In another embodiment, the composition is freeze dried (lyophilized).

The invention also provides a sealed package (e.g., a sealed sterile package) comprising a polypeptide that unfolds reversibly (e.g., when heated (e.g., a polypeptide comprising an immunoglobulin variable domain that unfolds reversibly)). In some embodiments, the sealed package further comprises a sterile instrument. In particular embodiments, the sterile instrument is a medical instrument, such as a surgical instrument.

The polypeptides that unfold reversibly described herein will typically find use in preventing, suppressing or treating inflammatory states, allergic hypersensitivity, cancer, bacterial or viral infection, and autoimmune disorders (which include, but are not limited to, Type I diabetes, multiple sclerosis, rheumatoid arthritis, systemic lupus erythematosus, Crohn's disease and myasthenia gravis).

In the instant application, the term “prevention” involves administration of the protective composition prior to the induction of the disease. “Suppression” refers to administration of the composition after an inductive event, but prior to the clinical appearance of the disease. “Treatment” involves administration of the protective composition after disease symptoms become manifest.

Animal model systems which can be used to screen the effectiveness of polypeptides that unfold reversibly in protecting against or treating the disease are available. Methods for the testing of systemic lupus erythematosus (SLE) in susceptible mice are known in the art (Knight et al. (1978) J. Exp. Med., 147: 1653; Reinersten et al. (1978) New Eng. J. Med., 299: 515). Myasthenia Gravis (MG) is tested in SJL/J female mice by inducing the disease with soluble AchR protein from another species (Lindstrom et al. (1988) Adv. Immunol., 42: 233). Arthritis is induced in a susceptible strain of mice by injection of Type II collagen (Stuart et al. (1984) Ann. Rev. Immunol., 42:233). A model by which adjuvant arthritis is induced in susceptible rats by injection of mycobacterial heat shock protein has been described (Van Eden et al. (1988) Nature, 331: 171). Thyroiditis is induced in mice by administration of thyroglobulin as described (Maron et al. (1980) J. Exp. Med., 152: 1115). Insulin dependent diabetes mellitus (IDM) occurs naturally or can be induced in certain strains of mice such as those described by Kanasawa et al. (1984) Diabetologia, 27: 113. EAE in mouse and rat serves as a model for MS in human In this model, the demyelinating disease is induced by administration of myelin basic protein (see Paterson (1986) Textbook of Immunopathology, Mischer et al., eds., Grune and Stratton, New York, pp. 179-213; McFarlin et al. (1973) Science, 179: 478: and Satoh et al. (1987) J. Immunol., 138: 179).

The selected polypeptides of the present invention may be used as separately administered compositions or in conjunction with other agents. These can include various immunotherapeutic drugs, such as cyclosporine, methotrexate, adriamycin or cisplatinum, and immunotoxins. Pharmaceutical compositions can include “cocktails” of various cytotoxic or other agents in conjunction with the selected antibodies, receptors or binding proteins thereof of the present invention, or even combinations of selected polypeptides according to the present invention having different specificities, such as polypeptides selected using different target ligands, whether or not they are pooled prior to administration.

The route of administration of pharmaceutical compositions according to the invention may be any of those commonly known to those of ordinary skill in the art. For therapy, including without limitation immunotherapy, the selected antibodies, receptors or binding proteins thereof of the invention can be administered to any patient in accordance with standard techniques. The administration can be by any appropriate mode, including parenterally, intravenously, intramuscularly, intraperitoneally, transdermally, via the pulmonary route, or also, appropriately, by direct infusion with a catheter. The dosage and frequency of administration will depend on the age, sex and condition of the patient, concurrent administration of other drugs, counterindications and other parameters to be taken into account by the clinician. A therapeutically effective amount of a polypeptide that unfolds reversibly (e.g., an antibody variable domain that unfolds reversibly) is administered. A therapeutically effective amount is an amount sufficient to achieve the desired therapeutic effect, under the conditions of administration.

The invention also provides a kit use in administering a polypeptide that unfold reversibly to a subject (e.g., patient), comprising a polypeptide that unfolds reversibly, a drug delivery device and, optionally, instructions for use. The polypeptide that unfolds reversibly can be provided as a formulation, such as a freeze dried formulation. In certain embodiments, the drug delivery device is selected from the group consisting of a syringe, an inhaler, an intranasal or ocular administration device (e.g., a mister, eye or nose dropper) a needleless injection device.

The selected polypeptides of this invention can be lyophilised for storage and reconstituted in a suitable carrier prior to use. Any suitable lyophilization method (e.g., spray drying, cake drying) and/or reconstitution techniques can be employed. It will be appreciated by those skilled in the art that lyophilisation and reconstitution can lead to varying degrees of antibody activity loss (e.g., with conventional immunoglobulins, IgM antibodies tend to have greater activity loss than IgG antibodies) and that use levels may have to be adjusted upward to compensate. In a particular embodiment, the invention provides a composition comprising a lyophilized (freeze dried) polypeptide that unfolds reversibly as described herein. Preferably, the lyophilized (freeze dried) polypeptide loses no more than about 20%, or no more than about 25%, or no more than about 30%, or no more than about 35%, or no more than about 40%, or no more than about 45%, or no more than about 50% of its activity when rehydrated. Activity is the amount of polypeptide required to produce the effect of the polypeptide before it was lyophilized. For example, the amount of rehydrated enzyme needed to produce half maximal conversion of a substrate into a product in a give time period, or the amount of a binding polypeptide needed to achieve half saturation of binding sites on a target protein. The activity of the polypeptide can be determined using any suitable method before lyophilization, and the activity can be determined using the same method after rehydration to determine amount of lost activity.

Compositions containing the present selected polypeptides or a cocktail thereof can be administered for prophylactic and/or therapeutic treatments. In certain therapeutic applications, an adequate amount to accomplish at least partial inhibition, suppression, modulation, killing, or some other measurable parameter, of a population of selected cells is defined as a “therapeutically-effective dose.” Amounts needed to achieve this dosage will depend upon the severity of the disease and the general state of the patient's own immune system, but generally range from 0.005 to 5.0 mg of selected antibody, receptor (e.g. a T-cell receptor) or binding protein thereof per kilogram of body weight, with doses of 0.05 to 2.0 mg/kg/dose being more commonly used. For prophylactic applications, compositions containing the present selected polypeptides or cocktails thereof may also be administered in similar or slightly lower dosages.

A composition containing a selected polypeptide according to the present invention may be utilised in prophylactic and therapeutic settings to aid in the alteration, inactivation, killing or removal of a select target cell population in a mammal. In addition, the selected repertoires of polypeptides described herein may be used extracorporeally or in vitro selectively to kill, deplete or otherwise effectively remove a target cell population from a heterogeneous collection of cells. Blood from a mammal may be combined extracorporeally with the selected antibodies, cell-surface receptors or binding proteins thereof whereby the undesired cells are killed or otherwise removed from the blood for return to the mammal in accordance with standard techniques.

### EXEMPLIFICATION

### Section 1: EP-V_{H} Library and EP-V_{L} Library

Error-prone PCR is a random mutagenesis strategy that introduces mutations into a DNA segment. Hence, it is a useful tool for preparing nucleic acids encoding diversified proteins that contain random amino acid substitutions. Error-prone PCR can be carried out in a number of ways, generally by altering buffer conditions (e.g., varying dNTP concentrations) to reduce the fidelity of nucleotide incorporation. In this study, an error-prone PCR library was constructed using the GENEMORPH PCR Mutagenesis Kit (Stratagene). The kit incorporates the MUTAZYME DNA polymerase that has a high intrinsic error rate of nucleotide incorporation compared to Taq polymerase. Mutation frequency using this system can be altered by manipulating the starting concentration of template (V_{H} and Vκ coding sequence) in the reaction. The starting concentration was altered accordingly to give a varying rate of mutational frequency. Initially, two libraries were constructed for each V_{H} and Vκ template and cloned into a phagemid vector pR2. The V_{H} template was V3-23/DP47 and JH4b, and the V_{L} template was 012/02/DPK9 and Jκ1. The pR2 vector is derived from pHEN1. (Hoogenboom, H R et al., Nucleic Acids Res. 19:4133-4137 (1991).) pR2 contains a lac promoter, a leader sequence upstream of the cloning site which is followed by His6 and VSV tags, an amber stop condon and the gene encoding the pIII phage coat protein. These consisted of one having a low mutational frequency (˜1 bp change/template) and the other with a medium mutational frequency (˜2 bp changes/template). These libraries were combined to give a diversity of 1-2×10⁵.

Subcloning the Error-Prone PCR Library into Phage Fd-Myc

The strategy involved the PCR amplification of the error-prone PCR libraries from the pR2 phagemid vector followed by subcloning the amplified product into the phage Fd-Myc. The error-prone PCR libraries, in the pR2 phagemid in the E. coli host HB2151, were plated out to give confluent growth on large plates (22×22 cm). The estimated total number of colonies was 10⁷-10⁸, ensuring that the diversity of the error-prone libraries was well covered. The colonies were scraped from the plates and the DNA of the phagemid library subsequently isolated. The isolated phagemid DNA library was used as the template for PCR amplification of the error-prone library.

The library was PCR amplified using synthetic oligonucleotide primers that contained the restriction sites ApaL 1 and Not 1. Thus facilitating subcloning of the amplified products into the corresponding sites in phage Fd-Myc.

V_{H} Fd-Myc PCR Primers:

(SEQ ID NO:61)

5′ GAG CGC CGT GCA CAG GTG CAG CTG TTG 3′

(SEQ ID NO:62)

5′ GAG TCG ACT TGC GGC CGC GCT CGA GAC GGT GAC 3′
Vκ Fd-Myc PCR Primers:

(SEQ ID NO:63)

5′ GAG CGC CGT GCA CAG ATC CAG ATG ACC CAG TCT
CC 3′

(SEQ ID NO:64)

5′ GAG TCG ACT TGC GGC CGC CCG TTT GAT TTC CAC
CTT GG 3′

Restriction sites ApaL 1 (GTGCAC) and Not 1 (GCGGCCGC) are underlined. The primers were biotinylated at the 5′ terminus. Incorporating the ApaL1 site into nucleic acids encoding V_{H} or Vκ causes the first amino acid of both V_{H} and Vκ to become a glutamine.

The PCR products of the amplified library were purified from an agarose gel and then restriction enzyme digested with ApaL 1 and Not 1. The digested product was purified by phenol/chloroform extraction, treated with streptavidin DYNABEADS (superparamagnetic monodisperse polymer beads; Dynal Biotech) to remove cut 5′ ends and undigested product, and then subjected to QIAQUICK PCR purification kit (Qiagen). The product was ligated into the ApaL 1/Not 1 sites in phage Fd-Myc and transformed into E. coli TG1 giving a library size of 10⁶-10⁷.

### Section 2: Library 3.25G

### Construction of Fd-myc Vector

The Fd-myc vector was assembled from Fd-tet-Dog1 (McCafferty et al. (Nature) 1989) by cutting the vector at ApaL1 and Not1, and ligating a synthetic double-stranded DNA cassette composed of 5′-end phosphorylated oligos LJ1012 and LJ1013 (SEQ ID NO:65 and SEQ ID NO:66, respectively) which encode a myc tag and a trypsin cleavage site. The resulting vector Fd-myc is very similar to Fd-Tet-Dog1 in that ApaL1 and Not1 sits are present for the cloning of insert in between the leader sequence and gene M. The additional feature is the presence of a myc-tag in between the Not1 site and gene II which allows for immunological detection of encoded gene III fusion protein, and also allows bound phage (e.g., selected using anti-myc antibody) to be eluted by digestion with trypsin since there is a trypsin cleavage site in the myc-tag.

LJ1012:

(SEQ ID NO:65)

P-TGCACAGGTCCACTGCAGGAGGCGGCCGCAGAACAAAAACTCATCTCA
GAAGAGGATCTGAATTC
LJ1013:

(SEQ ID NO:66)

P-GGCCGAATTCAGATCCTCTTCTGAGATGAGTTTTTGTTCTGCGGCCGC
GAGGACGTCACCTGCTG

### Preparation of the 3.25G Insert and Ligation

Eleven PCRs using the ligated DNAs of libraries pR3-7781, pR3-7782, pR3-7783, pR3-7784, pR3-7785, pR3-7786, pR3-7787, pR3-7788, pR3-7789, pR3-77890 or pR3-7791 as template were performed. These libraries are based on V_{H}-DP47 and contain diversified CDR1, CDR2, and CDR3 (CDR3 varying from 10 to 20 amino acids in length). The PCRs were performed on each sub-library using primers LJ1011 and LJ1027, to append an ApaL1 site at the 5′-end and a Not1 site at the 3′-end. The resulting amplified fragments were purified, digested consecutively with ApaL1 and with Not1, re-purified and then ligated into the corresponding sites of Fd-myc.

| | |
|---|---|
| LJ1011: | |
| GAGTCGACTTGCGGCCGCGCTCGAGACGGTGACCAG | (SEQ ID NO:67) |
| LJ1027: | |
| GAGCGCCGTGCACAGGTGCAGCTGTTGGAGTCTGGG | (SEQ ID NO:68) |

### Electroporation of Library 3.25G and Storage

After purification, the 11 ligations were pooled and electro-transformed into E. coli TG1 cells. After electroporation, the cells were resuspended in 2×TY and incubated for 1 hour at 37° C. for phenotypic expression. The resulting library was then plated on TYE plates supplemented with 15 μg/ml tetracycline for overnight growth, and an aliquot was taken for titration on TYE plates supplemented with 15 μg/ml tetracycline. The size of the library was 1.6×10⁹ clones. Aliquots of the library were prepared by resuspending the bacteria at an OD600 of 40, diluting with an equivalent volume of glycerol (final OD600=20), and aliquoting as 1 ml samples that were frozen and stored at −80° C. until use.

### Phage Production and Purification

A 1 ml sample of library 3.25G was thawed and used to inoculate 500 ml of 2×TY supplemented with 15 μg/ml of tetracycline, in a 2.5 L shaker flask. The culture was incubated for 20 hours at 30° C. for phage production. The cells were pelleted by centrifugation at 5,500 g for 15 min to remove bacteria. To precipitate phage, 90 ml PEG/NaCl (20% Polyethylene glycol 8000 [Sigma; formally sold as PEG 6000], 2.5 M NaCl) were added to 450 ml of culture supernatant, and after mixing, the solution was incubated for 1 hour on ice. Phage were collected from the resulting mile by centrifugation at 5,500 g for 30 min at 4PC. The supernatant was discarded, the tubes were re-centrifuged briefly, and the remaining PEG/NaCl was carefully removed. The pellet was resuspended in 10 ml of PBS, centrifuged at 3,300 g for 15 min to remove remaining bacteria, and then filtrated through a 0.45 μm disposable filter. Phage titer was estimated by spectroscopy: a 100 dilution in PBS was prepared and the absorbance at 260 nm is measured. The phage titer (in TU per ml) was calculated using the formula: OD26×10¹³×2.214. The phage were stored at −20° C. after adding 10-15% glycerol (final concentration).

### Section 3: Phage Selection

### Coating/Blocking of Immunotube

Immunotubes (Nunc) were coated overnight (about 18 hours) at room temperature with either 4 ml of PBS containing 10 μg/ml of protein A, or 4 ml of PBS containing 10 μg/ml of protein L. In the morning, the solutions were discarded and the tubes were blocked with PBS supplemented with 2% v/v TWEEN 20 (Polyoxyethylensorbitan monolaurate; for protein A-coated immunotubes) or 2% w/v BSA (for protein L-coated immunotubes). The tubes were incubated for t hour at 37° C., then washed three times with PENS, before use for phage selection.

### Heat Unfolding and Refolding of Fd-phage Displayed Polypeptides

Approximately 5×10¹⁰ TU of domain antibody phage library was diluted into 200 μl of PBS, and aliquoted in two tin-walled PCR tubes. The tubes were then placed in a PCR apparatus for heating at 80° C. for 10 minutes (temperature of covet lid: 85° C.). After heating, the solutions were rapidly cooled down to 4° C. in the PCR apparatus to produce refolded phage solutions.

### Selection of Refolded Fd-Phage Displayed Polypeptides

The refolded phage solutions were pooled and added to 4 ml of PBS supplemented with either 2% v/v TWEEN 20 (Polyoxyethylensorbitan monolaurate; for selection on protein A) or 2% w/v BSA (for selection on protein L). The resulting phage solutions were added to Immunotubes coated with protein A or Immunotubes coated with protein L, after sealing the tubes were rotated end-over-end 30 min at room temperate, and then held on the bench at room temperature for 1.5 hours. Unbound phage were removed by washing the tubes ten times with PBS supplemented with 0.1% TWEEN 20 (Polyoxyethylensorbitan monolaurate), and ten times with PBS. Bound phage were eluted by adding 1 ml of PBS supplemented with trypsin (1 mg/ml) and incubating for 10-IS min while gently rotating. The solution containing the eluted phage was then transferred to a fresh microcentrifuge tube and stored on ice.

E. coli Infection of Selected fd-Phage

From an overnight culture of E. coli TG1 cells in 2×TY at 37° C., a 100-fold dilution was prepared in 25 ml of fresh 2×TY medium, and the culture was incubated at 37° C. with shaking (250 rpm) until the optical density at 600 nm (OD₆₀₀) was 0.5-0.7 (mid-log phase). Ten milliliters of this culture was then incubated with 500 ti of the eluted phage sample (the remaining 500 μl were kept at 4 C.) at 37° C. for 30 min without shaking to allow for phage infection. After phage infection, a 100 μl aliquot was taken for titration of the phage: 10 μl of a 1:10² dilution and 10 μl of a 1:10⁴ dilution in 2×TY were spotted on TYE plates containing 15 μg/ml tetracycline and grown overnight at 37° C. The titre was determined by multiplying the number of colonies by the dilution factor (i.e., 100 or 10,000) then multiplying by 1000 (10 μl spotted from 10 ml infected culture), to gives the titre for 500 μl of eluted phage. The total number of eluted phage was determined by multiplying by 2 (1 ml total eluate). The remaining infected E. coli TG1 culture (9.9 ml) was transferred to a disposable 14 ml tube, and centrifuged at 3,300 g in for 10 min. The cell pellet was resuspended in 2 ml of fresh 2×TY, plated on a large 22 cm² dish containing TYE, 15 μg/ml tetracycline, and incubated overnight at 37° C.

Amplification of Selected fd-Phage Vectors

The next day, 10 ml of 2×TY supplemented with 15% glycerol were added to the 22 cm² dish, the cells were loosened using a glass spreader, and the resulting mixture was transferred to a fresh 50 ml disposable tube. Fifty microliters of the cell suspension were then used to inoculate 100 ml of 2×TY containing 15 μg/ml tetracycline, whilst 1 ml of bacterial suspension was diluted with 1 ml sterile glycerol and stored at −70° C. The 100 ml culture was grown with shaking at 37° C. overnight,

Purification of Selected fd-Phage Vectors

The next day, the 100 ml overnight culture was centrifuged at 3,300 g for 15 min to remove bacteria. The supernatant was filtered through a 0.45 um disposable filter. To precipitate phage, 20 ml PEG/NaCl (20% Polyethylene glycol 8000; Sigma [formally sold as PEG 6000], 2.5 M NaCl) was added to 80 ml of supernatant, and after mixing, the solution was incubated for 1 hour on ice. Phage were collected from the resulting mixture by centrifugation at 3,300 g for 30 min at 4° C. The supernatant was discarded, the tubes were re-centrifuged briefly, and the remaining PEG/NaCl was carefully removed. The pellet was resuspended in 1 ml of PBS, then transferred to a fresh micro-centrifuge tube. Remaining bacterial debris were removed by centrifuging the microcentrifuge tube at 11,600 g for 10 min. The supernatent was transferred to a fresh micro-centrifuge tube, and stored at 4° C., until the next selection round. Phage titer was estimated by spectroscopy: a 100-dilution in PBS was prepared and the absorbance at 260 nm was measured. The phage titer (in TU per ml) was calculated using the formula: OD₂₆₀×10¹³×2.214.

### Results

Using this protocol and 3.25G phage library (Section 2), three rounds of selection for binding to protein A-coated immunotubes were conducted. After round 1, the phage titer was below 10⁷ TU, whilst after the third selection round, the phage titer bad risen to be greater than 10⁹ TU. A sample of the bacterial suspension obtained from phage amplification after round 3, was serially diluted (10-fold series) and plated on TYE plates supplemented with 15 μg/ml tetracycline. After overnight incubation at 37° C., individual colonies were picked for screening (see section 4).

Using this protocol and EP-V_{H} phage library (Section 1), three selection rounds (for protein A binding) were performed to produce a high titer preparation. A sample of the bacterial suspension obtained from phage amplification after round 3, was serially diluted (10-fold series) and plated on TYE plates supplemented with 15 μg/ml tetracycline. After overnight incubation at 37° C., individual colonies were picked for screening (see section 4).

Using this protocol and EP-Vκ phage library (Section 2), three selection rounds (for protein L binding) were performed to produce a high titer preparation. A sample of the bacterial suspension obtained from phage amplification after round 3, was serially diluted (10-fold series) and plated on TYE plates supplemented with 15 μg/ml tetracycline. After overnight incubation at 37° C., individual colonies were picked for screening (see section 4).

### Section 4: Phage Screening 1

### Growing Phage Clones and Preparation

A 96-well culture plate (flat bottom, with evaporation lid, Corning) was used for individual phage growth: each well was filled with 175 μl of 2×TY containing 15 μg/ml tetracycline, and inoculated with a single colony from the selected bacterial clones obtained using the Phage Selection protocol. The plate was incubated overnight (about 18 hours) with shaking at 37° C. The next day, the cells were pelleted by plate centrifugation for 20 min at 2,000 rpm at room temperature. One hundred microliters (100 μl) of each culture supernatant (containing the phage) were transferred to a fresh 96-well culture plate.

To facilitate detection of bound phage by ELISA, phage were chemically derivatized with a biotinylated reagent. This procedure allowed bound phage to be detected using a conjugate of streptavidin and horseradish peroxydase (Str-HRP, Sigma). This strategy was chosen to decrease the possibility of cross reactivity between antibodies used to detect bound phage and immobilized protein A or protein L in the wells. Thus, each 100 μl sample of culture supernatant was reacted with 100 μl of PBS containing a 500 μM concentration of EZ-link Sulfo-NHS biotin (Perbio), for 1 hour at room temperature (with medium agitation on a rotating plate).

### Phage Thermodenaturation (Heat Induced Unfolding of Phage Displayed Polypeptide)

After biotinylation of the phage, 80 μl of each 200 μl sample was transferred to a THERMOWELL 96-well plate (Costar). This step was repeated with another 96-well THERMOWELL 96-well plate (Costar). The first plate was covered with a lid and placed in a PCR apparatus for incubation at 80° C. during 10 min (temperature of cover lid: 85° C.). After heating, the plate was rapidly cooled down to 4° C. in the PCR apparatus. The second plate was kept on ice. Both plates were then treated in parallel: to each well (containing 80 μl of heated or non-heated phage supernatant), 20 μl of PBS supplemented with 10% v/v TWEEN 20 (Polyoxyethylensorbitan monolaurate; for protein A-based ELISA) or 10% w/v BSA (for protein L-based ELISA) was added and mixed. The samples were then assayed by ELISA.

### Coating and Blocking of ELISA Plates

MAXSORB 96-well plates (Nunc) were coated overnight (about 18 hours) at room temperature with either 100 μl of PBS containing 10 μg/ml of protein A, or 100 μl of PBS containing 10 μg/ml of protein L, per individual well. The next day, the plates were emptied, and the wells were blocked with 200 μl of PBS supplemented with 2% v/v TWEEN 20 (Polyoxyethylensorbitan monolaurate; for protein A-coated wells) or 2% w/v BSA (for protein L-coated wells). The plates are incubated for 1 h at 37° C., thien washed three times with PBS, before use for screening.

### Phage ELISA

Heat treated or control phage samples were transferred to the empty wells of coated/blocked ELISA plates, and incubated for 2 hours at room temperature. Unbound phage was then removed by washing the wells 6-times with PBS. For detection, Str-HRP (from a 1 mg/ml stock in PBS) is diluted 1/2000 in PBS supplemented with 2% v/v TWEEN 20 (Polyoxyothylensoibitan monolautate; for protein A-based ELISA) or 2% w/v BSA (for protein L-based ELISA), and 100 μl of this solution was added to each ELISA well. After incubation for 1 hour at room temperature, the unbound Str-RRP was removed by washing the wells 6-times with PBS. For colorimetric reaction, a 10 mg/ml solution of TMB (tetramethylbenzidine) was diluted 100-fold in a buffer of 0.1 M sodium acetate, pH 6.0. Next, hydrogen peroxyde was added (0.4 μl per ml of buffer/TMB), and 100 μl of the resulting solution was added to each ELISA well. After color (blue) had developed, the reaction was stopped by adding 50 μl of 1 M sulfuric acid per well (color turns to yellow). The optical density or each well at 450 nm was measured.

### Results

The described method was used for screening phage in five separate studies:
Clones from the 3.25G phage library (Section 2) selected for refolding
Clones from the EP-V_{H} phage library (Section 1) selected for refolding
Clones from the EP-Vκ phage library (Section 1) selected for refolding
Clones from the ten mini-phage libraries in V_{H}-DP47d (Section 10)
Clones from the five mini-phage libraries in Vκ-DPK9d (Section 10)

For each screening, positive and negative controls were used in order to establish the % refolding range: thus for ELISA on protein A, negative control was phage displaying V_{H}-DP47, and positive control was phage displaying HEL4. As shown herein V_{H}-DP47 (also referred to as V_{H}-DP47 dummy) does not unfold reversibly when heated and cooled; while HEL4 (a single V_{H} that binds hen egg white lysozyme that was selected from a library based on a V_{H} 3 scaffold (DP47 germline+JH4 segment) with randomised CDR 1, 2 and 3) does unfold reversibly under these conditions. Thus for ELISA on protein L, negative control was phage displaying Vκ-DPK9 which does not unfold reversibly when heated and cooled, and positive control was phage displaying Vκ-DPK9-A50P (which was obtained after screening the EP Vκ library for Vκ domains that unfold reversibly when heated).

For each series of phage clones, the un-heated and the heat-treated phage were tested for binding in an ELISA. This approach provides a semi-quantitative measure of refoldability of the antibody polypeptide displayed on the phage. For example, if an un-heated phage clone produces an OD450 of say 1.5 by ELISA (1.45 when the value of the background using a blank supernatant is subtracted), and the same phage clone produces an OD450 of say 0.6 by ELISA (and 0.55 when the value of the background using a blank supernatant is subtracted) after heat treatment, then the “percentage refolding” (which is assimilated to the percentage of protein A-binding activity that remains after heating/cooling) of this particular clone is (0.55/1.45)*100=29.0%.

Phage clones which yielded significant % refolding were then submitted to DNA sequencing of the V_{H} gene or Vκ gene insert (see section 6). In addition, selected clones were submitted to a second ELISA (see section 7) to further quantify refolding.

### Section 5: Phage Screening 2

### Growing Phage Clones and Preparation

Fifty milliliter disposable tubes (Corning) were used for individual phage growth: each tube was filled with 11 ml of 2×TY containing 15 μg/ml tetracycline, and inoculated with a single colony from the selected bacterial clones obtained using the Phage Selection protocol (Section 3) or after Phage Screening 1 (Section 4). The tubes were incubated overnight (−18 hours) with shaking at 37° C. In the morning, the cells were pelleted by centrifugation for 20 min at 3,300 g at 4° C. to remove bacteria. The supernatant was filtered through a 0.45 um disposable filter. To precipitate phage, 2 ml PEG/NaCl (20% Polyethylene glycol 8000 [Sigma; formally sold as PEG 6000], 2.5 M NaCl) was added to 80 ml supernatant, and after mixing, the solution was incubated for 1 hour on ice. Phage were collected by centrifuging the resulting mixture at 3,300 g for 30 min at 4° C. The supernatant was discarded, the tubes were recentrifuged briefly, and the remaining PEG/NaCl was carefully removed. The pellet was resuspended in 0.2 ml of PBS, then transferred to a fresh micro-centrifuge tube. Remaining bacterial debris was removed by centrifuging the micro-centrifuge tube at 11,600 g for 10 min. The supernatant was transferred to a fresh micro-centrifuge tube, and stored on ice. Phage titer was estimated by spectroscopy: a 100-dilution in PBS was prepared and the absorbance at 260 nm was measured. The phage titer (in TU per ml) was calculated with the formula: OD₂₆₀×10¹³×2.214.

To facilitate detection of bound phage by ELISA, phage were chemically derivatized with a biotinylated reagent. This procedure allowed bound phage to be detected using a conjugate of streptavidin and horseradish peroxydase (Str-HRP, Sigma). This strategy was chosen to decrease the possibility of cross reactivity between antibodies used to detect bound phage and immobilized protein A or protein L in the wells. Thus, 4×10¹⁰ TU phage in 100 μl of PBS was reacted with 100 μl of PBS containing a 50 μM concentration of EZ-link Sulfo-NHS biotin (Perbio), for 1 hour at room temperature (with medium agitation on a rotating plate) or overnight at 4° C.

### Phage Thermodenaturation (Heat Induced Unfolding of Phage Displayed Polypeptide)

After biotinylation of the phage, for each clone, a 100 μl sample of phage was transferred to a thin-wall PCR tube (and the remaining biotinylated phage was kept on ice). The tube was placed in a PCR apparatus for incubation at 80° C. during 10 min (temperature of cover lid: 85° C.). After heating, the tube was rapidly cooled down to 4° C. in the PCR apparatus. Both tubes (heated sample and sample kept on ice) were then treated in parallel: first eight 4-fold dilutions were prepared for both heat-treated and nonheat-treated samples of the same clone, in the appropriate buffer (PBS supplemented with 2% v/v TWEEN 20 (Polyoxyethylensorbitan monolaurate) for V_{H}-DP47 displaying phage; or PBS supplemented with 2% w/v BSA for Vκ-DPK9 displaying phage. Thus, in the tubes with the highest phage concentration, the titer was 10¹¹ TU per ml. The samples were then ready for assay by ELISA.

### Phage ELISA

ELISA plates were coated and blocked as described in Section 4. The samples were transferred to the empty wells of coated/blocked ELISA plates, and incubated for 2 hours at room temperature. Unbound phage was then removed by washing the wells 6-ties with PBS. For detection, Str-HRP (from a 1 mg/ml stock in PBS) were diluted 1/2000 in PBS supplemented with 2% v/v TWEEN 20 (Polyoxyethylensorbitan monolaurate; for protein A-based ELISA) or 2% w/v BSA (for protein L-based ELISA), and 100 μl of the resulting solution was added to each ELISA well. After incubation for 1 hour at room temperature, the unbound conjugate was removed by washing the wells 6-times with PBS. For colorimetric reaction, a 10 mg/ml solution of TMB (tetramethylbenzidine) was diluted 100-fold in a buffer of 0.1 M sodium acetate, pH 6.0. Next, hydrogen peroxyde was added (0.4 ul per ml of buffer/TMB, and 100 ul of this solution was added to each ELISA well. After color (blue) developed, the reaction was stopped by adding 50 μl of 1 M sulfuric acid per well (color turns to yellow). The optical density was recorded at 450 nm.

### Results

This method was used for screening clones in five experiments:

Clones with individual or multiple amino acid mutations in V_{H}-DP47;
Clones with individual or multiple amino acid mutations in V_{H}-DPK9;
Clones such as DP47, BSA1, HEL4, pAC (13, 36, 47, 59, 76, 85), V_{H}-DPK9; and
A subset of clones from the ten mini-phage libraries in V_{H}-DP47, that showed promising % refolding.

BSA1 is a single V_{H} Cat binds bovine serum albumin and does not unfold reversibly when heated and cooled, that was selected from a library based on a V_{H} 3 scaffold (P47 germline+JH4 segment) with randomised CDRs 1, 2 and 3.

For each screening, positive and negative controls were used in order to establish the % refolding range: thus for ELISA on protein A, negative control was phage displaying V_{H}-DP47, and positive control was phage displaying HEL4. Thus for ELISA on protein L, negative control was phage displaying Vκ-DPK9, and positive control was phage displaying Vκ-DPK9-A50P.

The scoring was done as follows: for each clone, the phage were tested as un-heated sample and as heat-treated sample in an eight-point dilution series. This approach permitted quantitative deductions about the refoldability of the domain antibody displayed on phage to be made. Thus, the OD450 were plotted onto a semilog graph (on the X-axis, concentration of phage (in TU) per well according to a semi-log scale; on the Y-axis, OD450 observed at each phage concentration), and linked together by simple linear interpolation between each data points.

The percent refolding was calculated as illustrated in the following example. For each clone, the phage concentration that produced a particular OD450 (e.g., 0.2) was calculated (one value for the phage concentration of the non-treated sample, and one value for the heat-treated sample). Assume the concentration that produced that OD450 was 2×10⁸ for the non-treated phage, and 5×10⁹ for the heat-treated phage.

The percent refolding would then be calculated using the formula: (2×10⁸/5×10⁹)*100=4% refolding. Using this system, we repeatedly observed a percent refolding of approx 0.5% for V_{H}-DP47 on phage, and about 18% refolding for phage displaying HEL4.

### Section 6: DNA Sequencing

DNAs encoding variable domains from selected clones that display reversible heat unfolding were sequenced as follows:

PCR reaction mix:

5 μl 10× Buffer

1 μl Primer LU212 (20 pmol/ul)

1 μl Primer LU006 (20 pmol/ul)

1 μl 20 mM dNTPs

0.5 μl Taq DNA polymerase

41.5 μl H20

50 μl of the PCR reaction mix was aliquoted into each well of a 96 well PCR microplate. A colony (Fd-Myc/TG1) was gently touched with a sterile toothpick and transferred into the PCR mix. The toothpick was twisted about 5 times in the mixture. The mix was overlayed with mineral oil. The PCR parameters were: 94° C. for 10 min, followed by 30 cycles of: 94° C. 30 sec, 50° C. 30 sec, 72° C. 45 sec; and a final incubation at 72° C. 5 min. The amplified samples were purified using a QIAQUICK PCR product purification kit (Qiagen). Sequencing as carried out using either of the original PCR primers (LJ212 and/or LJ006).

Mutations that were detected in the sequencing of clones that encode immunoglobulin variable domains that unfold reversibly are presented in Tables 3 and 4.

| | |
|---|---|
| Primer Sequences: | |
| LJ006 | |
| 5′ ATGGTTGTTGTCATTGTCGGCGCA 3′ | (SEQ ID NO:69) |
| LJ212 | |
| 5′ ATGAGGTTTTGCTAAACAACTTTC 3′ | (SEQ ID NO:70) |

### Section 7: List of Selected EP V_{H}

TABLE 3
Mutations Found in Clones From EP-V_{H} Library
Selected for Reversible Heat Unfolding

| | | Elisa |
|---|---|---|
| Mutation | Frequency | Signal* |
| Y32D | 5 | m |
| S30N/A33D | 1 | H |
| S31N/A84D | 1 | m |
| V12E/A33P/G55D | 1 | m |
| A23V/F27S/G54D | 2 | m |
| F27S/A33D/T87S | 3 | m |
| S30G/G54D/A98D | 1 | m |
| M34L/G52aD/K94E | 1 | m |
| L11S/S30G/Y32D/T77M | 1 | m |
| S31N/S62P/E85D/ | 8 | 6m/2H |
| Y96N/W103G | | |

*m indicates medium ELISA signal and H indicates high ELISA signal.

TABLE 4
Frequency of Mutation in Clones From EP-V_{H} Library
Selected for Reversible Heat Unfolding

| Position of | Overall Frequency |
|---|---|
| mutation | of selection |
| 27 | 5 |
| 30 | 3 |
| 31 | 9 |
| 32 | 6 |
| 33 | 5 |
| 34 | 1 |

### Section 8: List of Selected BP Vκ

TABLE 5
Mutations Found in Clones From EP-Vκ Library Selected
for Reversible Heat Unfolding

| Mutation | Frequency |
|---|---|
| K45E | 1 |
| I48N | 2 |
| Y49N | 3 |
| Y49D | 4 |
| A50P | 1 |
| I75N | 4 |
| S31G/Y49N | 1 |
| Y32S/I75N | 1 |
| P40S/Y49D | 1 |
| K39/Y49N | 1 |
| K45E/I75N | 1 |
| L46P/A50D/W35G | 1 |
| S26N/K42T/A50D | 1 |
| Y32F/K45E/G57E | 1 |
| Y49D/P80A/Q89R | 1 |
| Y49N/G68E/Q79R | 1 |
| T20S/C23W/L46F/Y49N | 1 |
| I29V/K42N/K45E/F83L/ | 2 |
| Y92H | |

All clones selected gave a high ELISA signal.

TABLE 6
Frequency of Mutation in Clones From EP-Vₖ Library Selected for
Reversible Heat Unfolding

| Position of mutation | Overall Frequency of Selection |
|---|---|
| 45 | 5 |
| 48 | 2 |
| 49 | 13 |
| 50 | 2 |
| 75 | 6 |

### Section 9: List of Selected 3.25G V_{H}

After selecting library 3.25G with the heat/cool phage selection (see section 3), a large scale screening (see section 4) was performed to identify V_{H} clones that refolded when displayed on phage after thermodenaturation.

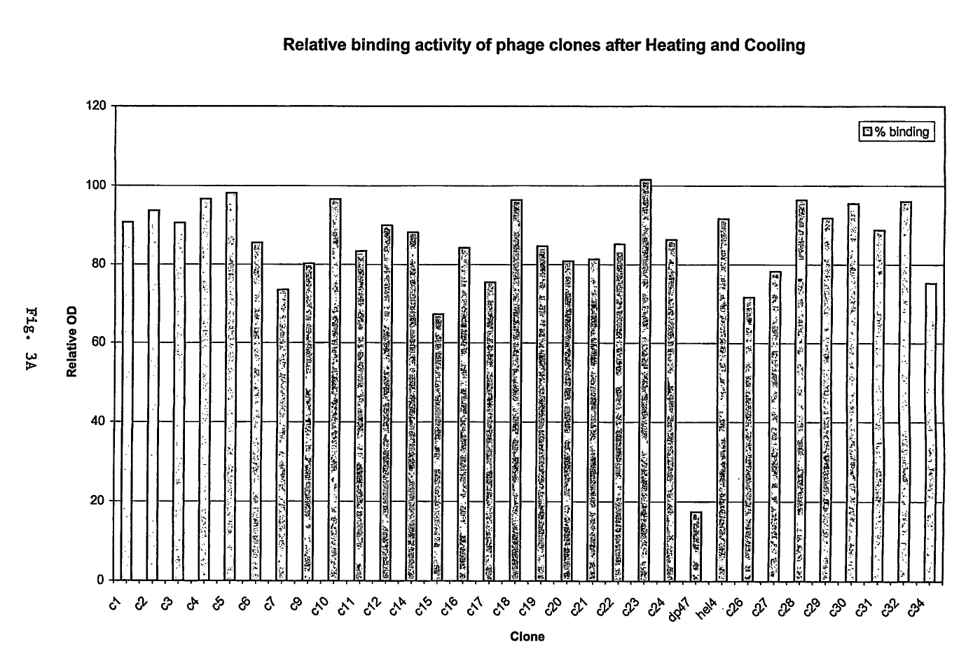

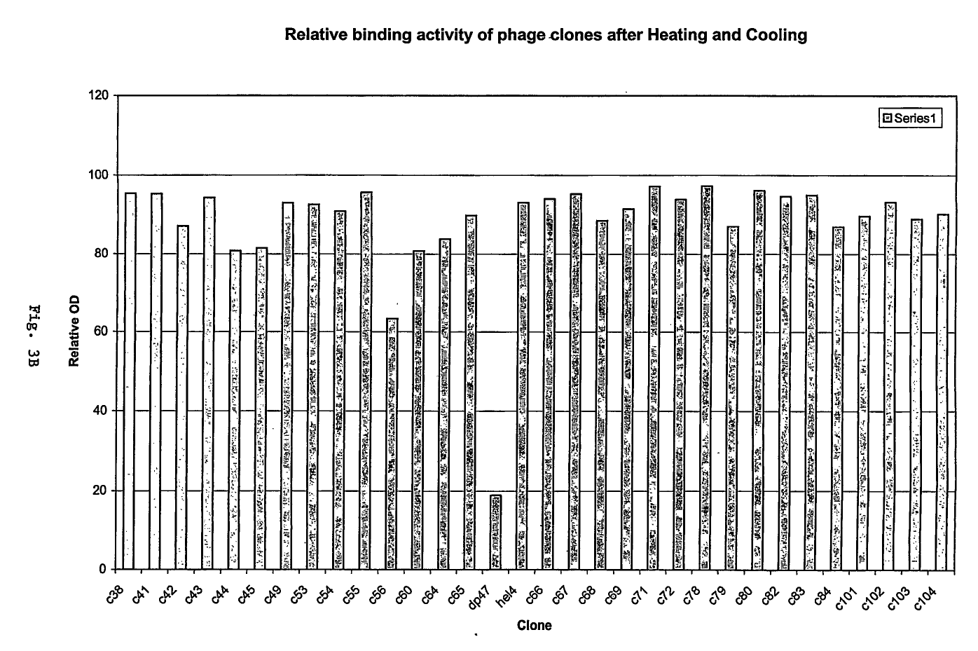

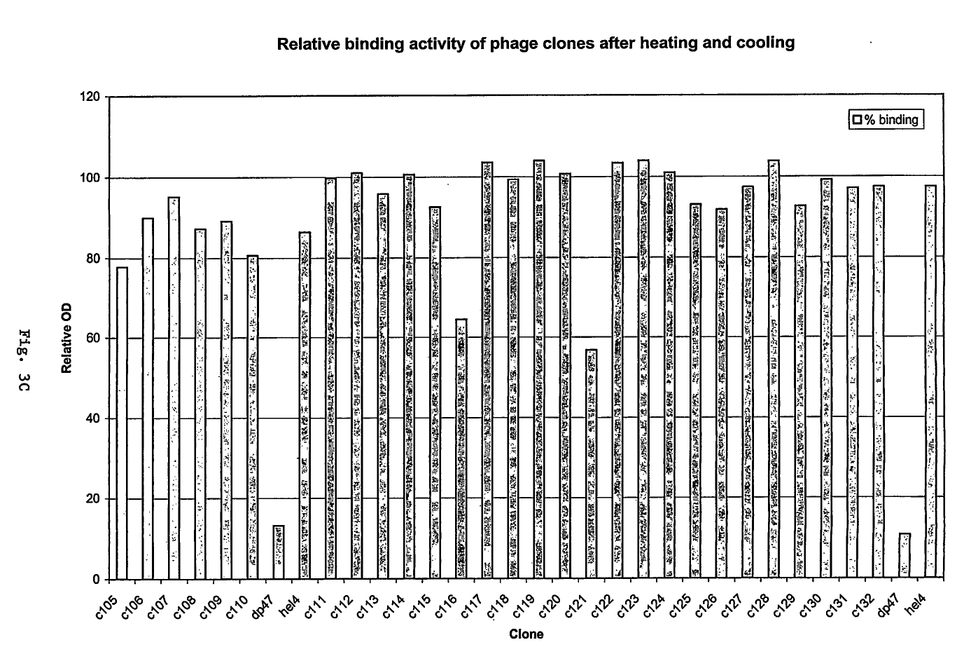

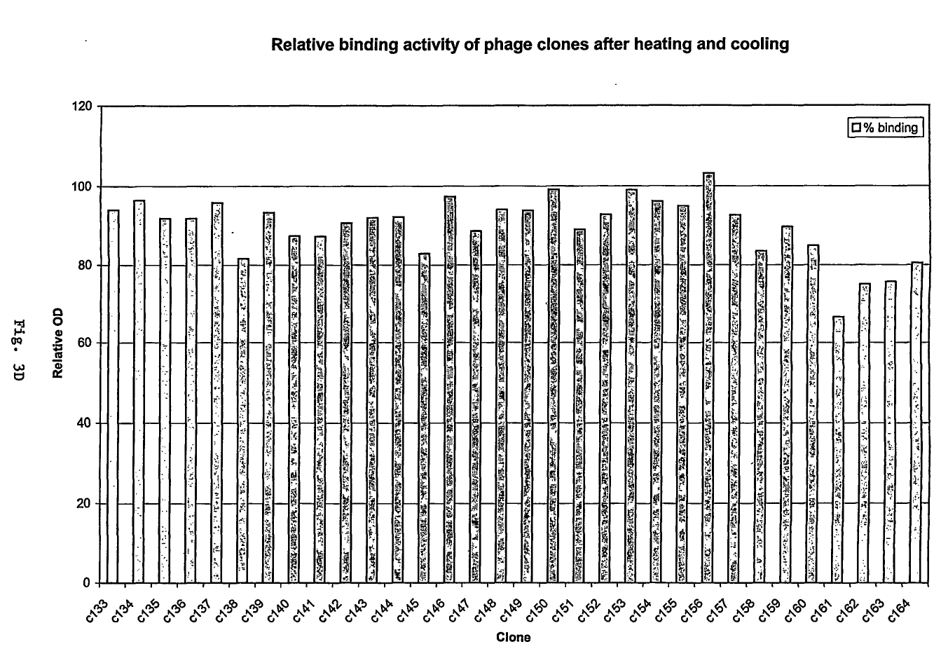

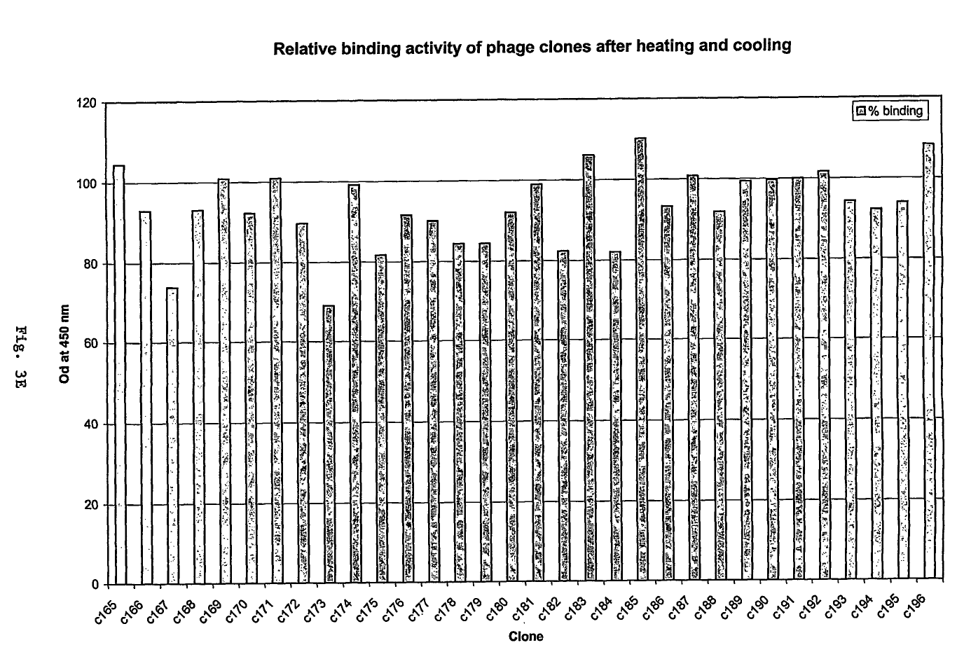

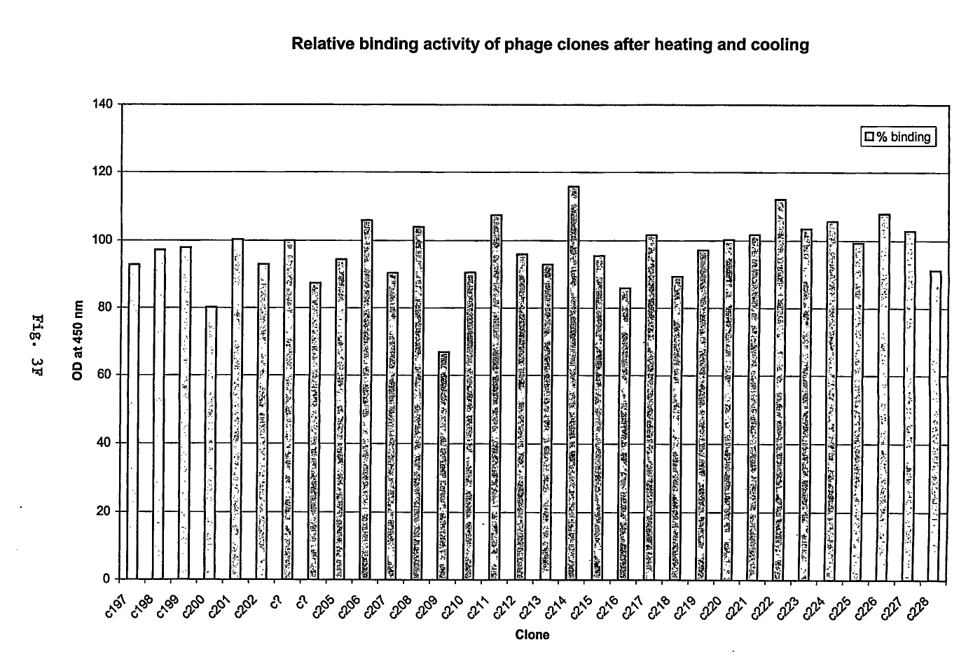

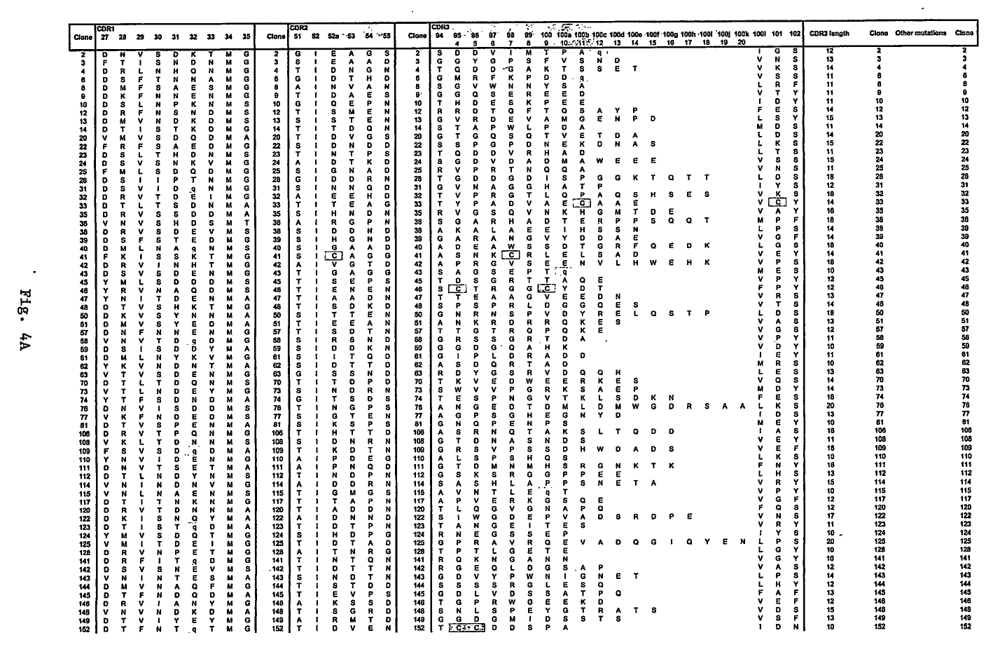

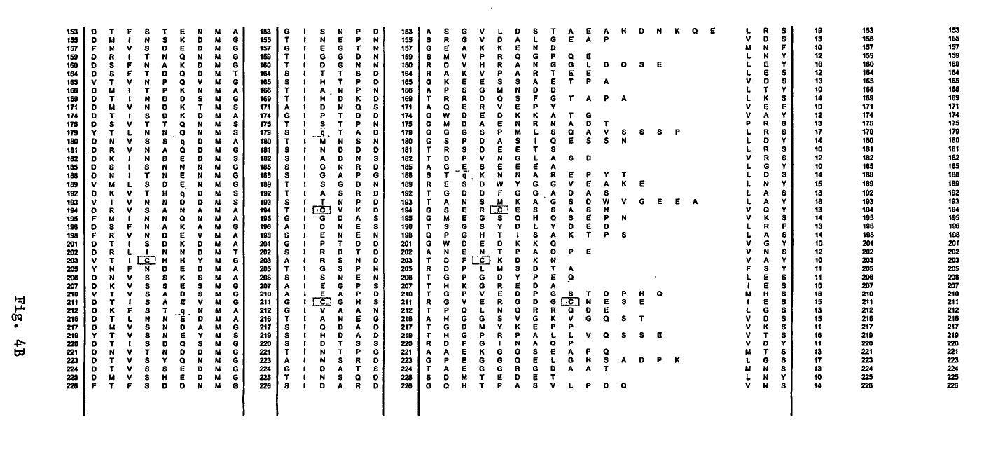

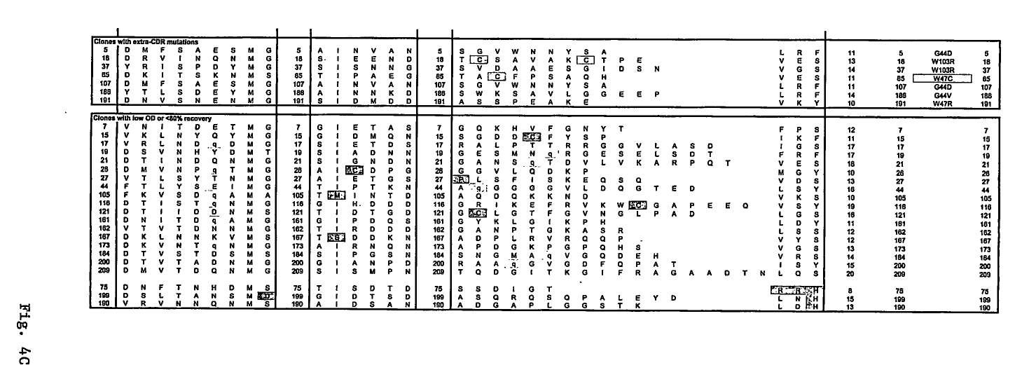

Clones were analyzed by assessing binding of heat treated and control phage to protein A in an ELISA as described herein. (FIGS. 3A-3F) Clones that had above 60% refolding were further analyzed by sequencing. FIGS. 4A-4C present the sequence of may of the clones that had above 60% refolding. The first set of sequences present in FIGS. 4A-4C are from clone giving a high OD450 in the ELISA and a high % refolding. These sequences do not contain cysteines. This group of sequences forms the dataset for the analysis of amino acid preferences at all positions of CDR1, CDR2 and CDR3.

The next set of sequences in FIGS. 4A-4C are from clones with excellent ELISA signals and good refolding. These clones contain mutations outside the CDRs.

The final group of sequences in FIGS. 4A-4C are from with relatively low ELISA signals and/or refolding.

From the sequences presented in FIGS. 4A-4C, six clones were selected and her analyzed in detail on phage (as displayed polypeptide) and as soluble proteins. The six clones selected are referred to as pA-C13, pA-36, pA-C47, pA-C59, pA-C76 and pA-C85. (Clones are identified in FIGS. 4A-4C using the suffix only, i.e., “pA-C13” is “C13.”)

In addition, individual mutants were designed into DP47 and analyzed for refolding on phage (as displayed polypeptide) as for some of these mutations, as soluble protein. The particular mutations were: F27D, P29V, F27D/F29V, Y32B, S35G, P27D/F29V/Y32D/S35G, S53P, G54D, S53P/G54D, W47R, F100nV, Y102S, F100nV/Y102S, W103R.

These clones were characterized for refoldability on phage (according to the protocol of Section 5, but with three data points being taken) and in solution. For the refolding in solution, thermodenaturation was followed by CD (Section 12). The results of these studies is presented in Table 7.

TABLE 7

| | Refoldability on phage | Refoldability |
|---|---|---|
| Clone | (%) | in solution* |
| HEL4 | 82 | Y |
| BSA1 | 0 | N |
| pA-C36 | 80 | Y |
| DP47d | 0 | N |
| F27D | 65 | Y |
| F29V | 35 | N |
| F27D/F29V | 62 | nd |
| S30N/A33D | 81 | N |
| Y32D | 75 | Y |
| S35G | 15 | N |
| F27D/F29V/Y32D/S35G | 80 | Y |
| W47R | 5 | N |
| S53P | 2 | nd |
| G54D | 22 | N |
| S53P/G54D | 19 | nd |
| F100nV | 2 | nd |
| Y102S | 4 | N |
| F100nV/Y102S | 2 | nd |
| W103R | 3 | N |

*Y indicates refoldablility in solution, N indicates that the variable domain was not refoldable in solution, nd = not determined

### Section 10: Mini-Library Protocol

The positions of amino acid substitutions found in clones from the temperature selected libraries (the Error-Prone and G3.25 libraries) were analysed so that the entire sequence space at that particular site could be investigated.

Error-prone PCR samples a limited sequence space. For example, the A50P substitution selected from the error-prone Vκ library that has a frequency of 1 bp change/template would sample only 6 additional amino acids in total. Alanine at position 50 is encoded by the codon GCT. Changing this codon by 1 base gives the following codon permutations and amino acids:

### Alanine=GCT, OCA, GCG, GCC

### Aspartate=GAT

### Glycine GGT

### Proline CCT

### Serine TCT

### Threomne ACT

### Valine OTT

Oligonucleotides randomized at a particular site by the codon NNK (N=A, G, C or T; K=G or T; M=A or C) were used in a PCR strategy to sample the entire sequence space (see Table 8). For Vκ a two-step PCR strategy was used. (See, Landt, O. et al. Gene 96:125-128 (1990)). The first PCR product (also referred to as “mega-primer”) was generated using the oligonucleotide carrying the NNK changes (see Tables 8 and 9) together with one of the forward or reverse Fd-Myc primers casing the ApaL 1 or Not 1 restriction site for subcloning into Fd-Myc as described previously:

Vκ Fd-Myc PCR Primers:

(SEQ ID NO:71)

5′ GAG CGC CGT GCA CAG ATC CAG ATG ACC CAG TCT
CC 3′

(SEQ ID NO:72)

5′ GAG TCG ACT TGC GGC CGC CCG TTT GAT TTC CAC CTT
GG 3′

Restriction sites ApaL 1 (GTGCAC) and Not 1 (GCGGCCGC) are underlined. The primers were biotinylated at the 5′ terminus. Incorporating the ApaL1 site causes the first amino acid of both V_{H} and Vκ to become a glutamine.

DPK9 was used as a DNA template. The first PCR product or mega-primer was subsequently used in a second PCR reaction together with the second Fd-Myc primer not used in the first reaction. This PCR gave a product containing Apal1/Not1 restriction sites suitable for subcloning into the respective sites in Fd-Myc.

For V_{H}, SOE PCR was employed. (See, Horton, R. M. et al. Gene 77:61-68 (1989)). The primers used to generate the substitution by SOB PCR are shown in the Table 9. The additional primers necessary for amplification of the mutagenised product and subsequent subcloning into the ApaL 1 and Not 1 sites in Fd-Myc are:

(SEQ ID NO:73)

5′ GAG CGC CGT GCA CAG GTG CAG CTG TTG 3′

(SEQ ID NO:74)

5′ GAG TCG ACT TGC GGC CGC GCT CGA GAC GGT GAC 3′

TABLE 8
Vκ Oligonucleotides containing the NNK codon

| Position of | |
|---|---|
| randomisation | 5′−>3′ Oligonucleotide sequence |
| in Vκ^{a} | containing the codon NNK |
| 45 | GCAGCATAGATCAGGAGKNNAGGGGCTTTCCCTGG |
| | (SEQ ID NO:75) |
| 48 | GCAAACTGGATGCAGCATAKNNCAGGAGCTTAGG |
| | (SEQ ID NO:76) |
| 49 | GCAAACTGGATGCAGCKNNGATCAGGAGCTTAGG |
| | (SEQ ID NO:77) |
| 50 | GCAAACTGGATGCKNNATAGATCAGGAGCTTAGG |
| | (SEQ ID NO:78) |
| 75 | TTCACTCTCACCNNKAGCAGTCTGCAACCTG |
| | (SEQ ID NO:79) |

^{a}Primers for positions 45, 48, 49 and 50 are to the reverse/antisense strand, hence the reversal of NNK to KNN, and were used in the first PCR reaction with the Vκ Fd-Myc primer designed to the coding strand containing the ApaL 1 site. Conversely, position 75 was designed to the coding strand and used with the antisense FD-Myc primer containing the Not 1 site.

TABLE 9
V_{H} Oligonucleotides for SOE PCR

| Position of | 5′−>3′ Oligonucleotide |
|---|---|
| randomisation in V_{H} | sequences for SOE PCR |
| 27 | (F) |
| | CCGGAGGCTGCACAGGAGAGACGCAGGG |
| | (SEQ ID NO:80) |
| | (R) |
| | CCCTGCGTCTCTCCTGTGCAGCCTCCGGANN |
| | KACCTTTAGCAGCTATGCCATG |
| | (SEQ ID NO:81) |
| 29 | (F) |
| | GAATCCGGAGGCTGCACAGGAGAGACGC |
| | (SEQ ID NO:82) |
| | (R) |
| | CTCTCCTGTGCAGCCTCCGGATTCACCNNKA |
| | GCAGCTATGCCATGAGCTGGGC |
| | (SEQ ID NO:83) |
| 30 | (F) |
| | GGCGGACCCAGCTCATGGCATAGCTMNNAAA |
| | GGTGAATCCGGAGGCTGCACAG |
| | (SEQ ID NO:84) |
| | (R) |
| | ATGCCATGAGCTGGGTCCGCCAGGCTC |
| | (SEQ ID NO:85) |
| 31 | (F) |
| | GGAGCCTGGCGGACCCAGCTCATGGCATAMN |
| | NGCTAAAGGTGAATCCGGAGGCTGCAC |
| | (SEQ ID NO:86) |
| | (R) |
| | ATGCCATGAGCTGGGTCCGCCAGGCTCCAG |
| | (SEQ ID NO:87) |
| 32 | (F) |
| | GCTAAAGGTGAATCCGGAGGCTGCACAG |
| | (SEQ ID NO:88) |
| | (R) |
| | GCAGCCTCCGGATTCACCTTTAGCAGCNNKG |
| | CCATGAGCTGGGTCCGCCAGGCTC |
| | (SEQ ID NO:89) |
| 33 | (F) |
| | AGCTGCTAAAGGTGAATCCGGAGGCTG |
| | (SEQ ID NO:90) |
| | (R) |
| | CCGGATTCACCTTTAGCAGCTATNNKATGAG |
| | CTGGGTCCGCCAGGCTCCAGG |
| | (SEQ ID NO:91) |
| 35 | (F) |
| | AGACCCTTCCCTGGAGCCTGGCGGACCCAMN |
| | NCATGGCATAGCTGCTAAAGGTGAATC |
| | (SEQ ID NO:92) |
| | (R) |
| | GGGTCCGCCAGGCTCCAGGGAAGGGTCTAG |
| | (SEQ ID NO:93) |
| 54 | (F) |
| | ACCACTAATAGCTGAGACCCACTCTA |
| | (SEQ ID NO:94) |
| | (R) |
| | AGAGTGGGTCTCAGCTATTAGTGGTAGTNNK |
| | GGTAGCACATACTACGCAGACTCCGTG |
| | (SEQ ID NO:95) |
| 84 | (F) |
| | CGCAGGCTGTTCATTTGCAGATACAGCG |
| | (SEQ ID NO:96) |
| | (R) |
| | GTATCTGCAAATGAACAGCCTGCGANNKGAG |
| | GACACCGCGGTATATTACTGTGCG |
| | (SEQ ID NO:97) |
| 85 | (F) |
| | GCACGCAGGCTGTTCATTTGCAGATA |
| | (SEQ ID NO:98) |
| | (R) |
| | CTGCAAATGAACAGCCTGCGTGCANNKGACA |
| | CCGCGGTATATTACTGTGCG |
| | (SEQ ID NO:99) |

Once assembled and digested, the PCR fragments were ligated into the ApaL1 and Not1 sites of Fd-myc. The ligated DNA was used to transform E. coli TG1 cells by electroporation. After one hour of phenotypic expression at 37° C., the cells were plated on TYE plates supplemented with 15 ug/ml of tetracycline.

For the screening of the mini-libraries, cultures were made in 96-well cell culture plates as described in Section 4. For the appropriate controls, three wells (usually A1, D6 and H11) were inoculated with a positive control phage (e.g. Fd-myc-HEL4) and three wells were inoculated with a negative control phage (e.g. Fd-myc-DP47d). The remaining 90 wells were inoculated with 90 different clones from a mini-library. This plate preparation procedure was repeated with each mini-library.

The use of 90 clones from each mini-library is sufficient to cover the encoded diversity. Indeed, since a NNK codon was used to diversify each position, there are 32 different codons possible. The screening of 90 clones ensures that there is over 90% chance that every possible codon (and hence amino acid) will be present at least once in the screened mini-library. This ensures that the screening covers all possible amino acid substitutions at the explored (randomized) positions. The procedures for biotinylation of phage, and detection/selection by ELISA are described in Section 4,

Several phage were obtained from the V_{H}-mini libraries that showed good refolding. These phage were then subjected to the Phage Screening 2 procedure (Section 5) to obtain mote quantitative data on the refolding.

Section 11: Subcloning, Expression and Purification of dAbs

### Subcloning

Selected substitutions were subcloned into an expression plasmid for expression in E. coli BL21(E3)(pLysS). DNA from selected Pd-Myc phage clones was amplified by PCR using primers containing Sal 1 and BamH 1 restriction sites.

The protocol was essentially as that described for DNA sequencing, isolating V_{H} or Vκ DNA from Fd-Myc/TG1 colonies by PCR. The primers used are shown in Table 10. The forward primers introduced an additional two amino acids (Ser and Thr) to the N-terminus. This is a result of creating a Sal 1 restriction site. The reverse primers were designed to have two consecutive stop codons (TAA) at the end of the coding region.

TABLE 10
Oligonucleotide for Subcloning

| | |
|---|---|
| Primer | Sequence 5′ to 3′ |

| | |
|---|---|
| V_{H} forward (Sal 1) | ACGCGTCGACGCAGGTGCAGCTGTTGG |
| | (SEQ ID NO:100) |
| V_{H} reverse (BamH 1) | TTAGGATCCTTATTAGCTCGAGACGGTGACC |
| | AG |
| | (SEQ ID NO:101) |
| Vκ forward (Sal 1) | ACGCGTCGACGCAGATCCAGATGACCCAG |
| | (SEQ ID NO:102) |
| Vκ reverse (BamH 1) | TTAGGATCCTTATTACCGTTTGATTTCCACC |
| | TTGG |
| | (SEQ ID NO:103) |

### Expression and Purification

A colony, from freshly transformed E. coli strain BL21(DE3)pLysS containing the expression plasmid clone, was grown overnight in 2×TY (ampicillin/chloramphenicol) at 37° C., 250 rpm. A 1/100 aliquot of the overnight culture was then used to inoculate a larger volume of the same media and allowed to grow under the same conditions until the OD₆₀₀=0.9. 1 mM IPTG (isopropyl β,D-thiogalactisidase) was then added to the culture, and the culture allowed to grow overnight at 30° C., 250 rpm. The culture was then centrifuged at 3300 g for 20 min at 4° C. The supernatant was then filtered through a 0.45 μm filter.

Soluble V_{H} or Vκ dAb were then captured on a protein A or protein L matrix (protein A agarose or protein L agarose). Depending on the culture volume, the supernatant was either loaded directly onto a prepacked protein A or L matrix column, or the matrix was added directly to the supernatant (batch binding). Elution from batch binding can be accomplished directly from collected matrix, or the matrix can be packed into a suitable column. Elution from protein A or protein L matrix was carried out at low pH. The dabs can be further purified by gel filtration using Superdex75 (Amersham Pharmacia Biotech).

### Section 12: CD Analysis

Purified dabs were dialyzed overnight in PBS at 4° C., and concentrated (if needed) by centrifugation using Millipore 5K Molecular Weight Cut Off centrifugation concentrator tubes (at 20° C.). One and a half ml of dAb at 1-5 μM in PBS was transferred to a CD cuvette (1 cm pathlength) and introduced in the Jasco J-720 spectropolarimeter. Spectra at room temperature (25° C.) or at high temperature (85° C.) were recorded in the far-TV from 200 nm to 250 nm (four accumulations followed by averaging) at a scan speed of 12 nm min⁻¹, with a 2-nm bandwith and a 1 second integration time.

Heat-induced unfolding curves were recorded at fixed wavelength (usually 235 nm, sometimes at 225 nm) using a 2 nm bandwith. The temperature in the cuvette was raised at a rate of 50° C. per hour, from 25° C. to 85° C. Data were acquired with a reading frequency of 1/20 sec⁻¹, a 1 second integration time and a 2 nm bandwith. After unfolding, the sample was rapidly cooled down to 25° C. (15° C. mind⁻¹), a spectrum was recorded, and a new heat-induced unfolding curves was recorded.

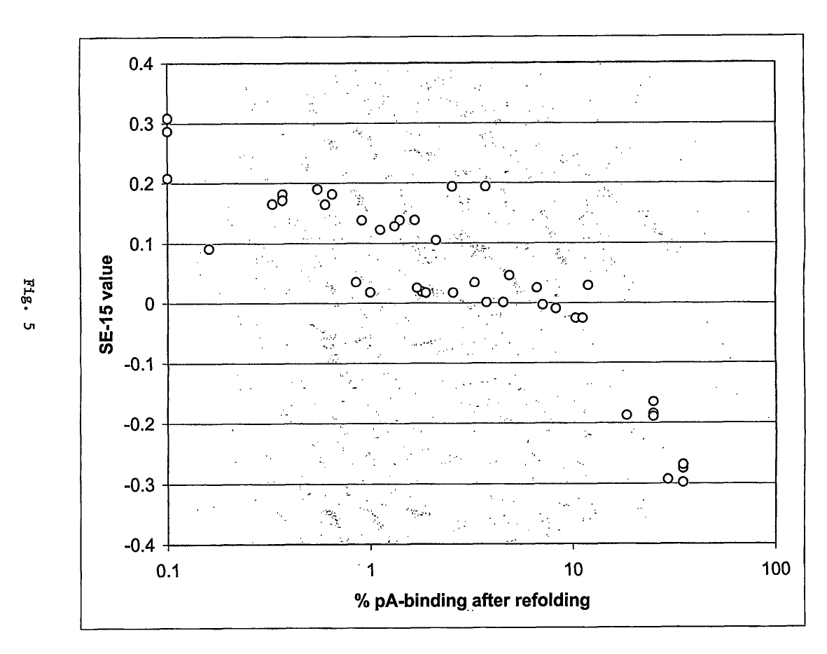

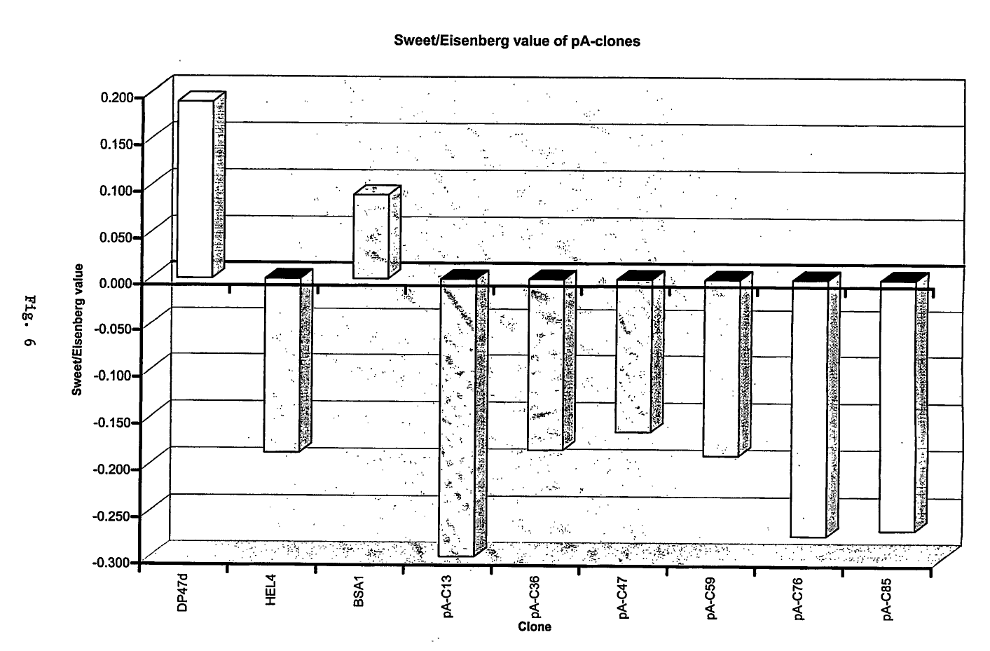

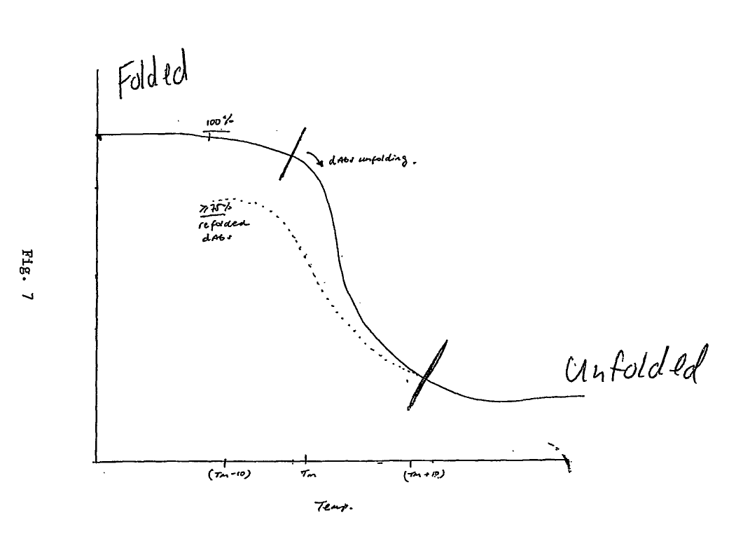

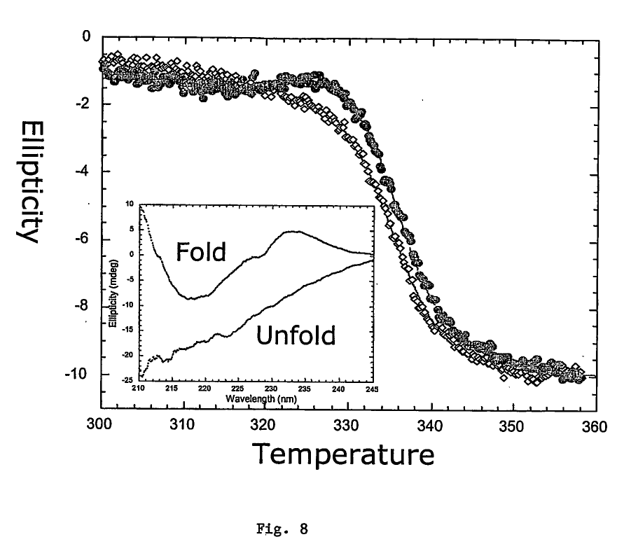

The ability of a dAb molecule to unfold reversibly following to heat-induced denaturation was evaluated by comparing the first and the second heat-induce unfolding curve. Super imposable first and second heat-induced unfolding curves indicate that the dAb underwent thermal-unfolding reversibly in PBS at 1-5 μM (e.g., pA-C36, pA-C47). The same holds true for the far-UV spectra: super imposable first and second spectra recorded at 25° C. indicated that the dAb unfolds reversibly (FIG. 8).

If a dAb aggregates upon thermal unfolding, the first unfolding curve is characterized by a steep transition upon melting and a “noisy” post-transition line (due to the accumulation of aggregates). Moreover, the second unfolding curve is radically different from the first one: a melting transition is barely detectable because no, or very few, unfolded molecules properly refold upon cooling the sample. As a result, the first and second far-UV spectra differ considerably, the latter being more akin to that observed using a denaturated molecule. A typical example of an aggregating dAb is DP47 dummy, or DP47-W47R (FIG. 9).

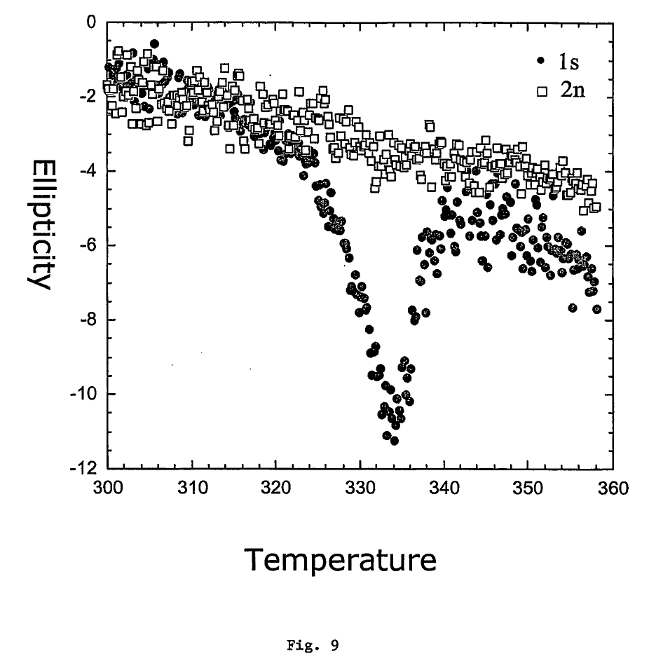

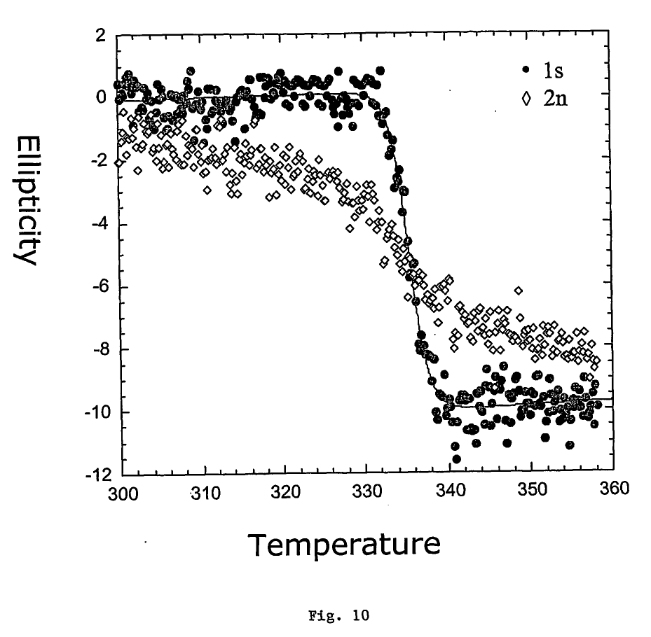

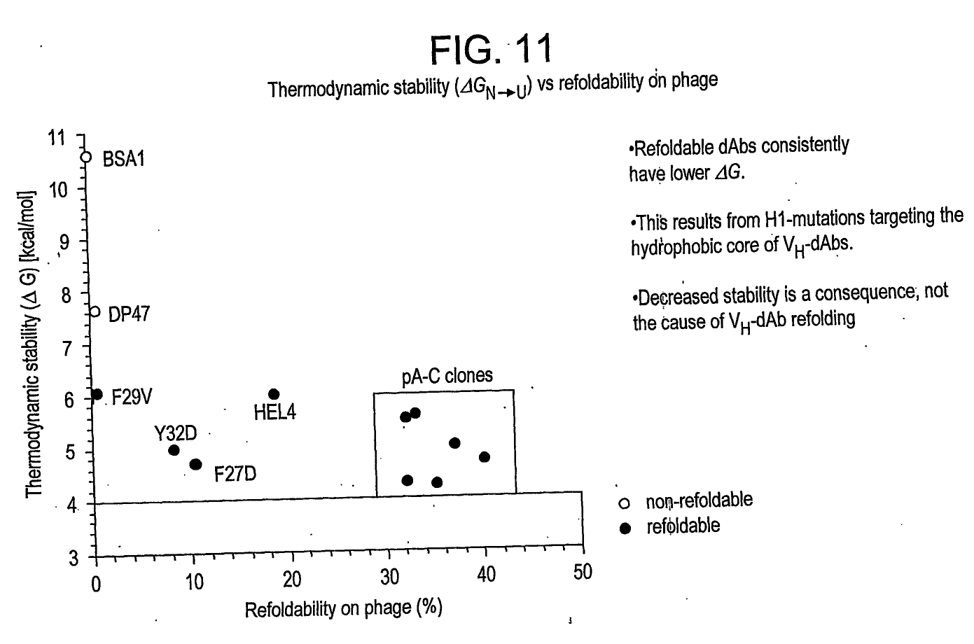

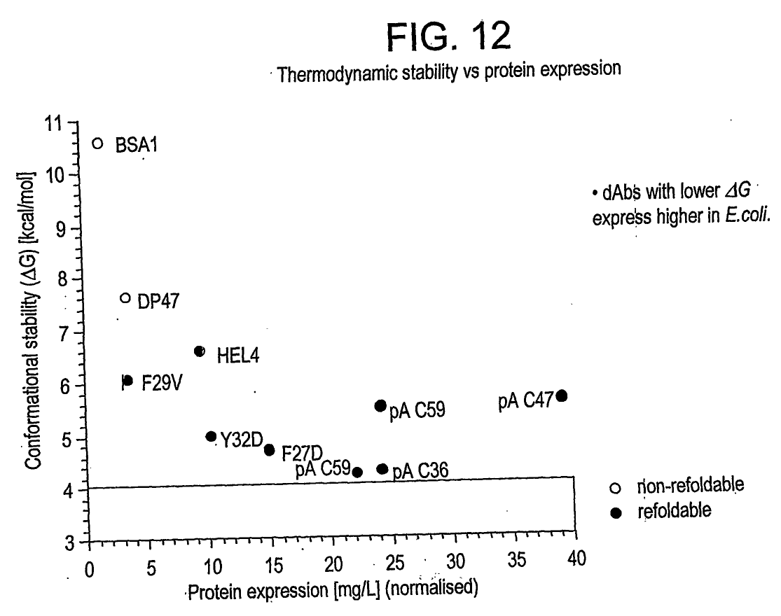

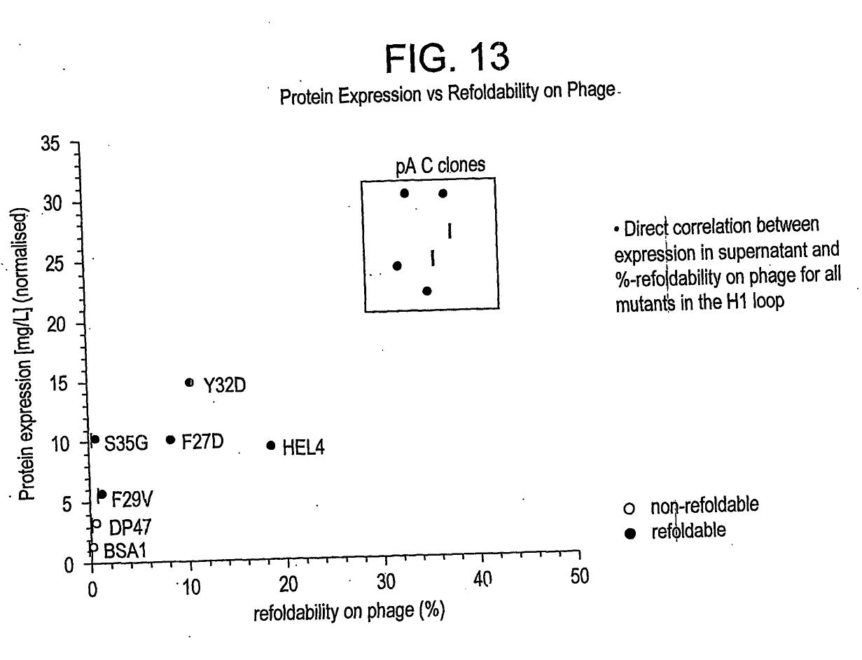

Some dabs do exhibit partial refolding at 1-5 μM (e.g., DP47-S35G): i.e., upon cooling, a proportion of the ellipticity (and hence a portion of the original secondary structure) is recovered, and a melting transition is observed upon re-heating the sample (FIG. 10). To calculate the percentage of refolding, the amount of ellipticity recovered after the first thermal denaturation is divided by the amount of ellipticity of the sample before the first thermal denaturation, and multiplied by 100.

Using this assay, the following isolated human Vκ dAbs were shown to undergo irreversible thermal unfolding: DP47 dummy, BSA1, DP47-F29V, DP47-W47R, DP47G54D, DP47-W103R.

Fully reversible unfolding was demonstrated with the following isolated human V_{H} dabs: HEL4, pAC:13, pA-C36, pA-C47, pAC59, pAC76, pA-C85, DP47-F27D, DP47-Y32D, DP47-P27D/F29V/Y32E/S35G. While DP47-S35G demonstrate reversible unfolding to a lesser degree.

### Section 13: Mini-Library in Vκ Results

Phage ELISA and scoring of the clones were done according to protocol of Section 4. DNA sequencing of selected clones that showed reversible heat unfolding was done according to protocol of Section 6.

TABLE 11
Mutations Found in Clones From Vκ Mini Library Selected
for Reversible Heat Unfolding

| | |
|---|---|
| I48 | 3P, 2D, 2T, 1G, 1N |
| Y49 | 5S, 1C, 1E, 1G, 1K, 1N, 1R |
| A50 | 3P, 2N, 1D, 1E |
| I75^{c} | 2N, 2M |

TABLE 12
Substitutions at Position 45 that Gave >70% Retention of Protein L
Binding Activity After Heat Treatment

| | Substitution Giving >70% Retention of Protein L |
|---|---|
| Position^{a} | Binding Activity After Heat Treatment^{b} |
| K45 | 4D, 2Q, 1P, 1N, 1H |

^{a}The single substitutions at K45E, I48N, Y49D/N, A50P and I75N were previously temperature selected from an error-prone phage display library (Section 1). Error-prone PCR samples a limited sequence space. Hence, these sites were randomised by NNK oligonucleotide mutagenesis so that the global sequence space was investigated.
^{b} Phage from 94 clones from each mini-library were screened for the retention of protein L binding activity after heating to 80° C. for 10 min. Phage were biotinylated prior to heat treatment and subsequently caputured on protein L coated plates and detected with streptavidin HRP. Approximately 10 clones, with an activity greater than 70%, from each library were subjected to sequencing. The total number of sequences is sometimes less than 10 due to second site substitutions as well as poor sequence signals. (E.g. Multiple substitutions found giving a high retention of activity were: K45T/Q90P; K45D/S60P; Y49R/S10F; Y49S/T20A; Y49S/Q27R; A50P/I48V; A50R/A13G/K42E). Note that five clones front the A50X mini-library with an activity in the 0-10% range gave the following sequences: 2A, 1T, 1V, 1Y.
^{c}Substitutions at position I75 represent partial results.

### Section 14: Mini-Library in V_{H} Results

Phage ELISA and scoring of the clones were done according to protocol of Section 4. DNA sequencing of selected clones that unfold reversibly when heated and cooled was done according to protocol of Section 6.

TABLE 13

| | | Best % refolding |
|---|---|---|
| Position | Selected amino acids | (ie pA-ELISA) |
| Phe27 | Gln(5), Ala(2), His(2), Asp(1), Ser(1), | Cys(56%), Asp(32%), |
| | Gly(1), Cys(1) | His(30%) |
| Phe29 | Gly(4), Ser(2), Asp(2), Pro(1), | Asp(55%), Pro(50%) |
| | Gln(1), His(1) | |
| Ser30 | Pro(4), Asp(2), Gly(1), Thr(1), | Pro(46%), Asp(48%) |
| | Leu(1), Val(1) | |
| Ser31 | Pro(6), Asp(1) | Pro(43%) |
| Tyr32 | Gly(9), Gln(2), Glu(1), Pro(1) | Pro(100%), Gly(56) |
| Ala33 | Pro(3), Asp(1), Gly(1) | Pro(37%), Aap(34%) |
| Ser35 | Asn(3), Asp(3) | Asp(56%) |
| Gly54 | Arg(2), Trp(1), Ser(1), Pro(1), Ala(1), | Pro (28%) |
| | Gly(1), Val(1) | |
| Ala84 | None | |
| Glu85 | None | |

In the selected amino acids columns, the number in ( ) corresponds to the number of clones carrying his mutation, that were picked as positive by the phage ELISA screening. In the Best % refolding (i.e. protein A ELISA), the number in ( ) corresponds to the mean % of refolding observed for all clones carrying the particular mutation.

A spurious mutation (Ser25 to Pro) was found in clones carrying the following mutations: A84E, or A33V, or A33E, or A33Q. It is possible that the S25P mutation has a positive effect on refolding, that is most likely surpassing the effect of the mutations at the intended positions.

A number of positive clones were then further analyzed for refolding on phage by following the protocol described in Section 5. The results are presented in Table 14.

TABLE 14

| clone | Ref | SE-15 |
|---|---|---|
| DP47d | 0.55 | 0.19 |
| HEL4 | 18.48 | −0.19 |
| BSA1 | 0.16 | 0.091 |
| pA-C13 | 35 | −0.3 |
| pA-C36 | 25 | −0.18 |
| pA-C47 | 25 | −0.16 |
| pA-C59 | 25 | −0.19 |
| pA-C76 | 35 | −0.28 |
| pA-C85 | 35 | −0.27 |
| F27D | 10.34 | −0.03 |
| F27H | 1.8 | 0.019 |
| F27A | 0.85 | 0.035 |
| F27Q | 3.75 | 0.001 |
| F27S | 1.7 | 0.025 |
| F27G | 2.57 | 0.017 |
| F29D | 11.2 | −0.03 |
| F29V | 1.12 | 0.123 |
| F29S | 6.66 | 0.025 |
| F29P | 11.9 | 0.029 |
| F29Q | 4.54 | 0.001 |
| F29G | 37.5 | 0.017 |
| S30D | 1.66 | 0.139 |
| S30P | 2.54 | 0.194 |
| S30G | 0.37 | 0.182 |
| S30T | 0.1 | 0.208 |
| S30L | 0.1 | 0.308 |
| S30Q | 0.33 | 0.166 |
| S30V | 0.1 | 0.287 |
| S31D | 1.4 | 0.139 |
| S31P | 3.72 | 0.194 |
| Y32D | 8.25 | −0.01 |
| Y32Q | 1 | 0.018 |
| Y32E | 7.11 | −0 |
| Y32P | 4.87 | 0.046 |
| Y32G | 3.28 | 0.034 |
| A33D | 1.32 | 0.129 |
| A33G | 0.37 | 0.172 |
| A33P | 1.88 | 0.017 |
| S35D | 0.91 | 0.139 |
| S35N | 0.6 | 0.165 |
| S35G | 0.65 | 0.182 |
| QUAD | 29.46 | −0.29 |
| A33D/S30N | 2.11 | 0.105 |

Ref. means % refolding on phage as determined by protienA-binding according to protocol of section 5.
SE-15 represents the S/E hydrophobicity score of the segment of sequence from Cys 22 (included) to Trp36 (included): the hydrophobicity scores of each amino acid of the particular clone in that segment are added and then divided by 15.
Quad means quadruple mutant (i.e. F27D/F29V/S35G/Y32E)

### Section 15: Aggregation Resistant Domain Antibodies Selected on Phage by Heat Denaturation

Protein aggregation is a problem in biotechnology. Here we describe a method for selecting aggregation resistant polypeptides by heat denaturation. This is illustrated with antibody heavy chain variable domains (dAbs) which are prone to aggregate (Ward; B. S., et al. Nature 341, 544-546 (1989); Ewert, S., et al. Biochemistry 41, 3628-3636 (2002)). The dAbs were displayed multivalently at the infective tip of filamentous bacteriophage, and heated transiently to induce unfolding and to promote aggregation of the dabs. After cooling, the dabs were selected for binding to protein A (a common generic ligand that binds the folded dAbs). Phage displaying dAbs that unfolded reversibly were thereby enriched with respect to those that did not. From a repertoire of phage dabs, six dabs were characterised after selection; all resisted aggregation, were soluble, well expressed from bacteria, and were purified in high yields. These results demonstrate that the methods described herein can be used to produce aggregation resistant polypeptides, and to identify amino acid residues, sequences or features that promote or prevent protein aggregation, including those responsible for protein misfolding diseases (Dobson, C. M. Trends Biochem Sci 24, 329-332 (1999); Rochet, J. C. & Lansbury, P. T., Jr. Curr Opin Struct Biol 10, 60-68 (2000)).

In contrast to human V_{H}.dAbs, those of camels and llamas have been shown to resist aggregation, even on heating at temperatures as high as 90° C. (Ewert, S., et al. Biochemistry 41, 3628-3636 (2002); Dumoulin, M. et al. Protein Sci 11, 500-515 (2002); van der Linden, R. H. et al. Biochim Biophys Acta 1431, 37-46 (1999)). This remarkable property has been attributed to reversible unfolding, and a series of highly-conserved, predominantly hydrophilic mutations in the β-sheet scaffold have been proposed to account for this behaviour (Ewert, S., et al. Biochemistry 41, 3628-3636 (2002); Dumoulin, M. et al. Protein Sci 11, 500-515 (2002)). As described herein, a human V_{H} dAb referred to as HEL4 has biophysical properties that are similar to those of camels and llamas (see also, Jespers, L., et al. J Mol Biol 337, 893-903 (2004)). For example, the HEL4 dAb unfolded reversibly above 62.1° C. (Tₘ) at concentrations as high as 56 μM. In contrast heating a 5.0 μM solution of the DP47d dAb (a typical human V_{H} dAb encoded by the same germ-line gene as the REL4 dAb) above 55° C. led to irreversible unfolding and formation of aggregates (Jespers, L., et al. J Mol Biol 337, 893-903 (2004)). The human HEL4 dAb is devoid of mutations in the β-sheet scaffold and differs from the DP47d dAb only by mutations in the loops comprising the complementarity determining regions (CDRs) (Table 15). We used the HEL4 and DP47d dAbs to develop a method for the selection of human V_{H} dabs that unfold reversibly from those that aggregate irreversibly.

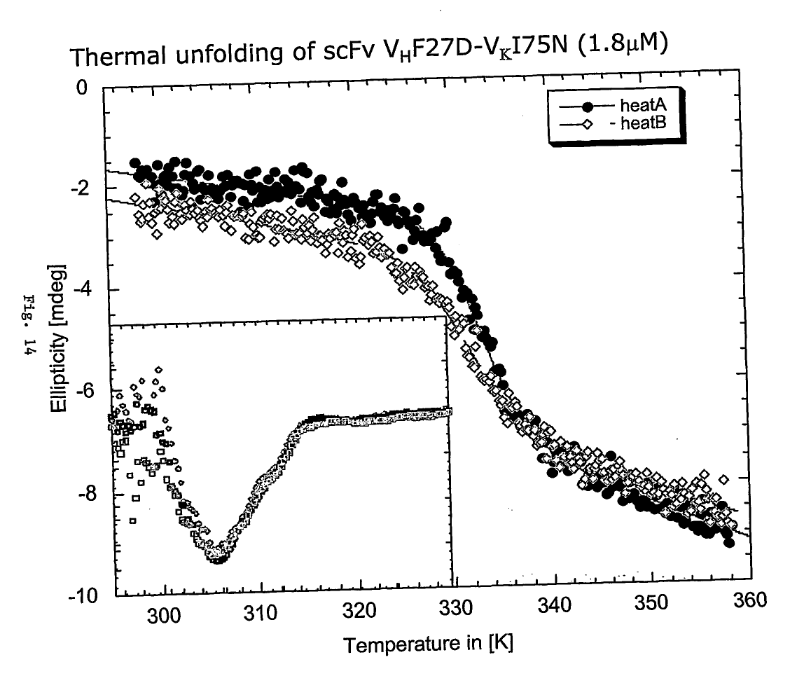

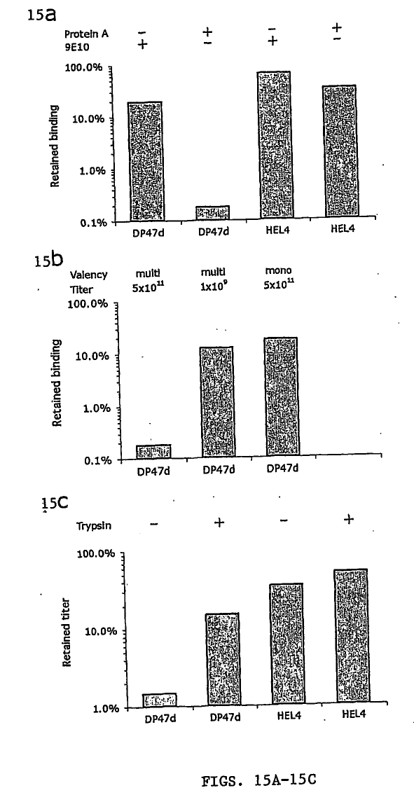

The HRL4 and DP47d dAbs were displayed in a multivalent state on the surface of filamentous bacteriophage, thereby providing a link between antibody phenotype and genotype and a powerful means of selection (McCafferty, J., et al. Nature 348, 552-554 (1990)). To induce denaturation, the fusion phage (5×10¹¹ transducing units per ml (TU/ml) were heated to 80° C. for 10 min; the phage capsid withstands this temperature (Holliger, P., et al. J Mol Biol 288, 649-657 (1999)) but not the dAbs, which unfold above 60° C. (Ewert, S., et al. Biochemistry 41, 3628-3636 (2002)). After cooling, the phage-displayed dabs were assayed for refolding by phage ELISA on protein A (a generic ligand common to these folded dabs). Binding was reduced 3-fold for the HEL4 phage but 560-fold for the DP47d phage (FIG. 15A). This suggested that the HEL4 dAb had reversibly unfolded on the phage tip to a significant degree, and that the DP47d dAb had not.

### DP47d dAb Aggregates Upon Heating

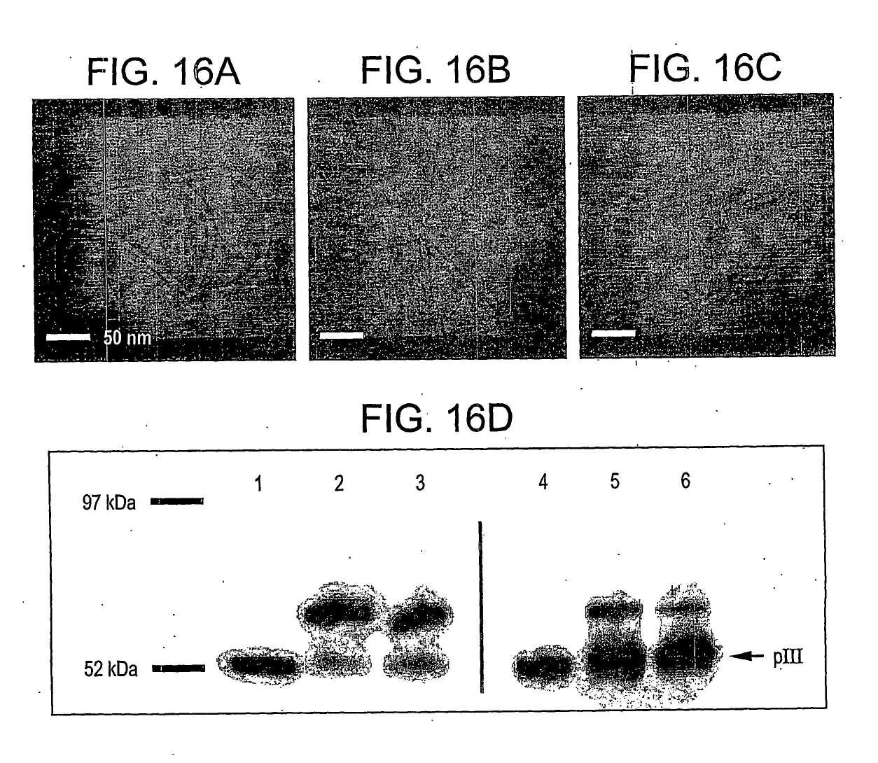

By transmission electron microscopy of negatively stained phage, it was observed that >90% of the heated DP47d phage (FIGS. 16A and 16B) were joined together via their tips whereas no clustering was seen with the untreated DP47d phage or heated HEL4 phage (FIG. 16C). These clusters of phage provide direct evidence of DP47d aggregation after heat denaturation. The appearance of clusters requires both high concentration of phage and high local concentration of the dAb at the phage tip (number of dAbs displayed per tip). Western blot analysis shows that for multivalent phage ˜80% of the five pIII coat proteins carry a fused dAb and for monovalent phage ˜20% (FIG. 16D). Thus no phage clusters were observed on heating multivalent DP47d phage at titers of 1×10⁹ TU/ml or monovalent DP47d phage at titers of 5×10¹¹ TU/ml, and in both cases the binding to protein A was only reduced 8-fold and 6-fold respectively (FIG. 15B). Without wishing to be bound by any particular theory, it appears that upon phage heating to 80° C., aggregation of DP47d dAb is nucleated by the formation of a micro-aggregate at the phage tip (intra-phage step) which then grows into oligomeric aggregates by phage clustering (inter-phage step), and hence that aggregation in our phage system follows a two-step process, as noted for other proteins (Dobson, C. M. Trends Biochem Sci 24, 329-332 (1999)).

Heating Phage Displaying dAbs that Do Not Unfold Reversibly Reduces Infectivity

Heating at 80° C. slightly reduced (3-fold down) the infectivity of the HEL4 phage, as previously observed with wild-type filamentous phage (Holliger, P., et al. J Mol Biol 288, 649-657 (1999)), but considerably reduced the infectivity of the DP47d phage (≧70-fold down) (FIG. 15C). The infectivity of heated DP47d phage could be partly restored by addition of trypsin which presumably cleaves within the dAb and/or the peptide linker connecting the dAb to the pIII protein. These observations are consistent with a model wherein intra- and inter-phage aggregates of DP47d dAb prevent the N-terminal domains of the pIII protein from binding to the bacterial pilus and/or to the TolA receptor (Holliger, P., et al. J Mol Biol 288, 649-657 (1999)).

A selection in which phage displaying the HEL4 and DP47d dabs were mixed in 1:106 ratio respectively, incubated at 80° C. for 10 min, cooled and selected on immobilized protein A was performed. Bound phage were eluted with trypsin, and used to re-infect bacteria. After two rounds of such selection, supernatants from infected colonies (n=86) were tested by ELISA on immobilized hen egg lysozyme (HEL) to distinguish the HEL-specific HELM phage from the DP47d phage. Phage from twelve colonies bound to hen egg lysozyme (corresponding to a 360-fold enrichment of the HEM phage per selection round). None of the 86 tested colonies secreted the HEMA phage when the selection on protein A was repeated without the heat step. Thus, by two rounds of heat denaturation and biopanning on protein A, phage dabs that resisted thermal aggregation were selected from those that did not.

A repertoire of human V_{H} dabs (1.6×10⁹ clones) was prepared by diversification of the loops comprising the CDRs in the DP47d dAb, and displayed multivalently on phage. After three rounds of heat denaturation followed by selection on protein A, 179 out of 200 colonies secreted dAb phage that retained more than 80% of protein A-binding activity after heating. Twenty clones were sequenced and revealed as many unique dAb sequences with a large variability in the CDR sequences and lengths Cable 15). The diversity shows that, as with HEM, mutations located entirely in the loops comprising the CDRs are sufficient to confer resistance to aggregation. Eighteen of these dabs had an acidic isoelectric point (5.1±1.1, mean±SD), consistent with earlier proposals of a direct correlation between net protein charge and resistance to aggregation (Wilkinson, D. L. & Harrison, R. G. Nature 341, 544-546 (1991); Chiti, F. et al. Proc Natl Acad Sci USA. 99, 16419-16426 (2002)).

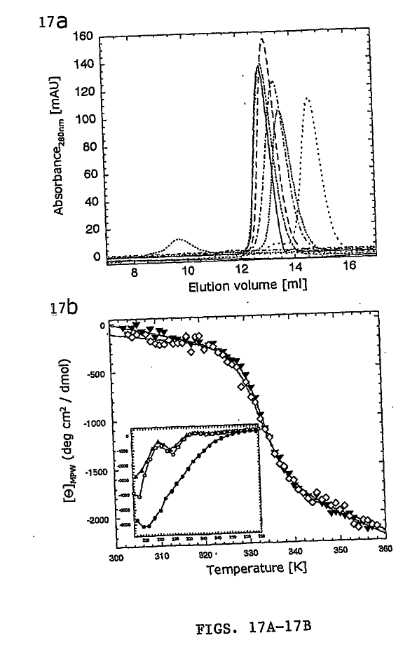

Six dAbs with CDR3s comprising 10 to 20 amino acids were chosen for further characterization (C13, C36, C47, C59, C76, and C85). These proteins were well secreted from bacteria, and the C36, C47 and C59 dAbs were recovered in yields greater than 20 mg/L in bacterial supernatants compared to only 2.9 mg/L for the DP47d dAb (Table 16). After purification on immobilized protein A, the dabs were subjected to size-exclusion chromatography on a SUPERDEX-75 column (gel filtration column; Amersham Biosciences). The dAbs eluted as mono-disperse symmetric peaks and the recoveries were nearly quantitative, indicating that in contrast to other human dabs (Ewert, S., et al. Biochemistry 41, 3628-3636 (2002); Ewert, S., et al. J Mol Biol 325, 531-553 (2003)) they did not stick to the column matrix. The dAbs eluted at a mean apparent molecular mass (Mᵣ₋ₐₚₚ) of 17 kDa (range 10 to 22 kDa), similar to the calculated molecular weight (M_{r-calc}) of 13-14 kDa for a monomeric dAb species (FIG. 17A). Variation in Mᵣ₋ₐₚₚ has been observed for other dabs (Ewert, S., et al. Biochemistry 41, 3628-3636 (2002); Ewert, S., et al. J Mol Biol 325, 531-553 (2003)) and may result from weak transient interactions with the column matrix or monomer/dimer equilibria (Sepulveda, J., et al. J Mol Biol 333, 355-365 (2003)). Importantly, at 5 μM, each selected dAb unfolded reversibly and cooperatively upon repeated cycles of thermodenaturation (FIG. 17B). Thus the selected dAbs not only resisted aggregation, but as reported for camel and llama dabs (Ewerr, S., et al Biochemistry 41, 3628-3636 (2002); Arbabi Ghahroudi, M, et al FEBS Lett 414, 521-526 (1997)), were mainly monomeric, well expressed, and purified in good yield by gel filtration.

### Selection on Antigen

In the work described above, protein A, a generic ligand that binds each member of the repertoire, was used for selection. However, any desired antigen can be used to select dAbs that combine the properties of reversible unfolding with a desired antigen specificity. This was demonstrated by selection of a synthetic human V_{H} repertoire for binding to human serum albumin (HSA), with and without a heat denaturation step, and followed by screening of 44 clones for binding to HSA after two rounds of selection. Without the heat step, six unique dAb clones (Table 15) that bound HSA were selected. When the heating step was employed, a single dAb clone (Clone #10, Table 15) was recovered. Only Clone #10 exhibited the properties of reversible unfolding (100% of HSA binding signal was retained after heating Clone #10 phage, compared with less than 10% retained binding signal the others) despite the close similarity in sequence to three of the other clones (#2, #5, #6 and #10 share 92% identity).

### Discussion

Protein aggregation is an off-pathway process that competes with the folding pathway, and usually involves association of the unfolded states, or partially unfolded states. Resistance to aggregation can be achieved by introducing mutations that stabilize the native state (increasing ΔG_{N-U}, the free energy of folding) and/or that reduce the propensity of the unfolded or partially unfolded states to aggregate (for example by increasing the solubility of these states). Several selection strategies have been devised to select for protein variants with improved stability: (i) by linking the infectivity of the phage to the proteolytic resistance of the displayed protein (Kristensen, P. & Winter, G. Fold Des 3, 321-328 (1998); Sieber, V., et al. Nat Biotechnol 16, 955-960 (1998); Martin, A., et al. J Mol Biol 309, 717-726 (2001)) and/or (ii) by challenging the displayed protein with elevated temperatures or denaturants (Shusta, E. V., et al. Nat Biotechnol 18, 754-759 (2000); Jung, S., et al. J Mol Biol 294, 163-180 (1999)). The focus until now has been to destabilize (and promote elimination of) all but the most able protein variants. For example, by heating a phage antibody library to 60° C., Jung et al. (J Mol Biol 294, 163-180 (1999)) selected a variant of the 4D5Flu antibody fragment, with an improved ΔG_{N-U} (+3.7 kcal/mol) and which remained folded at 60° C. Beyond this temperature, unfolding of the antibody fragment resulted in aggregation and loss of infectivity when phage displaying the antibody fragment was heated.

By contrast, in the studies described herein, selection included inducing unfolding of all the dAbs in the repertoire, stable and unstable alike. This selection process operates on the ability of the unfolded dAbs to avoid irreversible aggregation at the phage tip upon heating at 80° C. and cooling. The folding properties of the selected dabs cannot be attributed to stabilization of the native state, because biophysical analysis of thermodynamic stabilities of the selected dabs indicates that the selected domains are less stable than typical aggregation-prone human dAbs. Thus the free energies of folding (ΔG_{N-U}) at 25° C. (from 14 to 23 kJ/mol) (Table 16) are lower than those of the DP47d dAb (35 kJ/mol) and other aggregation-prone dabs based on the same human DP47/3-23 germ-line segment (from 39.7 to 52.7 kJ/mol) (Tomlinson, I. M., et al. J Mol Biol 227, 776-798 (1992); Ewert, S., et al. Biochemistry 41, 3628-3636 (2002)). It appears that the described selection process using heat denaturation selects favorable properties of the unfolded or partially unfolded states.

Other beneficial properties of these selected dAbs appear to follow directly from their resistance to aggregation. For example, the high level of expression obtain for these aggregation-resistant dabs is consistent with the identification of periplasmic aggregates as the major yield-limiting factor for the production of recombinant antibody fragments in E. coli (Wörn, A. & Plückthun, A. J Mol Biol 305, 989-1010 (2001)). In addition, the dAbs selected here were uniformly “non-sticky” upon gel filtration.

The methods described herein can be used to produce improved versions of other polypeptides (e.g. polypeptides expressed in the bacterial periplasm) that can be functionally displayed on the surface of filamentous bacteriophage (e.g. in a multivalent state) and bound by a ligand that recognizes only the properly folded state of the polypeptide (e.g., an antibody that binds properly folded polypeptide, a receptor that binds properly folded polypeptide). Such polypeptides can be diversified (e.g., by engineering random mutations) displayed on phage, denatured, and selected by bio-panning (or other suitable methods) after returning to conditions permissive to the native state (refolding). The methods described herein also provide an analytical tool to identify amino acid residues or polypeptide segments involved in off-pathway aggregation of proteins upon folding, including those involved in diseases of protein misfolding (Dobson, C. M. Trends Biochem Sci 24, 329-332 (1999); Rochet, J. C. & Lansbury, P. T., Jr. Curr Opin Struct Biol 10, 60-68 (2000)).

TABLE 15
Sequences of loops comprising the CDRs of dAbs described in this study

| | H1-CDR1¹ | H2-CDR2¹ | H3-CDR3¹ | |
|---|---|---|---|---|
| Clone | 26 to 35² | 50---a-------60-----² | 94---100abcdefghij102² | L⁴ |
| DP47d | GFTFSSYAMS | AISGSGGSTYYADSVKG | K SYGA-------------FDY | 7 |
| | (SEQ ID NO:104) | (SEQ ID NO:105) | (SEQ ID NO:106) | |
| HEL4 | GFRISDEDMG | SIYGPSGSTYYADSVKG | S ALEPLSEP---------LGF | 11 |
| | (SEQ ID NO:107) | (SEQ ID NO:108) | (SEQ ID NO:109) | |
| a)³ | GDMVNDKDMS | SISTENGSTYYADSVKG | G VRDEVAMGENPD----LSY | 15 |
| C13 | (SEQ ID NO:110) | (SEQ ID NO:111) | (SEQ ID NO:112) | |
| C22 | GFRFSAEDMG | SIDNDDGSTYYADSVKG | S SPGPDNEKDNAS-----LKS | 15 |
| | (SEQ ID NO:113) | (SEQ ID NO:114) | (SEQ ID NO:115) | |
| C24 | GDSVSNKVMG | AIDTKDGSTYYADSVKG | S GDVDADMAWEEE-----VSS | 15 |
| | (SEQ ID NO:116) | (SEQ ID NO:117) | (SEQ ID NO:118) | |
| C33 | GDTLTSDNMA | TITEAGGSTYYADSVKG | T YPADVAECAAE------VCY | 14 |
| | (SEQ ID NO:119) | (SEQ ID NO:120) | (SEQ ID NO:121) | |
| C36 | GVNVSHDSMT | AIRGPNGSTYYADSVKG | S GARHADTERPPSQQT--MPF | 18 |
| | (SEQ ID NO:122) | (SEQ ID NO:123) | (SEQ ID NO:124) | |
| C37 | GYRISPDYMG | SISNNGGSTYYADSVKG | S VDAAESGIDSN------VGS | 14 |
| | (SEQ ID NO:125) | (SEQ ID NO:126) | (SEQ ID NO:127) | |
| C46 | GYRVNAQDMS | TIENENGSTYYADSVKG | S CTRGGCYDT--------FPY | 12 |
| | (SEQ ID NO:128) | (SEQ ID NO:129) | (SEQ ID NO:130) | |
| C47 | GYNITDENMA | TIAADNGSTYYADSVKG | T TEAAGVEEDN-------VRS | 13 |
| | (SEQ ID NO:131) | (SEQ ID NO:132) | (SEQ ID NO:133) | |
| C50 | GDKVSYNNMA | SITTENGSTYYADSVKG | G NRNSPVDYRELQSTP--LDS | 18 |
| | (SEQ ID NO:134) | (SEQ ID NO:135) | (SEQ ID NO:136) | |
| C57 | GDNFNNENMG | TISDTNGSTYYADSVKG | T TGTRQPQKE--------VGS | 12 |
| | (SEQ ID NO:137) | (SEQ ID NO:138) | (SEQ ID NO:139) | |
| C58 | GVNVTDQDMG | SIRSNDGSTYYADSVKG | G RSSGRTDA---------VPY | 11 |
| | (SEQ ID NO:140) | (SEQ ID NO:141) | (SEQ ID NO:142) | |
| C59 | GDSISDDYMA | SIDDKNGSTYYADSVKG | G GDGQAHK----------VDY | 10 |
| | (SEQ ID NO:143) | (SEQ ID NO:144) | (SEQ ID NO:145) | |
| C61 | GDMLNYKVMG | SIITQDGSTYYADSVKG | G IPLDRADD---------IEY | 11 |
| | (SEQ ID NO:146) | (SEQ ID NO:147) | (SEQ ID NO:148) | |
| C62 | GYKVNDNTMA | SIDTTDGSTYYADSVKG | A SDQRTAD----------MRS | 10 |
| | (SEQ ID NO:149) | (SEQ ID NO:150) | (SEQ ID NO:151) | |
| C63 | GVTVSDENMG | GISSNDGSTYYADSVKG | R DYGSRVDQQH-------LES | 13 |
| | (SEQ ID NO:152) | (SEQ ID NO:153) | (SEQ ID NO:154) | |
| C73 | GVTLNDEYMG | SINDRNGSTYYADSVKG | S WVVPGRKSAEP------MDY | 14 |
| | (SEQ ID NO:155) | (SEQ ID NO:156) | (SEQ ID NO:157) | |
| C74 | GYTFSDNDMA | GITSDSGSTYYADSVKG | T ESPNGVTKLSDKN----FES | 16 |
| | (SEQ ID NO:158) | (SEQ ID NO:159) | (SEQ ID NO:160) | |
| C76 | GDNVISDDMS | TINGPSGSTYYADSVKG | A NGEDTDMLDMWGDRSAALKS | 20 |
| | (SEQ ID NO:161) | (SEQ ID NO:162) | (SEQ ID NO:163) | |
| C77 | GVKFNDEDMS | SIGTENGSTYYADSVKG | A GPSGHEGNYD-------IDS | 13 |
| | (SEQ ID NO:164) | (SEQ ID NO:165) | (SEQ ID NO:166) | |
| C85⁴ | GDKITSKNMS | TIPAEGGSTYYADSVKG | T ACFPSAQH--------VES | 11 |
| | (SEQ ID NO:167) | (SEQ ID NO:168) | (SEQ ID NO:169) | |
| b)³ | GFTFDLYDMS | SIVNSGVRTYYADSVKG | K LNQSYHWD---------FDY | 11 |
| #1 | (SEQ ID NO:170) | (SEQ ID NO:171) | (SEQ ID NO:172) | |
| #2 | GFTFSDYRMS | TIISNGKFTYYADSVKG | K QDWMYM----------FDY | 9 |
| | (SEQ ID NO:173) | (SEQ ID NO:174) | (SEQ ID NO:175) | |
| #3 | GFTFSKYWMS | SIDFMGPHTYYADSVKG | K GRTSMLPMKGK------FDY | 14 |
| | (SEQ ID NO:176) | (SEQ ID NO:177) | (SEQ ID NO:178) | |
| #4 | GFTFYDYNMS | TITHTGGVTYYADSVKG | K QNPSYQ-----------FDY | 9 |
| | (SEQ ID NO:179) | (SEQ ID NO:180) | (SEQ ID NO:181) | |
| #6 | GFTFHRYSMS | TILPGGDVTYYADSVKG | K QTPDYM----------FDY | 9 |
| | (SEQ ID NO:182) | (SEQ ID NO:183) | (SEQ ID NO:184) | |
| #7 | GFTFWKYNMA | TILGEGNNTYYADSVKG | K TMDYK------------FDY | 8 |
| | (SEQ ID NO:185) | (SEQ ID NO:186) | (SEQ ID NO:187) | |
| #10 | GFTFDEYNMS | TILPHGDRTYYADSVKG | K QDPLYR----------FDY | 9 |
| | (SEQ ID NO:188) | (SEQ ID NO:189) | (SEQ ID NO:190) | |

¹CDR1, 2 and 3 defined according to Kabat et al. and structural loops H1, 2 and 3 according to Chothia et al.. Sequences given include both these regions and residue 94 of FR3.
²Residue numbering according to Kabat et al.
³Sequences of clones selected on protein A (a) and human serum albumin (b).
⁴L: amino acid length of H3-CDR3.
⁴This clone also contains a mutation of Trp47 to Cys in framework 2.

TABLE 16
Biophysical and expression data of selected dAbs

| dAb | Tₘ¹ | ΔG_{N-U}² | % recovery⁴ on | Yield⁵ |
|---|---|---|---|---|
| clone | (° C.) | (kJ/mol) | Superdex-75 | (mg) |
| DP47d | 61.4 | 35³ | ≦5 | 2.9 |
| HEL4 | 62.1 | 28 | ≧90 | 9.5 |
| C13 | 54.1 | 14 | 88 | nd⁷ |
| C36 | 59.9 | 23 | 95 | 24 |
| C47 | 60.7 | 23 | 100 | 39 |
| C59 | 55.9 | 18 | 94 | 22 |
| C76 | 54.5 | 21 | 100 | nd |
| C85 | 61.2 | 20 | 86⁶ | nd |

¹Temperature of mid-point transition upon reversible unfolding (or aggregation for DP47d dAb).
²Thermodynamic stability value obtained from thermo-denaturation curves.
³Thermodynamic stability value obtained from urea-induced denaturation curves at 25° C. (unpublished data, L. J., O. S., G. W. and L. C. James).
⁴Obtained by integrating the areas of the peak(s) eluted from Superdex G75.
⁵Yield of purified protein obtained from a 1 L supernatant of bacterial culture normalised to 5.0 OD_{600 nm}.
⁶A peak corresponding 7% of the sample migrated as multimeric species.
⁷nd: not determined.

### Methods

Phage display of a human V_{H} dAb library. The dAb repertoire was created in two-steps by oligonucleotide-mediated diversification of several codons in the sequence of the DP47d dAb as follows (Kabat numbering for the amino acid positions and IUPAC-TUB code for the nucleotides): 27, KWT; 28, ANS; 29, NTT; 30, ANC; 31, NMT; 32, NAS; 33, DHT; 35, RSC; 50, RSC; 52, NNK; 52a, RNS; 53, VVW; 54, CGT; 94, RSW; 101, NVS; 102, THT; and NNK codons for all CDR3 positions from 95 to 100× (where x ranges alphabetically from a to k). The DNA inserts were flanked with ApaLI (at 5′-end) and NotI (at 3′-end) sites by PCR, digested and ligated into the corresponding sites of fd-myc, a multivalent phage vector derived from fdCAT1 (McCafferty, J., et al. Nature 348, 552-554 (1990)) that contains a c-myc tag between the NotI site and gene III. The ligation products were transformed by electroporation into E. coli TG1 cells, and plated on 2×TY plates supplemented with 15 μg/ml of tetracycline (2×TY-Tet), yielding a library of 1.6×10⁹ clones. For monovalent display, dAb genes (as NcoI-NotI DNA fragments) were ligated into the corresponding sites of pR2, a phagemid vector derived from pHENI (Hoogenboom, H. R. et al. Nucleic Acids Res 19, 4133-4137 (1991)) that contains the (His)₈ and VSV tags between the NotI site and gene III. Phage were prepared, purified and stored as described (McCafferty, J., et al. Nature 348, 552-554 (1990); Hoogenboom, H. R. et al. Nucleic Acids Res 19, 4133-4137 (1991)). For the analysis of phage proteins, 1×10¹⁰ transducing units (IU) was subjected to SDS PAGE (4-12% Bis-Tris gel, Invitrogen), and transferred to a PVDF Immobilon-P membrane (Millipore) for detection; the blocked membrane was incubated with murine anti-pIII antibody (MoBiTec), then anti-murine horseradish peroxidase conjugate (Sigma-Aldrich), and electro-chemiluminescence reagents (Amersham Biosciences).

Phage ELISA assays. The ELISA wells were coated overnight at 4° C. with one of the following ligands: 10 μg/ml of protein A in PBS, 10 μg/ml of mAb 9E10 in PBS, or 3 mg/ml of HEL in 0.1 M NaHCO₃ buffer, pH 9.6. After blocking the wells with PBS containing 2% Tween-20 (PBST), a dilution series of phage in PBST was incubated for 2 h. After washing with PBS, bound phage were detected as follows. In assays for binding to REL, phage was detected directly using a conjugate of horseradish peroxidase with an anti-M13 monoclonal antibody (Amersham) using 3,3′,5,5′-tetramethylbenzidine as substrate. In assays for binding to protein A, the phage (4×10¹⁰ TU/ml in PBS) was first biotinylated at 4° C. with biotin-NHS (Perbio) (50 μM final concentration) and detected by sequential addition of streptavidin-horseradish peroxidase conjugate (1 μg/ml) (Sigma-Aldrich) in PBST, and substrate as above. In assays for binding to human serum albumin (USA) (Sigma, coating at 10 μg/ml in PBS), the ELISA was performed in PBS supplemented with 2% skim-milk powder (PBSM) and bound phage were detected in two steps using a rabbit anti-fd bacteriophage monoclonal antibody (Sigma, 1/1000 dilution) and goat anti-rabbit IgG serum conjugated with horseradish peroxidase (Sigma, 1/1000 dilution) and substrate as above.

Electron microscopy. Phage (1×10¹² TU/ml in PBS) were heated at 80° C. for 10 min and then cooled at 4° C. for 10 min or left untreated as control. After dilution to 1×10¹⁰ TU/ml in PBS, phage were adsorbed on glow discharged carbon coated copper grids (S160-3, Agar Scientific), washed with PBS and then negatively stained with 2% uranyl acetate (w/v). The samples were studied using a FEI Tecnai 12 transmission electron microscope operating at 120 kV and recorded on film with calibrated magnifications.

Phage selection. Immunotubes (Nunc) were coated overnight with protein A, and blocked with PHST. Purified phage (1×10¹¹ TU/ml in PBS) were heated as described above, diluted with 3 ml of PBST, and incubated for 2 h in the immunotubes. After 10 washes with PBS, protein A-bound phage were eluted in 1 ml of 100 μg/ml trypsin in PBS during 10 min, then used to infect 10 ml of log-phase E. coli TG1 cells at 37° C. during 30 min. Serial dilutions (for phage titer) and library plating were performed on 2×TY-Tet agar plates. For the next selection round, cells were scraped from the plates and used to inoculate 200 ml of 2×TY-Tet at 37° C. for phage amplification (McCafferty, J., et al Nature 348, 552-554 (1990)). For selection on HSA, a similar synthetic human VH repertoire (Domantis Ltd) was used, the antigen (10 μg/ml in PBS) was coated in immunotubes, the blocking agent was PBSM, and the phage library (1×10¹² TU in 1 ml PBS) was heat-treated or left untreated before each round of biopanning.

Protein expression and purification. The genes encoding for the various dAbs were subcloned into pET-12a (Novagen) followed by the addition of SalI and BamHI sites by PCR. After transformation of E. coli B121(DE3)pLysS cells (Novagen), dAb expression (1 L scale) was induced in the presence of 1 mM IPTG (final concentration) at 30° C. during 16 hours. After centrifugation, the supernatants were filtered (0.22 dM and each incubated overnight with 5 mL of STREAMLINE-protein A beads (Amersham Biosciences) at 4° C. The beads were packed into a column, washed with PBS, and bound dabs were eluted in 0.1 M glycine-HCl, pH 3.0. After neutralisation to pH 7.4, the protein samples were dialyzed in PBS and concentrated before storage at 4° C. Protein purity was estimated by visual inspection after SDS-PAGE on 12% Bis-Tris gel (Invitrogen). To obtain expression yields from normalized cultures, five individual colonies from freshly transformed bacteria were grown overnight at 37° C., and induced for expression as described above (50 ml scale). Following to overnight expression, the cultures were combined and a culture volume corresponding to 600×OD₆₀₀ₙₘ (120 to 135 ml) was processed for dAb purification as described. The amount of purified protein was extrapolated to the protein yield per litre of bacterial culture, corrected for a final absorbance of 5.0 at OD₆₀₀ₙₘ. For analytical gel-filtration, 500 μl of a 7 μM solution of dAb were loaded on a SUPERDEX-75 (Amersham Biosciences). The Mᵣ of each of the peaks on the chromatograms were assigned using a scale calibrated with markets, and the yields calculated from the areas under the curve.

Circular dichroism measurements. CD cuvettes (1 cm path-length) were filled with a 5 μM solution of dAb in PBS and transferred to a J-720 polarimeter (Jasco). CD spectra at 25° C. and 85° C. were recorded in the far-UV (200 nm to 250 nm) with a 2 nm bandwidth and a 1 second integration time. Unfolding curves from 25° C. to 85° C. were monitored at 235 nm and repeated twice for each dAb. The unfolding curves were assumed to be two-state and fitted as described (Pace, C. N. & Scholtz, J. M. in Protein Structure, A Practical Approach, Edn. 2. (ed. T. Creighton) 299-321 (Oxford University Press, New York; 1997)) using a ΔCₚ contribution of 12 cal per amino acid residue (Myers, J. K., et al. Protein Sci 4, 2138-2148 (1995)). The values obtained for Tₘ (midpoint transition temperature in Kelvin), ΔHₘ (enthalpy change for unfolding at Tₘ) were then used to calculate the thermodynamic stability (ΔG_{N-U}) of the protein at 25° C. as described (Pace, C. N. & Scholtz, J. M. in Protein Structure, A Practical Approach, Edn. 2. (Ed, T. E. Creighton) 299-321 (Oxford University Press, New York, 1997)).

Section 16. Introducing “Folding Gatekeeper” Residues Into Single Variable Domain with Defined Specificity.

A “folding gatekeeper” is an amino acid that, by the virtue of its biophysical characteristics and by its position in the primary sequence of a protein, prevents the irreversible formation of aggregates upon protein unfolding. A folding gatekeeper residue blocks off-pathway aggregation, thereby ensuring that the protein can undergo reversible unfolding. The effectiveness of folding gatekeepers (determined by the position(s) and the biophysical characteristics) influence the maximal concentration at which the unfolded protein can remain in solution without forming aggregates. As described herein, folding gatekeepers have been introduced into single variable domains (DP47d, or VKdummy) lacking antigen-specificity.

TAR2-10-27 is a human V_{H}3 domain which has binding specificity for human tumor necosis factor receptor 1 (also referred to as “TAR2”). The amino acid sequence of TAR2-10-27 is:

(SEQ ID NO:191)

EVQLLESGGGLVQPGGSLRLSCAASGFTFEWYWMGWVRQAPGKGLEWVSA
ISGSGGSTYYADSVKGRFTISRDNSKNTLYLQMNSLRAEDAAVYYCAKVK
LGGGPNFGYRGQGTLVTVSS

The results of this rational-design approach complements another approach in which folding gatekeepers are introduced ab initio in dAb libraries displayed on phage (see Section 18).

### Choosing the Folding Gatekeepers for TAR2-10-27

In the human DP-47-V_{H}3 domain, aggregation is mediated by the hydrophobic segment encompassing the H1-loop. Site-directed mutagenesis and biophysical analysis have shown that even a single point mutation that lower the SE-score over residue 22 to 36 in DP47 to below zero, can confer proper folding in this variable domain at concentration up to 5 uM. The preferred positions for single point mutations are residues Phe27 and Tyr32 and, the preferred substitutions are the hydrophilic Asp, Glu, Ulna Asn residues, or the beta-strand breaking residue Pro. As shown in Table 17, four single mutants in the H1-loop of TAR2-10-27 significantly lower the SE-15 score, and may therefore confer high folding yield. Combinations of mutations would further lower the SE-15 score below zero.

TABLE 17

| | | |
|---|---|---|
| Clone | H1 sequence | SE-15 score |

| | | |
|---|---|---|
| TAR2-10-27 | CAASGFTFEWYWMGW | 0.267 |
| | (SEQ ID NO:192) | |
| TAR2-10-27-F27D | CAASGDTFEWYWMGW | 0.051 |
| | (SEQ ID NO:193) | |
| TAR2-10-27-F27Q | CAASGQTFEWYWMGW | 0.079 |
| | (SEQ ID NO:194) | |
| TAR2-10-27-Y32D | CAASGFTFEWDWMGW | 0.068 |
| | (SEQ ID NO:195) | |
| TAR2-10-27-Y32Q | CAASGFTFEWQWMGW | 0.095 |
| | (SEQ ID NO:196) | |

The F27D, F27Q, Y32D or Y32Q point mutations were introduced into the DP47-V_{H}3 domain using SOE-PCR, and the nucleic acids encoding the mutated V_{H}3 domains were subcloned, expressed and the encoded proteins were purified

The PCR-amplified genes encoding these proteins were subcloned into a derivative of the pET-11A vector in which the OmpT leader sequence was replaced with an eukaryotic leader sequence, using the SalI and NotI restriction sites. The ligated DNAs were used to transform E. coli BL21 (DE3)pLysS, which were then plated on agar plates supplemented with TYE-agar+5% glucose+100 μg/ml ampicillin and incubated at 37° C. overnight

A 10 mL 2×TY culture was inoculated with a single bacterial colony from the plates and grown overnight at 37° C. The 2×YT culture contained ampicillin (100 μg/mL and glucose (5%). A 500 mL 2×TY culture in a 2.5 L culture flask was inoculated with 5 mL of the over-night culture and grown at 37° C. with shaking (250 rpm) until an OD₆₀₀ₙₘ of 0.5-0.6. The media also contains ampicilin (50 μg/mL) and glucose (0.1%). When the OD₆₀₀ₙₘ reached 0.5-0.6, the culture flasks were further incubated at 30° C. with shaking. After about 20 minutes, protein production was induced by the addition of 1 mM IPTG (final concentration) and the cultures were grown overnight.

Then the culture media was transferred to cylindrical 0.5 or 1 L bottles (glass or plastic). 0.5-1 mL of a 1:1 slurry of protein A-beads (Amersham Biosciences) was added, and the mixture was rolled on horizontal flask rollers at 4° C. overnight. Then the bottles were left upright allowing the resin to settle. The resin (beads) was repeatedly washed with 1×PBS, 500 mM NaCl (2×), and the washed resin was loaded into a drip column. The resin was washed again with 5 column volumes of 1×PBS, 500 mM NaCl. After the resin had almost run dry, 0.1 M glycine pH 3.0 was applied to the column and 1 ml fractions are collected. The collection tubes were filled prior to the elution with 200 μL 1M Tris, pH 7.4 in order to neutralise the solution. The OD₂₈₀ₙₘ was checked for each fraction and the protein elution monitored. The fractions that contained protein were combined and dialysed against an appropriate buffer (1×PBS in most cases). The protein concentration was again determined (using a calculated extinction coefficient) and purity was evaluated by SDS-PAGE analysis.

The protein yields per litre of culture supernatant are shown in Table 18. As previously described herein, recombinant expression of the DPA47-V_{H}3 domain in the pET/BL12(DE3)pLysS system was increased when folding gatekeepers were inserted into the protein sequence.

TABLE 18

| Clone | mg protein per Litre |
|---|---|
| TAR2-10-27 | 0.35 |
| TAR2-10-27 F27Q | nd |
| TAR2-10-27 F27D | 4.6 |
| TAR2-10-27 Y32Q | nd |
| TAR2-10-27 Y32D | 5.3 |

Aggregation of heated and cooled proteins was assessed at different concentrations. The proteins were heated at different concentrations (1-100 μM for 10 minutes at 80° C. Then, the protein was allowed to refold at either room temperature or 4° C. for 10 minutes. Protein A beads were added to the refolded protein solution, and the mixture was rolled until all refolded protein has been captured by the beads. The beads were washed repeatedly and equal amounts of beads were loaded onto a SDS-PAGE gel for visualisation. Densitometry was used to quantify the amount/concentration of protein recovered, and to calculate the concentration at which half the protein properly refolded after exposure to high temperature ([protein]_{50%}).

Samples of each protein at different concentrations ranging from 1-100 μM were prepared. The samples were heated for 10 minutes at 80° C. in a PCR block using 0.5 mL thin-walled tubes. The ramping was 10° C./min. Duplicate samples were prepared and processed in parallel but omitting the heating step.

After heating, the samples were kept at room temperature or 4° C. for a few minutes. The samples were transferred to 1.5 mL micro tubes and centrifuged at 4° C. for 10 minutes at high speed. The supernatant was recovered without disturbing any pellets that formed. 20 μL of a 1:1 slurry of protein A-beads was added to each tube, the tube was topped up to 1 mL of PBS and rolled for 1-2 hours on an over-head roller at room temperature. When the protein A beads had settled, the supernatant was removed without disturbing the beads. The beads were washed three times with 1 mL PBS and resuspended in 40 μL of SDS-loading buffer, including DTT. The SDS-loading buffer contained a known concentration of BSA which served as a standard to normalise for possible error the loading volume. The samples were heated at 90° C. for 10 minutes, centrifuged for 10 minutes at 14,000 rpm and then equal amounts of each sample were loaded and separated on a 12% Bis/Tris SDS-NuPage gel. Equal loading, background and intensity of bands were quantified using densitometry. The densitometry data was plotted against the concentration of initial protein to produce a sigmoidal curve that was used to determine the protein concentration at which 50% of the protein refolded after heat-unfolding ([protein]_{50%}). The [protein]_{50%} are shown in Table 19.

TABLE 19

| Clone | [protein]_{50%} (μM) |
|---|---|
| TAR2-10-27 | 2-4 |
| TAR2-10-27 F27Q | nd |
| TAR2-10-27 F27D | 5-10 |
| TAR2-10-27 Y32Q | 5-10 |
| TAR2-10-27 Y32D | 25-50 |

Introducing folding gatekeeper mutations had a beneficial effect on TAR2-10-27 by conferring the ability to resist aggregation at higher protein concentration: 2- to 4-fold higher for TAR210-27 F27D and TAR2-10-27 Y32Q, and 7 to 25-fold higher for TAR210-27 Y32D, relative to the parental TAR2-10-27.

### Functional Assays

TNFR1 binding activity of the V_{H} domains was assessed in a receptor binding assay and a cell-based assay.

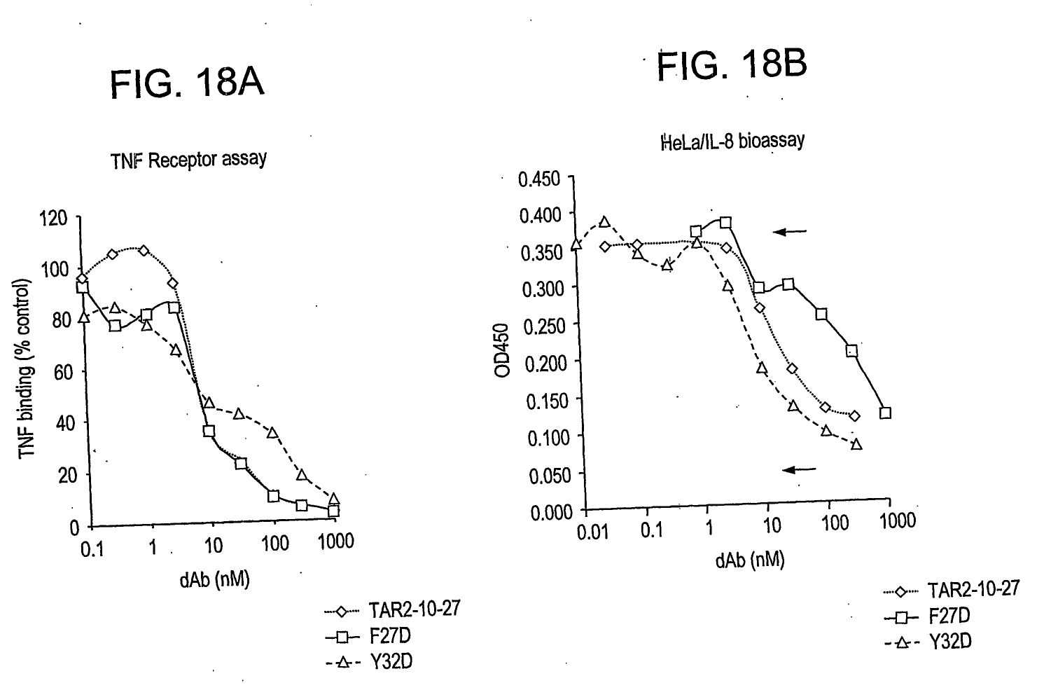

In the receptor binding assay, anti-TNFR1V_{H} domains were tested for the ability to inhibit the binding of TNF to recombinant TNF receptor 1 (p55). Briefly, MAXISORP plates were incubated overnight with 30Mg/ml anti-human Fc mouse monoclonal antibody (Zymed, San Francisco, USA). The wells were washed with phosphate buffered saline (PBS) containing 0.05% TWEEN-20 and then blocked with 1% BSA in PBS before being incubated with 100 ng/ml TNF receptor 1 Fc fusion protein (R&D Systems, Minneapolis, USA). Anti-INFR1 V_{H} domain was mixed with TNF which was added to the washed wells at a final concentration of 10 ng/ml. TNF binding was detected with 0.2 μg/ml biotinylated anti-TNF antibody (HyCult biotechnology, Uben, Netherlands) followed by 1 in 500 dilution of horse radish peroxidase labelled streptavidin (Amersham Biosciences, UK), and then incubation with TMB substrate (KPL, Gaithersburg, USA). The reaction was stopped by the addition of HCl and the absorbance was read at 450 mm. Anti-TNFR1 V_{H} domain binding activity lead to a decrease in TNF binding to receptor and therefore a decrease in absorbance compared with the TNF only control. (FIG. 18A)

In the cell-based assay, anti-TNFR1 V_{H} domains were tested for the ability to neutralise the induction of 118 secretion by TNF in HeLa cells (method adapted from that of Akeson, L. et al. Journal of Biological Chemstry 271, 30517-30523 (1996), describing the induction of IL-8 by IL-1 in HUVEC). Briefly, HeLa cells were plated in microtitre plates and incubated overnight with V_{H} domain proteins and 300 pg INF. Post incubation, the supernatant was aspirated off the cells and the amount of IL-8 in the supernatant was measured using a sandwich ELUSA (R&D Systems). Anti-TNFR1V_{H} domain activity lead to a decrease in IL-8 secretion into the supernatant compared with the TNF only control. (FIG. 18B)

The results of both assays demonstrate that TAR2-10-27 F27D and TAR2-10-27 Y32D retained biological activity. The activity of TAR2-10-27 Y32D was about equivalent to that of the parental dAb TAR2-10-27, while the activity of TAR2-10-27 was slightly reduced relative to TAR2-10-27. (FIGS. 18A and 18B)

For both the receptor-binding assay and the cell based assay, IC50 values can be calculated from the sigmoidal curves with an average precision within a factor of two.

### Conclusion

This section shows that a folding gatekeeper residue can be introduced into a V_{H} domain of pre-defined specificity such that the resulting variant combines increased resistance to aggregation with antigen-binding activity. This was achieved without knowing the functional epitope that is bound by the V_{H} domain. One variant in particular (TAR2-1027-Y32D) retained full biological activity and had a 10-fold increase in resistance to aggregation ([protein]_{50%}). Another benefit of introducing folding gatekeepers, is the increased expression level of the proteins (e.g., by >10-fold in the pET/BL21(DE3)pLysS system). The SE-score of TAR2-10-27-Y32D (0.068) is still above 0 and above the value obtained for HEL4 (−0.187). Thus, if desired, additional folding gatekeepers could be introduced into TAR2-10-27-Y32D for further improvement of its biophysical properties.

Section 17. Selection of an Antigen-Specific VH Domain that Contains a Folding Gatekeepers from a Synthetic Library of VH Domains.

Using phage display technology, antibody variable domains can be isolated from a synthetic repertoire based on binding to an antigen (e.g., by binding antigen immobilized on in a Petri dish and recovering adherent phage, “biopanning’). This approach was used to select a human V_{H} that binds human serum albumin (HSA) from a synthetic human VH repertoire following a heat denaturation step (or without the heat denaturation step for negative control).

The phage library of synthetic VH domains was the library 4G, which is based on a human V_{H}3 comprising the DP47 germline gene and the J_{H}4 segment. The diversity at the following specific positions was introduced by mutagenesis (using NNK codons; numbering according to Kabat) in CDR1: 30, 31, 33, 35; in CDR2: 50, 52, 52a, 53, 55, 56; and in CDR3: 4-12 diversified residues: e.g. H195, H96, H97, and H98 in 4G H11 and H95, H96, H97, H98, H99, H100, H100a, H100b, H100c, H100d, H100e and H100f in 4G H19. The last three CDR3 residues are FDY so CDR3 lengths vary from 7-15 residues. The library comprises >1×10¹⁰ individual clones.

### Protocol

The 4G library was divided into two sub-libraries of equal number of transducing units (1×10¹¹). One was used as such for panning against HSA, and the other was heat-unfolded at 80° C. for 10 minutes before each panning step. For the heating step, the phage sample was dispensed as 100 μL fractions in a PCR tube. After heating, the fractions were combined. Both samples (heat treated and unheated control) were centrifuges for 10 minutes at 14,000 rpm at 4§C. The supernatants were taken further into the selections on immuno-tubes. The antigen (HSA, Sigma-Aldrich) was coated in immuno-tabes (at 100 ug/mL in PBS), stored at 4° C. The tubes were blocked with 2% skim-milk in PBS (2 MPBS).

### Results

After the first round of selection (R1), approx. 3000 phage were eluted from the tubes (both from the heated phage library and from the un-heated library). After a second round of selection (R2), a confluent lawn of colonies was obtained from the selection with un-heated phage, whereas the enrichment was less pronounced for the heated phage library (approx. 2 to 5-fold increase in titer) Individual colonies (n14) were randomly picked from both libraries (heat treated and control) after R2 and separately grown overnight to secrete phage in the supernatant (using a 96-well microtiter cell culture plate).

A phage ELISA was performed according to the protocol of Section 4, with some modifications. The microtiter wells were coated overnight with HSA (10 μg/mL in PBS) and blocked with 2 MPBS. Each of the samples was washed three times with 0.1% TWEEN-20 in PBS. The detection reagents were rabbit-anti-bacteriophage fd full IgG (Sigma) at 1:1000 dilution followed by goat-anti-rabbit conjugated with horseradish peroxidase (full IgG) (Sigma) at 1:1000 dilution. All individual clones were tested against HSA with heat-step or without heat step. They were also tested against BSA (1 ug/mL) and plastic. Only 2/37 positive signals were unspecific.

As predicted, all colonies obtained from the unheated control selection secreted phage VH domains that did not sustain heat-treatment. In contrast all colonies from the heated-selection secreted phage VH domains that refold upon cooling. Thirty-six positive clones in ELISA were sequenced, and 6 unique sequences were obtained for clones from the unheated panning and 1 unique sequence was obtained from the heat-unfolding panning (clone #10) (Table 15 b) #1-4, #6, #7 and #10).

Clone 10, which has two acidic residues at positions 30 and 31 in the CDR1, exhibits the lowest SE-score (0.06) (15 amino acid window). In contrast, the mean SE score obtained from all sequences from the unheated phage selection (Clones #1-7) was above 0.15 (was 0.203±0.020; mean±standard deviation), thereby explaining their greater propensity to aggregate. Interestingly, clone #10 shares 92% identity with clones #2, #5, and #6, suggesting a common binding epitope on HSA for these four V_{H} domains. But only clone #10 exhibits the refolding property and has folding gatekeepers at positions 30 and 31.

The behaviour of the phage-displayed V_{H} domains was further analysed with purified phage. A phage ELISA was performed according to the protocol of Section 5 with the following modifications. 1×10¹⁰ phage were either heat-treated (10 minutes at 80° C. in 100 μL aliquots) or left untreated. The samples were centrifuged for 10 minutes at 14,000 rpm at 4° C. and the supernatants were added to ELISA wells coated with HSA (with a dilution series of ⅓). After developing the ELISA, the OD450 nm values (y-axis) for each heat treated/unheated phage pair were plotted against the phage number α-axis) and the %-refoldability was calculated. The results are shown in Table 20.

TABLE 20

| clone | +Heat | −Heat | Refoldability [%] |
|---|---|---|---|
| #1 | 10¹⁰ | 1.5 × 10⁸ | 1.5 |
| #2 | 10¹⁰ | 1.3 × 10⁹ | n.d. |
| #3 | 10¹⁰ | 5.5 × 10⁷ | 0.55 |
| #4 | 10¹⁰ | 5.7 × 10⁸ | 9.1 |
| #6 | 9.75 × 10⁹ | 2.1 × 10⁷ | <0.2 |
| #7 | nd | nd | Nd |
| #10 | 10¹⁰ | 10¹⁰ | ~100 |

### Conclusion

The results show that the V_{H} domain clone selected on HSA (clone #10) following a heat unfolding step is fully resistant to aggregation when expressed on phage, whereas none of the V_{H} domain clones selected without the heat unfolding step exhibited greater than 10% refolding after heating. This study demonstrates that antigen-specific variable domains that unfold reversibly upon heating can be selected from a repertoire of aggregation-prone V_{H} domains (>98% of the clones from the primary library 4G have been shown to aggregate upon heating).

Section 18. Creation of Phage Libraries of Synthetic VH Domains that Include Folding Gatekeeper Residues.

Section 16, demonstrated that a VH domain with good folding properties can be isolated from a repertoire of aggregation-prone VH domains in which the CDR1 loop was diversified and hence, a small percentage of the VH domains in the primary repertoire had folding gatekeepers in the CDR1 loop. This section describers the preparation of a phage repertoire in which the majority of VH domains unfold reversibly.

### Methods and Results

Diversity was introduced by randomly combining DNA fragments encoding diversified CDR1, CDR2 and CDR3 using assembly PCR. The resulting fragments were cloned into a phage vector (Fd-myc in which the leader sequence was replaced with an eukaryotic leader sequence; see Section 2), to yield a primary library (VH-60). The V_{H} library is based on a single human framework (V3-23/DP-47 and J_{H}4b). The canonical structures (V_{H}: 1-3) encoded by this frameworks are the most common in the human antibody repertoire. Side chain diversity was incorporated using NNK diversified codons at positions in the antigen binding site that make contacts with antigen in known structures, and are highly diverse in the mature repertoire. Diversity was incorporated at the following positions (Kabat numbering):
V_{H} CDR1: H30, H31, H32, H33, H35.
V_{H} CDR2: H50, H52, H52a, H53, H55 and H56.
V_{H} CDR3: 4-12 diversified residues: e.g. H95, H96, H97, and H98 in 4G
H11 and H95, H96, H97, H98, H99, H100, H100a, H100b, H100c, H100d, H100e and H100f in 4G H19. The last three CDR3 residues are FDY so CDR3 lengths vary from 7-15 residues.

The primary library was then used to produce phage stock. The phage stock was split in 2: one stock was used as such for panning on immobilised protein A (which binds correctly folded V_{H} domains). Bound phages were eluted, used to infect E. coli and library DNA was prepared from the pooled infected cells (DNA pool “E”).

The second stock was first heated at 80° C. for 10 minutes, and subsequently panned on protein A. The library of phage propagated after panning was enriched for V_{H} domains that refold after heat denaturation. The DNA pool obtained from these phages is referred to as DNA pool “H”.

Individual colonies from the primary library and from the selected libraries were separately grown for phage production. The phages were tested for their ability to bind to protein A (to assess production as well as correct folding) when untreated or after the heat treatment at 80° C. The results are shown in Table 21.

TABLE 21

| | % positive clones on pA | % positive on pA ELISA (with |
|---|---|---|
| Pool | ELISA (no pre-heating) | heating at 80° C. for 10 min) |
| VH-6G | 1 | nd |
| VH-6G-E | 91 | 24 |
| VH-6G-H | 82 | 51 |

Next a DNA fragment comprising the pooled CDR1 and CDR2 regions was amplified from DNA pool H. From DNA pool E, only the pooled CDR3s were amplified. Finally, a pool of CDR3s was PCR amplified from a naïve passage (nP) with the 6G primary library. The naïve passage pool was produced by growing phage from the primary library, purifying the phage by precipitation, infecting E. coli with the purified phage and recovering DNA from the bacteria. Using SOE-PCR, the pools of CDR1 and CDR2s were randomly recombined with the pool of CDR3s, to recreate full V_{H} domain genes. The following combinations were prepared (Table 22).

TABLE 22

| Code | CDR1/CDR2s | CDR3s |
|---|---|---|
| VH-6G-H + E | H | E |
| VH-6G-H + nP | H | nP |

The CDR1 and CDR2s were systematically taken from the DNA pool H, because the CDR1 segment contains the main determinants of aggregation. In contrast, the CDR3s were from the ‘E’ and ‘np’ pools, which are less important for aggregation.

After SOE-PCR, the fragments were cloned into the phage vector (Fd-myc in which the leader sequence was replaced with an eukaryotic leader sequence; see Section 2), and used to transform E. coli by electroporation in order to obtain large repertoires (>10¹⁰ clones). Individual colonies (n=44) from the 6G-H+E and 6G-H+nP V_{H} libraries were separately grown for phage production. The phages were tested for their ability to bind to protein A (to assess production as well as correct folding) when untreated or after the heat treatment at 80° C. The results are shown in Table 23.

TABLE 23

| | | % positive |
|---|---|---|
| | % positive clones on pA | on pA ELISA (with |
| Code | ELISA (no pre-heating) | heating at 80° C. for 10 min) |
| VH-6G-H + E | 68 | 57 |
| VH-6G-H + nP | 70 | 61 |
| VH-4G-H20 | 50 | 6 |

About 85% of the phage that displayed a functional VH domain containing heat selected CDR1 and CDR2 loops, retained protein A binding activity after the heating step. Thus most of the V_{H} domains in library VH-6G include folding gatekeepers. In contrast, only 12% of the V_{H} domain clones in the unoptimised library 4G (VH-4G-H20) resist aggregation upon heating and retain protein A binding activity. These results demonstrate that adding a single heating step at the library clean-up stage (on protein A), resulted in enrichment of the VH domain library (by 7-fold) with DNA segments encoding VH domains that contain folding gatekeepers and that unfold reversibly upon heating.

Fourteen randomly picked clones from libraries VH-6 GH+E and VH-6G-H+nP were picked and sequenced. The sequences of the loop comprising the CDR1 are listed below as well as their SE-score (using a window of 15 amino acids). The diversified amino acids are underlined.

| | | |
|---|---|---|
| Clone | Sequence | SE-score |

| | | |
|---|---|---|
| 1. | CAASGFTFQYGPMSW | 0.152 |
| | (SEQ ID NO:197) | |
| 2. | CAASGFTFAADNMDW | −0.074 |
| | (SEQ ID NO:198) | |
| 3. | CAASGFTFPTNEMSW | −0.015 |
| | (SEQ ID NO:199) | |
| 4. | CAASGFTFGNASMDW | −0.041 |
| | (SEQ ID NO:200) | |
| 5. | CAASGFTFEDDLMNW | −0.021 |
| | (SEQ ID NO:201) | |
| 6. | CAASGFTFGGDEMTW | −0.061 |
| | (SEQ ID NO:202) | |
| 7. | CAASGFTFDDSTMQW | −0.075 |
| | (SEQ ID NO:203) | |
| 8. | CAASGFTFDNSVMGW | 0.046 |
| | (SEQ ID NO:204) | |
| 9. | CAASGFTFDQTAMHW | −0.021 |
| | (SEQ ID NO:205) | |
| 10. | CAASGFTFPELPMGW | 0.105 |
| | (SEQ ID NO:206) | |
| 11. | CAASGFTFTPGKMNW | 0.013 |
| | (SEQ ID NO:207) | |
| 12. | CAASGFTFEHRTMGW | −0.011 |
| | (SEQ ID NO:208) | |
| 13. | CAASGFTFPNSDMVW | 0.058 |
| | (SEQ ID NO:209) | |
| 14. | CAASGFTFGKSTMAW | 0.044 |
| | (SEQ ID NO:210) | |

Overall, the mean (±SD) SE-score for this region of the 14 Clones is 0.007 (±0.018) which is well below the mean SE-score of V_{H} dummy (DP47d) (0.190) and the mean SE score (0.220) calculated for the encoded diversity (NNK codons) for that region. The diversity at each position was relatively large: 7, 11, 8, 10 and 9 different amino acids were counted in the dataset, at position 30, 31, 32, 33 and 35, respectively. Strongly hydrophilic and β-sheet breakers such as Asp, Glu, Pro and Gly accounted for 43% of the amino acids (versus 19% based on the encoded genetic diversity).

### Conclusion

A synthetic library of human V_{H}3 domain was created by recombination of PCR fragments and displayed on the surface of filamentous phage. A majority of the V_{H}3 dAbs (85%) unfolded reversibly upon beating at 80° C. This library was produced by (1) diversification of the CDR1 region (at position 30, 31, 32, 33 and 35), (2) heat-treatment of the primary phage library before clean-up on protein A, and (3) PCR-mediated recombination of heat-selected CDR1-CDR2-encoding genes and naïve passage-(or simply protein A-cleaned-up) CDR3-encoding genes. In the resulting library, the CDR1 sequences were diverse, but enriched for folding gatekeeper residues such as Asp, Glu, Pro and Gly.

Section 19. Additional Studies Introducing Folding Gatekeepers into dAbs with Predefined Specificity

This section describes the implementation of folding gatekeepers into a dAb with pre-defined specificity. TAR1-5-19 is a Vκ1 domain which is specific for TNF-α. Its sequence is:

(SEQ ID NO:211)

DIQMTQSPSSLSASVGDRVTITCRASQSIDSYLHWYQQKPGKAPKLLIYS
ASELQSGVPSRFSGSGSGTDFTLTISSLQPEDFATYYCQQVVWRPFTFGQ
GTKVEIKR

The results of this rational-design work complements another approach wherein ‘folding gatekeepers’ axe introduced ab initio in dAb libraries displayed on phage.

### Choosing the Folding Gatekeepers for TAR1-5-19:

As described and demonstrated herein, folding gatekeepers can be introduced into the region comprising the H1 loop of DP47d, or the region comprising FR2-CDR2 of V_{κ} dummy (DPK9). For TAR1-5-19, we selected position 49, a solvent-exposed residue at the boundary between FR2 and CDR2. It should be noted that in the absence of structural and mutagenesis data on the dAb, mutations within (or close to) the paratope may be likely to affect binding activity.

As shown in Table 28, two single mutants in PEP1-5-19 lower the SE-15 score (using the Sweet-Eisenberg (SE) scale over a window of 15 amino acids—Sweet R. M. & Eisenberg D., J. Mol. Biol. 171:479-488 (1983)), and therefore indicate that the mutant polypeptide would have high folding yield. It should be also noted that within that 15 aa region, the SE-score of PEP1-5-19 is already fairly low.

TABLE 28

| | | |
|---|---|---|
| Clone | H1 sequence | SE-15 score |

| | | |
|---|---|---|
| TAR1-5-19 | KAPKLLIYSASELQS | 0.011 |
| TAR1-5-19-Y49D | KAPKLLIDSASELQS | −0.187 |
| TAR1-5-19-Y49N | KAPKLLINSASELQS | −0.161 |

### Aggregation Assay of Phage-Displayed TAR1-5-19 and Mutants Thereof:

Using the methods described in Section 5, Phage Screening 2, monoclonal phages displaying TAR1-5-19 and variants were heated for 10 min at 80° C. or left un-heated, and then incubated in TNF-α coated wells for ELISA. The % refolding data were calculated as described in Section 5, Phage Screening 2, and the results are shown in Table 30.

TABLE 30

| Clone | % refolding |
|---|---|
| TAR1-5-19 | 80 |
| TAR1-5-19-Y49N | 98 |
| TAR1-5-19-Y49D | 93 |

The folding gatekeepers have a beneficial effect on TAR1-5-19 refolding, and the variants that contained folding gatekeepers resisted aggregation when heated to 80° C. even when displayed on phage. However, it should be noted that parental TAR1-5-19 also showed good refolding ability due to its low SE-score (0.011).

### Receptor Binding Assay of TAR1-5-19 and Mutants Thereof:

The activity assay was a RBA-ELISA (receptor-binding assay where increasing amount of dAb is used to compete with soluble TNF-binding to immobilised TNF-α-receptor. Bound TNF-α was then detected with a biotinylated non-competing antibody, and streptavidin-HRP conjugate. The IC₅₀ (in nM) is the dAb dose require to produce a 50% reduction of a non-saturating amount of TNF-α to the receptor. The results are shown in Table 31.

TABLE 31

| Clone | IC₅₀ (nM) |
|---|---|
| TAR1-5-19 | 30 |
| TAR1-5-19-Y49N | 900 |
| TAR1-5-19-Y49D | 200 |

Here, the introduction of the folding gatekeeper into TAR1-5-19 affected the in-vitro activity of TAR1-5-19. This suggests that residue Y49 in TAR1-5-19 may be involved (directly or indirectly) in specific contact with TNF-α For TAR1-5-19, Y49 does not appear to be the best choice for introducing a folding gatekeeper (although the mutants are still moderately active). Other positions within the 15 amino acid segment centered around Y49 could be considered to achieve a reduction of the SE-score without reducing the activity of the dAb. For example, TAR1-5-19 variants in which 148 is replaced with P, D, T, G or N, Y49 is replaced with S, C, E, G, K, N or R and/or I75 is replaced with N or M can be produced and characterized as described herein. Such a TAR1-5-19 variant can readily be produce using the methods demonstrated herein.

### Conclusion

In this study, folding gatekeepers were introduced into a dAb of pre-defined specificity, without prior knowledge of structure of the antigen-dAb complex. Binding of variants of TAR1-5-19 was reduced by 6- to 20-fold, but the variants still bound the target with moderate activity, demonstrating that the variants have biological activity. It should be noted that only a two single point mutants were created and studied. Further benefits of introducing folding gatekeepers would be realized by creating and screening additional variants that contain single point mutations or combinations of mutations, for example by positional diversification or by library generation.

TABLE 24
Sweet-Eisenberg (S/E) values of DP47-V_{H} (with
window of 11 amino acids)

| | amino | |
|---|---|---|
| Position | acid | S/E |
| 1 | E | 0.000 |
| 2 | V | 0.000 |
| 3 | Q | 0.000 |
| 4 | L | 0.000 |
| 5 | L | 0.000 |
| 6 | E | −0.122 |
| 7 | S | 0.072 |
| 8 | G | −0.094 |
| 9 | G | −0.055 |
| 10 | G | −0.227 |
| 11 | L | −0.399 |
| 12 | V | −0.338 |
| 13 | Q | −0.177 |
| 14 | P | −0.170 |
| 15 | G | 0.002 |
| 16 | G | 0.013 |
| 17 | S | −0.083 |
| 18 | L | −0.202 |
| 19 | R | −0.155 |
| 20 | L | −0.161 |
| 21 | S | −0.161 |
| 22 | C | 0.075 |
| 23 | A | 0.099 |
| 24 | A | 0.163 |
| 25 | S | 0.166 |
| 26 | G | 0.005 |
| 27 | F | 0.207 |
| 28 | T | 0.155 |
| 29 | F | 0.285 |
| 30 | S | 0.271 |
| 31 | S | 0.366 |
| 32 | Y | 0.510 |
| 33 | A | 0.282 |
| 34 | M | 0.225 |
| 35 | S | 0.014 |
| 36 | W | 0.019 |
| 37 | V | 0.008 |
| 38 | R | −0.205 |
| 39 | Q | −0.229 |
| 40 | A | −0.211 |
| 41 | P | −0.272 |
| 42 | G | −0.272 |
| 43 | K | −0.272 |
| 44 | G | −0.268 |
| 45 | L | −0.222 |
| 46 | E | −0.072 |
| 47 | W | −0.077 |
| 48 | V | −0.077 |
| 49 | S | −0.066 |
| 50 | A | −0.066 |
| 51 | I | −0.238 |
| 52 | S | −0.177 |
| 53 | G | −0.248 |
| 54 | S | −0.179 |
| 55 | G | 0.023 |
| 56 | G | 0.023 |
| 57 | S | −0.210 |
| 58 | T | −0.210 |
| 59 | Y | −0.066 |
| 60 | Y | −0.077 |
| 61 | A | −0.077 |
| 62 | D | −0.070 |
| 63 | S | 0.155 |
| 64 | V | 0.155 |
| 65 | K | 0.116 |
| 66 | G | −0.085 |
| 67 | R | −0.103 |
| 68 | F | −0.103 |
| 69 | T | −0.136 |
| 70 | I | −0.269 |
| 71 | S | −0.269 |
| 72 | R | −0.292 |
| 73 | D | −0.264 |
| 74 | N | −0.327 |
| 75 | S | −0.150 |
| 76 | K | −0.153 |
| 77 | N | −0.185 |
| 78 | T | −0.039 |
| 79 | L | −0.004 |
| 80 | Y | 0.030 |
| 81 | L | 0.191 |
| 82 | Q | 0.198 |
| 83 | M | 0.245 |
| 84 | N | 0.160 |
| 85 | S | −0.070 |
| 86 | L | −0.247 |
| 87 | R | −0.395 |
| 88 | A | −0.229 |
| 89 | E | −0.170 |
| 90 | D | 0.065 |
| 91 | T | 0.131 |
| 92 | A | −0.016 |
| 93 | V | −0.024 |
| 94 | Y | −0.037 |
| 95 | Y | 0.225 |
| 96 | C | 0.284 |
| 97 | A | 0.273 |
| 98 | K | 0.484 |
| 99 | S | 0.282 |
| 100 | Y | 0.282 |
| 101 | G | 0.175 |
| 102 | A | 0.099 |
| 103 | F | 0.053 |
| 104 | D | 0.053 |
| 105 | Y | 0.077 |
| 106 | W | 0.036 |
| 107 | G | 0.180 |
| 108 | Q | 0.191 |
| 109 | G | 0.099 |
| 110 | T | 0.168 |
| 111 | L | 0.000 |
| 112 | V | 0.000 |
| 113 | T | 0.000 |
| 114 | V | 0.000 |
| 115 | S | 0.000 |
| 116 | S | 0.000 |

TABLE 25
Sweet-Eisenberg (S/E) values of DPK9-Vκ (with
window of 11 amino acids)

| | amino | |
|---|---|---|
| Position | acid | S/E |
| 1 | D | 0.000 |
| 2 | I | 0.000 |
| 3 | Q | 0.000 |
| 4 | M | 0.000 |
| 5 | T | 0.000 |
| 6 | Q | −0.187 |
| 7 | S | −0.118 |
| 8 | P | −0.268 |
| 9 | S | −0.235 |
| 10 | S | −0.245 |
| 11 | L | −0.281 |
| 12 | S | −0.317 |
| 13 | A | −0.321 |
| 14 | S | −0.194 |
| 15 | V | −0.169 |
| 16 | G | −0.005 |
| 17 | D | −0.142 |
| 18 | R | −0.076 |
| 19 | V | −0.094 |
| 20 | T | −0.080 |
| 21 | I | −0.213 |
| 22 | T | −0.235 |
| 23 | C | −0.165 |
| 24 | R | 0.002 |
| 25 | A | −0.131 |
| 26 | S | −0.155 |
| 27 | Q | −0.117 |
| 28 | S | 0.019 |
| 29 | I | −0.080 |
| 30 | S | 0.019 |
| 31 | S | 0.207 |
| 32 | Y | 0.175 |
| 33 | L | 0.175 |
| 34 | N | 0.164 |
| 35 | W | 0.005 |
| 36 | Y | −0.005 |
| 37 | Q | −0.016 |
| 38 | Q | −0.205 |
| 39 | K | −0.360 |
| 40 | P | −0.337 |
| 41 | G | −0.272 |
| 42 | K | −0.313 |
| 43 | A | −0.116 |
| 44 | P | 0.118 |
| 45 | K | 0.143 |
| 46 | L | 0.151 |
| 47 | L | 0.162 |
| 48 | I | 0.173 |
| 49 | Y | 0.320 |
| 50 | A | 0.282 |
| 51 | A | 0.293 |
| 52 | S | 0.121 |
| 53 | S | 0.093 |
| 54 | L | −0.065 |
| 55 | Q | −0.267 |
| 56 | S | −0.285 |
| 57 | G | −0.074 |
| 58 | V | −0.074 |
| 59 | P | −0.085 |
| 60 | S | −0.245 |
| 61 | R | −0.224 |
| 62 | F | −0.224 |
| 63 | S | −0.224 |
| 64 | G | −0.332 |
| 65 | S | −0.406 |
| 66 | G | −0.182 |
| 67 | S | −0.154 |
| 68 | G | −0.217 |
| 69 | T | −0.193 |
| 70 | D | −0.018 |
| 71 | F | −0.018 |
| 72 | T | −0.007 |
| 73 | L | 0.154 |
| 74 | T | 0.132 |
| 75 | I | 0.113 |
| 76 | S | 0.121 |
| 77 | S | −0.173 |
| 78 | L | 0.027 |
| 79 | Q | −0.120 |
| 80 | P | −0.120 |
| 81 | E | −0.082 |
| 82 | D | 0.120 |
| 83 | F | 0.185 |
| 84 | A | −0.008 |
| 85 | T | −0.008 |
| 86 | Y | −0.014 |
| 87 | Y | 0.249 |
| 88 | C | 0.318 |
| 89 | Q | 0.118 |
| 90 | Q | 0.110 |
| 91 | S | 0.052 |
| 92 | Y | −0.125 |
| 93 | S | −0.103 |
| 94 | T | −0.179 |
| 95 | P | −0.179 |
| 96 | N | −0.157 |
| 97 | T | −0.133 |
| 98 | F | −0.345 |
| 99 | G | −0.213 |
| 100 | Q | −0.298 |
| 101 | G | −0.140 |
| 102 | T | −0.117 |
| 103 | K | −0.145 |
| 104 | V | −0.356 |
| 105 | E | 0.000 |
| 106 | I | 0.000 |
| 107 | K | 0.000 |
| 108 | R | 0.000 |
| 109 | A | 0.000 |
| 110 | A | 0.000 |

TABLE 26
Sweet-Eisenberg (S/E) values of DP47-V_{H} (with
window of 15 amino acids)

| Position | S/E |
|---|---|
| 8 | −0.167 |
| 9 | −0.130 |
| 10 | −0.227 |
| 11 | −0.085 |
| 13 | −0.206 |
| 14 | −0.161 |
| 15 | −0.113 |
| 16 | −0.095 |
| 17 | −0.077 |
| 18 | −0.069 |
| 19 | −0.195 |
| 20 | −0.128 |
| 21 | −0.086 |
| 22 | 0.075 |
| 23 | 0.083 |
| 24 | 0.091 |
| 25 | 0.239 |
| 26 | 0.131 |
| 27 | 0.238 |
| 28 | 0.120 |
| 29 | 0.190 |
| 30 | 0.239 |
| 31 | 0.227 |
| 32 | 0.193 |
| 33 | 0.203 |
| 34 | 0.215 |
| 35 | 0.042 |
| 36 | 0.016 |
| 37 | −0.157 |
| 38 | −0.039 |
| 39 | −0.083 |
| 40 | −0.161 |
| 41 | −0.074 |
| 42 | −0.179 |
| 43 | −0.169 |
| 44 | −0.119 |
| 45 | −0.216 |
| 46 | −0.221 |
| 47 | −0.197 |
| 48 | −0.215 |
| 46 | −0.221 |
| 49 | −0.227 |
| 50 | −0.219 |
| 51 | −0.193 |
| 52 | −0.037 |
| 53 | −0.007 |
| 54 | −0.047 |
| 55 | −0.073 |
| 56 | −0.171 |
| 57 | −0.073 |
| 58 | −0.091 |
| 59 | −0.219 |
| 60 | −0.222 |
| 61 | −0.049 |
| 62 | −0.031 |
| 63 | 0.097 |
| 64 | 0.105 |
| 65 | 0.102 |
| 66 | 0.033 |
| 67 | −0.139 |
| 68 | −0.287 |
| 69 | −0.305 |
| 70 | −0.279 |
| 71 | −0.261 |
| 72 | −0.241 |
| 73 | −0.085 |
| 74 | 0.041 |
| 75 | 0.020 |
| 76 | −0.040 |
| 77 | −0.083 |
| 78 | −0.203 |
| 79 | −0.085 |
| 80 | −0.085 |
| 81 | −0.024 |
| 82 | −0.044 |
| 83 | −0.095 |
| 84 | −0.069 |
| 85 | −0.034 |
| 86 | 0.045 |
| 87 | 0.075 |
| 88 | 0.075 |
| 89 | 0.005 |
| 90 | 0.039 |
| 91 | −0.073 |
| 92 | −0.049 |
| 93 | 0.099 |
| 94 | −0.027 |
| 95 | −0.014 |
| 96 | 0.141 |
| 97 | 0.135 |
| 98 | 0.333 |
| 99 | 0.385 |
| 100 | 0.367 |
| 101 | 0.246 |
| 102 | 0.090 |
| 103 | −0.040 |
| 104 | 0.030 |
| 105 | 0.117 |
| 106 | 0.143 |
| 107 | 0.241 |
| 108 | 0.093 |
| 109 | 0.101 |

TABLE 27
Sweet-Eisenberg (S/E) values of DPK9-Vκ (with
window of 15 amino acids)

| Position | S/E |
|---|---|
| 8 | −0.177 |
| 9 | −0.134 |
| 10 | −0.305 |
| 11 | −0.283 |
| 12 | −0.291 |
| 13 | −0.291 |
| 14 | −0.147 |
| 15 | −0.129 |
| 16 | −0.085 |
| 17 | −0.087 |
| 18 | −0.077 |
| 19 | −0.195 |
| 20 | −0.219 |
| 21 | −0.229 |
| 22 | −0.109 |
| 23 | −0.207 |
| 24 | −0.199 |
| 25 | −0.000 |
| 26 | 0.121 |
| 27 | −0.001 |
| 28 | 0.051 |
| 29 | 0.079 |
| 30 | 0.037 |
| 31 | −0.035 |
| 32 | −0.041 |
| 33 | −0.047 |
| 34 | −0.055 |
| 35 | −0.039 |
| 36 | −0.029 |
| 37 | −0.145 |
| 38 | −0.153 |
| 39 | −0.035 |
| 40 | −0.065 |
| 41 | −0.063 |
| 42 | 0.110 |
| 43 | 0.050 |
| 44 | −0.088 |
| 45 | −0.064 |
| 46 | −0.040 |
| 47 | 0.086 |
| 48 | 0.058 |
| 49 | 0.066 |
| 50 | 0.066 |
| 51 | 0.153 |
| 52 | 0.153 |
| 53 | 0.161 |
| 54 | 0.041 |
| 55 | 0.087 |
| 56 | −0.033 |
| 57 | −0.189 |
| 58 | −0.199 |
| 59 | −0.217 |
| 60 | −0.217 |
| 61 | −0.225 |
| 62 | −0.325 |
| 63 | −0.351 |
| 64 | −0.187 |
| 65 | −0.161 |
| 66 | −0.140 |
| 67 | −0.126 |
| 68 | −0.006 |
| 69 | −0.003 |
| 70 | −0.168 |
| 71 | −0.050 |
| 72 | −0.066 |
| 73 | −0.062 |
| 74 | −0.099 |
| 75 | −0.149 |
| 76 | 0.023 |
| 77 | 0.015 |
| 78 | 0.084 |
| 79 | 0.067 |
| 80 | 0.197 |
| 81 | 0.127 |
| 82 | 0.085 |
| 83 | −0.059 |
| 84 | −0.059 |
| 85 | 0.089 |
| 86 | −0.029 |
| 90 | 0.102 |
| 91 | 0.102 |
| 92 | 0.084 |
| 93 | 0.042 |
| 94 | −0.114 |
| 95 | −0.244 |
| 96 | −0.300 |
| 97 | −0.179 |
| 98 | −0.199 |
| 99 | −0.079 |
| 100 | −0.235 |
| 101 | −0.238 |
| 102 | −0.246 |
| 103 | −0.240 |

While this invention has been particularly shown and described with references to preferred embodiments thereof, it will be understood by those skilled in the art that various changes in form and details may be made therein without departing from the scope of the invention encompassed by the appended claims.

1. A process for recovering at least one polypeptide that unfolds reversibly from a repertoire of polypeptides, wherein the polypeptides in the repertoire that unfold reversibly have a common selectable characteristic that distinguishes folded polypeptides from unfolded or misfolded polypeptides, the process comprising
providing a polypeptide display system comprising the repertoire of displayed polypeptides;
unfolding at least a portion of said displayed polypeptides;
refolding at least a portion of the unfolded polypeptides; and
recovering at least one polypeptide that unfolds reversibly and has said selectable characteristic from the refolded portion.

2. The process of claim 1, wherein said unfolding is effectuated by heating to a temperature Ts, said refolding is effectuated by cooling to a temperature Tc, said recovering is at a temperature Tr, and the recovered polypeptide has a melting temperature Tm, wherein Ts>Tm>Tc and Ts>Tm>Tr.

3. The process of claim 2, wherein after heating and cooling, the polypeptide display system comprises at least a portion of polypeptides that have unfolded and refolded and a portion of polypeptides that have aggregated.

4. The process of claim 1, further comprising determining the amino acid sequence of a recovered polypeptide that unfolds reversibly.

5. The process of claim 1, wherein said polypeptide display system comprises a library.

6. The process of claim 1, wherein said polypeptide display system is selected from the group consisting of bacteriophage display, ribosome display, emulsion compartmentalization and display, yeast display, puromycin display, bacterial display, polypeptide display on plasmid and covalent display.

7. The process of claim 1, wherein said polypeptide display system is bacteriophage display.

8. The process of claim 1, wherein unfolding is effectuated by raising the temperature of the polypeptide display system, modulating the pressure of the polypeptide display system, modulating the pH of the polypeptide display system, increasing the concentration of a chaotropic agent in the polypeptide display system and/or increasing the concentration of an organic solvent in the polypeptide display system.

9. The process of claim 1, wherein the polypeptides are unfolded using an unfolding agent that does not substantially inhibit aggregation of unfolded polypeptides that do not unfold reversibly.

10. The process of claim 1, wherein unfolding is effectuated by raising the temperature of the polypeptide display system to an unfolding temperature at which at least about 50% of the displayed polypeptides are unfolded, and refolding is effectuated by reducing the temperature of the polypeptide display system to a refolding temperature at which at least a portion of the unfolded polypeptides refold.

11. The process of claim 10, wherein the polypeptide display system is heated to an unfolding temperature at which substantially all of the displayed polypeptides are unfolded.

12. The process of claim 11, wherein said unfolding temperature and said refolding temperature differ by at least about 10° C.

13. The process of claim 1, wherein said common selectable characteristic is a selectable functional characteristic selected from the group consisting of binding to a ligand, a catalytic activity and resistance to proteolysis.

14. The process of claim 13, wherein said selectable functional characteristic is binding to a generic ligand.

15. The process of claim 1, wherein said common selectable characteristic is an epitope presented on the displayed polypeptides when folded, but absent from misfolded or unfolded polypeptides.

16. The process of claim 1, wherein each displayed polypeptide comprises an antibody variable domain.

17. The process of claim 16, wherein said antibody variable domain is a human antibody variable domain.

18. The process of claim 17, with the proviso that said variable domain does not contain one or more amino acids that are unique to Camelid immunoglobulin variable domains encoded by germline sequences.

19. The process of claim 16, wherein one or more of the framework regions (FR) in said variable domain comprises (a) the amino acid sequence of a human framework region, (b) at least 8 contiguous amino acids of the amino acid sequence of a human framework region, or (c) an amino acid sequence encoded by a human germline antibody gene segment, wherein said framework regions are as defined by Kabat.

20. The process of claim 16, wherein the amino acid sequences of one or more framework regions in said variable domain is the same as the amino acid sequence of a corresponding framework region encoded by a human germline antibody gene segment, or the amino acid sequences of one or more of said framework regions collectively comprise up to 5 amino acid differences relative to the corresponding framework regions encoded by a human germline antibody gene segment.

21-200. (canceled)
